(19) United States
(12) Patent Application Publication
(10) Pub. No.: US 2026/0047576 A1
(43) Pub. Date: Feb. 19, 2026

(54) Methods for controlling weeds in short-statured corn plants with herbicides

(71) Applicant: BASF SE, Ludwigshafen (DE)

(72) Inventors: Cyrill Zagar, Raleigh, NC (US); Wilfried Baetz, Limburgerhof (DE); Mark Oostlander, Calgary (CA); Ronald Repage, Durham, NC (US); Thomas Seitz, Ludwigshafen (DE)

(21) Appl. No.: 19/294,735

(22) Filed: Aug. 8, 2025

Related U.S. Application Data
(60) Provisional application No. 63/683,108, filed on Aug. 14, 2024.

(51) Int. Cl. A01N 43/10; A01N 37/40; A01N 43/54; A01N 43/80; A01N 47/34; A01N 57/20; A01P 13/02

(52) U.S. Cl. CPC A01N 43/10; A01N 37/40; A01N 43/54; A01N 43/80; A01N 47/34; A01N 57/20; A01P 13/02

(57) ABSTRACT

The present invention relates to methods for controlling weeds in short-statured corn plants with herbicides comprising the application of herbicides to the plants, parts of such plants, their seeds, or their locus of growth.

The present invention relates to methods for controlling weeds in short-statured corn plants with herbicides comprising the application of herbicides to the plants, parts of such plants, their seeds, or their locus of growth.

Hybrid corn plants often reach average heights well over 2.00 m during the growing season, particularly during later stages of development. Corn can be harvested after having reached maturity, typically after drying down to a desired moisture content for storage. Growers have to balance product value, plant health, kernel moisture content, and standability (e.g. due to the propensity of corn to lodge, or greensnap), when determining the optimum time for harvesting. The risk of lodging increases with time due to weather events (e.g strong winds) or plant senescence.

Corn plants can be described by their vegetative growth, reproductive stages and by the stages of corn kernel development (Leaf Collar method: V1-Vn, Vt, R1-R6, etc.) as described in: L. J. Abendroth, R. W. Elmore, M. J. Boyer, and S. K. Marlay, Corn Growth and Development 2011, PMR 1009, Iowa State University Extension, Ames, Iowa. Stages of corn plant growth are divided into vegetative (V) stages and reproductive (R) stages. Upon germination, a corn plant is said to be in VE stage (emergence). Once the first leaf collar (e.g the ligule) is visible, the corn plant is in the VI stage. The emergence of the second leaf collar signifies V2 stage; the emergence of the third leaf collar signifies the V3 stage; and so on until the tassel emerges. For example, if twelve leaf collars are visible, the plant is a V12 stage plant. Once the bottom-most branch of the tassel emerges the plant is in VT stage, which is the final vegetative stage. The reproductive stage of growth occurs after the vegetative stage. The number of vegetative stages prior to VT stage can vary by environment and corn line. The first reproductive stage (RI; silking stage;“silking”) occurs when silk is visible outside the husk leaves surrounding an ear of com. R2 (blistering stage) occurs when corn kernels are white on the outside and are filled with a clear liquid inside. R3 (milk stage) occurs when the kernels are yellow on the outside and are filled with a milky white fluid inside. R4 (dough stage) occurs when the kernels are filled with a thick, or pasty, fluid. In some corn lines the cob will also turn pink or red at this stage. R5 (dent stage) occurs when a majority of the kernels are at least partially dented. The final reproductive stage, R6 (physiological maturity), occurs when the kernels have attained their maximum dry weight.

Another method to describe the developmental growth stage of corn is given in the BBCH monograph by U. Meier (ed.), Federal Biological Research Centre for Agriculture and Forestry, Germany, Growth Stages of Mono- And Dicotyledonous Plants, 2001 (2^{nd} edition). The development of corn plants in this monograph is divided into principal growth stages germination (0) with 00 being the dry seed up to 09 at emergence when the coleoptile is penetrating the soil surface, leaf development (1) with the first leaf unfolded at stage 11 to 9 or more leaves unfolded at stage 19, stem elongation (3) with beginning of stem elongation at stage 30 to 9 or more nodes of the stem detectable at stage 39, inflorescence emerging (heading) with begining of tassel emergence (tassel detectable at the top of the stem) at stage 51 to end of tassel emergence (tassel fully emerged and separated) at stage 59, flowering or anthesis (6) with stamens in the middle of the tassel visible (male) and tip of the ear emerging from the leaf sheath (female) at stage 61 to end of flowering (stigma completely dry) at stage 69, development of fruit (7) with beginning of grain development at stage 71 to nearly all kernels have reached final size at stage 79, ripening (8) starting with early dough (kernel content soft) and ending when the kernels are fully ripe (kernels are hard and shiny) at stage 89, and senescence (9) with the plant being dead at stage 97 and the harvested product at stage 99.

Corn is also known as Indian corn or maize (Zea mays) which comprises all kinds of corn such as field corn and sweet corn. As used herein, the terms “maize” and “corn” are used interchangeably. According to the diclosure provided herein all maize or corn subspecies and/or varieties are comprised, in particular flour corn (Zea mays var. amylacea), popcorn (Zea mays var. everta), dent corn (Zea mays var. indentata), flint corn (Zea mays var. indurata), sweet corn (Zea mays var. saccharata and var. rugosa), waxy corn (Zea mays var. ceratina), amylomaize (high amylose Zea mays varieties), pod corn or wild maize (Zea mays var. tunicata) and striped maize (Zea mays var. japonica).

Short-statured corn (herein referred to as SSC) is characterized by a reduced average height as compared to conventional hybrid corn, with the same number of nodes, albeit shorter stalk internodes (i.e. reduced distance between the nodes). The yield potential is essentially the same in conventional hybrid corn and SSC. SSC is also known to the skilled person as “dwarfed” or “semi-dwarfed” corn. By providing plants with reduced heights that have improved standability performance (i.e. resistance to lodging as it is less of a wind target), growers are enabled to allow for greater periods of time until harvest, thereby drying down the kernels to a desired moisture content for storage, without increasing their risk of yield loss due to lodging. Shorter plants permit higher densities of plants per planted area and emphasize ear and kernel production rather than plant biomass as do taller corn plants.

Surprisingly, it has now been found that treatment of SSC with herbicides provides effective weed control.

Accordingly, the present invention relates to a method for the treatment of SSC plants with an agricultural composition comprising herbicides in a herbicidally effective amount by application of said compositions to the SSC plants, parts of such plants, their seeds, or their locus of growth, wherein the agricultural composition comprises at least one of the herbicides I-1 to I-25, or an agriculturally useful salt, or a combination of the herbicides I-12, I-13 or I-14 and the safener II-1, and wherein the herbicides and the safener are: I-1: Dimethenamid-P, I-2: pyroxasulfone, I-3: isoxaflutole, I-4: saflufenacil, I-5: trifludimoxazin, I-6: epyrifenacil, I-7: 2-[2-[[3-chloro-6-[3,6-dihydro-3-methyl-2,6-dioxo-4-(trifluoromethyl)-1(2H-pyrimidinyl]-5-fluoro-2-pyridinyl]oxy]phenoxy]acetic acid ethyl ester (CAS 2158274-50-9), I-8: glufosinate, I-9 glufosinate ammonium, I-10: L-glufosinate, I-11: L-glufosinate ammonium, I-12: dicamba, I-13: dicamba sodium salt, I-14: dicamba BAPMA salt (BAPMA: N,N-Bis(3-aminopropyl)methylamine), I-15: diflufenzopyr sodium salt, I-16: topramezone, 1:17: pendime-thalin, I-18: 3,6-dicyclopropylisoxazolo[5,4-b]pyridine-4-carboxylic acid (CAS 937600-24-3), I-19: clethodim, I-20: quizalofop, I-21: quizalofop-ethyl, I-22: quizalofop-tefuryl, I-23: quizalofop-P, I-24: quizalofop-P-ethyl, I-25: quizalofop-P-tefuryl, II-1: isoxadifen-ethyl.

The herbicides referred to as herbicides I-1 to I-25 and the safener ∥-1, their preparation and their activity against weeds, respectively its safening effect, are known (cf.: http:/jwv.alanwood.net/esticides/) and/or they are commercially available. The herbicide I-7 is known from WO 2017/202768.

Compound I-18, its preparation and its use as a herbicide is known from WO 2012/010633, WO 2015/155236 and WO 2018/108612.

Agriculturally acceptable salts of the chemical pesticides encompass especially the salts of those cations which have no adverse effect on the herbicidal action of the active compounds. Suitable cations are thus in particular the ions of the alkali metals, preferably sodium and potassium, of the alkaline earth metals, preferably calcium and magnesium, and also the ammonium ion which, if desired, may carry 1 to 4 C₁-C₄-alkyl or hydroxy-C₁-C₄-alkyl substituents and/or one phenyl or benzyl substituent, preferably ammonium, methylammonium, isopropylammonium, 2-hydroxyethylammonium, di(2-hydroxyethyl)ammonium, diisopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium.

The term SSC plants relates to plants, which have been modified by conventional breeding techniques, including targeted and non-targeted mutagenesis.

The term SSC plants also relates to plants, which have been modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant (traits). Such traits comprise but are not limited to ear traits, yield traits or general agronomic traits. Genes, which have been integrated into the genome of a plant are frequently referred to as “transgenes”. Plants that have these transgenes incorporated are referred to as a “transgenic plant”, so as to refer to a plant whose genome has been altered by the integration or insertion of a recombinant DNA molecule, construct, cassette or sequence for expression of a non-coding RNA molecule, mRNA and/or protein in the plant. A transgenic plant includes an Rₒ plant developed or regenerated from an originally transformed plant cell(s) as well as progeny transgenic plants in later generations or crosses from the Rₒ transgenic plant that comprise the recombinant DNA molecule, construct, cassette or sequence. A plant having an integrated or inserted recombinant DNA molecule, construct, cassette or sequence is considered a transgenic plant even if the plant also has other mutation(s) or edit(s) that would not themselves be considered transgenic.

As used herein, the term SSC plant also referred to a “brachytic plant”, which is a plant having a mutated, edited or suppressed brachytic gene and a short semi-dwarf height and stature relative to a control plant (e.g., a wild-type sibling plant comprising all other traits except the brachytic trait) due to a shortening of the average intemode length. Such a brachytic mutant plant can have a short semi-dwarf height and stature due to a shortening of the average intemode length. As used herein, a “brachytic gene”, “BR gene”, or “br gene”, or “Br gene” refers to any brachytic gene in a corn plant that when suppressed, mutated or edited to reduce its expression or function can result in a shorter, semi-dwarf corn plant and phenotype. It will be appreciated in the art that dwarf, semi-dwarf, and brachytic plants can be inbred or hybrid plants. Three brachytic mutants have been isolated in maize to date: brachyticl (brl), brachytic2 (br2) and brachytic3 (br3). brachytic3 is also known as brevis plant 1 (Bvl). Both brl and br3 mutations cause a reduction in corn plant height which has been thought too severe for commercial exploitation due to potential impacts on yield. In contrast, the br2 mutant has particular agronomic potential because of shortening of the intemodes of the lower stalk without an obvious reduction in other plant organs. In addition, br2 lines exhibit an unusual stalk strength and tolerance to wind lodging, while the leaves are often darker and persist longer in the active green than those of the wild-type plants. The br2 phenotype is insensitive to treatment with Gibberellins, auxins, brassinosteroids and cytokinins, suggesting that the biosynthesis of these hormones is not modified by the br2 mutation. Multani etal. identified the genomic sequence of the br2 gene and deposited it under GenBank Accession No. AY366085. See Multani el al, Science, 302:81-84 (2003). Br2 was annotated to encode a putative protein similar to adenosine triphosphate (ATP)-binding cassette transporters of the multi drug resistant (MDR) class of P-gly coproteins (PGPs). Pilu et al. reported a br2-23 allele having an 8-bp deletion in the 3′ end of the br2 gene and claimed a direct relationship between this deletion and the brachytic phenotype in their br2-23 plants. See Pilu et al., Molecular Breeding, 20:83-91(2007). Other brachytic gene alleles are known in the art which may be used according to embodiments of the present invention.

As mentioned above, the term SSC plant also relates to plants, which have been modified by a targeted geome editing technique, a method, protocol or technique that allows the precise and/or targeted editing of a specific location in an endogenous genome of a plant using a site-specific nuclease, such as meganuclease, a zinc-finger nuclease (ZFN), an RNA-guided endonuclease (e.g. the CRISPR/Cas9 system), a TALE-endonuclease (TALEN), a recombinase, or a transportase.

In one embodiment, a SSC plant or plurality thereof provided herein can comprise a mutation or edit in one or more loci or genes, or a transgene targeting such one or more loci or genes, that have been associated with a short stature phenotype in com, such as one or more of the following: anther ear 1 (Anl), brachytic 1 (Brl), brevis plant 1 (Bvl) or brachytic 3 (br3), crinkly 4 (Cr4), compact plant 2 (Ct2), dwarf plant 1 (dl), dwarf plant 8 (d8), dwarf plant 9 (d9), nana plant 1 (Nal), nana plant 2 (Na2), non-chromosomal stripe 3 (Nsc3), narrow leaf dwarf 1 (Nidi), reduced plant 1 (Rdl), semi dwarf 1 (Sdwl), semi-dwarf 2 (Sdw2), tangled 1 (Tanl), terminal ear 1 (Tel), and vanishing tassel 2 (Vt2). As used herein, a “mutation” includes an edit—i.e. , a mutation introduced via a genome editing technique.

The term SSC also relates to corn plants, which have a shorter average hight due to a treatment with plant treatment agents. Thus, as used herein, a plant treatment agent can refer to any exogenously provided compound that can be applied to the surface of a plant and migrate into the plant tissue. Contacting a corn plant with a plant treatment agent can occur before, during, or after the application of other substances. plant treatment agents include, but are not limited to, macromolecules including polynucleotides including nucleic acids (e.g. DNA and/or RNA), polypeptides, polysaccharides, polyketides, and the like. Polynucleotides can be single-stranded or double-stranded and can include antisense molecules and interfering RNAs. Polynucleotides can include mutations and/or various other modifications, such as to their backbones, that are well known in the art. Polynucleotides include “genetic elements”, which comprise recombinant DNA constructs (commonly referred to as “transgenes”) that have been inserted into a plant genome, or a nucleotide sequence, or a genetic locus of a plant genome. In certain embodiments a plant treatment agent comprises a plant growth regulator (PGR). PGRs are a class of compounds that affect the cellular processes, growth, development or behavior of a plant or plant part. In some embodiments a PGR is responsible for accelerating or retarding the rate of growth or maturation or otherwise altering the behavior of a plant or plant part. In some embodiments, a PGR is a naturally occurring plant hormone. In some embodiments, a PGR is a microbial pesticide with plant stress reducing, plant growth regulator, plant growth promoting and/or yield enhancing activity: Azospirillum brasilense Ab-V5 and Ab-V6, A. brasilense Sp245, Bradyrhizobium elkanii SEMIA 587, B. elkanii SEMIA 5019, B. japonicum 532c, B. japonicum E-109, B. japonicum SEMIA 5079, B. japonicum SEMIA 5080.

In some embodiments, a PGR is a chemical, which alters internode length, apical dominance, ripening, root architecture, or fruiting, including any substance that affects growth, development, behavior, or reproduction in a corn plant. Plant growth regulators are commonly known tho the skilled person. They include, but are not limited to, auxins (e.g. indole-3-acetic acid, or IAA; and inodole-3-butyric acid, or IBA; both are naturally-occurring forms of a class of plant hormones called auxins). Other variations of auxin can be used, including synthetic auxins, such as 2,4-D (2,4-Dichlorophenoxyactic acid and a-NAA (a-Naphthalene acetic acid) and auxin inhibitors, cytokinins (e.g. N-(Phenylmethyl)-7H-pruin-6-amine, or BAP) and cytokinin inhibitors, compounds that can stimulate ethylene production (i.e. ACC and the like) and compounds that can inhibit ethylene production (i.e. AVG and the like), and compounds that inhibit ethylene perception (silver and the like). Plant growth regulators also comprise compounds that modulate plant perception, signaling, and/or behavior, such as giberrellins and their inhibitors (also referred to herein as gibberellic acid-inhibitors (GA-inhibitors)), abscisic acid and its inhibitors, and jasmonic acid and its inhibitors. Other examples include peptide hormones, for example, systemin, phytosulfokine, rapid alkalinization factor and the like.

The term SSC also relates to corn plants which have been modified by mutagenesis or genetic engineering in order to provide a new trait to a plant or to modify an already present trait that is different from the aforementioned traits related to short stature, in particular traits that confer tolerance to herbicides or insects.

Mutagenesis includes techniques of random mutagenesis using X-rays or mutagenic chemicals, but also techniques of targeted mutagenesis, in order to create mutations at a specific locus of a plant genome. Targeted mutagenesis techniques frequently use oligonucleotides or proteins like CRISPR/Cas, zinc-finger nucleases, TALENs or meganucleases to achieve the targeting effect.

Genetic engineering usually uses recombinant DNA techniques to create modifications in a plant genome which under natural circumstances cannot readily be obtained by cross breeding, mutagenesis or natural recombination. Typically, one or more genes are integrated into the genome of a plant in order to add a trait or improve a trait. These integrated genes are also referred to as transgenes in the art, while plant comprising such transgenes are referred to as transgenic plants. The process of plant transformation usually produces several transformation events, which differ in the genomic locus in which a transgene has been integrated. Plants comprising a specific transgene on a specific genomic locus are usually described as comprising a specific “event”, which is referred to by a specific event name. Traits which have been introduced in plants or have been modified include in particular herbicide tolerance, insect resistance, increased yield and tolerance to abiotic conditions, like drought.

Herbicide tolerance has been created by using mutagenesis as well as using genetic engineering. Plants which have been rendered tolerant to acetolactate synthase (ALS) inhibitor herbicides by conventional methods of mutagenesis and breeding comprise plant varieties commercially available under the name Clearfield®. However, most of the herbicide tolerance traits have been created via the use of transgenes.

Herbicide tolerance has been created to glyphosate, glufosinate, 2,4-D, dicamba, oxynil herbicides, like bromoxynil and ioxynil, sulfonylurea herbicides, ALS inhibitor herbicides and 4-hydroxyphenylpyruvate dioxygenase (HPPD) inhibitors, like isoxaflutole and mesotrione.

Transgenes wich have been used to provide herbicide tolerance traits comprise: for tolerance to glyphosate: cp4 epsps, epsps grg23ace5, mepsps, 2mepsps, gat4601, gat4621 and goxv247, for tolerance to glufosinate: pat and bar, for tolerance to 2,4-D: aad-1 and aad-12, for tolerance to dicamba: dmo, for tolerance to oxynil herbicies: bxn, for tolerance to sulfonylurea herbicides: zm-hra, csrl-2, gm-hra, S4-HrA, for tolerance to ALS inhibitor herbicides: csrl -2, for tolerance to HPPD inhibitor herbicides: hppdPF, W336 and avhppd-03.

Transgenic corn events comprising herbicide tolerance genes are for example, but not excluding others, DAS40278, MON801, MON802, MON809, MON810, MON832, MON87411, MON87419, MON87427, MON88017, MON89034, NK603, GA21, MZHGOJG, HCEM485, VCO-Ø1981-5, 676, 678, 680, 33121, 4114, 59122, 98140, Bt10, Bt176, CBH-351, DBT418, DLL25, MS3, MS6, MZIR098, T25, TC1507 and TC6275.

Insect resistance has mainly been created by transferring bacterial genes for insecticidal proteins to plants. Transgenes which have most frequently been used are toxin genes of Bacillus spec. and synthetic variants thereof, like crylA, crylAb, crylAb-Ac, crylAc, crylA.105, cryl F, cryl Fa2, cry2Ab2, cry2Ae, mcry3A, ecry3.1Ab, cry3Bb1, cry34Ab1, cry35Ab1, cry9C, vip3A(a), vip3Aa20. However, also genes of plant origin have been transferred to other plants. In particular genes coding for protease inhibitors, like CpTI and pinll. A further approach uses transgenes in order to produce double stranded RNA in plants to target and downregulate insect genes. An example for such a transgene is dvsnf7.

Transgenic corn events comprising genes for insecticidal proteins or double stranded RNA are for example, but not excluding others, Bt10, Bt11, Bt176, MON801, MON802, MON809, MON810, MON863, MON87411, MON88017, MON89034, 33121, 4114, 5307, 59122, TC1507, TC6275, CBH-351, MIR162, DBT418 and MZIR098.

Increased yield has been created by increasing ear biomass using the transgene athbl 7, being present in corn event MON87403, or by enhancing photosynthesis using the transgene bbx32, being present in the soybean event MON87712.

Tolerance to abiotic conditions, in particular to tolerance to drought, has been created by using the transgene cspB, comprised by the corn event MON87460.

Traits are frequently combined by combining genes in a transformation event or by combining different events during the breeding process. Preferred combination of traits are those that combine traits for short stature with traits for herbicide tolerance to different groups of herbicides, insect tolerance to different kind of insects, in particular tolerance to lepidopteran and coleopteran insects, herbicide tolerance with one or several types of insect resistance, herbicide tolerance with increased yield as well as a combination of herbicide tolerance and tolerance to abiotic conditions.

Plants comprising singular or stacked traits as well as the genes and events providing these traits are well known in the art. For example, detailed information as to the mutagenized or integrated genes and the respective events are available from websites of the organizations “International Service for the Acquisition of Agri-biotech Applications (ISAAA)” (http://www.isaaa.org/gmapprovaldatabase) and the “Center for Environmental Risk Assess-ment (CERA)” (http://cera-gmc.or/GjMCropDatabase), as well as in patent applications, like EP3028573 and WO2017/011288.

The use of compositions according to the invention on SSC may result in effects which are specific to corn comprising a certain gene or event. These effects might involve changes in growth behavior or changed resistance to biotic or abiotic stress factors. Such effects may in particular comprise enhanced yield, enhanced resistance or tolerance to insects, nematodes, fungal, bacterial, mycoplasma, viral or viroid pathogens as well as early vigour, early or delayed ripening, cold or heat tolerance as well as changed amino acid or fatty acid spectrum or content.

In one embodiment, the present invention relates to a method for controlling weeds in SSC plants with an agricultural composition comprising a single herbicidal active ingredient or a mixture of a single herbicide |-12, I-13, or I-14 with the safener ∥-1 by application of said compositions to the SSC plants, parts of such plants, their seeds, or their locus of growth, wherein the agricultural composition comprises, as active component, the herbicide I-1, I-2, I-3, I-4, I-5, I-6, I-7, I-8, I-9, I-10, I-11, I-12, I-13, I-14, I-15, I-16, I-17, I-18, 1-19, I-20, I-21, I-22, I-23, I-24, or I-25, or the following combinations of one herbicide I-12, I-13 or I-14 with the safener ∥-1: I-26: I-12+II-1; I-27: I-13+II-1; I-28: I-14+II-1.

In another embodiment, the present invention relates to a method for controlling weeds in SSC plants with an agricultural composition comprising a mixture of a single herbicide I-12, I-13 or I-14 with the herbicide I-15 and the safener ∥-1 by application of said compositions to the SSC plants, parts of such plants, their seeds, or their locus of growth, wherein the agricultural composition comprises, as active component, comprises the following combinations of one herbicide I-12, I-13 or I-14 with the herbicide I-15 and the safener 11-1: I-29: I-12+1-15+II-1; 1-30: I-13+1-15+II-1; 1-31: I-14+1-15+II-1.

In another embodiment, the present invention relates to a method for controlling weeds in SSC plants with an agricultural composition comprising mixtures of two or more herbicides selected from the group comprising the herbicides and herbicide combinations I-1 to I-31 by application of said compositions to the SSC plants, parts of such plants, their seeds, or their locus of growth, wherein the agricultural composition comprises, as active component, component 1) which is at least one herbicide selected from the group consisting of herbicide or herbicide combination I-1 to I-31; and component 2) which is at least one herbicide selected from the group consisting of herbicide or herbicide combination I-1 to I-31; and, optionally, component 3) which is at least one herbicide selected from the group consisting of herbicide or herbicide combination I-1 to I-31; with the provision that any one of components 1), 2) and 3) are not iden-tical.

Mixing the herbicides or the compositions comprising them in their suitable use form results in many cases in an expansion of the herbicidal spectrum of activity or in a prevention of herbicide resistance development. Furthermore, in many cases, synergistic effects are obtained (synergistic mixtures). Synergistic in the present context means that the use of herbicides in combination with a cultivated plant exceeds the additive effect, to be expected on weeds to be controlled and thus extends the range of action of a mixture and of the active principle expressed by the cultivated plant.

Thus, the term “synergistic”, is to be understood as synergistic herbicidal activity. The herbicidal effect of the method according to the invention can be shown by the tests described below.

The expected efficacies of active compound/plant combinations may be determined using Colby's formula (Colby, S.R. “Calculating synergistic and antagonistic responses of herbicide combinations”, Weeds, 15, pp. 20-22, 1967) and compared with the observed efficacies.

Colby's formula:

$$E = x + y - x \cdot y / 100$$

E expected efficacy, expressed in % of the unmodified treated control, when using the active compound at the concentrations a and b
x efficacy, expressed in % of the unmodified treated control, when using the active compound at the concentration a
y efficacy, expressed in % of the unmodified treated control, when using the active compound B at the concentration b.

In a preferred embodiment the present invention relates to methods for controlling weeds in SSC plants comprising the application of herbicide mixtures E.1 to E.7 that are identified in table E below.

### Table E

Embodiment E.1: A method for the control of weeds in SSC plants with an agricultural composition comprising a herbicide or herbicide combination selected from I-1 to I-31 or any one of the mixtures M.1 to M.29449 disclosed herein in a herbicidally effective amount by application of said compositions to the SSC plants or their locus of growth, wherein the SSC plants have average hights, at growth stage V12 (BBCH 37/39) or later, of less than or equal to 2.00 m.

Embodiment E.2: A method for the control of weeds in SSC plants with an agricultural composition comprising a herbicide or herbicide combination selected from I-1 to I-31 or any one of the mixtures M.1 to M.29449 disclosed herein in a herbicidally effective amount by application of said compositions to the SSC plants or their locus of growth, wherein the SSC plants have average hights, at growth stage V12 (BBCH 37/39) or later, of less than or equal to 1.80 m.

Embodiment E.3: A method for the control of weeds in SSC plants with an agricultural composition comprising a herbicide or herbicide combination selected from I-1 to I-31 or any one of the mixtures M.1 to M.29449 disclosed herein in a herbicidally effective amount by application of said compositions to the SSC plants or their locus of growth, wherein the SSC plants have average hights, at growth stage V12 (BBCH 37/39) or later, of less than or equal to 1.60 m.

Embodiment E.4: A method for the control of weeds in SSC plants with an agricultural composition comprising a herbicide or herbicide combination selected from I-1 to I-31 or any one of the mixtures M.1 to M.29449 disclosed herein in a herbicidally effective amount by application of said compositions to the SSC plants or their locus of growth, wherein the SSC plants have average hights, at growth stage V4-V6 (BBCH 14-16) or later, of less than or equal to 1.00 m.

Embodiment E.5: A method for the control of weeds in SSC plants with an agricultural composition comprising a herbicide or herbicide combination selected from I-1 to I-31 or any one of the mixtures M.1 to M.29449 disclosed herein in a herbicidally effective amount by application of said compositions to the SSC plants or their locus of growth, wherein the SSC plants have average hights, at growth stage V4-V6 (BBCH 14-16) or later, of less than or equal to 0.80 m.

Embodiment E.6: A method for the control of weeds in SSC plants with an agricultural composition comprising a herbicide or herbicide combination selected from I-1 to I-31 or any one of the mixtures M.1 to M.29449 disclosed herein in a herbicidally effective amount by application of said compositions to the SSC plants or their locus of growth, wherein the SSC plants have an innate genetic potential of reaching an average height of less than or equal to 1.80 m at growth stage V12 (BBCH 37/39) or later.

Embodiment E.7: A method for the control of weeds in SSC plants with an agricultural composition comprising a herbicide or herbicide combination selected from I-1 to I-31 or any one of the mixtures M.1 to M.29449 disclosed herein in a herbicidally effective amount by application of said compositions to the SSC plants or their locus of growth, wherein the SSC seeds have an innate genetic potential of of developing into plants reaching an average height of less than or equal to 1.00 m at growth stage V4-V6 (BBCH 14-16) or later.

The compounds I-1 to I-31, or the formulations and/or the mixtures comprising them, can be applied pre-, post-emergence or pre-plant, or together with the seed of a crop plant. It is also possible to apply the compounds I-1 to I-31, or the formulations and/or the mixtures comprising them, by applying seed, pretreated with the compounds I-1 to I-31, or the formulations and/or the mixtures comprising them, of a crop plant. If the active ingredients are less well tolerated by certain crop plants, application techniques may be used in which the mixtures are sprayed, with the aid of the spraying equipment, in such a way that as far as possible they do not come into contact with the leaves of the sensitive crop plants, while the active ingredients reach the leaves of undesired vegetation growing underneath, or the bare soil surface (post-directed, lay-by).

Moreover, it may be useful to apply the compounds I-1 to I-31 in combination with safeners. Safeners are chemical compounds which prevent or reduce damage on useful plants without having a major impact on the herbicidal action of the compounds I-1 to I-31 towards undesired vegetation. They can be applied either before sowings (e.g. on seed treatments, shoots or seedlings) or in the pre-emergence application or post-emergence application of the useful plant. The safeners and the compounds I-1 to I-31 can be applied simultaneously or in succession.

In the methods of the present invention it is immaterial whether the active ingredient (i. e. herbicide and/or safener) components of I-26 to I-31 and M.1 to M.29449 are formulated and applied jointly or separately.

In the case of separate application it is of minor importance, in which order the application takes place. It is only necessary, that the active ingredient (i. e. herbicide and/or safener) components of I-26 to I-31 and M.1 to M.29449 are applied in a time frame that allows simultaneous action of the active ingredients on the plants, preferably within a time-frame of at most 14 days, in particular at most 7 days.

The compounds and mixtures according to the invention are suitable as herbicides. They are suitable as such or as an appropriately formulated mixture (agrochemical mixture).

The methods and mixtures according to the invention have an outstanding herbicidal activity against undesired vegetation, i.e. against a large variety of unwanted plants, including monocotyledonous weeds and dicotyledonous weeds and comprising also volunteer crop plants as defined above.

The methods and mixtures according to the invention are useful for controlling a large variety of unwanted plants (undesired vegetation), in particular for controlling weeds, which are selected from the genera Abutilon, Ageratum, Alisma, Alopecurus, Amaranthus, Ambrosia, Ammania, Ammi, Amsinckia, Andropogon, Aneilema, Anthemis, Apera, Atriplex, Avena, Axonopis, Barbar-ea, Bidens, Borreria, Brachiaria, Brassica, Bromus, Bunias, Butomus, Calandrinia, Capsella, Cardamine, Cenchrus, Centaurea, Chenopodium, Cirsium, Conium, Convolvolus, Conyza, Coronopus, Cyclospermum, Cyperus, Datura, Daucus, Descurainia, Digitaria, Echinochloa, Eleusine, Epilobium, Epimedium, Eragrostis, Erigeron, Eriochloa, Erodium, Euphorbia, Fumaria, Galinsoga, Galium, Geranium, Gnaphalium, Helianthus, Heliotropium, Heteranthera, Hibiscus, Hordeum, Hypochaeris, Ipomoea, Kochia, Lactuca, Lamium, Leersia, Leptochloa, Lolium, Ly-copsis, Malva, Marchantia, Matricaria, Mediago, Melinus, Mercurialis, Mollugo, Oenothera, Oro-banche, Oryza, Oxalis, Panicum, Papaver, Pennisetum, Picris, Plantago, Poa, Polygonum, Portulaca, Raphanus, Ricardia, Salsola, Scirpus, Senecio, Sesbania, Setaria, Sida, Sinapis, Sisymbrium, Solanum, Sonchus, Sorghum, Stachys, Stellaria, Taraxacum, Thlaspi, Tribulus, Trifolium, Triticum, Urtica, Veronica, Vicia, Viola, and Xanthium.

Mentioned below are some representatives of monocotyledonous and dicotyledonous weeds, which can be controlled by the mixtures according to the invention without the enumeration being a restriction to certain species.

Preferably the methods and mixtures according to the invention are used to control monocotyledonous weeds.

Examples of monocotyledonous weeds on which the methods and mixtures according to the invention act efficiently are selected from the genera Alopecurus spp., Avena spp., Brachiaria spp., Bromus spp., Cenchrus spp., Chloris spp., Commelina spp., Cyperus spp., Digitaria spp., Echinochloa spp., Eleusine spp., Eragrostis spp., Eriochloa spp., Hordeum spp., Leptochloa spp., Lolium spp., Panicum spp., Pennisetum spp., Poa spp., Setaria spp., and Sorghum spp..

Preferred examples of monocotyledonous weeds on which the methods and mixtures according to the invention act efficiently are selected from the genera Avena spp., Brachiaria spp., Commelina ssp., Cyperus spp., Digitaria spp., Echinochloa spp., Hordeum spp., Lolium ssp., Setaria spp. and Sorghum spp..

Preferred examples of monocotyledonous weeds on which the methods and mixtures according to the invention act efficiently are selected from the species Avena fatua, Avena sativa, Avena sterilis, Brachiaria decumbens, Brachiaria plantaginea, Brachiaria platyphylla, Bromus diandrus, Bromus rigidus, Bromus rubens L., Bromus secalinus, Bromus sterilis, Cenchrus echinatus, Chloris virgata, Commelina benghalensis, Cynodon dactylon, Cyperus compressus, Cyperus esculentes, Cyperus iria, Cyperus kylingia, Cyperus rotundus, Digitaria horizontalis, Digitaria insularis, Digitaria ischaemum, Digitaria sanguinalis, Echinochloa colonum, Echinochloa crus-galli, Eleusine indica, Eragrostis pectinacea, Eriochloa gracilis, Leptochloa fusca, Lolium multi-florum, Lolium perenne, Lolium rigidum, Ottochloa nodosa, Panicum maximum, Panicum miliaceum, Pennisetum glaucum, Poa annua, Setaria faberi, Setaria italica, Setaria lutescens, Setaria palmifolia, Setaria verticillata, Setaria viridis, Sorghum halepense and Urochloa paricoides.

Especially preferred examples of monocotyledonous weeds on which the methods and mixtures according to the invention act efficiently are selected from the species Avena spp., Brachiaria spp., Bromus spp., Commelina spp., Digitaria spp., Echinochloa spp., Eleusine spp., Lolium spp., Setaria spp. and Sorghum spp.

Also especially preferred examples of monocotyledonous weeds on which the methods and mixtures according to the invention act efficiently are selected from Avena fatua, Brachiaria decumbens, Commelina benghalensis, Cyperus iria, Digitaria sanguinales, Echinocloa crus-galli, Hordeum vulgare, Lolium multiflorum, Setaria faberi, Setaria viridis and Sorghum vulgare.

More preferably the methods and mixtures according to the invention are used to control commelinids. In plant taxonomy, “commelinids” (originally commelinoids) are a clade of flowering plants within the monocotyledons (commonly referred to as “monocots”).

Particularly preferred the methods and mixtures according to the invention are used to control unwanted plants selected from the families of Commelinaceae, Cyperaceae and Poaceae.

According to another embodiment, the methods and mixtures of the present invention are suitable for controlling monocotyledonous weeds, which are selected from the family Commelinaceae.

Examples for Commelinaceae are Commelina benghalensis, Commelina communis, Commelina diffusa, Commelina latifolia and Commelina virginica.

Preferably the methods and mixtures according to the invention are used to control Commelinaceae selected from Commelina benghalensis and Commelina latifolia.

According to another embodiment, the methods and mixtures of the present invention are suitable for controlling monocotyledonous weeds, which are selected from the family Cyperaceae.

Examples for Cyperaceae are Cyperus compressus, Cyperus difformis, Cyperus esculentes, Cyperus ferax, Cyperus iria, Cyperuls kylingia, Cyperus malaccensis, Cyperus rotundus and Cyperus serotinus.

Preferably the methods and mixtures according to the invention are used to control Cyperaceae selected from Cyperus esculentes, Cyperus iria, Cyperuls kylingia, and Cyperus rotundus.

According to another embodiment, the methods and mixtures of the present invention are suitable for controlling monocotyledonous weeds, which are selected from the family Poaceae (Gra-mineae), commonly known as grasses.

Examples for Poaceae are Avena fatua, Avena sativa, Avena sterilis, Brachiaria decumbens, Brachiaria plantaginea, Brachiaria platyphylla, Bromus diandrus, Bromus rigidus, Bromus rubens, Bromus secalinus, Bromus sterilis, Cenchrus echinatus, Digitaria horizontalis, Digitaria insularis, Digitaria ischaemum, Digitaria sanguinalis, Echinochloa crus-galli, Echinochloa colonum, Eleusine indica, Eragrostis pectinacea, Eriochloa gracilis, Leptochloa fusca, Lolium multi-florum, Lolium perenne, Lolium rigidum, Panicum miliaceum, Panicum maximum, Pennisetum glaucum, Poa annua, Setaria faberi, Setaria italica, Setaria lutescens, Setaria verticillata, Setaria viridis and Sorghum halepense.

Preferably the methods and mixtures according to the invention are used to control Poaceae selected from Avena fatua, Avena sativa, Avena sterilis, Brachiaria decumbens, Brachiaria plantaginea, Brachiaria platyphylla, Bromus rigidus, Bromus secalinus, Digitaria horizontalis, Digitaria insularis, Digitaria ischaemum, Digitaria sanguinalis, Echinochloa crus-galli, Echinochloa colonum, Eleusine indica, Lolium multiflorum, Lolium perenne, Lolium rigidum, Setaria faberi, Setaria italica, Setaria lutescens, Setaria verticillate and Setaria viridis.

Preferred examples of commelinids, on which the methods and mixtures according to the invention act efficiently, are selected from the genera Avena spp., Brachiaria spp., Commelina ssp., Cyperus spp., Digitaria spp., Echinochloa spp., Lolium ssp., Setaria spp. and Sorghum spp..

Preferred examples of Commelinaceae, Cyperaceae and Poaceae, on which the methods and mixtures according to the invention act efficiently, are selected from Avena spp., Brachiaria spp, Commelina spp., Digitaria spp., Echinochloa spp., Eleusine spp., Lolium spp. and Setaria spp..

According to another embodiment, the methods and mixtures according to the invention are used to control dicotyledonous weeds, commonly known as broadleaf weeds.

Examples of dicotyledonous weeds on which the methods and mixtures according to the invention act efficiently are selected from the genera Abutilon spp., Ageratum spp., Alternathera spp., Amaranthus spp., Ambrosia spp., Amsinckia spp., Andropogon spp., Asystasia spp, Axonopus spp, Bidens spp.,Borreria spp. (Spermacoce spp.), Brassica spp., Calandrinia spp., Capsella spp., Cardamine spp., Cenchrus spp., Chenopodium spp., Cirsium spp., Cleome spp., Conyza spp., Coronopus spp., Cyclospermum spp., Datura spp., Epilobium spp., Epimedium spp., Eragrostis spp., Erigeron spp., Erodium spp., Euphorbia spp., Galium spp., Galinsoga spp., Gnaphalium spp., Helianthus spp., Hypochaeris spp., Ipomoea spp., Kochia spp., Lactuca spp., Lamium spp., Malva spp., Marchantia spp., Matricaria spp., Medicago spp., Mollugo spp., Mucuna spp, ., Nicotiana spp., Oenothera spp., Oxalis spp., Paspalum spp., Phylanthus spp, Picris spp., Plantago spp., Polygonum spp., Portulaca spp., Raphanus spp., Richardia spp., Salsola spp., Senecio spp., Sesbania spp., Sida spp, Sinapis spp., Sisymbrium spp., Solanum spp., Sonchus spp., Stellaria spp., Stenochlaena spp., Taraxacum spp., Tribulus spp., Trifolium spp., Urtica spp., Veronica spp. and Vicia spp..

Preferred examples of dicotyledonous weeds on which the methods and mixtures according to the invention act efficiently are selected from the genera Abutilon ssp., Amaranthus spp., Erigeron spp. and Kochia spp..

Preferred examples of dicotyledonous weeds on which the methods and mixtures according to the invention act efficiently are selected from the species Abutilon theophrasti, Ageratum co-nycoides, Ambrosia artemisiifolia, Ambrosia elatior, Andropogon bicornis, Amaranthus blitoides, Amaranthus chlorostachys, Amaranthus hybridus, Amaranthus lividus, Amaranthus palmeri, Amaranthus rudis, Amaranthus retroflexus, Amaranthus spinosus, Amaranthus tamariscina, Amaranthus tuberculatos, Bidens bipinnata, Bidens pilosa, Borreria latifolia (Spermacoce latifolia), Borreria verticilata (Spermacoce verticilata), Brassica nigra, Brassica rapa, Brassica napus, Capsella bursa-pastoris, Chenopodium album, Circium arvense, Epimedium spp., Erigeron bonariensis (Conyza bonariensis), Erigeron canadensis, Euphorbia heterophylla, Euphorbia maculate, Galium aparine, Galium spurium, Galinsoga spp., Helianthus annuus, Ipomoea gran-difolia, Ipomoea hederacea, Ipomoea lacunosa, Kochia scoparia, Lactuca serriola, Lamium am-plexicaule, Malva parviflora, Malva neglecta, Marchantia spp., Matricaria matriccarioides, Oxalis spp., , Plantago spp., Polygonum aviculare, Polygonum convolvulus, Portulaca oleracea, Raphanus raphanistrum, Richardia scabra, Senecio vulgaris, Sesbania exaltata, Sida spinosa, Sinapis arvensis, Solanum spp., Sonchus oleraceus, Stellaria media, Trifolium spp., Veronica spp. and Vicia benghalensis.

Especially preferred examples of dicotyledonous weeds on which the methods and mixtures according to the invention act efficiently are selected from the species Abutilon spp., Amaranthus spp., Ambrosia spp., Bidens spp., Borreria spp. (Spermacoce spp.), Chenopodium spp., Conyza spp., Erigeron spp., Euphorbia spp., Galium spp., Ipomoea spp., Kochia spp., Polygonum spp., Portulaca spp. and Raphanus spp..

Most preferred examples of dicotyledonous weeds on which the methods and mixtures according to the invention act efficiently are selected from Amaranthus spp., Ambrosia spp., Borreria spp. (Spermacoce spp.), Chenopodium spp., Conyza spp., Erigeron spp., Galium spp., Ipomoea spp. and Kochia spp..

According to another embodiment, the methods and mixtures of the present invention are suitable for controlling undesired vegetation, wherein the undesired vegetation comprises volunteer crop plants. Volunteer crop plants are crop plants that volunteer in planted crops.

Weeds, which are controlled by the methods and uses according to the present invention include monocots and dicots, preferably monocots.

In one aspect the present invention relates to methods and uses for controlling herbicide resistant weeds in crops.

In the context of the present invention, exemplary herbicide resistant weed species include, but are not limited to, biotypes resistant to herbicides selected from the group consisting of Acetyl CoA carboxylase (ACCase) inhibitors (HRAC Group 1), acetolactate synthase (ALS) inhibitors (HRAC Group 2), inhibitor of photosynthesis at photosystem II (PS II) (HRAC Groups 5 and 6), photosystem I (PS I) inhibitors (HRAC Group 22), protoporphyrinogen oxidase (PPO) inhibitors (HRAC Group 14), 4-hydroxyphenyl-pyruvate-dioxygenase (HPPD) inhibitors (HRAC Group 27), phytoene desaturase (PDS) inhibitors (HRAC Group 12), lycopene cyclase inhibitors (HRAC Group 34), DOXP synthase inhibitors (HRAC Group 13), 5-enolpyruvylshikimate-3-phosphate (EPSP) inhibitors (HRAC Group 9), glutamine synthetase inhibitors (HRAC Group 10), Dihy-dropteroate (DHP) synthase inhibitors (HRAC Group 18), inhibitors of microtubuli assembly (HRAC Group 3), inhibitors of mitosis/microtubuli organization (HRAC Group 23), very long chain fatty acid (VLCFA) inhibitors (HRAC Group 15), inhibitors of cell wall synthesis (HRAC Group 29), uncoupler (membran disruption) (HRAC Group 24), synthetic auxins (HRAC Group 4), auxin transport inhibitors (HRAC Group 19), dihydroorotate dehydrogenase (DHODH) inhibitors (HRAC Group 28), solanesyl diphosphate synthase (SDS) inhibitors (HRAC Group 32), serine-threonine protein phosphatase inhibitors (HRAC Group 31), fatty acid thioesterase (FAT) inhibitors (HRAC Group 30), inhibitor of (HRAC Group 18), homogentisate solanesyltransfer-aseand (HST) inhibitors (HRAC Group 33), and herbicides with unknown mode of action (HRAC Group 0).

Preferably, the herbicide resistant weed species is selected from biotypes resistant to herbicides selected from the group consisting of Acetyl CoA carboxylase (ACCase) inhibitors (HRAC Group 1), acetolactate synthase (ALS) inhibitors (HRAC Group 2), inhibitor of photosynthesis at photosystem II (PS II) (HRAC Groups 5 and 6), protoporphyrinogen oxidase (PPO) inhibitors (HRAC Group 14), 4-hydroxyphenyl-pyruvate-dioxygenase (HPPD) inhibitors (HRAC Group 27), phytoene desaturase (PDS) inhibitors (HRAC Group 12), 5-enolpyruvylshikimate-3-phosphate (EPSP) inhibitors (HRAC Group 9), inhibitors of microtubuli assembly (HRAC Group 3), very long chain fatty acid (VLCFA) inhibitors (HRAC Group 15), inhibitors of cell wall synthesis (HRAC Group 29), inhibitors of glutamine synthetase (HRAC Group 10), dihydroorotate dehydrogenase (DHODH) inhibitors (HRAC Group 28), fatty acid thioesterase (FAT) inhibitors (HRAC Group 30), and herbicides with unknown mode of action (HRAC Group 0).

More preferably, the herbicide resistant weed species is selected from biotypes resistant to herbicides selected from the group consisting of acetyl CoA carboxylase (ACCase) inhibitors (HRAC Group 1), acetolactate synthase (ALS) inhibitors (HRAC Group 2), 4-hydroxyphenyl-pyruvate-dioxygenase (HPPD) inhibitors (HRAC Group 27), 5-enolpyruvylshikimate-3-phosphate (EPSP) inhibitors (HRAC Group 9), inhibitors of microtubuli assembly (HRAC Group 3), very long chain fatty acid (VLCFA) inhibitors (HRAC Group 15), inhibitors of cell wall synthesis (HRAC Group 29), inhibitors of glutamine synthetase (HRAC Group 10), fatty acid thioesterase (FAT) inhibitors (HRAC Group 30).

Even more preferably, the herbicide resistant weed species is selected from biotypes with resistance or tolerance to at least one herbicide selected from the group consisting of acetyl CoA carboxylase (ACCase) inhibitors (HRAC Group 1), acetolactate synthase (ALS) inhibitors (HRAC Group 2), 4-hydroxyphenyl-pyruvate-dioxygenase (HPPD) inhibitors (HRAC Group 27), 5-enolpyruvylshikimate-3-phosphate (EPSP) inhibitors (HRAC Group 9), inhibitors of microtubuli assembly (HRAC Group 3), very long chain fatty acid (VLCFA) inhibitors (HRAC Group 15), inhibitors of glutamine synthetase (HRAC Group 10).

In the context of the present invention, the herbicide resistant weed species is in particular selected from biotypes with resistance or tolerance to at least one herbicide selected from the group consisting of acetyl CoA carboxylase (ACCase) inhibitors (HRAC Group 1) and acetolactate synthase (ALS) inhibitors (HRAC Group 2).

In one embodiment, the herbicide resistant weed species is selected from biotypes with resistance or tolerance to at least one herbicide selected from acetyl CoA carboxylase (AC-Case) inhibitors (HRAC Group 1).

In another embodiment, the herbicide resistant weed species is selected from biotypes with resistance or tolerance to at least one herbicide selected from acetolactate synthase (ALS) inhibitors (HRAC Group 2).

In the context of the present invention, the herbicide resistant weed is selected from the genera Abutilon, Aeschynomene, Alisma, Alopecurus, Alternanthera, Amaranthus, Ambrosia, Ammannia, Bacopa, Bidens, Bolboschoenus, Brachiaria, Calystegia, Capsella, Caperonia, Centaurea, Chenopodium, Cleome, Commelina, Convolvulus, Cynodon, Cyperus, Descurainia, Digitaria, Echinochloa, Eclipta, Eleocharis, Eleusine, Eriochloa, Erigeron, Euphorbia, Fimbristylis, Galium, Helianthus annuus, Heteranthera, Ipomoea, Ischaemum, Isolepis, Kochia, Leptochloa, Limnocharis, Lindernia, Lolium, Ludwigia, Marsilia, Matricaria, Melochia, Mollugo, Monochoria, Oryza sativa, Panicum, Papaver, Paspalum, Persicaria, Phalaris, Poa, Polygonum, Pontederia, Portulaca, Raphanus, Rottboellia, Sagittaria, Schoenoplectiella, Schoenoplectus, Scirpoides, Scirpus, Sesbania, Setaria, Sida, Sinapis, Sisymbrium, Sphenoclea, Sorghum halepense, Stellaria, Thlaspi, Trichophorum, Typha, Urochloa and Xanthium.

In one embodiment, the herbicide resistant weed is a monocotyledonous weed species selected from the genera Agropyron, Alopecurus, Alisma, Apera, Avena, Bolboschoenus, Brachiaria, Bromus, Commelina, Cynodon, Cyperus, Digitaria, Echinochloa, Eleocharis, Eleusine, Eriochloa, Fimbristylis, Heteranthera, Ischaemum, Isolepis, Leptochloa, Limnocharis, Lolium, Monochoria, Oryza sativa, Panicum, Paspalum, Phalaris, Poa, Pontederia, Rottboellia, Sagittaria, Schoenoplectiella, Schoenoplectus, Scirpoides, Scirpus, Setaria, Sorghum halepense, Trichophorum, Typha and Urochloa.

More preferably, the herbicide resistant weed is a monocotyledonous weed species selected from the genera Alopecurus, Apera, Avena, Cyperus, Digitaria, Echinochloa, Eleusine, Leptochloa, Lolium, Phalaris, Poa and Setaria.

Most preferably, the herbicide resistant weed species is a monocotyledonous weed species selected from the genera Alopecurus and Avena, In particular, the herbicide resistant weed is selected from the monocotyledonous weed species Alopecurus myosuroides, Alopecurus aequalis, Apera spica-venti, Avena fatua, Avena sterilis, Brachiaria plantaginea, Brachiaria decumbens, Bromus secalinus, Bromus sterilis, Bromus tec-torum, Bolboschoenus planiculmis, Cynodon dactylon, Cynodon transvaalensis, Cyperus compressus, Cyperus difformis, Cyperus iria, Cyperus sp., Digitaria ciliaris, Digitaria insularis, Digitaria ischaemum, Digitaria sanguinalis, Echinochloa colona, Echinochloa colonum, Echinochloa crus-galli, Echinochloa crus-pavonis, Echinochloa erecta, Echinochloa formosensis, Echinochloa oryzoides, Echinochloa phyllogogon, Echinochloa sp., Echinochloa zelayensis, Eleusine indica, Fimbristylis quinquangularis, Ischaemum rugosum, Leptochloa chinensis, Leptochloa panicoides, Leptochloa scabra, Leptochloa virgata, Lolium multiflorum, Lolium perenne, Lolium rigidum, Lolium x hybridum, Panicum capillare, Panicum dichotomiflorum, Phalaris brachystachyx, Phalaris minor, Phalaris paradoxa, Poa annua, Poa pratensis, Poa trivialis, Rottboellia exaltata, Schoenoplectiella juncoides, Setaria faberi, Setaria glauca, Setaria pumila, Setaria verticillate and Setaria viridis.

Preferably, the herbicide resistant weed is selected from the monocotyledonous weed species Alopecurus myosuroides, Alopecurus aequalis, Apera spica-venti, Avena fatua, Avena sterilis, Digitaria insularis, Echinochloa colona, Echinochloa colonum, Echinochloa crus-galli, Echinochloa crus-pavonis, Echinochloa erecta, Echinochloa formosensis, Echinochloa oryzoides, Echinochloa phyllogo-gon, Echinochloa sp., Echinochloa zelayensis, Eleusine indica, Leptochloa chinensis, Leptochloa panicoides, Leptochloa scabra, Leptochloa virgata, Lolium multiflorum, Lolium perenne, Lolium rigidum, Lolium x hybridum, Phalaris brachystachyx, Phalaris minor, Phalaris paradoxa, Poa annua, Poa pratensis, Poa trivialis, Setaria faberi, Setaria glauca, Setaria pumila, Setaria verticillate and Setaria viridis.

More preferably, the herbicide resistant weed is selected from the monocotyledonous weed species Alopecurus myosuroides, Alopecurus aequalis, Avena fatua, Avena sterilis, Digitaria insularis, Echinochloa colona, Echinochloa colonum, Echinochloa crus-galli, Echinochloa crus-pavonis, Echinochloa erecta, Echinochloa formosensis, Echinochloa oryzoides, Echinochloa phyllogogon, Echinochloa sp., Echinochloa zelayensis, Leptochloa chinensis, Leptochloa panicoides, Leptochloa scabra, Leptochloa virgata, Lolium multiflorum, Lolium perenne, Lolium rigidum, Lolium x hybridum, Phalaris brachystachyx, Phalaris minor, Phalaris paradoxa, Poa annua, Poa pratensis, Poa trivialis, Setaria faberi, Setaria glauca, Setaria pumila, Setaria verticillate and Setaria viridis.

Most preferably, the herbicide resistant weed is selected from the monocotyledonous weed species Alopecurus myosuroides and Avena fatua.

In another embodiment, the herbicide resistant weed is a dicotyledonous weed species selected from the genera Abutilon, Aeschynomene, Alternanthera, Ambrosia, Ammannia, Amaranthus, Anthemis, Bacopa, Bidens, Calystegia, Capsella, Caperonia, Centaurea, Chenopodium, Cleome, Commelina, Convolvulus, Conyza, Descurainia, Desmodium, Eclipta, Erigeron, Euphorbia, Galium, Helianthus annuus, Ipomoea, Kochia, Lindernia, Limnocharis, Ludwigia, Matricaria, Melochia, Mollugo, Papaver, Persicaria, Polygonum, Pontederia, Portulaca, Raphanus, Sesbania, Sida, Sinapis, Sisymbrium, Sphenoclea, Stellaria, Thlaspi, Tripleurospermum, Veronica and Xanthium.

In particular, the herbicide resistant weed is selected from the dicotyledonous weed species Abutilon theophrasti, Amaranthus albus, Amaranthus blitoides, Amaranthus hybridus, Amaranthus palmeri, Amaranthus powellii, Amaranthus retroflexus, Amaranthus tuberculatus, Amaranthus rudis, Amaranthus viridis, Ambrosia artemisifolia, Ammannia auriculata, Ammannia baccif-era, Ammannia multiflora, Anthemis arvensis, Capsella bursa-pastoris, Centaurea cyanus, Chenopodium album, Chenopodium ficifolium, Chenopodium polyspermum, Chenopodium hybridum, Commelina benghalensis, Conyza bonariensis, Conyza canadensis, Descurania so-phia, Galium aparine, Galium spurium, Galium tricornutum, Kochia scoparia, Limnocharis flava, Ludwigia decurrens, Ludwigia octovalvis, Ludwigia prostrata, Matricaria chamomilla, Matricaria discoidea, Matricaria inodora, Papaver rhoeas, Pontederia korsakowii, Pontederia vaginalis, Potamogeton distinctus, Raphanus raphanistrum, Sinapis alba, Sinapis arvensis, Sisymbrium officinale, Sisymbrium orientale, Stellaria media, Sphenoclea zeylanic, Thlaspi arvense, Tripleurospermum inodorum and Veronica persica.

In another embodiment, the methods and uses of this invention are suitable for controlling AC-Case-resistant monocotyledonous weeds selected from the genera Alopecurus, Apera, Avena, Digitaria, Echinochloa, Eleusine, Leptochloa, Lolium, Phalaris, Poa and Setaria.

More preferably, ACCase-resistant monocotyledonous weeds are selected from the genera Alopecurus, Avena, Echinochloa, Leptochloa and Lolium.

More specifically, ACCase-resistant monocotyledonous weed species are selected from Alopecurus myosuroides, Alopecurus aequalis, Apera spica-venti, Avena fatua, Avena sterilis, Digitaria ciliaris, Digitaria insularis, Digitaria ischaemum, Digitaria sanguinalis, Echinochloa colona, Echinochloa crus-galli, Echinochloa crus-pavonis, Echinochloa erecta, Echinochloa oryzoides, Echinochloa phyllogogon, Echinochloa sp., Eleusine indica, Leptochloa chinensis, Leptochloa panicoides, Leptochloa scabra, Leptochloa virgata, Lolium multiflorum, Lolium perenne, Lolium rigidum, Lolium x hybridum, Phalaris brachystachyx, Phalaris minor, Phalaris paradoxa, Poa annua, Poa pratensis, Poa trivialis, Setaria faberi, Setaria glauca, Setaria pumila, Setaria verticillata and Setaria viridis.

More preferably, ACCase-resistant monocotyledonous weed species are selected from Alopecurus myosuroides, Alopecurus aequalis, Avena fatua, Avena sterilis, Echinochloa crus-galli, Echinochloa sp., Leptochloa chinensis, Lolium multiflorum, Lolium perenne, Lolium rigidum, Lolium x hybridum, Phalaris brachystachys, Phalaris minor, Phalaris paradoxa, Poa annua and Poa trivialis.

In particular, ACCase-resistant monocotyledonous weed species are selected from Alopecurus myosuroides and Avena fatua.

In another embodiment, the methods and uses of this invention are suitable for controlling ALS-resistant monocotyledonous weeds selected from the genera Alopecurus, Apera, Avena, Cyperus, Digitaria, Echinochloa, Eleusine, Leptochloa, Lolium, Phalaris, Poa and Setaria.

Preferably, ALS-resistant monocotyledonous weeds are selected from the genera Alopecurus, Avena, Echinochloa, Leptochloa and Lolium.

More specifically, ALS-resistant monocotyledonous weed species are selcted from Alopecurus myosuroides, Alopecurus aequalis, Apera spica-venti, Avena fatua, Avena sterilis, Digitaria ciliaris, Digitaria insularis, Digitaria ischaemum, Digitaria sanguinalis, Echinochloa colona, Echinochloa crus-galli, Echinochloa crus-pavonis, Echinochloa erecta, Echinochloa oryzoides, Echinochloa phyllogogon, Echinochloa sp., Eleusine indica, Leptochloa chinensis, Leptochloa panicoides, Leptochloa scabra, Leptochloa virgata, Lolium multiflorum, Lolium perenne, Lolium rigidum, Lolium x hybridum, Phalaris brachystachyx, Phalaris minor, Phalaris paradoxa, Poa annua, Poa pratensis, Poa trivialis, Setaria faberi, Setaria glauca, Setaria pumila, Setaria verticillata and Setaria viridis.

More preferably, ALS-resistant monocotyledonous weed species are selected from Alopecurus myosuroides, Alopecurus aequalis, Avena fatua, Avena sterilis, Echinochloa crus-galli, Echinochloa sp., Leptochloa chinensis, Lolium multiflorum, Lolium perenne, Lolium rigidum, Lolium x hybridum, Phalaris brachystachys, Phalaris minor, Phalaris paradoxa, Poa annua and Poa trivialis.

In particular, ALS-resistant monocotyledonous weed species are selected from Alopecurus myosuroides and Avena fatua.

In another embodiment, the methods and uses of this invention are suitable for controlling multiple resistant monocotyledonous weeds selected from the genera Alopecurus, Apera, Avena, Cyperus, Digitaria, Echinochloa, Eleusine, Leptochloa, Lolium, Phalaris, Poa and Setaria.

More preferably, multiple resistant weeds are selected from the genera Alopecurus, Avena, Echinochloa, Leptochloa and Lolium.

More specifically, multiple resistant monocotyledonous weed species are selcted from Alopecurus myosuroides, Alopecurus aequalis, Apera spica-venti, Avena fatua, Avena sterilis, Digitaria ciliaris, Digitaria insularis, Digitaria ischaemum, Digitaria sanguinalis, Echinochloa colona, Echinochloa crus-galli, Echinochloa crus-pavonis, Echinochloa erecta, Echinochloa oryzoides, Echinochloa phyllogogon, Echinochloa sp., Eleusine indica, Leptochloa chinensis, Leptochloa panicoides, Leptochloa scabra, Leptochloa virgata, Lolium multiflorum, Lolium perenne, Lolium rigidum, Lolium x hybridum, Phalaris brachystachyx, Phalaris minor, Phalaris paradoxa, Poa annua, Poa pratensis, Poa trivialis, Setaria faberi, Setaria glauca, Setaria pumila, Setaria verticillata and Setaria viridis.

More preferably, multiple resistant monocotyledonous weed species are selected from Alopecurus myosuroides, Alopecurus aequalis, Avena fatua, Avena sterilis, Echinochloa crus-galli, Echinochloa sp., Leptochloa chinensis, Lolium multiflorum, Lolium perenne, Lolium rigidum, Lolium x hybridum, Phalaris brachystachys, Phalaris minor, Phalaris paradoxa, Poa annua and Poa trivialis.

Most preferably, multiple resistant monocotyledonous weed species are selected from Alopecurus myosuroides and Avena fatua.

The herbicides or mixtures comprising two or more herbicides are employed as such or in form of agrochemical compositions comprising them. The application can be carried out both before and after the emergence of the SSC plants, or before or after emergence of unwanted vegetation. As used herein, the term “agrochemical composition” comprises an effective amount of one, two or more herbicides and auxiliary components. The herbicides, and their salts can be converted into customary types of agrochemical compositions, e. g. solutions, emulsions, suspensions, dusts, powders, pastes, granules, pressings, capsules, and mixtures thereof.

Examples for composition types (see “Catalogue of pesticide formulation types and international coding system”, Technical Monograph No. 2, 6^{th} Ed. May 2008, CropLife International) are suspensions (e. g. SC, OD, FS), emulsifiable concentrates (e. g. EC), emulsions (e. g. EW, EO, ES, ME), capsules (e. g. CS, ZC), pastes, pastilles, wettable powders or dusts (e. g. WP, SP, WS, DP, DS), pressings (e. g. BR, TB, DT) or granules (e. g. WG, SG, GR, FG, GG, MG). The compositions are prepared in a known manner, such as described by Mollet and Grubemann, Formulation technology, Wiley VCH, Weinheim, 2001; or by Knowles, New developments in crop protection product formulation, Agrow Reports DS243, T&F Informa, London, 2005. The invention also relates to agrochemical compositions comprising an auxiliary and at least one herbicide or herbicide combination I or mixture M. Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, antl-freezing agents, antl-foaming agents, colorants, tackifiers and binders.

The agrochemical compositions generally comprise between 0.01 and 95%, preferably between 0.1 and 90%, more preferably between 1 and 70%, and in particular between 10 and 60%, by weight of active substance (e.g. at least one herbicide or herbicide combination I or mixture M). Further, the agrochemical compositions generally comprise between 5 and 99.9%, preferably between 10 and 99.9%, more preferably between 30 and 99%, and in particular between 40 and 90%, by weight of at least one auxiliary.

When employed in plant protection, the amounts of active substances applied are, depending on the kind of effect desired, from 0.001 to 2 kg per ha, preferably from 0.005 to 2 kg per ha, more preferably from 0.025 to 1.5 kg per ha.

Various types of oils, wetters, adjuvants, fertilizers, or micronutrients, and further pesticides (e. g. fungicides, growth regulators, herbicides, insecticides, safeners) may be added to the herbicides or herbicide combinations I or mixtures M as premix, or, not until immediately prior to use (tank mix). These agents can be admixed with the compositions according to the invention in a weight ratio of 1:100 to 100:1, preferably 1:10 to 10:1.

The user applies the agrochemical composition usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

In the combinations I-26 to I-31, the weight ratio of the individual components is usually in the following range:

The weight ratio between the herbicide I-12, I-13, or I-14 and the herbicide I-15 is usually in the range from 10:1 to 1:1, preferably 5:1 to 1.5:1, most preferably 3:1 to 2:1.

The weight ratio between the herbicide I-12, I-13, or I-14 and the safener II-1 is usually in the range from 10:1 to 1:1, preferably 8:1 to 2:1, most preferably 6:1 to 3:1.

In the binary mixtures the weight ratio of the component 1) and the component 2) generally depends on the properties of the components used; usually, it is in the range of from 150:1 to 1:150, preferably from 50:1 to 1:50, more preferably from 25:1 to 1:25.

In the ternary mixtures, i. e. the compositions comprising component 1), component 2) and component 3), the weight ratio of the component 1) and the component 2) generally depends on the properties of the components used; usually, it is in the range of from 150:1 to 1:150, preferably from 50:1 to 1:50, more preferably from 25:1 to 1:25; and the weight ratio of the component 1) and the component 3) is usually in the range of from 150:1 to 1:150, preferably from 50:1 to 1:50, more preferably from 25:1 to 1:25.

In one embodiment, the present invention relates to binary herbicidal mixtures M.1 to M.450 listed in Table M(a) below, comprising as active components 1) and 2) two herbicides or herbicide combinations selected from the group consisting of I-1 to I-31.

TABLE M(a)

M.1: I-2 + I-1; M.2: I-3 + I-1; M.3: I-4 + I-1; M.4: I-5 + I-1; M.5: I-6 + I-1;
M.6: I-7 + I-1; M.7: I-8 + I-1; M.8: I-9 + I-1; M.9: I-10 + I-1; M.10: I-11 + I-1;
M.11: I-12 + I-1; M.12: I-13 + I-1; M.13: I-14 + I-1; M.14: I-15 + I-1; M.15: I-16 + I-1;
M.16: I-17 + I-1; M.17: I-18 + I-1; M.18: I-19 + I-1; M.19: I-20 + I-1; M.20: I-21 + I-1;
M.21: I-22 + I-1; M.22: I-23 + I-1; M.23: I-24 + I-1; M.24: I-25 + I-1; M.25: I-26 + I-1;
M.26: I-27 + I-1; M.27: I-28 + I-1; M.28: I-29 + I-1; M.29: I-30 + I-1; M.30: I-31 + I-1;
M.31: I-3 + I-2; M.32: I-4 + I-2; M.33: I-5 + I-2; M.34: I-6 + I-2; M.35: I-7 + I-2;
M.36: I-8 + I-2; M.37: I-9 + I-2; M.38: I-10 + I-2; M.39: I-11 + I-2; M.40: I-12 + I-2;
M.41: I-13 + I-2; M.42: I-14 + I-2; M.43: I-15 + I-2; M.44: I-16 + I-2; M.45: I-17 + I-2;
M.46: I-18 + I-2; M.47: I-19 + I-2; M.48: I-20 + I-2; M.49: I-21 + I-2; M.50: I-22 + I-2;
M.51: I-23 + I-2; M.52: I-24 + I-2; M.53: I-25 + I-2; M.54: I-26 + I-2; M.55: I-27 + I-2;
M.56: I-28 + I-2; M.57: I-29 + I-2; M.58: I-31 + I-2; M.59: I-4 + I-3; M.60: I-5 + I-3;
M.61: I-6 + I-3; M.62: I-7 + I-3; M.63: I-8 + I-3; M.64: I-9 + I-3; M.65: I-10 + I-3;
M.66: I-11 + I-3; M.67: I-12 + I-3; M.68: I-13 + I-3; M.69: I-14 + I-3; M.70: I-15 + I-3;
M.71: I-16 + I-3; M.72: I-17 + I-3; M.73: I-18 + I-3; M.74: I-19 + I-3; M.75: I-20 + I-3;
M.76: I-21 + I-3; M.77: I-22 + I-3; M.78: I-23 + I-3; M.79: I-24 + I-3; M.80: I-25 + I-3;
M.81: I-26 + I-3; M.82: I-27 + I-3; M.83: I-28 + I-3; M.84: I-29 + I-3; M.85: I-30 + I-3;
M.86: I-31 + I-3; M.87: I-5 + I-4; M.88: I-6 + I-4; M.89: I-7 + I-4; M.90: I-8 + I-4;
M.91: I-9 + I-4; M.92: I-10 + I-4; M.93: I-11 + I-4; M.94: I-12 + I-4; M.95: I-13 + I-4;
M.96: I-14 + I-4; M.97: I-15 + I-4; M.98: I-16 + I-4; M.99: I-17 + I-4; M.100: I-18 + I-4;
M.101: I-19 + I-4; M.102: I-20 + I-4; M.103: I-21 + I-4; M.104: I-22 + I-4; M.105: I-23 + I-4;
M.106: I-24 + I-4; M.107: I-25 + I-4; M.108: I-26 + I-4; M.109: I-27 + I-4; M.110: I-28 + I-4;
M.111: I-29 + I-4; M.112: I-30 + I-4; M.113: I-31 + I-4; M.114: I-6 + I-5; M.115: I-7 + I-5;
M.116: I-8 + I-5; M.117: I-9 + I-5; M.118: I-10 + I-5; M.119: I-11 + I-5; M.120: I-12 + I-5;
M.121: I-13 + I-5; M.122: I-14 + I-5; M.123: I-15 + I-5; M.124: I-16 + I-5; M.125: I-17 + I-5;
M.126: I-18 + I-5; M.127: I-19 + I-5; M.128: I-20 + I-5; M.129: I-21 + I-5; M.130: I-22 + I-5;
M.131: I-23 + I-5; M.132: I-24 + I-5; M.133: I-25 + I-5; M.134: I-26 + I-5; M.135: I-27 + I-5;
M.136: I-28 + I-5; M.137: I-29 + I-5; M.138: I-30 + I-5; M.139: I-31 + I-5; M.140: I-7 + I-6;
M.141: I-8 + I-6; M.142: I-9 + I-6; M.143: I-10 + I-6; M.144: I-11 + I-6; M.145: I-12 + I-6;
M.146: I-13 + I-6; M.147: I-14 + I-6; M.148: I-15 + I-6; M.149: I-16 + I-6; M.150: I-17 + I-6;
M.151: I-18 + I-6; M.152: I-19 + I-6; M.153: I-20 + I-6; M.154: I-21 + I-6; M.155: I-22 + I-6;
M.156: I-23 + I-6; M.157: I-24 + I-6; M.158: I-25 + I-6; M.159: I-26 + I-6; M.160: I-27 + I-6;
M.161: I-28 + I-6; M.162: I-29 + I-6; M.163: I-30 + I-6; M.164: I-31 + I-6; M.165: I-8 + I-7;
M.166: I-9 + I-7; M.167: I-10 + I-7; M.168: I-11 + I-7; M.169: I-12 + I-7; M.170: I-13 + I-7;
M.171: I-14 + I-7; M.172: I-15 + I-7; M.173: I-16 + I-7; M.174: I-17 + I-7; M.175: I-18 + I-7;
M.176: I-19 + I-7; M.177: I-20 + I-7; M.178: I-21 + I-7; M.179: I-22 + I-7; M.180: I-23 + I-7;
M.181: I-24 + I-7; M.182: I-25 + I-7; M.183: I-26 + I-7; M.184: I-27 + I-7; M.185: I-28 + I-7;
M.186: I-29 + I-7; M.187: I-30 + I-7; M.188: I-31 + I-7; M.189: I-9 + I-8; M.190: I-10 + I-8;
M.191: I-11 + I-8; M.192: I-12 + I-8; M.193: I-13 + I-8; M.194: I-14 + I-8; M.195: I-15 + I-8;
M.196: I-16 + I-8; M.197: I-17 + I-8; M.198: I-18 + I-8; M.199: I-19 + I-8; M.200: I-20 + I-8;
M.201: I-21 + I-8; M.202: I-22 + I-8; M.203: I-23 + I-8; M.204: I-24 + I-8; M.205: I-25 + I-8;
M.206: I-26 + I-8; M.207: I-27 + I-8; M.208: I-28 + I-8; M.209: I-29 + I-8; M.210: I-30 + I-8;
M.211: I-31 + I-8; M.212: I-10 + I-9; M.213: I-11 + I-9; M.214: I-12 + I-9; M.215: I-13 + I-9;
M.216: I-14 + I-9; M.217: I-15 + I-9; M.218: I-16 + I-9; M.219: I-17 + I-9; M.220: I-18 + I-9;
M.221: I-19 + I-9; M.222: I-20 + I-9; M.223: I-21 + I-9; M.224: I-22 + I-9; M.225: I-23 + I-9;
M.226: I-24 + I-9; M.227: I-25 + I-9; M.228: I-26 + I-9; M.229: I-27 + I-9; M.230: I-28 + I-9;
M.231: I-29 + I-9; M.232: I-30 + I-9; M.233: I-31 + I-9; M.234: I-11 + I-10; M.235: I-12 + I-10;
M.236: I-13 + I-10; M.237: I-14 + I-10; M.238: I-15 + I-10; M.239: I-16 + I-10; M.240: I-17 + I-10;
M.241: I-18 + I-10; M.242: I-19 + I-10; M.243: I-20 + I-10; M.244: I-21 + I-10; M.245: I-22 + I-10;
M.246: I-23 + I-10; M.247: I-24 + I-10; M.248: I-25 + I-10; M.249: I-26 + I-10; M.250: I-27 + I-10;
M.251: I-28 + I-10; M.252: I-29 + I-10; M.253: I-30 + I-10; M.254: I-31 + I-10; M.255: I-12 + I-11;
M.256: I-13 + I-11; M.257: I-14 + I-11; M.258: I-15 + I-11; M.259: I-16 + I-11; M.260: I-17 + I-11;
M.261: I-18 + I-11; M.262: I-19 + I-11; M.263: I-20 + I-11; M.264: I-21 + I-11; M.265: I-22 + I-11;
M.266: I-23 + I-11; M.267: I-24 + I-11; M.268: I-25 + I-11; M.269: I-26 + I-11; M.270: I-27 + I-11;
M.271: I-28 + I-11; M.272: I-29 + I-11; M.273: I-30 + I-11; M.274: I-31 + I-11; M.275: I-13 + I-12;
M.276: I-14 + I-12; M.277: I-15 + I-12; M.278: I-16 + I-12; M.279: I-17 + I-12; M.280: I-18 + I-12;
M.281: I-19 + I-12; M.282: I-20 + I-12; M.283: I-21 + I-12; M.284: I-22 + I-12; M.285: I-23 + I-12;
M.286: I-24 + I-12; M.287: I-25 + I-12; M.288: I-26 + I-12; M.289: I-27 + I-12; M.290: I-28 + I-12;
M.291: I-29 + I-12; M.292: I-30 + I-12; M.293: I-31 + I-12; M.294: I-14 + I-13; M.295: I-15 + I-13;
M.296: I-16 + I-13; M.297: I-17 + I-13; M.298: I-18 + I-13; M.299: I-19 + I-13; M.300: I-20 + I-13;
M.301: I-21 + I-13; M.302: I-22 + I-13; M.303: I-23 + I-13; M.302: I-24 + I-13; M.303: I-25 + I-13;
M.304: I-26 + I-13; M.305: I-27 + I-13; M.306: I-28 + I-13; M.307: I-29 + I-13; M.308: I-30 + I-13;
M.309: I-31 + I-13; M.310: I-15 + I-14; M.311: I-16 + I-14; M.312: I-17 + I-14; M.313: I-18 + I-14;
M.314: I-19 + I-14; M.315: I-20 + I-14; M.316: I-21 + I-14; M.317: I-22 + I-14; M.318: I-23 + I-14;
M.319: I-24 + I-14; M.320: I-25 + I-14; M.321: I-26 + I-14; M.322: I-27 + I-14; M.323: I-28 + I-14;
M.324: I-29 + I-14; M.325: I-30 + I-14; M.326: I-31 + I-14; M.327: I-16 + I-15; M.328: I-17 + I-15;
M.329: I-18 + I-15; M.330: I-19 + I-15; M.331: I-20 + I-15; M.332: I-21 + I-15; M.333: I-22 + I-15;
M.334: I-23 + I-15; M.335: I-24 + I-15; M.336: I-25 + I-15; M.337: I-26 + I-15; M.338: I-27 + I-15;
M.339: I-28 + I-15; M.340: I-29 + I-15; M.341: I-30 + I-15; M.342: I-31 + I-15; M.343: I-17 + I-16;
M.344: I-18 + I-16; M.345: I-19 + I-16; M.346: I-20 + I-16; M.348: I-21 + I-16; M.349: I-22 + I-16;
M.350: I-23 + I-16; M.351: I-24 + I-16; M.352: I-25 + I-16; M.353: I-26 + I-16; M.354: I-27 + I-16;
M.355: I-28 + I-16; M.356: I-29 + I-16; M.357: I-30 + I-16; M.358: I-31 + I-16; M.359: I-18 + I-17;
M.360: I-19 + I-17; M.361: I-20 + I-17; M.362: I-21 + I-17; M.363: I-22 + I-17; M.364: I-23 + I-17;
M.365: I-24 + I-17; M.366: I-25 + I-17; M.367: I-26 + I-17; M.368: I-27 + I-17; M.369: I-28 + I-17;
M.370: I-29 + I-17; M.371: I-30 + I-17; M.372: I-31 + I-17; M.373: I-19 + I-18; M.374: I-20 + I-18;
M.375: I-21 + I-18; M.376: I-22 + I-18; M.377: I-23 + I-18; M.378: I-24 + I-18; M.379: I-25 + I-18;
M.380: I-26 + I-18; M.381: I-27 + I-18; M.382: I-28 + I-18; M.383: I-29 + I-18; M.384: I-30 + I-18;
M.385: I-31 + I-18; M.386: I-20 + I-19; M.387: I-21 + I-19; M.388: I-22 + I-19; M.389: I-23 + I-19;
M.390: I-24 + I-19; M.391: I-25 + I-19; M.392: I-26 + I-19; M.393: I-27 + I-19; M.394: I-28 + I-19;
M.395: I-29 + I-19; M.396: I-30 + I-19; M.397: I-31 + I-19; M.398: I-22 + I-20; M.390: I-23 + I-20;
M.391: I-24 + I-20; M.392: I-25 + I-20; M.393: I-26 + I-20; M.394: I-27 + I-20; M.395: I-28 + I-20;
M.396: I-29 + I-20; M.397: I-30 + I-20; M.398: I-31 + I-20; M.399: M.400: I-22 + I-21; M.401: I-24 + I-21;
M.402: I-25 + I-21; M.403: I-26 + I-21; M.404: I-27 + I-21; M.405: I-28 + I-21; M.406: I-29 + I-21;
M.407: I-30 + I-21; M.408: I-31 + I-21; M.409: I-24 + I-22; M.410: I-26 + I-22; M.411: I-27 + I-22;
M.412: I-28 + I-22; M.413: I-29 + I-22; M.414: I-30 + I-22; M.415: I-31 + I-22; M.416: I-24 + I-23;
M.417: I-25 + I-23; M.418: I-26 + I-23; M.419: I-28 + I-23; M.420: I-29 + I-23; M.421: I-30 + I-23;
M.422: I-31 + I-23; M.423: I-25 + I-24; M.424: I-26 + I-24; M.425: I-27 + I-24; M.426: I-28 + I-24;
M.427: I-29 + I-24; M.428: I-30 + I-24; M.429: I-31 + I-24; M.430: I-26 + I-25; M.431: I-27 + I-25;
M.432: I-28 + I-25; M.433: I-29 + I-25; M.434: I-30 + I-25; M.435: I-31 + I-25; M.436: I-27 + I-26;
M.437: I-28 + I-26; M.438: I-29 + I-26; M.439: I-30 + I-26; M.440: I-31 + I-26; M.441: I-28 + I-27;
M.442: I-29 + I-27; M.443: I-30 + I-27; M.444: I-31 + I-27; M.445: I-29 + I-28; M.446: I-30 + I-28;
M.447: I-31 + I-28; M.448: I-30 + I-29; M.449: I-31 + I-29; M.450: I-31 + I-30.

In another embodiment, the present invention relates to ternary herbicidal mixtures M.1000 to M.1449 listed in Table M(b) below, comprising mixtures of the binary mixtures depicted in table M(a) and a third herbicide I-3.

TABLE M(b)
M.1000: M.1 + I-3; M.1001: M.2 + I-3; M.1002: M.3 + I-3; M.1003: M.4 + I-3; M.1004: M.5 + I-3;
M.1005: M.6 + I-3; M.1006: M.7 + I-3; M.1007: M.8 + I-3; M.1008: M.9 + I-3; M.1009: M.10 + I-3;
M.1010: M.11 + I-3; M.1011: M.12 + I-3; M.1012: M.13 + I-3; M.1013: M.14 + I-3; M.1014: M.15 + I-3;
M.1015: M.16 + I-3; M.1016: M.17 + I-3; M.1017: M.18 + I-3; M.1018: M.19 + I-3; M.1019: M.20 + I-3;
M.1020: M.21 + I-3; M.1021: M.22 + I-3; M.1022: M.23 + I-3; M.1023: M.24 + I-3; M.1024: M.25 + I-3;
M.1025: M.26 + I-3; M.1026: M.27 + I-3; M.1027: M.28 + I-3; M.1028: M.29 + I-3; M.1029: M.30 + I-3;
M.1030: M.31 + I-3; M.1031: M.32 + I-3; M.1032: M.33 + I-3; M.1033: M.34 + I-3; M.1034: M.35 + I-3;
M.1035: M.36 + I-3; M.1036: M.37 + I-3; M.1037: M.38 + I-3; M.1038: M.39 + I-3; M.1039: M.40 + I-3;
M.1040: M.41 + I-3; M.1041: M.42 + I-3; M.1042: M.43 + I-3; M.1043: M.44 + I-3; M.1044: M.45 + I-3;
M.1045: M.46 + I-3; M.1046: M.47 + I-3; M.1047: M.48 + I-3; M.1048: M.49 + I-3; M.1049: M.50 + I-3;
M.1050: M.51 + I-3; M.1051: M.52 + I-3; M.1052: M.53 + I-3; M.1053: M.54 + I-3; M.1054: M.55 + I-3;
M.1055: M.56 + I-3; M.1056: M.57 + I-3; M.1057: M.58 + I-3; M.1058: M.59 + I-3; M.1059: M.60 + I-3;
M.1060: M.61 + I-3; M.1061: M.62 + I-3; M.1062: M.63 + I-3; M.1063: M.64 + I-3; M.1064: M.65 + I-3;
M.1065: M.66 + I-3; M.1066: M.67 + I-3; M.1067: M.68 + I-3; M.1068: M.69 + I-3; M.1069: M.70 + I-3;
M.1070: M.71 + I-3; M.1071: M.72 + I-3; M.1072: M.73 + I-3; M.1073: M.74 + I-3; M.1074: M.75 + I-3;
M.1075: M.76 + I-3; M.1076: M.77 + I-3; M.1077: M.78 + I-3; M.1078: M.79 + I-3; M.1079: M.80 + I-3;
M.1080: M.81 + I-3; M.1081: M.82 + I-3; M.1082: M.83 + I-3; M.1083: M.84 + I-3; M.1084: M.85 + I-3;
M.1085: M.86 + I-3; M.1086: M.87 + I-3; M.1087: M.88 + I-3; M.1088: M.89 + I-3; M.1089: M.90 + I-3;
M.1090: M.91 + I-3; M.1091: M.92 + I-3; M.1092: M.93 + I-3; M.1093: M.94 + I-3; M.1094: M.95 + I-3;
M.1095: M.96 + I-3; M.1096: M.97 + I-3; M.1097: M.98 + I-3; M.1098: M.99 + I-3; M.1099: M.100 + I-3;
M.1100: M.101 + I-3; M.1101: M.102 + I-3; M.1102: M.103 + I-3; M.1103: M.104 + I-3; M.1104: M.105 + I-3;
M.1105: M.106 + I-3; M.1106: M.107 + I-3; M.1107: M.108 + I-3; M.1108: M.109 + I-3; M.1109: M.110 + I-3;
M.1110: M.111 + I-3; M.1111: M.112 + I-3; M.1112: M.113 + I-3; M.1113: M.114 + I-3; M.1114: M.115 + I-3;
M.1115: M.116 + I-3; M.1116: M.117 + I-3; M.1117: M.118 + I-3; M.1118: M.119 + I-3; M.1119: M.120 + I-3;
M.1120: M.121 + I-3; M.1121: M.122 + I-3; M.1122: M.123 + I-3; M.1123: M.124 + I-3; M.1124: M.125 + I-3;
M.1125: M.126 + I-3; M.1126: M.127 + I-3; M.1127: M.128 + I-3; M.1128: M.129 + I-3; M.1129: M.130 + I-3;
M.1130: M.131 + I-3; M.1131: M.132 + I-3; M.1132: M.133 + I-3; M.1133: M.134 + I-3; M.1134: M.135 + I-3;
M.1135: M.136 + I-3; M.1136: M.137 + I-3; M.1137: M.138 + I-3; M.1138: M.139 + I-3; M.1139: M.140 + I-3;
M.1140: M.141 + I-3; M.1141: M.142 + I-3; M.1142: M.143 + I-3; M.1143: M.144 + I-3; M.1144: M.145 + I-3;
M.1145: M.146 + I-3; M.1146: M.147 + I-3; M.1147: M.148 + I-3; M.1148: M.149 + I-3; M.1149: M.150 + I-3;
M.1150: M.151 + I-3; M.1151: M.152 + I-3; M.1152: M.153 + I-3; M.1153: M.154 + I-3; M.1154: M.155 + I-3;
M.1155: M.156 + I-3; M.1156: M.157 + I-3; M.1157: M.158 + I-3; M.1158: M.159 + I-3; M.1159: M.160 + I-3;
M.1160: M.161 + I-3; M.1161: M.162 + I-3; M.1162: M.163 + I-3; M.1163: M.164 + I-3; M.1164: M.165 + I-3;
M.1165: M.166 + I-3; M.1166: M.167 + I-3; M.1167: M.168 + I-3; M.1168: M.169 + I-3; M.1169: M.170 + I-3;
M.1170: M.171 + I-3; M.1171: M.172 + I-3; M.1172: M.173 + I-3; M.1173: M.174 + I-3; M.1174: M.175 + I-3;
M.1175: M.176 + I-3; M.1176: M.177 + I-3; M.1177: M.178 + I-3; M.1178: M.179 + I-3; M.1179: M.180 + I-3;
M.1180: M.181 + I-3; M.1181: M.182 + I-3; M.1182: M.183 + I-3; M.1183: M.184 + I-3; M.1184: M.185 + I-3;
M.1185: M.186 + I-3; M.1186: M.187 + I-3; M.1187: M.188 + I-3; M.1188: M.189 + I-3; M.1189: M.190 + I-3;
M.1190: M.191 + I-3; M.1191: M.192 + I-3; M.1192: M.193 + I-3; M.1193: M.194 + I-3; M.1194: M.195 + I-3;
M.1195: M.196 + I-3; M.1196: M.197 + I-3; M.1197: M.198 + I-3; M.1198: M.199 + I-3; M.1199: M.200 + I-3;
M.1200: M.201 + I-3; M.1201: M.202 + I-3; M.1202: M.203 + I-3; M.1203: M.204 + I-3; M.1204: M.205 + I-3;
M.1205: M.206 + I-3; M.1206: M.207 + I-3; M.1207: M.208 + I-3; M.1208: M.209 + I-3; M.1209: M.210 + I-3;
M.1210: M.211 + I-3; M.1211: M.212 + I-3; M.1212: M.213 + I-3; M.1213: M.214 + I-3; M.1214: M.215 + I-3;
M.1215: M.216 + I-3; M.1216: M.217 + I-3; M.1217: M.218 + I-3; M.1218: M.219 + I-3; M.1219: M.220 + I-3;
M.1220: M.221 + I-3; M.1221: M.222 + I-3; M.1222: M.223 + I-3; M.1223: M.224 + I-3; M.1224: M.225 + I-3;
M.1225: M.226 + I-3; M.1226: M.227 + I-3; M.1227: M.228 + I-3; M.1228: M.229 + I-3; M.1229: M.230 + I-3;
M.1230: M.231 + I-3; M.1231: M.232 + I-3; M.1232: M.233 + I-3; M.1233: M.234 + I-3; M.1234: M.235 + I-3;
M.1235: M.236 + I-3; M.1236: M.237 + I-3; M.1237: M.238 + I-3; M.1238: M.239 + I-3; M.1239: M.240 + I-3;
M.1240: M.241 + I-3; M.1241: M.242 + I-3; M.1242: M.243 + I-3; M.1243: M.244 + I-3; M.1244: M.245 + I-3;
M.1245: M.246 + I-3; M.1246: M.247 + I-3; M.1247: M.248 + I-3; M.1248: M.249 + I-3; M.1249: M.250 + I-3;
M.1250: M.251 + I-3; M.1251: M.252 + I-3; M.1252: M.253 + I-3; M.1253: M.254 + I-3; M.1254: M.255 + I-3;
M.1255: M.256 + I-3; M.1256: M.257 + I-3; M.1257: M.258 + I-3; M.1258: M.259 + I-3; M.1259: M.260 + I-3;
M.1260: M.261 + I-3; M.1261: M.262 + I-3; M.1262: M.263 + I-3; M.1263: M.264 + I-3; M.1264: M.265 + I-3;
M.1265: M.266 + I-3; M.1266: M.267 + I-3; M.1267: M.268 + I-3; M.1268: M.269 + I-3; M.1269: M.270 + I-3;
M.1270: M.271 + I-3; M.1271: M.272 + I-3; M.1272: M.273 + I-3; M.1273: M.274 + I-3; M.1274: M.275 + I-3;
M.1275: M.276 + I-3; M.1276: M.277 + I-3; M.1277: M.278 + I-3; M.1278: M.279 + I-3; M.1279: M.280 + I-3;
M.1280: M.281 + I-3; M.1281: M.282 + I-3; M.1282: M.283 + I-3; M.1283: M.284 + I-3; M.1284: M.285 + I-3;
M.1285: M.286 + I-3; M.1286: M.287 + I-3; M.1287: M.288 + I-3; M.1288: M.289 + I-3; M.1289: M.290 + I-3;
M.1290: M.291 + I-3; M.1291: M.292 + I-3; M.1292: M.293 + I-3; M.1293: M.294 + I-3; M.1294: M.295 + I-3;
M.1295: M.296 + I-3; M.1296: M.297 + I-3; M.1297: M.298 + I-3; M.1298: M.299 + I-3; M.1299: M.300 + I-3;
M.1300: M.301 + I-3; M.1301: M.302 + I-3; M.1302: M.303 + I-3; M.1303: M.304 + I-3; M.1304: M.305 + I-3;
M.1305: M.306 + I-3; M.1306: M.307 + I-3; M.1307: M.308 + I-3; M.1308: M.309 + I-3; M.1309: M.310 + I-3;
M.1310: M.311 + I-3; M.1311: M.312 + I-3; M.1312: M.313 + I-3; M.1313: M.314 + I-3; M.1314: M.315 + I-3;
M.1315: M.316 + I-3; M.1316: M.317 + I-3; M.1317: M.318 + I-3; M.1318: M.319 + I-3; M.1319: M.320 + I-3;
M.1320: M.321 + I-3; M.1321: M.322 + I-3; M.1322: M.323 + I-3; M.1323: M.324 + I-3; M.1324: M.325 + I-3;
M.1325: M.326 + I-3; M.1326: M.327 + I-3; M.1327: M.328 + I-3; M.1328: M.329 + I-3; M.1329: M.330 + I-3;
M.1330: M.331 + I-3; M.1331: M.332 + I-3; M.1332: M.333 + I-3; M.1333: M.334 + I-3; M.1334: M.335 + I-3;
M.1335: M.336 + I-3; M.1336: M.337 + I-3; M.1337: M.338 + I-3; M.1338: M.339 + I-3; M.1339: M.340 + I-3;
M.1340: M.341 + I-3; M.1341: M.342 + I-3; M.1342: M.343 + I-3; M.1343: M.344 + I-3; M.1344: M.345 + I-3;
M.1345: M.346 + I-3; M.1346: M.347 + I-3; M.1347: M.348 + I-3; M.1348: M.349 + I-3; M.1349: M.350 + I-3;
M.1350: M.351 + I-3; M.1351: M.352 + I-3; M.1352: M.353 + I-3; M.1353: M.354 + I-3; M.1354: M.355 + I-3;
M.1355: M.356 + I-3; M.1356: M.357 + I-3; M.1357: M.358 + I-3; M.1358: M.359 + I-3; M.1359: M.360 + I-3;
M.1360: M.361 + I-3; M.1361: M.362 + I-3; M.1362: M.363 + I-3; M.1363: M.364 + I-3; M.1364: M.365 + I-3;
M.1365: M.366 + I-3; M.1366: M.367 + I-3; M.1367: M.368 + I-3; M.1368: M.369 + I-3; M.1369: M.370 + I-3;
M.1370: M.371 + I-3; M.1371: M.372 + I-3; M.1372: M.373 + I-3; M.1373: M.374 + I-3; M.1374: M.375 + I-3;
M.1375: M.376 + I-3; M.1376: M.377 + I-3; M.1377: M.378 + I-3; M.1378: M.379 + I-3; M.1379: M.380 + I-3;
M.1380: M.381 + I-3; M.1381: M.382 + I-3; M.1382: M.383 + I-3; M.1383: M.384 + I-3; M.1384: M.385 + I-3;
M.1385: M.386 + I-3; M.1386: M.387 + I-3; M.1387: M.388 + I-3; M.1388: M.389 + I-3; M.1389: M.390 + I-3;
M.1390: M.391 + I-3; M.1391: M.392 + I-3; M.1392: M.393 + I-3; M.1393: M.394 + I-3; M.1394: M.395 + I-3;
M.1395: M.396 + I-3; M.1396: M.397 + I-3; M.1397: M.398 + I-3; M.1398: M.399 + I-3; M.1399: M.400 + I-3;
M.1400: M.401 + I-3; M.1401: M.402 + I-3; M.1402: M.403 + I-3; M.1403: M.404 + I-3; M.1404: M.405 + I-3;
M.1405: M.406 + I-3; M.1406: M.407 + I-3; M.1407: M.408 + I-3; M.1408: M.409 + I-3; M.1409: M.410 + I-3;
M.1410: M.411 + I-3; M.1411: M.412 + I-3; M.1412: M.413 + I-3; M.1413: M.414 + I-3; M.1414: M.415 + I-3;
M.1415: M.416 + I-3; M.1416: M.417 + I-3; M.1417: M.418 + I-3; M.1418: M.419 + I-3; M.1419: M.420 + I-3;
M.1420: M.421 + I-3; M.1421: M.422 + I-3; M.1422: M.423 + I-3; M.1423: M.424 + I-3; M.1424: M.425 + I-3;
M.1425: M.426 + I-3; M.1426: M.427 + I-3; M.1427: M.428 + I-3; M.1428: M.429 + I-3; M.1429: M.430 + I-3;
M.1430: M.431 + I-3; M.1431: M.432 + I-3; M.1432: M.433 + I-3; M.1433: M.434 + I-3; M.1434: M.435 + I-3;
M.1435: M.436 + I-3; M.1436: M.437 + I-3; M.1437: M.438 + I-3; M.1438: M.439 + I-3; M.1439: M.440 + I-3;
M.1440: M.441 + I-3; M.1441: M.442 + I-3; M.1442: M.443 + I-3; M.1443: M.444 + I-3; M.1444: M.445 + I-3;
M.1445: M.446 + I-3; M.1446: M.447 + I-3; M.1447: M.448 + I-3; M.1448: M.449 + I-3; M.1449: M.450 + I-3.

In another embodiment, the present invention relates to ternary herbicidal mixtures M.2000 to M.2449 listed in Table M(c) below, comprising mixtures of the binary mixtures depicted in table M(a) and a third herbicide I-4.

TABLE M(c)
M.2000: M.1 + I-4; M.2001: M.2 + I-4; M.2002: M.3 + I-4; M.2003: M.4 + I-4; M.2004: M.5 + I-4;
M.2005: M.6 + I-4; M.2006: M.7 + I-4; M.2007: M.8 + I-4; M.2008: M.9 + I-4; M.2009: M.10 + I-4;
M.2010: M.11 + I-4; M.2011: M.12 + I-4; M.2012: M.13 + I-4; M.2013: M.14 + I-4; M.2014: M.15 + I-4;
M.2015: M.16 + I-4; M.2016: M.17 + I-4; M.2017: M.18 + I-4; M.2018: M.19 + I-4; M.2019: M.20 + I-4;
M.2020: M.21 + I-4; M.2021: M.22 + I-4; M.2022: M.23 + I-4; M.2023: M.24 + I-4; M.2024: M.25 + I-4;
M.2025: M.26 + I-4; M.2026: M.27 + I-4; M.2027: M.28 + I-4; M.2028: M.29 + I-4; M.2029: M.30 + I-4;
M.2030: M.31 + I-4; M.2031: M.32 + I-4; M.2032: M.33 + I-4; M.2033: M.34 + I-4; M.2034: M.35 + I-4;
M.2035: M.36 + I-4; M.2036: M.37 + I-4; M.2037: M.38 + I-4; M.2038: M.39 + I-4; M.2039: M.40 + I-4;
M.2040: M.41 + I-4; M.2041: M.42 + I-4; M.2042: M.43 + I-4; M.2043: M.44 + I-4; M.2044: M.45 + I-4;
M.2045: M.46 + I-4; M.2046: M.47 + I-4; M.2047: M.48 + I-4; M.2048: M.49 + I-4; M.2049: M.50 + I-4;
M.2050: M.51 + I-4; M.2051: M.52 + I-4; M.2052: M.53 + I-4; M.2053: M.54 + I-4; M.2054: M.55 + I-4;
M.2055: M.56 + I-4; M.2056: M.57 + I-4; M.2057: M.58 + I-4; M.2058: M.59 + I-4; M.2059: M.60 + I-4;
M.2060: M.61 + I-4; M.2061: M.62 + I-4; M.2062: M.63 + I-4; M.2063: M.64 + I-4; M.2064: M.65 + I-4;
M.2065: M.66 + I-4; M.2066: M.67 + I-4; M.2067: M.68 + I-4; M.2068: M.69 + I-4; M.2069: M.70 + I-4;
M.2070: M.71 + I-4; M.2071: M.72 + I-4; M.2072: M.73 + I-4; M.2073: M.74 + I-4; M.2074: M.75 + I-4;
M.2075: M.76 + I-4; M.2076: M.77 + I-4; M.2077: M.78 + I-4; M.2078: M.79 + I-4; M.2079: M.80 + I-4;
M.2080: M.81 + I-4; M.2081: M.82 + I-4; M.2082: M.83 + I-4; M.2083: M.84 + I-4; M.2084: M.85 + I-4;
M.2085: M.86 + I-4; M.2086: M.87 + I-4; M.2087: M.88 + I-4; M.2088: M.89 + I-4; M.2089: M.90 + I-4;
M.2090: M.91 + I-4; M.2091: M.92 + I-4; M.2092: M.93 + I-4; M.2093: M.94 + I-4; M.2094: M.95 + I-4;
M.2095: M.96 + I-4; M.2096: M.97 + I-4; M.2097: M.98 + I-4; M.2098: M.99 + I-4; M.2099: M.100 + I-4;
M.2100: M.101 + I-4; M.2101: M.102 + I-4; M.2102: M.103 + I-4; M.2103: M.104 + I-4; M.2104: M.105 + I-4;
M.2105: M.106 + I-4; M.2106: M.107 + I-4; M.2107: M.108 + I-4; M.2108: M.109 + I-4; M.2109: M.110 + I-4;
M.2110: M.111 + I-4; M.2111: M.112 + I-4; M.2112: M.113 + I-4; M.2113: M.114 + I-4; M.2114: M.115 + I-4;
M.2115: M.116 + I-4; M.2116: M.117 + I-4; M.2117: M.118 + I-4; M.2118: M.119 + I-4; M.2119: M.120 + I-4;
M.2120: M.121 + I-4; M.2121: M.122 + I-4; M.2122: M.123 + I-4; M.2123: M.124 + I-4; M.2124: M.125 + I-4;
M.2125: M.126 + I-4; M.2126: M.127 + I-4; M.2127: M.128 + I-4; M.2128: M.129 + I-4; M.2129: M.130 + I-4;
M.2130: M.131 + I-4; M.2131: M.132 + I-4; M.2132: M.133 + I-4; M.2133: M.134 + I-4; M.2134: M.135 + I-4;
M.2135: M.136 + I-4; M.2136: M.137 + I-4; M.2137: M.138 + I-4; M.2138: M.139 + I-4; M.2139: M.140 + I-4;
M.2140: M.141 + I-4; M.2141: M.142 + I-4; M.2142: M.143 + I-4; M.2143: M.144 + I-4; M.2144: M.145 + I-4;
M.2145: M.146 + I-4; M.2146: M.147 + I-4; M.2147: M.148 + I-4; M.2148: M.149 + I-4; M.2149: M.150 + I-4;
M.2150: M.151 + I-4; M.2151: M.152 + I-4; M.2152: M.153 + I-4; M.2153: M.154 + I-4; M.2154: M.155 + I-4;
M.2155: M.156 + I-4; M.2156: M.157 + I-4; M.2157: M.158 + I-4; M.2158: M.159 + I-4; M.2159: M.160 + I-4;
M.2160: M.161 + I-4; M.2161: M.162 + I-4; M.2162: M.163 + I-4; M.2163: M.164 + I-4; M.2164: M.165 + I-4;
M.2165: M.166 + I-4; M.2166: M.167 + I-4; M.2167: M.168 + I-4; M.2168: M.169 + I-4; M.2169: M.170 + I-4;
M.2170: M.171 + I-4; M.2171: M.172 + I-4; M.2172: M.173 + I-4; M.2173: M.174 + I-4; M.2174: M.175 + I-4;
M.2175: M.176 + I-4; M.2176: M.177 + I-4; M.2177: M.178 + I-4; M.2178: M.179 + I-4; M.2179: M.180 + I-4;
M.2180: M.181 + I-4; M.2181: M.182 + I-4; M.2182: M.183 + I-4; M.2183: M.184 + I-4; M.2184: M.185 + I-4;
M.2185: M.186 + I-4; M.2186: M.187 + I-4; M.2187: M.188 + I-4; M.2188: M.189 + I-4; M.2189: M.190 + I-4;
M.2190: M.191 + I-4; M.2191: M.192 + I-4; M.2192: M.193 + I-4; M.2193: M.194 + I-4; M.2194: M.195 + I-4;
M.2195: M.196 + I-4; M.2196: M.197 + I-4; M.2197: M.198 + I-4; M.2198: M.199 + I-4; M.2199: M.200 + I-4;
M.2200: M.201 + I-4; M.2201: M.202 + I-4; M.2202: M.203 + I-4; M.2203: M.204 + I-4; M.2204: M.205 + I-4;
M.2205: M.206 + I-4; M.2206: M.207 + I-4; M.2207: M.208 + I-4; M.2208: M.209 + I-4; M.2209: M.210 + I-4;
M.2210: M.211 + I-4; M.2211: M.212 + I-4; M.2212: M.213 + I-4; M.2213: M.214 + I-4; M.1214: M.215 + I-4;
M.2215: M.216 + I-4; M.1216: M.217 + I-4; M.2217: M.218 + I-4; M.1218: M.219 + I-4; M.2219: M.220 + I-4;
M.1220: M.221 + I-4; M.2221: M.222 + I-4; M.2222: M.223 + I-4; M.2223: M.224 + I-4; M.2224: M.225 + I-4;
M.2225: M.226 + I-4; M.2226: M.227 + I-4; M.2227: M.228 + I-4; M.2228: M.229 + I-4; M.2229: M.230 + I-4;
M.2230: M.231 + I-4; M.2231: M.232 + I-4; M.2232: M.233 + I-4; M.2233: M.234 + I-4; M.2234: M.235 + I-4;
M.2235: M.236 + I-4; M.2236: M.237 + I-4; M.2237: M.238 + I-4; M.2238: M.239 + I-4; M.2239: M.240 + I-4;
M.2240: M.241 + I-4; M.2241: M.242 + I-4; M.2242: M.243 + I-4; M.2243: M.244 + I-4; M.2244: M.245 + I-4;
M.2245: M.246 + I-4; M.2246: M.247 + I-4; M.2247: M.248 + I-4; M.2248: M.249 + I-4; M.2249: M.250 + I-4;
M.2250: M.251 + I-4; M.2251: M.252 + I-4; M.2252: M.253 + I-4; M.2253: M.254 + I-4; M.2254: M.255 + I-4;
M.2255: M.256 + I-4; M.2256: M.257 + I-4; M.2257: M.258 + I-4; M.2258: M.259 + I-4; M.2259: M.260 + I-4;
M.2260: M.261 + I-4; M.2261: M.262 + I-4; M.2262: M.263 + I-4; M.2263: M.264 + I-4; M.2264: M.265 + I-4;
M.2265: M.266 + I-4; M.2266: M.267 + I-4; M.2267: M.268 + I-4; M.2268: M.269 + I-4; M.2269: M.270 + I-4;
M.2270: M.271 + I-4; M.2271: M.272 + I-4; M.2272: M.273 + I-4; M.2273: M.274 + I-4; M.2274: M.275 + I-4;
M.2275: M.276 + I-4; M.2276: M.277 + I-4; M.2277: M.278 + I-4; M.2278: M.279 + I-4; M.2279: M.280 + I-4;
M.2280: M.281 + I-4; M.2281: M.282 + I-4; M.2282: M.283 + I-4; M.2283: M.284 + I-4; M.2284: M.285 + I-4;
M.2285: M.286 + I-4; M.2286: M.287 + I-4; M.2287: M.288 + I-4; M.2288: M.289 + I-4; M.2289: M.290 + I-4;
M.2290: M.291 + I-4; M.2291: M.292 + I-4; M.2292: M.293 + I-4; M.2293: M.294 + I-4; M.2294: M.295 + I-4;
M.2295: M.296 + I-4; M.2296: M.297 + I-4; M.2297: M.298 + I-4; M.2298: M.299 + I-4; M.2299: M.300 + I-4;
M.2300: M.301 + I-4; M.2301: M.302 + I-4; M.2302: M.303 + I-4; M.2303: M.304 + I-4; M.2304: M.305 + I-4;
M.2305: M.306 + I-4; M.2306: M.307 + I-4; M.2307: M.308 + I-4; M.2308: M.309 + I-4; M.2309: M.310 + I-4;
M.2310: M.311 + I-4; M.2311: M.312 + I-4; M.2312: M.323 + I-4; M.2313: M.314 + I-4; M.2314: M.315 + I-4;
M.2315: M.316 + I-4; M.2316: M.317 + I-4; M.2317: M.318 + I-4; M.2318: M.319 + I-4; M.2319: M.320 + I-4;
M.2320: M.321 + I-4; M.2321: M.322 + I-4; M.2322: M.323 + I-4; M.2323: M.324 + I-4; M.2324: M.325 + I-4;
M.2325: M.326 + I-4; M.2326: M.327 + I-4; M.2327: M.328 + I-4; M.2328: M.329 + I-4; M.2329: M.330 + I-4;
M.2330: M.331 + I-4; M.2331: M.332 + I-4; M.2332: M.333 + I-4; M.2333: M.334 + I-4; M.2334: M.335 + I-4;
M.2335: M.336 + I-4; M.2336: M.337 + I-4; M.2337: M.338 + I-4; M.2338: M.339 + I-4; M.2339: M.340 + I-4;
M.2340: M.341 + I-4; M.2341: M.342 + I-4; M.2342: M.343 + I-4; M.2343: M.344 + I-4; M.2344: M.345 + I-4;
M.2345: M.346 + I-4; M.2346: M.347 + I-4; M.2347: M.348 + I-4; M.2348: M.349 + I-4; M.2349: M.350 + I-4;
M.2350: M.351 + I-4; M.2351: M.352 + I-4; M.2352: M.353 + I-4; M.2353: M.354 + I-4; M.2354: M.355 + I-4;
M.2355: M.356 + I-4; M.2356: M.357 + I-4; M.2357: M.358 + I-4; M.2358: M.359 + I-4; M.2359: M.360 + I-4;
M.2360: M.361 + I-4; M.2361: M.362 + I-4; M.2362: M.363 + I-4; M.2363: M.364 + I-4; M.2364: M.365 + I-4;
M.2365: M.366 + I-4; M.2366: M.367 + I-4; M.2367: M.368 + I-4; M.2368: M.369 + I-4; M.2369: M.370 + I-4;
M.2370: M.371 + I-4; M.2371: M.372 + I-4; M.2372: M.373 + I-4; M.2373: M.374 + I-4; M.2374: M.375 + I-4;
M.2375: M.376 + I-4; M.2376: M.377 + I-4; M.2377: M.378 + I-4; M.2378: M.379 + I-4; M.2379: M.380 + I-4;
M.2380: M.381 + I-4; M.2381: M.382 + I-4; M.2382: M.383 + I-4; M.2383: M.384 + I-4; M.2384: M.385 + I-4;
M.2385: M.386 + I-4; M.2386: M.387 + I-4; M.2387: M.388 + I-4; M.2388: M.389 + I-4; M.2389: M.390 + I-4;
M.2390: M.391 + I-4; M.2391: M.392 + I-4; M.2392: M.393 + I-4; M.2393: M.394 + I-4; M.2394: M.395 + I-4;
M.2395: M.396 + I-4; M.2396: M.397 + I-4; M.2397: M.398 + I-4; M.2398: M.399 + I-4; M.2399: M.400 + I-4;
M.2400: M.401 + I-4; M.2401: M.402 + I-4; M.2402: M.403 + I-4; M.2403: M.404 + I-4; M.2404: M.405 + I-4;
M.2405: M.406 + I-4; M.2406: M.407 + I-4; M.2407: M.408 + I-4; M.2408: M.409 + I-4; M.2409: M.410 + I-4;
M.2410: M.411 + I-4; M.2411: M.412 + I-4; M.2412: M.413 + I-4; M.2413: M.424 + I-4; M.2414: M.415 + I-4;
M.2415: M.416 + I-4; M.2416: M.417 + I-4; M.2417: M.418 + I-4; M.2418: M.419 + I-4; M.2419: M.420 + I-4;
M.2420: M.421 + I-4; M.2421: M.422 + I-4; M.2422: M.423 + I-4; M.2423: M.424 + I-4; M.2424: M.425 + I-4;
M.2425: M.426 + I-4; M.2426: M.427 + I-4; M.2427: M.428 + I-4; M.2428: M.429 + I-4; M.2429: M.430 + I-4;
M.2430: M.431 + I-4; M.2431: M.432 + I-4; M.2432: M.433 + I-4; M.2433: M.434 + I-4; M.2434: M.435 + I-4;
M.2435: M.436 + I-4; M.2436: M.437 + I-4; M.2437: M.438 + I-4; M.2438: M.439 + I-4; M.2439: M.440 + I-4;
M.2440: M.441 + I-4; M.2441: M.442 + I-4; M.2442: M.443 + I-4; M.2443: M.444 + I-4; M.2444: M.445 + I-4;
M.2445: M.446 + I-4; M.2446: M.447 + I-4; M.2447: M.448 + I-4; M.2448: M.449 + I-4; M.2449: M.450 + I-4.

In another embodiment, the present invention relates to ternary herbicidal mixtures M.3000 to M.3449 listed in Table M(d) below, comprising mixtures of the binary mixtures depicted in table M(a) and a third herbicide I-5.

TABLE M(d)
M.3000: M.1 + I-5; M.3001: M.2 + I-5; M.3002: M.3 + I-5; M.3003: M.4 + I-5; M.3004: M.5 + I-5;
M.3005: M.6 + I-5; M.3006: M.7 + I-5; M.3007: M.8 + I-5; M.3008: M.9 + I-5; M.3009: M.10 + I-5;
M.3010: M.11 + I-5; M.3011: M.12 + I-5; M.3012: M.13 + I-5; M.3013: M.14 + I-5; M.3014: M.15 + I-5;
M.3015: M.16 + I-5; M.3016: M.17 + I-5; M.3017: M.18 + I-5; M.3018: M.19 + I-5; M.3019: M.20 + I-5;
M.3020: M.21 + I-5; M.3021: M.22 + I-5; M.3022: M.23 + I-5; M.3023: M.24 + I-5; M.3024: M.25 + I-5;
M.3025: M.26 + I-5; M.3026: M.27 + I-5; M.3027: M.28 + I-5; M.3028: M.29 + I-5; M.3029: M.30 + I-5;
M.3030: M.31 + I-5; M.3031: M.32 + I-5; M.3032: M.33 + I-5; M.3033: M.34 + I-5; M.3034: M.35 + I-5;
M.3035: M.36 + I-5; M.3036: M.37 + I-5; M.3037: M.38 + I-5; M.3038: M.39 + I-5; M.3039: M.40 + I-5;
M.3040: M.41 + I-5; M.3041: M.42 + I-5; M.3042: M.43 + I-5; M.3043: M.44 + I-5; M.3044: M.45 + I-5;
M.3045: M.46 + I-5; M.3046: M.47 + I-5; M.3047: M.48 + I-5; M.3048: M.49 + I-5; M.3049: M.50 + I-5;
M.3050: M.51 + I-5; M.3051: M.52 + I-5; M.3052: M.53 + I-5; M.3053: M.54 + I-5; M.3054: M.55 + I-5;
M.3055: M.56 + I-5; M.3056: M.57 + I-5; M.3057: M.58 + I-5; M.3058: M.59 + I-5; M.3059: M.60 + I-5;
M.3060: M.61 + I-5; M.3061: M.62 + I-5; M.3062: M.63 + I-5; M.3063: M.64 + I-5; M.3064: M.65 + I-5;
M.3065: M.66 + I-5; M.3066: M.67 + I-5; M.3067: M.68 + I-5; M.3068: M.69 + I-5; M.3069: M.70 + I-5;
M.3070: M.71 + I-5; M.3071: M.72 + I-5; M.3072: M.73 + I-5; M.3073: M.74 + I-5; M.3074: M.75 + I-5;
M.3075: M.76 + I-5; M.3076: M.77 + I-5; M.3077: M.78 + I-5; M.3078: M.79 + I-5; M.3079: M.80 + I-5;
M.3080: M.81 + I-5; M.3081: M.82 + I-5; M.3082: M.83 + I-5; M.3083: M.84 + I-5; M.3084: M.85 + I-5;
M.3085: M.86 + I-5; M.3086: M.87 + I-5; M.3087: M.88 + I-5; M.3088: M.89 + I-5; M.3089: M.90 + I-5;
M.3090: M.91 + I-5; M.3091: M.92 + I-5; M.3092: M.93 + I-5; M.3093: M.94 + I-5; M.3094: M.95 + I-5;
M.3095: M.96 + I-5; M.3096: M.97 + I-5; M.3097: M.98 + I-5; M.3098: M.99 + I-5; M.3099: M.100 + I-5;
M.3100: M.101 + I-5; M.3101: M.102 + I-5; M.3102: M.103 + I-5; M.3103: M.104 + I-5; M.3104: M.105 + I-5;
M.3105: M.106 + I-5; M.3106: M.107 + I-5; M.3107: M.108 + I-5; M.3108: M.109 + I-5; M.3109: M.110 + I-5;
M.3110: M.111 + I-5; M.3111: M.112 + I-5; M.3112: M.113 + I-5; M.3113: M.114 + I-5; M.3114: M.115 + I-5;
M.3115: M.116 + I-5; M.3116: M.117 + I-5; M.3117: M.118 + I-5; M.3118: M.119 + I-5; M.3119: M.120 + I-5;
M.3120: M.121 + I-5; M.3121: M.122 + I-5; M.3122: M.123 + I-5; M.3123: M.124 + I-5; M.3124: M.125 + I-5;
M.3125: M.126 + I-5; M.3126: M.127 + I-5; M.3127: M.128 + I-5; M.3128: M.129 + I-5; M.3129: M.130 + I-5;
M.3130: M.131 + I-5; M.3131: M.132 + I-5; M.3132: M.133 + I-5; M.3133: M.134 + I-5; M.3134: M.135 + I-5;
M.3135: M.136 + I-5; M.3136: M.137 + I-5; M.3137: M.138 + I-5; M.3138: M.139 + I-5; M.3139: M.140 + I-5;
M.3140: M.141 + I-5; M.3141: M.142 + I-5; M.3142: M.143 + I-5; M.3143: M.144 + I-5; M.3144: M.145 + I-5;
M.3145: M.146 + I-5; M.3146: M.147 + I-5; M.3147: M.148 + I-5; M.3148: M.149 + I-5; M.3149: M.150 + I-5;
M.3150: M.151 + I-5; M.3151: M.152 + I-5; M.3152: M.153 + I-5; M.3153: M.154 + I-5; M.3154: M.155 + I-5;
M.3155: M.156 + I-5; M.3156: M.157 + I-5; M.3157: M.158 + I-5; M.3158: M.159 + I-5; M.3159: M.160 + I-5;
M.3160: M.161 + I-5; M.3161: M.162 + I-5; M.3162: M.163 + I-5; M.3163: M.164 + I-5; M.3164: M.165 + I-5;
M.3165: M.166 + I-5; M.3166: M.167 + I-5; M.3167: M.168 + I-5; M.3168: M.169 + I-5; M.3169: M.170 + I-5;
M.3170: M.171 + I-5; M.3171: M.172 + I-5; M.3172: M.173 + I-5; M.3173: M.174 + I-5; M.3174: M.175 + I-5;
M.3175: M.176 + I-5; M.3176: M.177 + I-5; M.3177: M.178 + I-5; M.3178: M.179 + I-5; M.3179: M.180 + I-5;
M.3180: M.181 + I-5; M.3181: M.182 + I-5; M.3182: M.183 + I-5; M.3183: M.184 + I-5; M.3184: M.185 + I-5;
M.3185: M.186 + I-5; M.3186: M.187 + I-5; M.3187: M.188 + I-5; M.3188: M.189 + I-5; M.3189: M.190 + I-5;
M.3190: M.191 + I-5; M.3191: M.192 + I-5; M.3192: M.193 + I-5; M.3193: M.194 + I-5; M.3194: M.195 + I-5;
M.3195: M.196 + I-5; M.3196: M.197 + I-5; M.3197: M.198 + I-5; M.3198: M.199 + I-5; M.3199: M.200 + I-5;
M.3200: M.201 + I-5; M.3201: M.202 + I-5; M.3202: M.203 + I-5; M.3203: M.204 + I-5; M.3204: M.205 + I-5;
M.3205: M.206 + I-5; M.3206: M.207 + I-5; M.3207: M.208 + I-5; M.3208: M.209 + I-5; M.3209: M.210 + I-5;
M.3210: M.211 + I-5; M.3211: M.212 + I-5; M.3212: M.213 + I-5; M.3213: M.214 + I-5; M.3214: M.215 + I-5;
M.3215: M.216 + I-5; M.3216: M.217 + I-5; M.3217: M.218 + I-5; M.3218: M.219 + I-5; M.3219: M.220 + I-5;
M.3220: M.221 + I-5; M.3221: M.222 + I-5; M.3222: M.223 + I-5; M.3223: M.224 + I-5; M.3224: M.225 + I-5;
M.3225: M.226 + I-5; M.3226: M.227 + I-5; M.3227: M.228 + I-5; M.3228: M.229 + I-5; M.3229: M.230 + I-5;
M.3230: M.231 + I-5; M.3231: M.232 + I-5; M.3232: M.233 + I-5; M.3233: M.234 + I-5; M.3234: M.235 + I-5;
M.3235: M.236 + I-5; M.3236: M.237 + I-5; M.3237: M.238 + I-5; M.3238: M.239 + I-5; M.3239: M.240 + I-5;
M.3240: M.241 + I-5; M.3241: M.242 + I-5; M.3242: M.243 + I-5; M.3243: M.244 + I-5; M.3244: M.245 + I-5;
M.3245: M.246 + I-5; M.3246: M.247 + I-5; M.3247: M.248 + I-5; M.3248: M.249 + I-5; M.3249: M.250 + I-5;
M.3250: M.251 + I-5; M.3251: M.252 + I-5; M.3252: M.253 + I-5; M.3253: M.254 + I-5; M.3254: M.255 + I-5;
M.3255: M.256 + I-5; M.3256: M.257 + I-5; M.3257: M.258 + I-5; M.3258: M.259 + I-5; M.3259: M.260 + I-5;
M.3260: M.261 + I-5; M.3261: M.262 + I-5; M.3262: M.263 + I-5; M.3263: M.264 + I-5; M.3264: M.265 + I-5;
M.3265: M.266 + I-5; M.3266: M.267 + I-5; M.3267: M.268 + I-5; M.3268: M.269 + I-5; M.3269: M.270 + I-5;
M.3270: M.271 + I-5; M.3271: M.272 + I-5; M.3272: M.273 + I-5; M.3273: M.274 + I-5; M.3274: M.275 + I-5;
M.3275: M.276 + I-5; M.3276: M.277 + I-5; M.3277: M.278 + I-5; M.3278: M.279 + I-5; M.3279: M.280 + I-5;
M.3280: M.281 + I-5; M.3281: M.282 + I-5; M.3282: M.283 + I-5; M.3283: M.284 + I-5; M.3284: M.285 + I-5;
M.3285: M.286 + I-5; M.3286: M.287 + I-5; M.3287: M.288 + I-5; M.3288: M.289 + I-5; M.3289: M.290 + I-5;
M.3290: M.291 + I-5; M.3291: M.292 + I-5; M.3292: M.293 + I-5; M.3293: M.294 + I-5; M.3294: M.295 + I-5;
M.3295: M.296 + I-5; M.3296: M.297 + I-5; M.3297: M.298 + I-5; M.3298: M.299 + I-5; M.3299: M.300 + I-5;
M.3300: M.301 + I-5; M.3301: M.302 + I-5; M.3302: M.303 + I-5; M.3303: M.304 + I-5; M.3304: M.305 + I-5;
M.3305: M.306 + I-5; M.3306: M.307 + I-5; M.3307: M.308 + I-5; M.3308: M.309 + I-5; M.3309: M.310 + I-5;
M.3310: M.311 + I-5; M.3311: M.312 + I-5; M.3312: M.313 + I-5; M.3313: M.314 + I-5; M.3314: M.315 + I-5;
M.3315: M.316 + I-5; M.3316: M.317 + I-5; M.3317: M.318 + I-5; M.3318: M.319 + I-5; M.3319: M.320 + I-5;
M.3320: M.321 + I-5; M.3321: M.322 + I-5; M.3322: M.323 + I-5; M.3323: M.324 + I-5; M.3324: M.325 + I-5;
M.3325: M.326 + I-5; M.3326: M.327 + I-5; M.3327: M.328 + I-5; M.3328: M.329 + I-5; M.3329: M.330 + I-5;
M.3330: M.331 + I-5; M.3331: M.332 + I-5; M.3332: M.333 + I-5; M.3333: M.334 + I-5; M.3334: M.335 + I-5;
M.3335: M.336 + I-5; M.3336: M.337 + I-5; M.3337: M.338 + I-5; M.3338: M.339 + I-5; M.3339: M.340 + I-5;
M.3340: M.341 + I-5; M.3341: M.342 + I-5; M.3342: M.343 + I-5; M.3343: M.344 + I-5; M.3344: M.345 + I-5;
M.3345: M.346 + I-5; M.3346: M.347 + I-5; M.3347: M.348 + I-5; M.3348: M.349 + I-5; M.3349: M.350 + I-5;
M.3350: M.351 + I-5; M.3351: M.352 + I-5; M.3352: M.353 + I-5; M.3353: M.354 + I-5; M.3354: M.355 + I-5;
M.3355: M.356 + I-5; M.3356: M.357 + I-5; M.3357: M.358 + I-5; M.3358: M.359 + I-5; M.3359: M.360 + I-5;
M.3360: M.361 + I-5; M.3361: M.362 + I-5; M.3362: M.363 + I-5; M.3363: M.364 + I-5; M.3364: M.365 + I-5;
M.3365: M.366 + I-5; M.3366: M.367 + I-5; M.3367: M.368 + I-5; M.3368: M.369 + I-5; M.3369: M.370 + I-5;
M.3370: M.371 + I-5; M.3371: M.372 + I-5; M.3372: M.373 + I-5; M.3373: M.374 + I-5; M.3374: M.375 + I-5;
M.3375: M.376 + I-5; M.3376: M.377 + I-5; M.3377: M.378 + I-5; M.3378: M.379 + I-5; M.3379: M.380 + I-5;
M.3380: M.381 + I-5; M.3381: M.382 + I-5; M.3382: M.383 + I-5; M.3383: M.384 + I-5; M.3384: M.385 + I-5;
M.3385: M.386 + I-5; M.3386: M.387 + I-5; M.3387: M.388 + I-5; M.3388: M.389 + I-5; M.3389: M.390 + I-5;
M.3390: M.391 + I-5; M.3391: M.392 + I-5; M.3392: M.393 + I-5; M.3393: M.394 + I-5; M.3394: M.395 + I-5;
M.3395: M.396 + I-5; M.3396: M.397 + I-5; M.3397: M.398 + I-5; M.3398: M.399 + I-5; M.3399: M.400 + I-5;
M.3400: M.401 + I-5; M.3401: M.402 + I-5; M.3402: M.403 + I-5; M.3403: M.404 + I-5; M.3404: M.405 + I-5;
M.3405: M.406 + I-5; M.3406: M.407 + I-5; M.3407: M.408 + I-5; M.3408: M.409 + I-5; M.3409: M.410 + I-5;
M.3410: M.411 + I-5; M.3411: M.412 + I-5; M.3412: M.413 + I-5; M.3413: M.414 + I-5; M.3414: M.415 + I-5;
M.3415: M.416 + I-5; M.3416: M.417 + I-5; M.3417: M.418 + I-5; M.3418: M.419 + I-5; M.3419: M.420 + I-5;
M.3420: M.421 + I-5; M.3421: M.422 + I-5; M.3422: M.423 + I-5; M.3423: M.424 + I-5; M.3424: M.425 + I-5;
M.3425: M.426 + I-5; M.3426: M.427 + I-5; M.3427: M.428 + I-5; M.3428: M.429 + I-5; M.3429: M.430 + I-5;
M.3430: M.431 + I-5; M.3431: M.432 + I-5; M.3432: M.433 + I-5; M.3433: M.434 + I-5; M.3434: M.435 + I-5;
M.3435: M.436 + I-5; M.3436: M.437 + I-5; M.3437: M.438 + I-5; M.3438: M.439 + I-5; M.3439: M.440 + I-5;
M.3440: M.441 + I-5; M.3441: M.442 + I-5; M.3442: M.443 + I-5; M.3443: M.444 + I-5; M.3444: M.445 + I-5;
M.3445: M.446 + I-5; M.3446: M.447 + I-5; M.3447: M.448 + I-5; M.3448: M.449 + I-5; M.3449: M.450 + I-5.

In another embodiment, the present invention relates to ternary herbicidal mixtures M.4000 to M.4449 listed in Table M(e) below, comprising mixtures of the binary mixtures depicted in table M(a) and a third herbicide I-6.

TABLE M(e)
M.4000: M.1 + I-6; M.4001: M.2 + I-6; M.4002: M.3 + I-6; M.4003: M.4 + I-6; M.4004: M.5 + I-6;
M.4005: M.6 + I-6; M.4006: M.7 + I-6; M.4007: M.8 + I-6; M.4008: M.9 + I-6; M.4009: M.10 + I-6;
M.4010: M.11 + I-6; M.4011: M.12 + I-6; M.4012: M.13 + I-6; M.4013: M.14 + I-6; M.4014: M.15 + I-6;
M.4015: M.16 + I-6; M.4016: M.17 + I-6; M.4017: M.18 + I-6; M.4018: M.19 + I-6; M.4019: M.20 + I-6;
M.4020: M.21 + I-6; M.4021: M.22 + I-6; M.4022: M.23 + I-6; M.4023: M.24 + I-6; M.4024: M.25 + I-6;
M.4025: M.26 + I-6; M.4026: M.27 + I-6; M.4027: M.28 + I-6; M.4028: M.29 + I-6; M.4029: M.30 + I-6;
M.4030: M.31 + I-6; M.4031: M.32 + I-6; M.4032: M.33 + I-6; M.4033: M.34 + I-6; M.4034: M.35 + I-6;
M.4035: M.36 + I-6; M.4036: M.37 + I-6; M.4037: M.38 + I-6; M.4038: M.39 + I-6; M.4039: M.40 + I-6;
M.4040: M.41 + I-6; M.4041: M.42 + I-6; M.4042: M.43 + I-6; M.4043: M.44 + I-6; M.4044: M.45 + I-6;
M.4045: M.46 + I-6; M.4046: M.47 + I-6; M.4047: M.48 + I-6; M.4048: M.49 + I-6; M.4049: M.50 + I-6;
M.4050: M.51 + I-6; M.4051: M.52 + I-6; M.4052: M.53 + I-6; M.4053: M.54 + I-6; M.4054: M.55 + I-6;
M.4055: M.56 + I-6; M.4056: M.57 + I-6; M.4057: M.58 + I-6; M.4058: M.59 + I-6; M.4059: M.60 + I-6;
M.4060: M.61 + I-6; M.4061: M.62 + I-6; M.4062: M.63 + I-6; M.4063: M.64 + I-6; M.4064: M.65 + I-6;
M.4065: M.66 + I-6; M.4066: M.67 + I-6; M.4067: M.68 + I-6; M.4068: M.69 + I-6; M.4069: M.70 + I-6;
M.4070: M.71 + I-6; M.4071: M.72 + I-6; M.4072: M.73 + I-6; M.4073: M.74 + I-6; M.4074: M.75 + I-6;
M.4075: M.76 + I-6; M.4076: M.77 + I-6; M.4077: M.78 + I-6; M.4078: M.79 + I-6; M.4079: M.80 + I-6;
M.4080: M.81 + I-6; M.4081: M.82 + I-6; M.4082: M.83 + I-6; M.4083: M.84 + I-6; M.4084: M.85 + I-6;
M.4085: M.86 + I-6; M.4086: M.87 + I-6; M.4087: M.88 + I-6; M.4088: M.89 + I-6; M.4089: M.90 + I-6;
M.4090: M.91 + I-6; M.4091: M.92 + I-6; M.4092: M.93 + I-6; M.4093: M.94 + I-6; M.4094: M.95 + I-6;
M.4095: M.96 + I-6; M.4096: M.97 + I-6; M.4097: M.98 + I-6; M.4098: M.99 + I-6; M.4099: M.100 + I-6;
M.4100: M.101 + I-6; M.4101: M.102 + I-6; M.4102: M.103 + I-6; M.4103: M.104 + I-6; M.4104: M.105 + I-6;
M.4105: M.106 + I-6; M.4106: M.107 + I-6; M.4107: M.108 + I-6; M.4108: M.109 + I-6; M.4109: M.110 + I-6;
M.4110: M.111 + I-6; M.4111: M.412 + I-6; M.1 12: M.113 + I-6; M.4113: M.114 + I-6; M.4114: M.115 + I-6;
M.4115: M.116 + I-6; M.4116: M.117 + I-6; M.4117: M.118 + I-6; M.4118: M.119 + I-6; M.4119: M.120 + I-6;
M.1120: M.121 + I-6; M.4121: M.122 + I-6; M.4122: M.123 + I-6; M.4123: M.124 + I-6; M.4124: M.125 + I-6;
M.4125: M.126 + I-6; M.4126: M.127 + I-6; M.4127: M.128 + I-6; M.4128: M.129 + I-6; M.4129: M.130 + I-6;
M.4130: M.131 + I-6; M.4131: M.132 + I-6; M.4132: M.133 + I-6; M.4133: M.134 + I-6; M.4134: M.135 + I-6;
M.4135: M.136 + I-6; M.4136: M.137 + I-6; M.4137: M.138 + I-6; M.4138: M.139 + I-6; M.4139: M.140 + I-6;
M.4140: M.141 + I-6; M.4141: M.142 + I-6; M.4142: M.143 + I-6; M.4143: M.144 + I-6; M.4144: M.145 + I-6;
M.4145: M.146 + I-6; M.4146: M.147 + I-6; M.4147: M.148 + I-6; M.4148: M.149 + I-6; M.4149: M.150 + I-6;
M.4150: M.151 + I-6; M.4151: M.152 + I-6; M.4152: M.153 + I-6; M.4153: M.154 + I-6; M.4154: M.155 + I-6;
M.4155: M.156 + I-6; M.4156: M.157 + I-6; M.4157: M.158 + I-6; M.4158: M.159 + I-6; M.4159: M.160 + I-6;
M.4160: M.161 + I-6; M.4161: M.162 + I-6; M.4162: M.163 + I-6; M.4163: M.164 + I-6; M.4164: M.165 + I-6;
M.4165: M.166 + I-6; M.4166: M.167 + I-6; M.4167: M.168 + I-6; M.4168: M.169 + I-6; M.4169: M.170 + I-6;
M.4170: M.171 + I-6; M.4171: M.172 + I-6; M.4172: M.173 + I-6; M.4173: M.174 + I-6; M.4174: M.175 + I-6;
M.4175: M.176 + I-6; M.4176: M.177 + I-6; M.4177: M.178 + I-6; M.4178: M.179 + I-6; M.4179: M.180 + I-6;
M.4180: M.181 + I-6; M.4181: M.182 + I-6; M.4182: M.183 + I-6; M.4183: M.184 + I-6; M.4184: M.185 + I-6;
M.4185: M.186 + I-6; M.4186: M.187 + I-6; M.4187: M.188 + I-6; M.4188: M.189 + I-6; M.4189: M.190 + I-6;
M.4190: M.191 + I-6; M.4191: M.192 + I-6; M.4192: M.193 + I-6; M.4193: M.194 + I-6; M.4194: M.195 + I-6;
M.4195: M.196 + I-6; M.4196: M.197 + I-6; M.4197: M.198 + I-6; M.4198: M.199 + I-6; M.4199: M.200 + I-6;
M.4200: M.201 + I-6; M.4201: M.202 + I-6; M.4202: M.203 + I-6; M.4203: M.204 + I-6; M.4204: M.205 + I-6;
M.4205: M.206 + I-6; M.4206: M.207 + I-6; M.4207: M.208 + I-6; M.4208: M.209 + I-6; M.4209: M.210 + I-6;
M.4210: M.211 + I-6; M.4211: M.212 + I-6; M.4212: M.213 + I-6; M.4213: M.214 + I-6; M.4214: M.215 + I-6;
M.4215: M.216 + I-6; M.4216: M.217 + I-6; M.4217: M.218 + I-6; M.4218: M.219 + I-6; M.4219: M.220 + I-6;
M.4220: M.221 + I-6; M.4221: M.222 + I-6; M.4222: M.223 + I-6; M.4223: M.224 + I-6; M.4224: M.225 + I-6;
M.4225: M.226 + I-6; M.4226: M.227 + I-6; M.4227: M.228 + I-6; M.4228: M.229 + I-6; M.4229: M.230 + I-6;
M.4230: M.231 + I-6; M.4231: M.232 + I-6; M.4232: M.233 + I-6; M.4233: M.234 + I-6; M.4234: M.235 + I-6;
M.4235: M.236 + I-6; M.4236: M.237 + I-6; M.4237: M.238 + I-6; M.4238: M.239 + I-6; M.4239: M.240 + I-6;
M.4240: M.241 + I-6; M.4241: M.242 + I-6; M.4242: M.243 + I-6; M.4243: M.244 + I-6; M.4244: M.245 + I-6;
M.4245: M.246 + I-6; M.4246: M.247 + I-6; M.4247: M.248 + I-6; M.4248: M.249 + I-6; M.4249: M.250 + I-6;
M.4250: M.251 + I-6; M.4251: M.252 + I-6; M.4252: M.253 + I-6; M.4253: M.254 + I-6; M.4254: M.255 + I-6;
M.4255: M.256 + I-6; M.4256: M.257 + I-6; M.4257: M.258 + I-6; M.4258: M.259 + I-6; M.4259: M.260 + I-6;
M.4260: M.261 + I-6; M.4261: M.262 + I-6; M.4262: M.263 + I-6; M.4263: M.264 + I-6; M.4264: M.265 + I-6;
M.4265: M.266 + I-6; M.4266: M.267 + I-6; M.4267: M.268 + I-6; M.4268: M.269 + I-6; M.4269: M.270 + I-6;
M.4270: M.271 + I-6; M.4271: M.272 + I-6; M.4272: M.273 + I-6; M.4273: M.274 + I-6; M.4274: M.275 + I-6;
M.4275: M.276 + I-6; M.4276: M.277 + I-6; M.4277: M.278 + I-6; M.4278: M.279 + I-6; M.4279: M.280 + I-6;
M.4280: M.281 + I-6; M.4281: M.282 + I-6; M.4282: M.283 + I-6; M.4283: M.284 + I-6; M.4284: M.285 + I-6;
M.4285: M.286 + I-6; M.4286: M.287 + I-6; M.4287: M.288 + I-6; M.4288: M.289 + I-6; M.4289: M.290 + I-6;
M.4290: M.291 + I-6; M.4291: M.292 + I-6; M.4292: M.293 + I-6; M.4293: M.294 + I-6; M.4294: M.295 + I-6;
M.4295: M.296 + I-6; M.4296: M.297 + I-6; M.4297: M.298 + I-6; M.4298: M.299 + I-6; M.4299: M.300 + I-6;
M.4300: M.301 + I-6; M.4301: M.302 + I-6; M.4302: M.303 + I-6; M.4303: M.304 + I-6; M.4304: M.305 + I-6;
M.4305: M.306 + I-6; M.4306: M.307 + I-6; M.4307: M.308 + I-6; M.4308: M.309 + I-6; M.4309: M.310 + I-6;
M.4310: M.311 + I-6; M.4311: M.312 + I-6; M.4312: M.313 + I-6; M.4313: M.314 + I-6; M.4314: M.315 + I-6;
M.4315: M.316 + I-6; M.4316: M.317 + I-6; M.4317: M.318 + I-6; M.4318: M.319 + I-6; M.4319: M.320 + I-6;
M.4320: M.321 + I-6; M.4321: M.322 + I-6; M.4322: M.323 + I-6; M.4323: M.324 + I-6; M.4324: M.325 + I-6;
M.4325: M.326 + I-6; M.4326: M.327 + I-6; M.4327: M.328 + I-6; M.4328: M.329 + I-6; M.4329: M.330 + I-6;
M.4330: M.331 + I-6; M.4331: M.332 + I-6; M.4332: M.333 + I-6; M.4333: M.334 + I-6; M.4334: M.335 + I-6;
M.4335: M.336 + I-6; M.4336: M.337 + I-6; M.4337: M.338 + I-6; M.4338: M.339 + I-6; M.4339: M.340 + I-6;
M.4340: M.341 + I-6; M.4341: M.342 + I-6; M.4342: M.343 + I-6; M.4343: M.344 + I-6; M.4344: M.345 + I-6;
M.4345: M.346 + I-6; M.4346: M.347 + I-6; M.4347: M.348 + I-6; M.4348: M.349 + I-6; M.4349: M.350 + I-6;
M.4350: M.351 + I-6; M.4351: M.352 + I-6; M.4352: M.353 + I-6; M.4353: M.354 + I-6; M.4354: M.355 + I-6;
M.4355: M.356 + I-6; M.4356: M.357 + I-6; M.4357: M.358 + I-6; M.4358: M.359 + I-6; M.4359: M.360 + I-6;
M.4360: M.361 + I-6; M.4361: M.362 + I-6; M.4362: M.363 + I-6; M.4363: M.364 + I-6; M.4364: M.365 + I-6;
M.4365: M.366 + I-6; M.4366: M.367 + I-6; M.4367: M.368 + I-6; M.4368: M.369 + I-6; M.4369: M.370 + I-6;
M.4370: M.371 + I-6; M.4371: M.372 + I-6; M.4372: M.373 + I-6; M.4373: M.374 + I-6; M.4374: M.375 + I-6;
M.4375: M.376 + I-6; M.4376: M.377 + I-6; M.4377: M.378 + I-6; M.4378: M.379 + I-6; M.4379: M.380 + I-6;
M.4380: M.381 + I-6; M.4381: M.382 + I-6; M.4382: M.383 + I-6; M.4383: M.384 + I-6; M.4384: M.385 + I-6;
M.4385: M.386 + I-6; M.4386: M.387 + I-6; M.4387: M.388 + I-6; M.4388: M.389 + I-6; M.4389: M.390 + I-6;
M.4390: M.391 + I-6; M.4391: M.392 + I-6; M.4392: M.393 + I-6; M.4393: M.394 + I-6; M.4394: M.395 + I-6;
M.4395: M.396 + I-6; M.4396: M.397 + I-6; M.4397: M.398 + I-6; M.4398: M.399 + I-6; M.4399: M.400 + I-6;
M.4400: M.401 + I-6; M.4401: M.402 + I-6; M.4402: M.403 + I-6; M.4403: M.404 + I-6; M.4404: M.405 + I-6;
M.4405: M.406 + I-6; M.4406: M.407 + I-6; M.4407: M.408 + I-6; M.4408: M.409 + I-6; M.4409: M.410 + I-6;
M.4410: M.411 + I-6; M.4411: M.412 + I-6; M.4412: M.413 + I-6; M.4413: M.414 + I-6; M.4414: M.415 + I-6;
M.4415: M.416 + I-6; M.4416: M.417 + I-6; M.4417: M.418 + I-6; M.4418: M.419 + I-6; M.4419: M.420 + I-6;
M.4420: M.421 + I-6; M.4421: M.422 + I-6; M.4422: M.423 + I-6; M.4423: M.424 + I-6; M.4424: M.425 + I-6;
M.4425: M.426 + I-6; M.4426: M.427 + I-6; M.4427: M.428 + I-6; M.4428: M.429 + I-6; M.4429: M.430 + I-6;
M.4430: M.431 + I-6; M.4431: M.432 + I-6; M.4432: M.433 + I-6; M.4433: M.434 + I-6; M.4434: M.435 + I-6;
M.4435: M.436 + I-6; M.4436: M.437 + I-6; M.4437: M.438 + I-6; M.4438: M.439 + I-6; M.4439: M.440 + I-6;
M.4440: M.441 + I-6; M.4441: M.442 + I-6; M.4442: M.443 + I-6; M.4443: M.444 + I-6; M.4444: M.445 + I-6;
M.4445: M.446 + I-6; M.4446: M.447 + I-6; M.4447: M.448 + I-6; M.4448: M.449 + I-6; M.4449: M.450 + I-6.

In another embodiment, the present invention relates to ternary herbicidal mixtures M.5000 to M.5449 listed in Table M(f) below, comprising mixtures of the binary mixtures depicted in table M(a) and a third herbicide I-7.

TABLE M(f)
M.5000: M.1 + I-7; M.5001: M.2 + I-7; M.5002: M.3 + I-7; M.5003: M.4 + I-7; M.5004: M.5 + I-7;
M.5005: M.6 + I-7; M.5006: M.7 + I-7; M.5007: M.8 + I-7; M.5008: M.9 + I-7; M.5009: M.10 + I-7;
M.5010: M.11 + I-7; M.5011: M.12 + I-7; M.5012: M.13 + I-7; M.5013: M.14 + I-7; M.5014: M.15 + I-7;
M.5015: M.16 + I-7; M.5016: M.17 + I-7; M.5017: M.18 + I-7; M.5018: M.19 + I-7; M.5019: M.20 + I-7;
M.5020: M.21 + I-7; M.5021: M.22 + I-7; M.5022: M.23 + I-7; M.5023: M.24 + I-7; M.5024: M.25 + I-7;
M.5025: M.26 + I-7; M.5026: M.27 + I-7; M.5027: M.28 + I-7; M.5028: M.29 + I-7; M.5029: M.30 + I-7;
M.5030: M.31 + I-7; M.5031: M.32 + I-7; M.5032: M.33 + I-7; M.5033: M.34 + I-7; M.5034: M.35 + I-7;
M.5035: M.36 + I-7; M.5036: M.37 + I-7; M.5037: M.38 + I-7; M.5038: M.39 + I-7; M.5039: M.40 + I-7;
M.5040: M.41 + I-7; M.5041: M.42 + I-7; M.5042: M.43 + I-7; M.5043: M.44 + I-7; M.5044: M.45 + I-7;
M.5045: M.46 + I-7; M.5046: M.47 + I-7; M.5047: M.48 + I-7; M.5048: M.49 + I-7; M.5049: M.50 + I-7;
M.5050: M.51 + I-7; M.5051: M.52 + I-7; M.5052: M.53 + I-7; M.5053: M.54 + I-7; M.5054: M.55 + I-7;
M.5055: M.56 + I-7; M.5056: M.57 + I-7; M.5057: M.58 + I-7; M.5058: M.59 + I-7; M.5059: M.60 + I-7;
M.5060: M.61 + I-7; M.5061: M.62 + I-7; M.5062: M.63 + I-7; M.5063: M.64 + I-7; M.5064: M.65 + I-7;
M.5065: M.66 + I-7; M.5066: M.67 + I-7; M.5067: M.68 + I-7; M.5068: M.69 + I-7; M.5069: M.70 + I-7;
M.5070: M.71 + I-7; M.5071: M.72 + I-7; M.5072: M.73 + I-7; M.5073: M.74 + I-7; M.5074: M.75 + I-7;
M.5075: M.76 + I-7; M.5076: M.77 + I-7; M.5077: M.78 + I-7; M.5078: M.79 + I-7; M.5079: M.80 + I-7;
M.5080: M.81 + I-7; M.5081: M.82 + I-7; M.5082: M.83 + I-7; M.5083: M.84 + I-7; M.5084: M.85 + I-7;
M.5085: M.86 + I-7; M.5086: M.87 + I-7; M.5087: M.88 + I-7; M.5088: M.89 + I-7; M.5089: M.90 + I-7;
M.5090: M.91 + I-7; M.5091: M.92 + I-7; M.5092: M.93 + I-7; M.5093: M.94 + I-7; M.5094: M.95 + I-7;
M.5095: M.96 + I-7; M.5096: M.97 + I-7; M.5097: M.98 + I-7; M.5098: M.99 + I-7; M.5099: M.100 + I-7;
M.5100: M.101 + I-7; M.5101: M.102 + I-7; M.5102: M.103 + I-7; M.5103: M.104 + I-7; M.5104: M.105 + I-7;
M.5105: M.106 + I-7; M.5106: M.107 + I-7; M.5107: M.108 + I-7; M.5108: M.109 + I-7; M.5109: M.110 + I-7;
M.5110: M.111 + I-7; M.5111: M.112 + I-7; M.5112: M.113 + I-7; M.5113: M.114 + I-7; M.5114: M.115 + I-7;
M.5115: M.116 + I-7; M.5116: M.117 + I-7; M.5117: M.118 + I-7; M.5118: M.119 + I-7; M.5119: M.120 + I-7;
M.5120: M.121 + I-7; M.5121: M.122 + I-7; M.5122: M.123 + I-7; M.5123: M.124 + I-7; M.5124: M.125 + I-7;
M.5125: M.126 + I-7; M.5126: M.127 + I-7; M.5127: M.128 + I-7; M.5128: M.129 + I-7; M.5129: M.130 + I-7;
M.5130: M.131 + I-7; M.5131: M.132 + I-7; M.5132: M.133 + I-7; M.5133: M.134 + I-7; M.5134: M.135 + I-7;
M.5135: M.136 + I-7; M.5136: M.137 + I-7; M.5137: M.138 + I-7; M.5138: M.139 + I-7; M.5139: M.140 + I-7;
M.5140: M.141 + I-7; M.5141: M.142 + I-7; M.5142: M.143 + I-7; M.5143: M.144 + I-7; M.5144: M.145 + I-7;
M.5145: M.146 + I-7; M.5146: M.147 + I-7; M.5147: M.148 + I-7; M.5148: M.149 + I-7; M.5149: M.150 + I-7;
M.5150: M.151 + I-7; M.5151: M.152 + I-7; M.5152: M.153 + I-7; M.5153: M.154 + I-7; M.5154: M.155 + I-7;
M.5155: M.156 + I-7; M.5156: M.157 + I-7; M.5157: M.158 + I-7; M.5158: M.159 + I-7; M.5159: M.160 + I-7;
M.5160: M.161 + I-7; M.5161: M.162 + I-7; M.5162: M.163 + I-7; M.5163: M.164 + I-7; M.5164: M.165 + I-7;
M.5165: M.166 + I-7; M.5166: M.167 + I-7; M.5167: M.168 + I-7; M.5168: M.169 + I-7; M.5169: M.170 + I-7;
M.5170: M.171 + I-7; M.5171: M.172 + I-7; M.5172: M.173 + I-7; M.5173: M.174 + I-7; M.5174: M.175 + I-7;
M.5175: M.176 + I-7; M.5176: M.177 + I-7; M.5177: M.178 + I-7; M.5178: M.179 + I-7; M.5179: M.180 + I-7;
M.5180: M.181 + I-7; M.5181: M.182 + I-7; M.5182: M.183 + I-7; M.5183: M.184 + I-7; M.5184: M.185 + I-7;
M.5185: M.186 + I-7; M.5186: M.187 + I-7; M.5187: M.188 + I-7; M.5188: M.189 + I-7; M.5189: M.190 + I-7;
M.5190: M.191 + I-7; M.5191: M.192 + I-7; M.5192: M.193 + I-7; M.5193: M.194 + I-7; M.5194: M.195 + I-7;
M.5195: M.196 + I-7; M.5196: M.197 + I-7; M.5197: M.198 + I-7; M.5198: M.199 + I-7; M.5199: M.200 + I-7;
M.5200: M.201 + I-7; M.5201: M.202 + I-7; M.5202: M.203 + I-7; M.5203: M.204 + I-7; M.5204: M.205 + I-7;
M.5205: M.206 + I-7; M.5206: M.207 + I-7; M.5207: M.208 + I-7; M.5208: M.209 + I-7; M.5209: M.210 + I-7;
M.5210: M.211 + I-7; M.5211: M.212 + I-7; M.5212: M.213 + I-7; M.5213: M.214 + I-7; M.5214: M.215 + I-7;
M.5215: M.216 + I-7; M.5216: M.217 + I-7; M.5217: M.218 + I-7; M.5218: M.219 + I-7; M.5219: M.220 + I-7;
M.5220: M.221 + I-7; M.5221: M.222 + I-7; M.5222: M.223 + I-7; M.5223: M.224 + I-7; M.5224: M.225 + I-7;
M.5225: M.226 + I-7; M.5226: M.227 + I-7; M.5227: M.228 + I-7; M.5228: M.229 + I-7; M.5229: M.230 + I-7;
M.5230: M.231 + I-7; M.5231: M.232 + I-7; M.5232: M.233 + I-7; M.5233: M.234 + I-7; M.5234: M.235 + I-7;
M.5235: M.236 + I-7; M.5236: M.237 + I-7; M.5237: M.238 + I-7; M.5238: M.239 + I-7; M.5239: M.240 + I-7;
M.5240: M.241 + I-7; M.5241: M.242 + I-7; M.5242: M.243 + I-7; M.5243: M.244 + I-7; M.5244: M.245 + I-7;
M.5245: M.246 + I-7; M.5246: M.247 + I-7; M.5247: M.248 + I-7; M.5248: M.249 + I-7; M.5249: M.250 + I-7;
M.5250: M.251 + I-7; M.5251: M.252 + I-7; M.5252: M.253 + I-7; M.5253: M.254 + I-7; M.5254: M.255 + I-7;
M.5255: M.256 + I-7; M.5256: M.257 + I-7; M.5257: M.258 + I-7; M.5258: M.259 + I-7; M.5259: M.260 + I-7;
M.5260: M.261 + I-7; M.5261: M.262 + I-7; M.5262: M.263 + I-7; M.5263: M.264 + I-7; M.5264: M.265 + I-7;
M.5265: M.266 + I-7; M.5266: M.267 + I-7; M.5267: M.268 + I-7; M.5268: M.269 + I-7; M.5269: M.270 + I-7;
M.5270: M.271 + I-7; M.5271: M.272 + I-7; M.5272: M.273 + I-7; M.5273: M.274 + I-7; M.5274: M.275 + I-7;
M.5275: M.276 + I-7; M.5276: M.277 + I-7; M.5277: M.278 + I-7; M.5278: M.279 + I-7; M.5279: M.280 + I-7;
M.5280: M.281 + I-7; M.5281: M.282 + I-7; M.5282: M.283 + I-7; M.5283: M.284 + I-7; M.5284: M.285 + I-7;
M.5285: M.286 + I-7; M.5286: M.287 + I-7; M.5287: M.288 + I-7; M.5288: M.289 + I-7; M.5289: M.290 + I-7;
M.5290: M.291 + I-7; M.5291: M.292 + I-7; M.5292: M.293 + I-7; M.5293: M.294 + I-7; M.5294: M.295 + I-7;
M.5295: M.296 + I-7; M.5296: M.297 + I-7; M.5297: M.298 + I-7; M.5298: M.299 + I-7; M.5299: M.300 + I-7;
M.5300: M.301 + I-7; M.5301: M.302 + I-7; M.5302: M.303 + I-7; M.5303: M.304 + I-7; M.5304: M.305 + I-7;
M.5305: M.306 + I-7; M.5306: M.307 + I-7; M.5307: M.308 + I-7; M.5308: M.309 + I-7; M.5309: M.310 + I-7;
M.5310: M.311 + I-7; M.5311: M.312 + I-7; M.5312: M.313 + I-7; M.5313: M.314 + I-7; M.5314: M.315 + I-7;
M.5315: M.316 + I-7; M.5316: M.317 + I-7; M.5317: M.318 + I-7; M.5318: M.319 + I-7; M.5319: M.320 + I-7;
M.5320: M.321 + I-7; M.5321: M.322 + I-7; M.5322: M.323 + I-7; M.5323: M.324 + I-7; M.5324: M.325 + I-7;
M.5325: M.326 + I-7; M.5326: M.327 + I-7; M.5327: M.328 + I-7; M.5328: M.329 + I-7; M.5329: M.330 + I-7;
M.5330: M.331 + I-7; M.5331: M.332 + I-7; M.5332: M.333 + I-7; M.5333: M.334 + I-7; M.5334: M.335 + I-7;
M.5335: M.336 + I-7; M.5336: M.337 + I-7; M.5337: M.338 + I-7; M.5338: M.339 + I-7; M.5339: M.340 + I-7;
M.5340: M.341 + I-7; M.5341: M.342 + I-7; M.5342: M.343 + I-7; M.5343: M.344 + I-7; M.5344: M.345 + I-7;
M.5345: M.346 + I-7; M.5346: M.347 + I-7; M.5347: M.348 + I-7; M.5348: M.349 + I-7; M.5349: M.350 + I-7;
M.5350: M.351 + I-7; M.5351: M.352 + I-7; M.5352: M.353 + I-7; M.5353: M.354 + I-7; M.5354: M.355 + I-7;
M.5355: M.356 + I-7; M.5356: M.357 + I-7; M.5357: M.358 + I-7; M.5358: M.359 + I-7; M.5359: M.360 + I-7;
M.5360: M.361 + I-7; M.5361: M.362 + I-7; M.5362: M.363 + I-7; M.5363: M.364 + I-7; M.5364: M.365 + I-7;
M.5365: M.366 + I-7; M.5366: M.367 + I-7; M.5367: M.368 + I-7; M.5368: M.369 + I-7; M.5369: M.370 + I-7;
M.5370: M.371 + I-7; M.5371: M.372 + I-7; M.5372: M.373 + I-7; M.5373: M.374 + I-7; M.5374: M.375 + I-7;
M.5375: M.376 + I-7; M.5376: M.377 + I-7; M.5377: M.378 + I-7; M.5378: M.379 + I-7; M.5379: M.380 + I-7;
M.5380: M.381 + I-7; M.5381: M.382 + I-7; M.5382: M.383 + I-7; M.5383: M.384 + I-7; M.5384: M.385 + I-7;
M.5385: M.386 + I-7; M.5386: M.387 + I-7; M.5387: M.388 + I-7; M.5388: M.389 + I-7; M.5389: M.390 + I-7;
M.5390: M.391 + I-7; M.5391: M.392 + I-7; M.5392: M.393 + I-7; M.5393: M.394 + I-7; M.5394: M.395 + I-7;
M.5395: M.396 + I-7; M.5396: M.397 + I-7; M.5397: M.398 + I-7; M.5398: M.399 + I-7; M.5399: M.400 + I-7;
M.5400: M.401 + I-7; M.5401: M.402 + I-7; M.5402: M.403 + I-7; M.5403: M.404 + I-7; M.5404: M.405 + I-7;
M.5405: M.406 + I-7; M.5406: M.407 + I-7; M.5407: M.408 + I-7; M.5408: M.409 + I-7; M.5409: M.410 + I-7;
M.5410: M.411 + I-7; M.5411: M.412 + I-7; M.5412: M.413 + I-7; M.5413: M.414 + I-7; M.5414: M.415 + I-7;
M.5415: M.416 + I-7; M.5416: M.417 + I-7; M.5417: M.418 + I-7; M.5418: M.419 + I-7; M.5419: M.420 + I-7;
M.5420: M.421 + I-7; M.5421: M.422 + I-7; M.5422: M.423 + I-7; M.5423: M.424 + I-7; M.5424: M.425 + I-7;
M.5425: M.426 + I-7; M.5426: M.427 + I-7; M.5427: M.428 + I-7; M.5428: M.429 + I-7; M.5429: M.430 + I-7;
M.5430: M.431 + I-7; M.5431: M.432 + I-7; M.5432: M.433 + I-7; M.5433: M.434 + I-7; M.5434: M.435 + I-7;
M.5435: M.436 + I-7; M.5436: M.437 + I-7; M.5437: M.438 + I-7; M.5438: M.439 + I-7; M.5439: M.440 + I-7;
M.5440: M.441 + I-7; M.5441: M.442 + I-7; M.5442: M.443 + I-7; M.5443: M.444 + I-7; M.5444: M.445 + I-7;
M.5445: M.446 + I-7; M.5446: M.447 + I-7; M.5447: M.448 + I-7; M.5448: M.449 + I-7; M.5449: M.450 + I-7.

In another embodiment, the present invention relates to ternary herbicidal mixtures M.6000 to M.6449 listed in Table M(g) below, comprising mixtures of the binary mixtures depicted in table M(a) and a third herbicide I-8.

TABLE M(g)
M.6000: M.1 + I-8; M.6001: M.2 + I-8; M.6002: M.3 + I-8; M.6003: M.4 + I-8; M.6004: M.5 + I-8;
M.6005: M.6 + I-8; M.6006: M.7 + I-8; M.6007: M.8 + I-8; M.6008: M.9 + I-8; M.6009: M.10 + I-8;
M.6010: M.11 + I-8; M.6011: M.12 + I-8; M.6012: M.13 + I-8; M.6013: M.14 + I-8; M.6014: M.15 + I-8;
M.6015: M.16 + I-8; M.6016: M.17 + I-8; M.6017: M.18 + I-8; M.6018: M.19 + I-8; M.6019: M.20 + I-8;
M.6020: M.21 + I-8; M.6021: M.22 + I-8; M.6022: M.23 + I-8; M.6023: M.24 + I-8; M.6024: M.25 + I-8;
M.6025: M.26 + I-8; M.6026: M.27 + I-8; M.6027: M.28 + I-8; M.6028: M.29 + I-8; M.6029: M.30 + I-8;
M.6030: M.31 + I-8; M.6031: M.32 + I-8; M.6032: M.33 + I-8; M.6033: M.34 + I-8; M.6034: M.35 + I-8;
M.6035: M.36 + I-8; M.6036: M.37 + I-8; M.6037: M.38 + I-8; M.6038: M.39 + I-8; M.6039: M.40 + I-8;
M.6040: M.41 + I-8; M.6041: M.42 + I-8; M.6042: M.43 + I-8; M.6043: M.44 + I-8; M.6044: M.45 + I-8;
M.6045: M.46 + I-8; M.6046: M.47 + I-8; M.6047: M.48 + I-8; M.6048: M.49 + I-8; M.6049: M.50 + I-8;
M.6050: M.51 + I-8; M.6051: M.52 + I-8; M.6052: M.53 + I-8; M.6053: M.54 + I-8; M.6054: M.55 + I-8;
M.6055: M.56 + I-8; M.6056: M.57 + I-8; M.6057: M.58 + I-8; M.6058: M.59 + I-8; M.6059: M.60 + I-8;
M.6060: M.61 + I-8; M.6061: M.62 + I-8; M.6062: M.63 + I-8; M.6063: M.64 + I-8; M.6064: M.65 + I-8;
M.6065: M.66 + I-8; M.6066: M.67 + I-8; M.6067: M.68 + I-8; M.6068: M.69 + I-8; M.6069: M.70 + I-8;
M.6070: M.71 + I-8; M.6071: M.72 + I-8; M.6072: M.73 + I-8; M.6073: M.74 + I-8; M.6074: M.75 + I-8;
M.6075: M.76 + I-8; M.6076: M.77 + I-8; M.6077: M.78 + I-8; M.6078: M.79 + I-8; M.6079: M.80 + I-8;
M.6080: M.81 + I-8; M.6081: M.82 + I-8; M.6082: M.83 + I-8; M.6083: M.84 + I-8; M.6084: M.85 + I-8;
M.6085: M.86 + I-8; M.6086: M.87 + I-8; M.6087: M.88 + I-8; M.6088: M.89 + I-8; M.6089: M.90 + I-8;
M.6090: M.91 + I-8; M.6091: M.92 + I-8; M.6092: M.93 + I-8; M.6093: M.94 + I-8; M.6094: M.95 + I-8;
M.6095: M.96 + I-8; M.6096: M.97 + I-8; M.6097: M.98 + I-8; M.6098: M.99 + I-8; M.6099: M.100 + I-8;
M.6100: M.101 + I-8; M.6101: M.102 + I-8; M.6102: M.103 + I-8; M.6103: M.104 + I-8; M.6104: M.105 + I-8;
M.6105: M.106 + I-8; M.6106: M.107 + I-8; M.6107: M.108 + I-8; M.6108: M.109 + I-8; M.6109: M.110 + I-8;
M.6110: M.111 + I-8; M.6111: M.112 + I-8; M.6112: M.113 + I-8; M.6113: M.114 + I-8; M.6114: M.115 + I-8;
M.6115: M.116 + I-8; M.6116: M.117 + I-8; M.6117: M.118 + I-8; M.6118: M.119 + I-8; M.6119: M.120 + I-8;
M.6120: M.121 + I-8; M.6121: M.122 + I-8; M.6122: M.123 + I-8; M.6123: M.124 + I-8; M.6124: M.125 + I-8;
M.6125: M.126 + I-8; M.6126: M.127 + I-8; M.6127: M.128 + I-8; M.6128: M.129 + I-8; M.6129: M.130 + I-8;
M.6130: M.131 + I-8; M.6131: M.132 + I-8; M.6132: M.133 + I-8; M.6133: M.134 + I-8; M.6134: M.135 + I-8;
M.6135: M.136 + I-8; M.6136: M.137 + I-8; M.6137: M.138 + I-8; M.6138: M.139 + I-8; M.6139: M.140 + I-8;
M.6140: M.141 + I-8; M.6141: M.142 + I-8; M.6142: M.143 + I-8; M.6143: M.144 + I-8; M.6144: M.145 + I-8;
M.6145: M.146 + I-8; M.6146: M.147 + I-8; M.6147: M.148 + I-8; M.6148: M.149 + I-8; M.6149: M.150 + I-8;
M.6150: M.151 + I-8; M.6151: M.152 + I-8; M.6152: M.153 + I-8; M.6153: M.154 + I-8; M.6154: M.155 + I-8;
M.6155: M.156 + I-8; M.6156: M.157 + I-8; M.6157: M.158 + I-8; M.6158: M.159 + I-8; M.6159: M.160 + I-8;
M.6160: M.161 + I-8; M.6161: M.162 + I-8; M.6162: M.163 + I-8; M.6163: M.164 + I-8; M.6164: M.165 + I-8;
M.6165: M.166 + I-8; M.6166: M.167 + I-8; M.6167: M.168 + I-8; M.6168: M.169 + I-8; M.6169: M.170 + I-8;
M.6170: M.171 + I-8; M.6171: M.172 + I-8; M.6172: M.173 + I-8; M.6173: M.174 + I-8; M.6174: M.175 + I-8;
M.6175: M.176 + I-8; M.6176: M.177 + I-8; M.6177: M.178 + I-8; M.6178: M.179 + I-8; M.6179: M.180 + I-8;
M.6180: M.181 + I-8; M.6181: M.182 + I-8; M.6182: M.183 + I-8; M.6183: M.184 + I-8; M.6184: M.185 + I-8;
M.6185: M.186 + I-8; M.6186: M.187 + I-8; M.6187: M.188 + I-8; M.6188: M.189 + I-8; M.6189: M.190 + I-8;
M.6190: M.191 + I-8; M.6191: M.192 + I-8; M.6192: M.193 + I-8; M.6193: M.194 + I-8; M.6194: M.195 + I-8;
M.6195: M.196 + I-8; M.6196: M.197 + I-8; M.6197: M.198 + I-8; M.6198: M.199 + I-8; M.6199: M.200 + I-8;
M.6200: M.201 + I-8; M.6201: M.202 + I-8; M.6202: M.203 + I-8; M.6203: M.204 + I-8; M.6204: M.205 + I-8;
M.6205: M.206 + I-8; M.6206: M.207 + I-8; M.6207: M.208 + I-8; M.6208: M.209 + I-8; M.6209: M.210 + I-8;
M.6210: M.211 + I-8; M.6211: M.212 + I-8; M.6212: M.213 + I-8; M.6213: M.214 + I-8; M.6214: M.215 + I-8;
M.6215: M.216 + I-8; M.6216: M.217 + I-8; M.6217: M.218 + I-8; M.6218: M.219 + I-8; M.6219: M.220 + I-8;
M.6220: M.221 + I-8; M.6221: M.222 + I-8; M.6222: M.223 + I-8; M.6223: M.224 + I-8; M.6224: M.225 + I-8;
M.6225: M.226 + I-8; M.6226: M.227 + I-8; M.6227: M.228 + I-8; M.6228: M.229 + I-8; M.6229: M.230 + I-8;
M.6230: M.231 + I-8; M.6231: M.232 + I-8; M.6232: M.233 + I-8; M.6233: M.234 + I-8; M.6234: M.235 + I-8;
M.6235: M.236 + I-8; M.6236: M.237 + I-8; M.6237: M.238 + I-8; M.6238: M.239 + I-8; M.6239: M.240 + I-8;
M.6240: M.241 + I-8; M.6241: M.242 + I-8; M.6242: M.243 + I-8; M.6243: M.244 + I-8; M.6244: M.245 + I-8;
M.6245: M.246 + I-8; M.6246: M.247 + I-8; M.6247: M.248 + I-8; M.6248: M.249 + I-8; M.6249: M.250 + I-8;
M.6250: M.251 + I-8; M.6251: M.252 + I-8; M.6252: M.253 + I-8; M.6253: M.254 + I-8; M.6254: M.255 + I-8;
M.6255: M.256 + I-8; M.6256: M.257 + I-8; M.6257: M.258 + I-8; M.6258: M.259 + I-8; M.6259: M.260 + I-8;
M.6260: M.261 + I-8; M.6261: M.262 + I-8; M.6262: M.263 + I-8; M.6263: M.264 + I-8; M.6264: M.265 + I-8;
M.6265: M.266 + I-8; M.6266: M.267 + I-8; M.6267: M.268 + I-8; M.6268: M.269 + I-8; M.6269: M.270 + I-8;
M.6270: M.271 + I-8; M.6271: M.272 + I-8; M.6272: M.273 + I-8; M.6273: M.274 + I-8; M.6274: M.275 + I-8;
M.6275: M.276 + I-8; M.6276: M.277 + I-8; M.6277: M.278 + I-8; M.6278: M.279 + I-8; M.6279: M.280 + I-8;
M.6280: M.281 + I-8; M.6281: M.282 + I-8; M.6282: M.283 + I-8; M.6283: M.284 + I-8; M.6284: M.285 + I-8;
M.6285: M.286 + I-8; M.6286: M.287 + I-8; M.6287: M.288 + I-8; M.6288: M.289 + I-8; M.6289: M.290 + I-8;
M.6290: M.291 + I-8; M.6291: M.292 + I-8; M.6292: M.293 + I-8; M.6293: M.294 + I-8; M.6294: M.295 + I-8;
M.6295: M.296 + I-8; M.6296: M.297 + I-8; M.6297: M.298 + I-8; M.6298: M.299 + I-8; M.6299: M.300 + I-8;
M.6300: M.301 + I-8; M.6301: M.302 + I-8; M.6302: M.303 + I-8; M.6303: M.304 + I-8; M.6304: M.305 + I-8;
M.6305: M.306 + I-8; M.6306: M.307 + I-8; M.6307: M.308 + I-8; M.6308: M.309 + I-8; M.6309: M.310 + I-8;
M.6310: M.311 + I-8; M.6311: M.312 + I-8; M.6312: M.313 + I-8; M.6313: M.314 + I-8; M.6314: M.315 + I-8;
M.6315: M.316 + I-8; M.6316: M.317 + I-8; M.6317: M.318 + I-8; M.6318: M.319 + I-8; M.6319: M.320 + I-8;
M.6320: M.321 + I-8; M.6321: M.322 + I-8; M.6322: M.323 + I-8; M.6323: M.324 + I-8; M.6324: M.325 + I-8;
M.6325: M.326 + I-8; M.6326: M.327 + I-8; M.6327: M.328 + I-8; M.6328: M.329 + I-8; M.6329: M.330 + I-8;
M.6330: M.331 + I-8; M.6331: M.332 + I-8; M.6332: M.333 + I-8; M.6333: M.334 + I-8; M.6334: M.335 + I-8;
M.6335: M.336 + I-8; M.6336: M.337 + I-8; M.6337: M.338 + I-8; M.6338: M.339 + I-8; M.6339: M.340 + I-8;
M.6340: M.341 + I-8; M.6341: M.342 + I-8; M.6342: M.343 + I-8; M.6343: M.344 + I-8; M.6344: M.345 + I-8;
M.6345: M.346 + I-8; M.6346: M.347 + I-8; M.6347: M.348 + I-8; M.6348: M.349 + I-8; M.6349: M.350 + I-8;
M.6350: M.351 + I-8; M.6351: M.352 + I-8; M.6352: M.353 + I-8; M.6353: M.354 + I-8; M.6354: M.355 + I-8;
M.6355: M.356 + I-8; M.6356: M.357 + I-8; M.6357: M.358 + I-8; M.6358: M.359 + I-8; M.6359: M.360 + I-8;
M.6360: M.361 + I-8; M.6361: M.362 + I-8; M.6362: M.363 + I-8; M.6363: M.364 + I-8; M.6364: M.365 + I-8;
M.6365: M.366 + I-8; M.6366: M.367 + I-8; M.6367: M.368 + I-8; M.6368: M.369 + I-8; M.6369: M.370 + I-8;
M.6370: M.371 + I-8; M.6371: M.372 + I-8; M.6372: M.373 + I-8; M.6373: M.374 + I-8; M.6374: M.375 + I-8;
M.6375: M.376 + I-8; M.6376: M.377 + I-8; M.6377: M.378 + I-8; M.6378: M.379 + I-8; M.6379: M.380 + I-8;
M.6380: M.381 + I-8; M.6381: M.382 + I-8; M.6382: M.383 + I-8; M.6383: M.384 + I-8; M.6384: M.385 + I-8;
M.6385: M.386 + I-8; M.6386: M.387 + I-8; M.6387: M.388 + I-8; M.6388: M.389 + I-8; M.6389: M.390 + I-8;
M.6390: M.391 + I-8; M.6391: M.392 + I-8; M.6392: M.393 + I-8; M.6393: M.394 + I-8; M.6394: M.395 + I-8;
M.6395: M.396 + I-8; M.6396: M.397 + I-8; M.6397: M.398 + I-8; M.6398: M.399 + I-8; M.6399: M.400 + I-8;
M.6400: M.401 + I-8; M.6401: M.402 + I-8; M.6402: M.403 + I-8; M.6403: M.404 + I-8; M.6404: M.405 + I-8;
M.6405: M.406 + I-8; M.6406: M.407 + I-8; M.6407: M.408 + I-8; M.6408: M.409 + I-8; M.6409: M.410 + I-8;
M.6410: M.411 + I-8; M.6411: M.412 + I-8; M.6412: M.413 + I-8; M.6413: M.414 + I-8; M.6414: M.415 + I-8;
M.6415: M.416 + I-8; M.6416: M.417 + I-8; M.6417: M.418 + I-8; M.6418: M.419 + I-8; M.6419: M.420 + I-8;
M.6420: M.421 + I-8; M.6421: M.422 + I-8; M.6422: M.423 + I-8; M.6423: M.424 + I-8; M.6424: M.425 + I-8;
M.6425: M.426 + I-8; M.6426: M.427 + I-8; M.6427: M.428 + I-8; M.6428: M.429 + I-8; M.6429: M.430 + I-8;
M.6430: M.431 + I-8; M.6431: M.432 + I-8; M.6432: M.433 + I-8; M.6433: M.434 + I-8; M.6434: M.435 + I-8;
M.6435: M.436 + I-8; M.6436: M.437 + I-8; M.6437: M.438 + I-8; M.6438: M.439 + I-8; M.6439: M.440 + I-8;
M.6440: M.441 + I-8; M.6441: M.442 + I-8; M.6442: M.443 + I-8; M.6443: M.444 + I-8; M.6444: M.445 + I-8;
M.6445: M.446 + I-8; M.6446: M.447 + I-8; M.6447: M.448 + I-8; M.6448: M.449 + I-8; M.6449: M.450 + I-8.

In another embodiment, the present invention relates to ternary herbicidal mixtures M.7000 to M.7449 listed in Table M(h) below, comprising mixtures of the binary mixtures depicted in table M(a) and a third herbicide I-9.

TABLE M(h)
M.7000: M.1 + I-9; M.7001: M.2 + I-9; M.7002: M.3 + I-9; M.7003: M.4 + I-9; M.7004: M.5 + I-9;
M.7005: M.6 + I-9; M.7006: M.7 + I-9; M.7007: M.8 + I-9; M.7008: M.9 + I-9; M.7009: M.10 + I-9;
M.7010: M.11 + I-9; M.7011: M.12 + I-9; M.7012: M.13 + I-9; M.7013: M.14 + I-9; M.7014: M.15 + I-9;
M.7015: M.16 + I-9; M.7016: M.17 + I-9; M.7017: M.18 + I-9; M.7018: M.19 + I-9; M.7019: M.20 + I-9;
M.7020: M.21 + I-9; M.7021: M.22 + I-9; M.7022: M.23 + I-9; M.7023: M.24 + I-9; M.7024: M.25 + I-9;
M.7025: M.26 + I-9; M.7026: M.27 + I-9; M.7027: M.28 + I-9; M.7028: M.29 + I-9; M.7029: M.30 + I-9;
M.7030: M.31 + I-9; M.7031: M.32 + I-9; M.7032: M.33 + I-9; M.7033: M.34 + I-9; M.7034: M.35 + I-9;
M.7035: M.36 + I-9; M.7036: M.37 + I-9; M.7037: M.38 + I-9; M.7038: M.39 + I-9; M.7039: M.40 + I-9;
M.7040: M.41 + I-9; M.7041: M.42 + I-9; M.7042: M.43 + I-9; M.7043: M.44 + I-9; M.7044: M.45 + I-9;
M.7045: M.46 + I-9; M.7046: M.47 + I-9; M.7047: M.48 + I-9; M.7048: M.49 + I-9; M.7049: M.50 + I-9;
M.7050: M.51 + I-9; M.7051: M.52 + I-9; M.7052: M.53 + I-9; M.7053: M.54 + I-9; M.7054: M.55 + I-9;
M.7055: M.56 + I-9; M.7056: M.57 + I-9; M.7057: M.58 + I-9; M.7058: M.59 + I-9; M.7059: M.60 + I-9;
M.7060: M.61 + I-9; M.7061: M.62 + I-9; M.7062: M.63 + I-9; M.7063: M.64 + I-9; M.7064: M.65 + I-9;
M.7065: M.66 + I-9; M.7066: M.67 + I-9; M.7067: M.68 + I-9; M.7068: M.69 + I-9; M.7069: M.70 + I-9;
M.7070: M.71 + I-9; M.7071: M.72 + I-9; M.7072: M.73 + I-9; M.7073: M.74 + I-9; M.7074: M.75 + I-9;
M.7075: M.76 + I-9; M.7076: M.77 + I-9; M.7077: M.78 + I-9; M.7078: M.79 + I-9; M.7079: M.80 + I-9;
M.7080: M.81 + I-9; M.7081: M.82 + I-9; M.7082: M.83 + I-9; M.7083: M.84 + I-9; M.7084: M.85 + I-9;
M.7085: M.86 + I-9; M.7086: M.87 + I-9; M.7087: M.88 + I-9; M.7088: M.89 + I-9; M.7089: M.90 + I-9;
M.7090: M.91 + I-9; M.7091: M.92 + I-9; M.7092: M.93 + I-9; M.7093: M.94 + I-9; M.7094: M.95 + I-9;
M.7095: M.96 + I-9; M.7096: M.97 + I-9; M.7097: M.98 + I-9; M.7098: M.99 + I-9; M.7099: M.100 + I-9;
M.7100: M.101 + I-9; M.7101: M.102 + I-9; M.7102: M.103 + I-9; M.7103: M.104 + I-9; M.7104: M.105 + I-9;
M.7105: M.106 + I-9; M.7106: M.107 + I-9; M.7107: M.108 + I-9; M.7108: M.109 + I-9; M.7109: M.110 + I-9;
M.7110: M.111 + I-9; M.7111: M.112 + I-9; M.7112: M.113 + I-9; M.7113: M.114 + I-9; M.7114: M.115 + I-9;
M.7115: M.116 + I-9; M.7116: M.117 + I-9; M.7117: M.118 + I-9; M.7118: M.119 + I-9; M.7119: M.120 + I-9;
M.7120: M.121 + I-9; M.7121: M.122 + I-9; M.7122: M.123 + I-9; M.7123: M.124 + I-9; M.7124: M.125 + I-9;
M.7125: M.126 + I-9; M.7126: M.127 + I-9; M.7127: M.128 + I-9; M.7128: M.129 + I-9; M.7129: M.130 + I-9;
M.7130: M.131 + I-9; M.7131: M.132 + I-9; M.7132: M.133 + I-9; M.7133: M.134 + I-9; M.7134: M.135 + I-9;
M.7135: M.136 + I-9; M.7136: M.137 + I-9; M.7137: M.138 + I-9; M.7138: M.139 + I-9; M.7139: M.140 + I-9;
M.7140: M.141 + I-9; M.7141: M.142 + I-9; M.7142: M.143 + I-9; M.7143: M.144 + I-9; M.7144: M.145 + I-9;
M.7145: M.146 + I-9; M.7146: M.147 + I-9; M.7147: M.148 + I-9; M.7148: M.149 + I-9; M.7149: M.150 + I-9;
M.7150: M.151 + I-9; M.7151: M.152 + I-9; M.7152: M.153 + I-9; M.7153: M.154 + I-9; M.7154: M.155 + I-9;
M.7155: M.156 + I-9; M.7156: M.157 + I-9; M.7157: M.158 + I-9; M.7158: M.159 + I-9; M.7159: M.160 + I-9;
M.7160: M.161 + I-9; M.7161: M.162 + I-9; M.7162: M.163 + I-9; M.7163: M.164 + I-9; M.7164: M.165 + I-9;
M.7165: M.166 + I-9; M.7166: M.167 + I-9; M.7167: M.168 + I-9; M.7168: M.169 + I-9; M.7169: M.170 + I-9;
M.7170: M.171 + I-9; M.7171: M.172 + I-9; M.7172: M.173 + I-9; M.7173: M.174 + I-9; M.7174: M.175 + I-9;
M.7175: M.176 + I-9; M.7176: M.177 + I-9; M.7177: M.178 + I-9; M.7178: M.179 + I-9; M.7179: M.180 + I-9;
M.7180: M.181 + I-9; M.7181: M.182 + I-9; M.7182: M.183 + I-9; M.7183: M.184 + I-9; M.7184: M.185 + I-9;
M.7185: M.186 + I-9; M.7186: M.187 + I-9; M.7187: M.188 + I-9; M.7188: M.189 + I-9; M.7189: M.190 + I-9;
M.7190: M.191 + I-9; M.7191: M.192 + I-9; M.7192: M.193 + I-9; M.7193: M.194 + I-9; M.7194: M.195 + I-9;
M.7195: M.196 + I-9; M.7196: M.197 + I-9; M.7197: M.198 + I-9; M.7198: M.199 + I-9; M.7199: M.200 + I-9;
M.7200: M.201 + I-9; M.7201: M.202 + I-9; M.7202: M.203 + I-9; M.7203: M.204 + I-9; M.7204: M.205 + I-9;
M.7205: M.206 + I-9; M.7206: M.207 + I-9; M.7207: M.208 + I-9; M.7208: M.209 + I-9; M.7209: M.210 + I-9;
M.7210: M.211 + I-9; M.7211: M.212 + I-9; M.7212: M.213 + I-9; M.7213: M.214 + I-9; M.7214: M.215 + I-9;
M.7215: M.216 + I-9; M.7216: M.217 + I-9; M.7217: M.218 + I-9; M.7218: M.219 + I-9; M.7219: M.220 + I-9;
M.7220: M.221 + I-9; M.7221: M.222 + I-9; M.7222: M.223 + I-9; M.7223: M.224 + I-9; M.7224: M.225 + I-9;
M.7225: M.226 + I-9; M.7226: M.227 + I-9; M.7227: M.228 + I-9; M.7228: M.229 + I-9; M.7229: M.230 + I-9;
M.7230: M.231 + I-9; M.7231: M.232 + I-9; M.7232: M.233 + I-9; M.7233: M.234 + I-9; M.7234: M.235 + I-9;
M.7235: M.236 + I-9; M.7236: M.237 + I-9; M.7237: M.238 + I-9; M.7238: M.239 + I-9; M.7239: M.240 + I-9;
M.7240: M.241 + I-9; M.7241: M.242 + I-9; M.7242: M.243 + I-9; M.7243: M.244 + I-9; M.7244: M.245 + I-9;
M.7245: M.246 + I-9; M.7246: M.247 + I-9; M.7247: M.248 + I-9; M.7248: M.249 + I-9; M.7249: M.250 + I-9;
M.7250: M.251 + I-9; M.7251: M.252 + I-9; M.7252: M.253 + I-9; M.7253: M.254 + I-9; M.7254: M.255 + I-9;
M.7255: M.256 + I-9; M.7256: M.257 + I-9; M.7257: M.258 + I-9; M.7258: M.259 + I-9; M.7259: M.260 + I-9;
M.7260: M.261 + I-9; M.7261: M.262 + I-9; M.7262: M.263 + I-9; M.7263: M.264 + I-9; M.7264: M.265 + I-9;
M.7265: M.266 + I-9; M.7266: M.267 + I-9; M.7267: M.268 + I-9; M.7268: M.269 + I-9; M.7269: M.270 + I-9;
M.7270: M.271 + I-9; M.7271: M.272 + I-9; M.7272: M.273 + I-9; M.7273: M.274 + I-9; M.7274: M.275 + I-9;
M.7275: M.276 + I-9; M.7276: M.277 + I-9; M.7277: M.278 + I-9; M.7278: M.279 + I-9; M.7279: M.280 + I-9;
M.7280: M.281 + I-9; M.7281: M.282 + I-9; M.7282: M.283 + I-9; M.7283: M.284 + I-9; M.7284: M.285 + I-9;
M.7285: M.286 + I-9; M.7286: M.287 + I-9; M.7287: M.288 + I-9; M.7288: M.289 + I-9; M.7289: M.290 + I-9;
M.7290: M.291 + I-9; M.7291: M.292 + I-9; M.7292: M.293 + I-9; M.7293: M.294 + I-9; M.7294: M.295 + I-9;
M.7295: M.296 + I-9; M.7296: M.297 + I-9; M.7297: M.298 + I-9; M.7298: M.299 + I-9; M.7299: M.300 + I-9;
M.7300: M.301 + I-9; M.7301: M.302 + I-9; M.7302: M.303 + I-9; M.7303: M.304 + I-9; M.7304: M.305 + I-9;
M.7305: M.306 + I-9; M.7306: M.307 + I-9; M.7307: M.308 + I-9; M.7308: M.309 + I-9; M.7309: M.310 + I-9;
M.7310: M.311 + I-9; M.7311: M.312 + I-9; M.7312: M.313 + I-9; M.7313: M.314 + I-9; M.7314: M.315 + I-9;
M.7315: M.316 + I-9; M.7316: M.317 + I-9; M.7317: M.318 + I-9; M.7318: M.319 + I-9; M.7319: M.320 + I-9;
M.7320: M.321 + I-9; M.7321: M.322 + I-9; M.7322: M.323 + I-9; M.7323: M.324 + I-9; M.7324: M.325 + I-9;
M.7325: M.326 + I-9; M.7326: M.327 + I-9; M.7327: M.328 + I-9; M.7328: M.329 + I-9; M.7329: M.330 + I-9;
M.7330: M.331 + I-9; M.7331: M.332 + I-9; M.7332: M.333 + I-9; M.7333: M.334 + I-9; M.7334: M.335 + I-9;
M.7335: M.336 + I-9; M.7336: M.337 + I-9; M.7337: M.338 + I-9; M.7338: M.339 + I-9; M.7339: M.340 + I-9;
M.7340: M.341 + I-9; M.7341: M.342 + I-9; M.7342: M.343 + I-9; M.7343: M.344 + I-9; M.7344: M.345 + I-9;
M.7345: M.346 + I-9; M.7346: M.347 + I-9; M.7347: M.348 + I-9; M.7348: M.349 + I-9; M.7349: M.350 + I-9;
M.7350: M.351 + I-9; M.7351: M.352 + I-9; M.7352: M.353 + I-9; M.7353: M.354 + I-9; M.7354: M.355 + I-9;
M.7355: M.356 + I-9; M.7356: M.357 + I-9; M.7357: M.358 + I-9; M.7358: M.359 + I-9; M.7359: M.360 + I-9;
M.7360: M.361 + I-9; M.7361: M.362 + I-9; M.7362: M.363 + I-9; M.7363: M.364 + I-9; M.7364: M.365 + I-9;
M.7365: M.366 + I-9; M.7366: M.367 + I-9; M.7367: M.368 + I-9; M.7368: M.369 + I-9; M.7369: M.370 + I-9;
M.7370: M.371 + I-9; M.7371: M.372 + I-9; M.7372: M.373 + I-9; M.7373: M.374 + I-9; M.7374: M.375 + I-9;
M.7375: M.376 + I-9; M.7376: M.377 + I-9; M.7377: M.378 + I-9; M.7378: M.379 + I-9; M.7379: M.380 + I-9;
M.7380: M.381 + I-9; M.7381: M.382 + I-9; M.7382: M.383 + I-9; M.7383: M.384 + I-9; M.7384: M.385 + I-9;
M.7385: M.386 + I-9; M.7386: M.387 + I-9; M.7387: M.388 + I-9; M.7388: M.389 + I-9; M.7389: M.390 + I-9;
M.7390: M.391 + I-9; M.7391: M.392 + I-9; M.7392: M.393 + I-9; M.7393: M.394 + I-9; M.7394: M.395 + I-9;
M.7395: M.396 + I-9; M.7396: M.397 + I-9; M.7397: M.398 + I-9; M.7398: M.399 + I-9; M.7399: M.400 + I-9;
M.7400: M.401 + I-9; M.7401: M.402 + I-9; M.7402: M.403 + I-9; M.7403: M.404 + I-9; M.7404: M.405 + I-9;
M.7405: M.406 + I-9; M.7406: M.407 + I-9; M.7407: M.408 + I-9; M.7408: M.409 + I-9; M.7409: M.410 + I-9;
M.7410: M.411 + I-9; M.7411: M.412 + I-9; M.7412: M.413 + I-9; M.7413: M.414 + I-9; M.7414: M.415 + I-9;
M.7415: M.416 + I-9; M.7416: M.417 + I-9; M.7417: M.418 + I-9; M.7418: M.419 + I-9; M.7419: M.420 + I-9;
M.7420: M.421 + I-9; M.7421: M.422 + I-9; M.7422: M.423 + I-9; M.7423: M.424 + I-9; M.7424: M.425 + I-9;
M.7425: M.426 + I-9; M.7426: M.427 + I-9; M.7427: M.428 + I-9; M.7428: M.429 + I-9; M.7429: M.430 + I-9;
M.7430: M.431 + I-9; M.7431: M.432 + I-9; M.7432: M.433 + I-9; M.7433: M.434 + I-9; M.7434: M.435 + I-9;
M.7435: M.436 + I-9; M.7436: M.437 + I-9; M.7437: M.438 + I-9; M.7438: M.439 + I-9; M.7439: M.440 + I-9;
M.7440: M.441 + I-9; M.7441: M.442 + I-9; M.7442: M.443 + I-9; M.7443: M.444 + I-9; M.7444: M.445 + I-9;
M.7445: M.446 + I-9; M.7446: M.447 + I-9; M.7447: M.448 + I-9; M.7448: M.449 + I-9; M.7449: M.450 + I-9.

In another embodiment, the present invention relates to ternary herbicidal mixtures M.8000 to M.8449 listed in Table M(i) below, comprising mixtures of the binary mixtures depicted in table M(a) and a third herbicide I-10.

TABLE M(i)
M.8000: M.1 + I-10; M.8001: M.2 + I-10; M.8002: M.3 + I-10; M.8003: M.4 + I-10; M.8004: M.5 + I-10;
M.8005: M.6 + I-10; M.8006: M.7 + I-10; M.8007: M.8 + I-10; M.8008: M.9 + I-10; M.8009: M.10 + I-10;
M.8010: M.11 + I-10; M.8011: M.12 + I-10; M.8012: M.13 + I-10; M.8013: M.14 + I-10; M.8014: M.15 + I-10;
M.8015: M.16 + I-10; M.8016: M.17 + I-10; M.8017: M.18 + I-10; M.8018: M.19 + I-10; M.8019: M.20 + I-10;
M.8020: M.21 + I-10; M.8021: M.22 + I-10; M.8022: M.23 + I-10; M.8023: M.24 + I-10; M.8024: M.25 + I-10;
M.8025: M.26 + I-10; M.8026: M.27 + I-10; M.8027: M.28 + I-10; M.8028: M.29 + I-10; M.8029: M.30 + I-10;
M.8030: M.31 + I-10; M.8031: M.32 + I-10; M.8032: M.33 + I-10; M.8033: M.34 + I-10; M.8034: M.35 + I-10;
M.8035: M.36 + I-10; M.8036: M.37 + I-10; M.8037: M.38 + I-10; M.8038: M.39 + I-10; M.8039: M.40 + I-10;
M.8040: M.41 + I-10; M.8041: M.42 + I-10; M.8042: M.43 + I-10; M.8043: M.44 + I-10; M.8044: M.45 + I-10;
M.8045: M.46 + I-10; M.8046: M.47 + I-10; M.8047: M.48 + I-10; M.8048: M.49 + I-10; M.8049: M.50 + I-10;
M.8050: M.51 + I-10; M.8051: M.52 + I-10; M.8052: M.53 + I-10; M.8053: M.54 + I-10; M.8054: M.55 + I-10;
M.8055: M.56 + I-10; M.8056: M.57 + I-10; M.8057: M.58 + I-10; M.8058: M.59 + I-10; M.8059: M.60 + I-10;
M.8060: M.61 + I-10; M.8061: M.62 + I-10; M.8062: M.63 + I-10; M.8063: M.64 + I-10; M.8064: M.65 + I-10;
M.8065: M.66 + I-10; M.8066: M.67 + I-10; M.8067: M.68 + I-10; M.8068: M.69 + I-10; M.8069: M.70 + I-10;
M.8070: M.71 + I-10; M.8071: M.72 + I-10; M.8072: M.73 + I-10; M.8073: M.74 + I-10; M.8074: M.75 + I-10;
M.8075: M.76 + I-10; M.8076: M.77 + I-10; M.8077: M.78 + I-10; M.8078: M.79 + I-10; M.8079: M.80 + I-10;
M.8080: M.81 + I-10; M.8081: M.82 + I-10; M.8082: M.83 + I-10; M.8083: M.84 + I-10; M.8084: M.85 + I-10;
M.8085: M.86 + I-10; M.8086: M.87 + I-10; M.8087: M.88 + I-10; M.8088: M.89 + I-10; M.8089: M.90 + I-10;
M.8090: M.91 + I-10; M.8091: M.92 + I-10; M.8092: M.93 + I-10; M.8093: M.94 + I-10; M.8094: M.95 + I-10;
M.8095: M.96 + I-10; M.8096: M.97 + I-10; M.8097: M.98 + I-10; M.8098: M.99 + I-10; M.8099: M.100 + I-10;
M.8100: M.101 + I-10; M.8101: M.102 + I-10; M.8102: M.103 + I-10; M.8103: M.104 + I-10; M.8104: M.105 + I-10;
M.8105: M.106 + I-10; M.8106: M.107 + I-10; M.8107: M.108 + I-10; M.8108: M.109 + I-10; M.8109: M.110 + I-10;
M.8110: M.111 + I-10; M.8111: M.112 + I-10; M.8112: M.113 + I-10; M.8113: M.114 + I-10; M.8114: M.115 + I-10;
M.8115: M.116 + I-10; M.8116: M.117 + I-10; M.8117: M.118 + I-10; M.8118: M.119 + I-10; M.8119: M.120 + I-10;
M.8120: M.121 + I-10; M.8121: M.122 + I-10; M.8122: M.123 + I-10; M.8123: M.124 + I-10; M.8124: M.125 + I-10;
M.8125: M.126 + I-10; M.8126: M.127 + I-10; M.8127: M.128 + I-10; M.8128: M.129 + I-10; M.8129: M.130 + I-10;
M.8130: M.131 + I-10; M.8131: M.132 + I-10; M.8132: M.133 + I-10; M.8133: M.134 + I-10; M.8134: M.135 + I-10;
M.8135: M.136 + I-10; M.8136: M.137 + I-10; M.8137: M.138 + I-10; M.8138: M.139 + I-10; M.8139: M.140 + I-10;
M.8140: M.141 + I-10; M.8141: M.142 + I-10; M.8142: M.143 + I-10; M.8143: M.144 + I-10; M.8144: M.145 + I-10;
M.8145: M.146 + I-10; M.8146: M.147 + I-10; M.8147: M.148 + I-10; M.8148: M.149 + I-10; M.8149: M.150 + I-10;
M.8150: M.151 + I-10; M.8151: M.152 + I-10; M.8152: M.153 + I-10; M.8153: M.154 + I-10; M.8154: M.155 + I-10;
M.8155: M.156 + I-10; M.8156: M.157 + I-10; M.8157: M.158 + I-10; M.8158: M.159 + I-10; M.8159: M.160 + I-10;
M.8160: M.161 + I-10; M.8161: M.162 + I-10; M.8162: M.163 + I-10; M.8163: M.164 + I-10; M.8164: M.165 + I-10;
M.8165: M.166 + I-10; M.8166: M.167 + I-10; M.8167: M.168 + I-10; M.8168: M.169 + I-10; M.8169: M.170 + I-10;
M.8170: M.171 + I-10; M.8171: M.172 + I-10; M.8172: M.173 + I-10; M.8173: M.174 + I-10; M.8174: M.175 + I-10;
M.8175: M.176 + I-10; M.8176: M.177 + I-10; M.8177: M.178 + I-10; M.8178: M.179 + I-10; M.8179: M.180 + I-10;
M.8180: M.181 + I-10; M.8181: M.182 + I-10; M.8182: M.183 + I-10; M.8183: M.184 + I-10; M.8184: M.185 + I-10;
M.8185: M.186 + I-10; M.8186: M.187 + I-10; M.8187: M.188 + I-10; M.8188: M.189 + I-10; M.8189: M.190 + I-10;
M.8190: M.191 + I-10; M.8191: M.192 + I-10; M.8192: M.193 + I-10; M.8193: M.194 + I-10; M.8194: M.195 + I-10;
M.8195: M.196 + I-10; M.8196: M.197 + I-10; M.8197: M.198 + I-10; M.8198: M.199 + I-10; M.8199: M.200 + I-10;
M.8200: M.201 + I-10; M.8201: M.202 + I-10; M.8202: M.203 + I-10; M.8203: M.204 + I-10; M.8204: M.205 + I-10;
M.8205: M.206 + I-10; M.8206: M.207 + I-10; M.8207: M.208 + I-10; M.8208: M.209 + I-10; M.8209: M.210 + I-10;
M.8210: M.211 + I-10; M.8211: M.212 + I-10; M.8212: M.213 + I-10; M.8213: M.214 + I-10; M.8214: M.215 + I-10;
M.8215: M.216 + I-10; M.8216: M.217 + I-10; M.8217: M.218 + I-10; M.8218: M.219 + I-10; M.8219: M.220 + I-10;
M.8220: M.221 + I-10; M.8221: M.222 + I-10; M.8222: M.223 + I-10; M.8223: M.224 + I-10; M.8224: M.225 + I-10;
M.8225: M.226 + I-10; M.8226: M.227 + I-10; M.8227: M.228 + I-10; M.8228: M.229 + I-10; M.8229: M.230 + I-10;
M.8230: M.231 + I-10; M.8231: M.232 + I-10; M.8232: M.233 + I-10; M.8233: M.234 + I-10; M.8234: M.235 + I-10;
M.8235: M.236 + I-10; M.8236: M.237 + I-10; M.8237: M.238 + I-10; M.8238: M.239 + I-10; M.8239: M.240 + I-10;
M.8240: M.241 + I-10; M.8241: M.242 + I-10; M.8242: M.243 + I-10; M.8243: M.244 + I-10; M.8244: M.245 + I-10;
M.8245: M.246 + I-10; M.8246: M.247 + I-10; M.8247: M.248 + I-10; M.8248: M.249 + I-10; M.8249: M.250 + I-10;
M.8250: M.251 + I-10; M.8251: M.252 + I-10; M.8252: M.253 + I-10; M.8253: M.254 + I-10; M.8254: M.255 + I-10;
M.8255: M.256 + I-10; M.8256: M.257 + I-10; M.8257: M.258 + I-10; M.8258: M.259 + I-10; M.8259: M.260 + I-10;
M.8260: M.261 + I-10; M.8261: M.262 + I-10; M.8262: M.263 + I-10; M.8263: M.264 + I-10; M.8264: M.265 + I-10;
M.8265: M.266 + I-10; M.8266: M.267 + I-10; M.8267: M.268 + I-10; M.8268: M.269 + I-10; M.8269: M.270 + I-10;
M.8270: M.271 + I-10; M.8271: M.272 + I-10; M.8272: M.273 + I-10; M.8273: M.274 + I-10; M.8274: M.275 + I-10;
M.8275: M.276 + I-10; M.8276: M.277 + I-10; M.8277: M.278 + I-10; M.8278: M.279 + I-10; M.8279: M.280 + I-10;
M.8280: M.281 + I-10; M.8281: M.282 + I-10; M.8282: M.283 + I-10; M.8283: M.284 + I-10; M.8284: M.285 + I-10;
M.8285: M.286 + I-10; M.8286: M.287 + I-10; M.8287: M.288 + I-10; M.8288: M.289 + I-10; M.8289: M.290 + I-10;
M.8290: M.291 + I-10; M.8291: M.292 + I-10; M.8292: M.293 + I-10; M.8293: M.294 + I-10; M.8294: M.295 + I-10;
M.8295: M.296 + I-10; M.8296: M.297 + I-10; M.8297: M.298 + I-10; M.8298: M.299 + I-10; M.8299: M.300 + I-10;
M.8300: M.301 + I-10; M.8301: M.302 + I-10; M.8302: M.303 + I-10; M.8303: M.304 + I-10; M.8304: M.305 + I-10;
M.8305: M.306 + I-10; M.8306: M.307 + I-10; M.8307: M.308 + I-10; M.8308: M.309 + I-10; M.8309: M.310 + I-10;
M.8310: M.311 + I-10; M.8311: M.312 + I-10; M.8312: M.313 + I-10; M.8313: M.314 + I-10; M.8314: M.315 + I-10;
M.8315: M.316 + I-10; M.8316: M.317 + I-10; M.8317: M.318 + I-10; M.8318: M.319 + I-10; M.8319: M.320 + I-10;
M.8320: M.321 + I-10; M.8321: M.322 + I-10; M.8322: M.323 + I-10; M.8323: M.324 + I-10; M.8324: M.325 + I-10;
M.8325: M.326 + I-10; M.8326: M.327 + I-10; M.8327: M.328 + I-10; M.8328: M.329 + I-10; M.8329: M.330 + I-10;
M.8330: M.331 + I-10; M.8331: M.332 + I-10; M.8332: M.333 + I-10; M.8333: M.334 + I-10; M.8334: M.335 + I-10;
M.8335: M.336 + I-10; M.8336: M.337 + I-10; M.8337: M.338 + I-10; M.8338: M.339 + I-10; M.8339: M.340 + I-10;
M.8340: M.341 + I-10; M.8341: M.342 + I-10; M.8342: M.343 + I-10; M.8343: M.344 + I-10; M.8344: M.345 + I-10;
M.8345: M.346 + I-10; M.8346: M.347 + I-10; M.8347: M.348 + I-10; M.8348: M.349 + I-10; M.8349: M.350 + I-10;
M.8350: M.351 + I-10; M.8351: M.352 + I-10; M.8352: M.353 + I-10; M.8353: M.354 + I-10; M.8354: M.355 + I-10;
M.8355: M.356 + I-10; M.8356: M.357 + I-10; M.8357: M.358 + I-10; M.8358: M.359 + I-10; M.8359: M.360 + I-10;
M.8360: M.361 + I-10; M.8361: M.362 + I-10; M.8362: M.363 + I-10; M.8363: M.364 + I-10; M.8364: M.365 + I-10;
M.8365: M.366 + I-10; M.8366: M.367 + I-10; M.8367: M.368 + I-10; M.8368: M.369 + I-10; M.8369: M.370 + I-10;
M.8370: M.371 + I-10; M.8371: M.372 + I-10; M.8372: M.373 + I-10; M.8373: M.374 + I-10; M.8374: M.375 + I-10;
M.8375: M.376 + I-10; M.8376: M.377 + I-10; M.8377: M.378 + I-10; M.8378: M.379 + I-10; M.8379: M.380 + I-10;
M.8380: M.381 + I-10; M.8381: M.382 + I-10; M.8382: M.383 + I-10; M.8383: M.384 + I-10; M.8384: M.385 + I-10;
M.8385: M.386 + I-10; M.8386: M.387 + I-10; M.8387: M.388 + I-10; M.8388: M.389 + I-10; M.8389: M.390 + I-10;
M.8390: M.391 + I-10; M.8391: M.392 + I-10; M.8392: M.393 + I-10; M.8393: M.394 + I-10; M.8394: M.395 + I-10;
M.8395: M.396 + I-10; M.8396: M.397 + I-10; M.8397: M.398 + I-10; M.8398: M.399 + I-10; M.8399: M.400 + I-10;
M.8400: M.401 + I-10; M.8401: M.402 + I-10; M.8402: M.403 + I-10; M.8403: M.404 + I-10; M.8404: M.405 + I-10;
M.8405: M.406 + I-10; M.8406: M.407 + I-10; M.8407: M.408 + I-10; M.8408: M.409 + I-10; M.8409: M.410 + I-10;
M.8410: M.411 + I-10; M.8411: M.412 + I-10; M.8412: M.413 + I-10; M.8413: M.414 + I-10; M.8414: M.415 + I-10;
M.8415: M.416 + I-10; M.8416: M.417 + I-10; M.8417: M.418 + I-10; M.8418: M.419 + I-10; M.8419: M.420 + I-10;
M.8420: M.421 + I-10; M.8421: M.422 + I-10; M.8422: M.423 + I-10; M.8423: M.424 + I-10; M.8424: M.425 + I-10;
M.8425: M.426 + I-10; M.8426: M.427 + I-10; M.8427: M.428 + I-10; M.8428: M.429 + I-10; M.8429: M.430 + I-10;
M.8430: M.431 + I-10; M.8431: M.432 + I-10; M.8432: M.433 + I-10; M.8433: M.434 + I-10; M.8434: M.435 + I-10;
M.8435: M.436 + I-10; M.8436: M.437 + I-10; M.8437: M.438 + I-10; M.8438: M.439 + I-10; M.8439: M.440 + I-10;
M.8440: M.441 + I-10; M.8441: M.442 + I-10; M.8442: M.443 + I-10; M.8443: M.444 + I-10; M.8444: M.445 + I-10;
M.8445: M.446 + I-10; M.8446: M.447 + I-10; M.8447: M.448 + I-10; M.8448: M.449 + I-10; M.8449: M.450 + I-10.

In another embodiment, the present invention relates to ternary herbicidal mixtures M.9000 to M.9449 listed in Table M(j) below, comprising mixtures of the binary mixtures depicted in table M(a) and a third herbicide I-11.

TABLE M(j)
M.9000: M.1 + I-11; M.9001: M.2 + I-11; M.9002: M.3 + I-11; M.9003: M.4 + I-11;
M.9004: M.5 + I-11; M.9005: M.6 + I-11; M.9006: M.7 + I-11; M.9007: M.8 + I-11;
M.9008: M.9 + I-11; M.9009: M.10 + I-11; M.9010: M.11 + I-11; M.9011: M.12 + I-11;
M.9012: M.13 + I-11; M.9013: M.14 + I-11; M.9014: M.15 + I-11; M.9015: M.16 + I-11;
M.9016: M.17 + I-11; M.9017: M.18 + I-11; M.9018: M.19 + I-11; M.9019: M.20 + I-11;
M.9020: M.21 + I-11; M.9021: M.22 + I-11; M.9022: M.23 + I-11; M.9023: M.24 + I-11;
M.9024: M.25 + I-11; M.9025: M.26 + I-11; M.9026: M.27 + I-11; M.9027: M.28 + I-11;
M.9028: M.29 + I-11; M.9029: M.30 + I-11; M.9030: M.31 + I-11; M.9031: M.32 + I-11;
M.9032: M.33 + I-11; M.9033: M.34 + I-11; M.9034: M.35 + I-11; M.9035: M.36 + I-11;
M.9036: M.37 + I-11; M.9037: M.38 + I-11; M.9038: M.39 + I-11; M.9039: M.40 + I-11;
M.9040: M.41 + I-11; M.9041: M.42 + I-11; M.9042: M.43 + I-11; M.9043: M.44 + I-11;
M.9044: M.45 + I-11; M.9045: M.46 + I-11; M.9046: M.47 + I-11; M.9047: M.48 + I-11;
M.9048: M.49 + I-11; M.9049: M.50 + I-11; M.9050: M.51 + I-11; M.9051: M.52 + I-11;
M.9052: M.53 + I-11; M.9053: M.54 + I-11; M.9054: M.55 + I-11; M.9055: M.56 + I-11;
M.9056: M.57 + I-11; M.9057: M.58 + I-11; M.9058: M.59 + I-11; M.9059: M.60 + I-11;
M.9060: M.61 + I-11; M.9061: M.62 + I-11; M.9062: M.63 + I-11; M.9063: M.64 + I-11;
M.9064: M.65 + I-11; M.9065: M.66 + I-11; M.9066: M.67 + I-11; M.9067: M.68 + I-11;
M.9068: M.69 + I-11; M.9069: M.70 + I-11; M.9070: M.71 + I-11; M.9071: M.72 + I-11;
M.9072: M.73 + I-11; M.9073: M.74 + I-11; M.9074: M.75 + I-11; M.9075: M.76 + I-11;
M.9076: M.77 + I-11; M.9077: M.78 + I-11; M.9078: M.79 + I-11; M.9079: M.80 + I-11;
M.9080: M.81 + I-11; M.9081: M.82 + I-11; M.9082: M.83 + I-11; M.9083: M.84 + I-11;
M.9084: M.85 + I-11; M.9085: M.86 + I-11; M.9086: M.87 + I-11; M.9087: M.88 + I-11;
M.9088: M.89 + I-11; M.9089: M.90 + I-11; M.9090: M.91 + I-11; M.9091: M.92 + I-11;
M.9092: M.93 + I-11; M.9093: M.94 + I-11; M.9094: M.95 + I-11; M.9095: M.96 + I-11;
M.9096: M.97 + I-11; M.9097: M.98 + I-11; M.9098: M.99 + I-11; M.9099: M.100 + I-11;
M.9100: M.101 + I-11; M.9101: M.102 + I-11; M.9102: M.103 + I-11; M.9103: M.104 + I-11;
M.9104: M.105 + I-11; M.9105: M.106 + I-11; M.9106: M.107 + I-11; M.9107: M.108 + I-11;
M.9108: M.109 + I-11; M.9109: M.110 + I-11; M.9110: M.111 + I-11; M.9111: M.112 + I-11;
M.9112: M.113 + I-11; M.9113: M.114 + I-11; M.9114: M.115 + I-11; M.9115: M.116 + I-11;
M.9116: M.117 + I-11; M.9117: M.118 + I-11; M.9118: M.119 + I-11; M.9119: M.120 + I-11;
M.9120: M.121 + I-11; M.9121: M.122 + I-11; M.9122: M.123 + I-11; M.9123: M.124 + I-11;
M.9124: M.125 + I-11; M.9125: M.126 + I-11; M.9126: M.127 + I-11; M.9127: M.128 + I-11;
M.9128: M.129 + I-11; M.9129: M.130 + I-11; M.9130: M.131 + I-11; M.9131: M.132 + I-11;
M.9132: M.133 + I-11; M.9133: M.134 + I-11; M.9134: M.135 + I-11; M.9135: M.136 + I-11;
M.9136: M.137 + I-11; M.9137: M.138 + I-11; M.9138: M.139 + I-11; M.9139: M.140 + I-11;
M.9140: M.141 + I-11; M.9141: M.142 + I-11; M.9142: M.143 + I-11; M.9143: M.144 + I-11;
M.9144: M.145 + I-11; M.9145: M.146 + I-11; M.9146: M.147 + I-11; M.9147: M.148 + I-11;
M.9148: M.149 + I-11; M.9149: M.150 + I-11; M.9150: M.151 + I-11; M.9151: M.152 + I-11;
M.9152: M.153 + I-11; M.9153: M.154 + I-11; M.9154: M.155 + I-11; M.9155: M.156 + I-11;
M.9156: M.157 + I-11; M.9157: M.158 + I-11; M.9158: M.159 + I-11; M.9159: M.160 + I-11;
M.9160: M.161 + I-11; M.9161: M.162 + I-11; M.9162: M.163 + I-11; M.9163: M.164 + I-11;
M.9164: M.165 + I-11; M.9165: M.166 + I-11; M.9166: M.167 + I-11; M.9167: M.168 + I-11;
M.9168: M.169 + I-11; M.9169: M.170 + I-11; M.9170: M.171 + I-11; M.9171: M.172 + I-11;
M.9172: M.173 + I-11; M.9173: M.174 + I-11; M.9174: M.175 + I-11; M.9175: M.176 + I-11;
M.9176: M.177 + I-11; M.9177: M.178 + I-11; M.9178: M.179 + I-11; M.9179: M.180 + I-11;
M.9180: M.181 + I-11; M.9181: M.182 + I-11; M.9182: M.183 + I-11; M.9183: M.184 + I-11;
M.9184: M.185 + I-11; M.9185: M.186 + I-11; M.9186: M.187 + I-11; M.9187: M.188 + I-11;
M.9188: M.189 + I-11; M.9189: M.190 + I-11; M.9190: M.191 + I-11; M.9191: M.192 + I-11;
M.9192: M.193 + I-11; M.9193: M.194 + I-11; M.9194: M.195 + I-11; M.9195: M.196 + I-11;
M.9196: M.197 + I-11; M.9197: M.198 + I-11; M.9198: M.199 + I-11; M.9199: M.200 + I-11;
M.9200: M.201 + I-11; M.9201: M.202 + I-11; M.9202: M.203 + I-11; M.9203: M.204 + I-11;
M.9204: M.205 + I-11; M.9205: M.206 + I-11; M.9206: M.207 + I-11; M.9207: M.208 + I-11;
M.9208: M.209 + I-11; M.9209: M.210 + I-11; M.9210: M.211 + I-11; M.9211: M.212 + I-11;
M.9212: M.213 + I-11; M.9213: M.214 + I-11; M.9214: M.215 + I-11; M.9215: M.216 + I-11;
M.9216: M.217 + I-11; M.9217: M.218 + I-11; M.9218: M.219 + I-11; M.9219: M.220 + I-11;
M.9220: M.221 + I-11; M.9221: M.222 + I-11; M.9222: M.223 + I-11; M.9223: M.224 + I-11;
M.9224: M.225 + I-11; M.9225: M.226 + I-11; M.9226: M.227 + I-11; M.9227: M.228 + I-11;
M.9228: M.229 + I-11; M.9229: M.230 + I-11; M.9230: M.231 + I-11; M.9231: M.232 + I-11;
M.9232: M.233 + I-11; M.9233: M.234 + I-11; M.9234: M.235 + I-11; M.9235: M.236 + I-11;
M.9236: M.237 + I-11; M.9237: M.238 + I-11; M.9238: M.239 + I-11; M.9239: M.240 + I-11;
M.9240: M.241 + I-11; M.9241: M.242 + I-11; M.9242: M.243 + I-11; M.9243: M.244 + I-11;
M.9244: M.245 + I-11; M.9245: M.246 + I-11; M.9246: M.247 + I-11; M.9247: M.248 + I-11;
M.9248: M.249 + I-11; M.9249: M.250 + I-11; M.9250: M.251 + I-11; M.9251: M.252 + I-11;
M.9252: M.253 + I-11; M.9253: M.254 + I-11; M.9254: M.255 + I-11; M.9255: M.256 + I-11;
M.9256: M.257 + I-11; M.9257: M.258 + I-11; M.9258: M.259 + I-11; M.9259: M.260 + I-11;
M.9260: M.261 + I-11; M.9261: M.262 + I-11; M.9262: M.263 + I-11; M.9263: M.264 + I-11;
M.9264: M.265 + I-11; M.9265: M.266 + I-11; M.9266: M.267 + I-11; M.9267: M.268 + I-11;
M.9268: M.269 + I-11; M.9269: M.270 + I-11; M.9270: M.271 + I-11; M.9271: M.272 + I-11;
M.9272: M.273 + I-11; M.9273: M.274 + I-11; M.9274: M.275 + I-11; M.9275: M.276 + I-11;
M.9276: M.277 + I-11; M.9277: M.278 + I-11; M.9278: M.279 + I-11; M.9279: M.280 + I-11;
M.9280: M.281 + I-11; M.9281: M.282 + I-11; M.9282: M.283 + I-11; M.9283: M.284 + I-11;
M.9284: M.285 + I-11; M.9285: M.286 + I-11; M.9286: M.287 + I-11; M.9287: M.288 + I-11;
M.9288: M.289 + I-11; M.9289: M.290 + I-11; M.9290: M.291 + I-11; M.9291: M.292 + I-11;
M.9292: M.293 + I-11; M.9293: M.294 + I-11; M.9294: M.295 + I-11; M.9295: M.296 + I-11;
M.9296: M.297 + I-11; M.9297: M.298 + I-11; M.9298: M.299 + I-11; M.9299: M.300 + I-11;
M.9300: M.301 + I-11; M.9301: M.302 + I-11; M.9302: M.303 + I-11; M.9303: M.304 + I-11;
M.9304: M.305 + I-11; M.9305: M.306 + I-11; M.9306: M.307 + I-11; M.9307: M.308 + I-11;
M.9308: M.309 + I-11; M.9309: M.310 + I-11; M.9310: M.311 + I-11; M.9311: M.312 + I-11;
M.9312: M.313 + I-11; M.9313: M.314 + I-11; M.9314: M.315 + I-11; M.9315: M.316 + I-11;
M.9316: M.317 + I-11; M.9317: M.318 + I-11; M.9318: M.319 + I-11; M.9319: M.320 + I-11;
M.9320: M.321 + I-11; M.9321: M.322 + I-11; M.9322: M.323 + I-11; M.9323: M.324 + I-11;
M.9324: M.325 + I-11; M.9325: M.326 + I-11; M.9326: M.327 + I-11; M.9327: M.328 + I-11;
M.9328: M.329 + I-11; M.9329: M.330 + I-11; M.9330: M.331 + I-11; M.9331: M.332 + I-11;
M.9332: M.333 + I-11; M.9333: M.334 + I-11; M.9334: M.335 + I-11; M.9335: M.336 + I-11;
M.9336: M.337 + I-11; M.9337: M.338 + I-11; M.9338: M.339 + I-11; M.9339: M.340 + I-11;
M.9340: M.341 + I-11; M.9341: M.342 + I-11; M.9342: M.343 + I-11; M.9343: M.344 + I-11;
M.9344: M.345 + I-11; M.9345: M.346 + I-11; M.9346: M.347 + I-11; M.9347: M.348 + I-11;
M.9348: M.349 + I-11; M.9349: M.350 + I-11; M.9350: M.351 + I-11; M.9351: M.352 + I-11;
M.9352: M.353 + I-11; M.9353: M.354 + I-11; M.9354: M.355 + I-11; M.9355: M.356 + I-11;
M.9356: M.357 + I-11; M.9357: M.358 + I-11; M.9358: M.359 + I-11; M.9359: M.360 + I-11;
M.9360: M.361 + I-11; M.9361: M.362 + I-11; M.9362: M.363 + I-11; M.9363: M.364 + I-11;
M.9364: M.365 + I-11; M.9365: M.366 + I-11; M.9366: M.367 + I-11; M.9367: M.368 + I-11;
M.9368: M.369 + I-11; M.9369: M.370 + I-11; M.9370: M.371 + I-11; M.9371: M.372 + I-11;
M.9372: M.373 + I-11; M.9373: M.374 + I-11; M.9374: M.375 + I-11; M.9375: M.376 + I-11;
M.9376: M.377 + I-11; M.9377: M.378 + I-11; M.9378: M.379 + I-11; M.9379: M.380 + I-11;
M.9380: M.381 + I-11; M.9381: M.382 + I-11; M.9382: M.383 + I-11; M.9383: M.384 + I-11;
M.9384: M.385 + I-11; M.9385: M.386 + I-11; M.9386: M.387 + I-11; M.9387: M.388 + I-11;
M.9388: M.389 + I-11; M.9389: M.390 + I-11; M.9390: M.391 + I-11; M.9391: M.392 + I-11;
M.9392: M.393 + I-11; M.9393: M.394 + I-11; M.9394: M.395 + I-11; M.9395: M.396 + I-11;
M.9396: M.397 + I-11; M.9397: M.398 + I-11; M.9398: M.399 + I-11; M.9399: M.400 + I-11;
M.9400: M.401 + I-11; M.9401: M.402 + I-11; M.9402: M.403 + I-11; M.9403: M.404 + I-11;
M.9404: M.405 + I-11; M.9405: M.406 + I-11; M.9406: M.407 + I-11; M.9407: M.408 + I-11;
M.9408: M.409 + I-11; M.9409: M.410 + I-11; M.9410: M.411 + I-11; M.9411: M.412 + I-11;
M.9412: M.413 + I-11; M.9413: M.414 + I-11; M.9414: M.415 + I-11; M.9415: M.416 + I-11;
M.9416: M.417 + I-11; M.9417: M.418 + I-11; M.9418: M.419 + I-11; M.9419: M.420 + I-11;
M.9420: M.421 + I-11; M.9421: M.422 + I-11; M.9422: M.423 + I-11; M.9423: M.424 + I-11;
M.9424: M.425 + I-11; M.9425: M.426 + I-11; M.9426: M.427 + I-11; M.9427: M.428 + I-11;
M.9428: M.429 + I-11; M.9429: M.430 + I-11; M.9430: M.431 + I-11; M.9431: M.432 + I-11;
M.9432: M.433 + I-11; M.9433: M.434 + I-11; M.9434: M.435 + I-11; M.9435: M.436 + I-11;
M.9436: M.437 + I-11; M.9437: M.438 + I-11; M.9438: M.439 + I-11; M.9439: M.440 + I-11;
M.9440: M.441 + I-11; M.9441: M.442 + I-11; M.9442: M.443 + I-11; M.9443: M.444 + I-11;
M.9444: M.445 + I-11; M.9445: M.446 + I-11; M.9446: M.447 + I-11; M.9447: M.448 + I-11;
M.9448: M.449 + I-11; M.9449: M.450 + I-11.

In another embodiment, the present invention relates to ternary herbicidal mixtures M.10000 to M.10449 listed in Table M(k) below, comprising mixtures of the binary mixtures depicted in table M(a) and a third herbicide I-12.

TABLE M(k)
M.10000: M.1 + I-12; M.10001: M.2 + I-12; M.10002: M.3 + I-12; M.10003: M.4 + I-12;
M.10004: M.5 + I-12; M.10005: M.6 + I-12; M.10006: M.7 + I-12; M.10007: M.8 + I-12;
M.10008: M.9 + I-12; M.10009: M.10 + I-12; M.10010: M.11 + I-12; M.10011: M.12 + I-12;
M.10012: M.13 + I-12; M.10013: M.14 + I-12; M.10014: M.15 + I-12; M.10015: M.16 + I-12;
M.10016: M.17 + I-12; M.10017: M.18 + I-12; M.10018: M.19 + I-12; M.10019: M.20 + I-12;
M.10020: M.21 + I-12; M.10021: M.22 + I-12; M.10022: M.23 + I-12; M.10023: M.24 + I-12;
M.10024: M.25 + I-12; M.10025: M.26 + I-12; M.10026: M.27 + I-12; M.10027: M.28 + I-12;
M.10028: M.29 + I-12; M.10029: M.30 + I-12; M.10030: M.31 + I-12; M.10031: M.32 + I-12;
M.10032: M.33 + I-12; M.10033: M.34 + I-12; M.10034: M.35 + I-12; M.10035: M.36 + I-12;
M.10036: M.37 + I-12; M.10037: M.38 + I-12; M.10038: M.39 + I-12; M.10039: M.40 + I-12;
M.10040: M.41 + I-12; M.10041: M.42 + I-12; M.10042: M.43 + I-12; M.10043: M.44 + I-12;
M.10044: M.45 + I-12; M.10045: M.46 + I-12; M.10046: M.47 + I-12; M.10047: M.48 + I-12;
M.10048: M.49 + I-12; M.10049: M.50 + I-12; M.10050: M.51 + I-12; M.10051: M.52 + I-12;
M.10052: M.53 + I-12; M.10053: M.54 + I-12; M.10054: M.55 + I-12; M.10055: M.56 + I-12;
M.10056: M.57 + I-12; M.10057: M.58 + I-12; M.10058: M.59 + I-12; M.10059: M.60 + I-12;
M.10060: M.61 + I-12; M.10061: M.62 + I-12; M.10062: M.63 + I-12; M.10063: M.64 + I-12;
M.10064: M.65 + I-12; M.10065: M.66 + I-12; M.10066: M.67 + I-12; M.10067: M.68 + I-12;
M.10068: M.69 + I-12; M.10069: M.70 + I-12; M.10070: M.71 + I-12; M.10071: M.72 + I-12;
M.10072: M.73 + I-12; M.10073: M.74 + I-12; M.10074: M.75 + I-12; M.10075: M.76 + I-12;
M.10076: M.77 + I-12; M.10077: M.78 + I-12; M.10078: M.79 + I-12; M.10079: M.80 + I-12;
M.10080: M.81 + I-12; M.10081: M.82 + I-12; M.10082: M.83 + I-12; M.10083: M.84 + I-12;
M.10084: M.85 + I-12; M.10085: M.86 + I-12; M.10086: M.87 + I-12; M.10087: M.88 + I-12;
M.10088: M.89 + I-12; M.10089: M.90 + I-12; M.10090: M.91 + I-12; M.10091: M.92 + I-12;
M.10092: M.93 + I-12; M.10093: M.94 + I-12; M.10094: M.95 + I-12; M.10095: M.96 + I-12;
M.10096: M.97 + I-12; M.10097: M.98 + I-12; M.10098: M.99 + I-12; M.10099: M.100 + I-12;
M.10100: M.101 + I-12; M.10101: M.102 + I-12; M.10102: M.103 + I-12; M.10103: M.104 + I-12;
M.10104: M.105 + I-12; M.10105: M.106 + I-12; M.10106: M.107 + I-12; M.10107: M.108 + I-12;
M.10108: M.109 + I-12; M.10109: M.110 + I-12; M.10110: M.111 + I-12; M.10111: M.112 + I-12;
M.10112: M.113 + I-12; M.10113: M.114 + I-12; M.10114: M.115 + I-12; M.10115: M.116 + I-12;
M.10116: M.117 + I-12; M.10117: M.118 + I-12; M.10118: M.119 + I-12; M.10119: M.120 + I-12;
M.10120: M.121 + I-12; M.10121: M.122 + I-12; M.10122: M.123 + I-12; M.10123: M.124 + I-12;
M.10124: M.125 + I-12; M.10125: M.126 + I-12; M.10126: M.127 + I-12; M.10127: M.128 + I-12;
M.10128: M.129 + I-12; M.10129: M.130 + I-12; M.10130: M.131 + I-12; M.10131: M.132 + I-12;
M.10132: M.133 + I-12; M.10133: M.134 + I-12; M.10134: M.135 + I-12; M.10135: M.136 + I-12;
M.10136: M.137 + I-12; M.10137: M.138 + I-12; M.10138: M.139 + I-12; M.10139: M.140 + I-12;
M.10140: M.141 + I-12; M.10141: M.142 + I-12; M.10142: M.143 + I-12; M.10143: M.144 + I-12;
M.10144: M.145 + I-12; M.10145: M.146 + I-12; M.10146: M.147 + I-12; M.10147: M.148 + I-12;
M.10148: M.149 + I-12; M.10149: M.150 + I-12; M.10150: M.151 + I-12; M.10151: M.152 + I-12;
M.10152: M.153 + I-12; M.10153: M.154 + I-12; M.10154: M.155 + I-12; M.10155: M.156 + I-12;
M.10156: M.157 + I-12; M.10157: M.158 + I-12; M.10158: M.159 + I-12; M.10159: M.160 + I-12;
M.10160: M.161 + I-12; M.10161: M.162 + I-12; M.10162: M.163 + I-12; M.10163: M.164 + I-12;
M.10164: M.165 + I-12; M.10165: M.166 + I-12; M.10166: M.167 + I-12; M.10167: M.168 + I-12;
M.10168: M.169 + I-12; M.10169: M.170 + I-12; M.10170: M.171 + I-12; M.10171: M.172 + I-12;
M.10172: M.173 + I-12; M.10173: M.174 + I-12; M.10174: M.175 + I-12; M.10175: M.176 + I-12;
M.10176: M.177 + I-12; M.10177: M.178 + I-12; M.10178: M.179 + I-12; M.10179: M.180 + I-12;
M.10180: M.181 + I-12; M.10181: M.182 + I-12; M.10182: M.183 + I-12; M.10183: M.184 + I-12;
M.10184: M.185 + I-12; M.10185: M.186 + I-12; M.10186: M.187 + I-12; M.10187: M.188 + I-12;
M.10188: M.189 + I-12; M.10189: M.190 + I-12; M.10190: M.191 + I-12; M.10191: M.192 + I-12;
M.10192: M.193 + I-12; M.10193: M.194 + I-12; M.10194: M.195 + I-12; M.10195: M.196 + I-12;
M.10196: M.197 + I-12; M.10197: M.198 + I-12; M.10198: M.199 + I-12; M.10199: M.200 + I-12;
M.10200: M.201 + I-12; M.10201: M.202 + I-12; M.10202: M.203 + I-12; M.10203: M.204 + I-12;
M.10204: M.205 + I-12; M.10205: M.206 + I-12; M.10206: M.207 + I-12; M.10207: M.208 + I-12;
M.10208: M.209 + I-12; M.10209: M.210 + I-12; M.10210: M.211 + I-12; M.10211: M.212 + I-12;
M.10212: M.213 + I-12; M.10213: M.214 + I-12; M.10214: M.215 + I-12; M.10215: M.216 + I-12;
M.10216: M.217 + I-12; M.10217: M.218 + I-12; M.10218: M.219 + I-12; M.10219: M.220 + I-12;
M.10220: M.221 + I-12; M.10221: M.222 + I-12; M.10222: M.223 + I-12; M.10223: M.224 + I-12;
M.10224: M.225 + I-12; M.10225: M.226 + I-12; M.10226: M.227 + I-12; M.10227: M.228 + I-12;
M.10228: M.229 + I-12; M.10229: M.230 + I-12; M.10230: M.231 + I-12; M.10231: M.232 + I-12;
M.10232: M.233 + I-12; M.10233: M.234 + I-12; M.10234: M.235 + I-12; M.10235: M.236 + I-12;
M.10236: M.237 + I-12; M.10237: M.238 + I-12; M.10238: M.239 + I-12; M.10239: M.240 + I-12;
M.10240: M.241 + I-12; M.10241: M.242 + I-12; M.10242: M.243 + I-12; M.10243: M.244 + I-12;
M.10244: M.245 + I-12; M.10245: M.246 + I-12; M.10246: M.247 + I-12; M.10247: M.248 + I-12;
M.10248: M.249 + I-12; M.10249: M.250 + I-12; M.10250: M.251 + I-12; M.10251: M.252 + I-12;
M.10252: M.253 + I-12; M.10253: M.254 + I-12; M.10254: M.255 + I-12; M.10255: M.256 + I-12;
M.10256: M.257 + I-12; M.10257: M.258 + I-12; M.10258: M.259 + I-12; M.10259: M.260 + I-12;
M.10260: M.261 + I-12; M.10261: M.262 + I-12; M.10262: M.263 + I-12; M.10263: M.264 + I-12;
M.10264: M.265 + I-12; M.10265: M.266 + I-12; M.10266: M.267 + I-12; M.10267: M.268 + I-12;
M.10268: M.269 + I-12; M.10269: M.270 + I-12; M.10270: M.271 + I-12; M.10271: M.272 + I-12;
M.10272: M.273 + I-12; M.10273: M.274 + I-12; M.10274: M.275 + I-12; M.10275: M.276 + I-12;
M.10276: M.277 + I-12; M.10277: M.278 + I-12; M.10278: M.279 + I-12; M.10279: M.280 + I-12;
M.10280: M.281 + I-12; M.10281: M.282 + I-12; M.10282: M.283 + I-12; M.10283: M.284 + I-12;
M.10284: M.285 + I-12; M.10285: M.286 + I-12; M.10286: M.287 + I-12; M.10287: M.288 + I-12;
M.10288: M.289 + I-12; M.10289: M.290 + I-12; M.10290: M.291 + I-12; M.10291: M.292 + I-12;
M.10292: M.293 + I-12; M.10293: M.294 + I-12; M.10294: M.295 + I-12; M.10295: M.296 + I-12;
M.10296: M.297 + I-12; M.10297: M.298 + I-12; M.10298: M.299 + I-12; M.10299: M.300 + I-12;
M.10300: M.301 + I-12; M.10301: M.302 + I-12; M.10302: M.303 + I-12; M.10303: M.304 + I-12;
M.10304: M.305 + I-12; M.10305: M.306 + I-12; M.10306: M.307 + I-12; M.10307: M.308 + I-12;
M.10308: M.309 + I-12; M.10309: M.310 + I-12; M.10310: M.311 + I-12; M.10311: M.312 + I-12;
M.10312: M.313 + I-12; M.10313: M.314 + I-12; M.10314: M.315 + I-12; M.10315: M.316 + I-12;
M.10316: M.317 + I-12; M.10317: M.318 + I-12; M.10318: M.319 + I-12; M.10319: M.320 + I-12;
M.10320: M.321 + I-12; M.10321: M.322 + I-12; M.10322: M.323 + I-12; M.10323: M.324 + I-12;
M.10324: M.325 + I-12; M.10325: M.326 + I-12; M.10326: M.327 + I-12; M.10327: M.328 + I-12;
M.10328: M.329 + I-12; M.10329: M.330 + I-12; M.10330: M.331 + I-12; M.10331: M.332 + I-12;
M.10332: M.333 + I-12; M.10333: M.334 + I-12; M.10334: M.335 + I-12; M.10335: M.336 + I-12;
M.10336: M.337 + I-12; M.10337: M.338 + I-12; M.10338: M.339 + I-12; M.10339: M.340 + I-12;
M.10340: M.341 + I-12; M.10341: M.342 + I-12; M.10342: M.343 + I-12; M.10343: M.344 + I-12;
M.10344: M.345 + I-12; M.10345: M.346 + I-12; M.10346: M.347 + I-12; M.10347: M.348 + I-12;
M.10348: M.349 + I-12; M.10349: M.350 + I-12; M.10350: M.351 + I-12; M.10351: M.352 + I-12;
M.10352: M.353 + I-12; M.10353: M.354 + I-12; M.10354: M.355 + I-12; M.10355: M.356 + I-12;
M.10356: M.357 + I-12; M.10357: M.358 + I-12; M.10358: M.359 + I-12; M.10359: M.360 + I-12;
M.10360: M.361 + I-12; M.10361: M.362 + I-12; M.10362: M.363 + I-12; M.10363: M.364 + I-12;
M.10364: M.365 + I-12; M.10365: M.366 + I-12; M.10366: M.367 + I-12; M.10367: M.368 + I-12;
M.10368: M.369 + I-12; M.10369: M.370 + I-12; M.10370: M.371 + I-12; M.10371: M.372 + I-12;
M.10372: M.373 + I-12; M.10373: M.374 + I-12; M.10374: M.375 + I-12; M.10375: M.376 + I-12;
M.10376: M.377 + I-12; M.10377: M.378 + I-12; M.10378: M.379 + I-12; M.10379: M.380 + I-12;
M.10380: M.381 + I-12; M.10381: M.382 + I-12; M.10382: M.383 + I-12; M.10383: M.384 + I-12;
M.10384: M.385 + I-12; M.10385: M.386 + I-12; M.10386: M.387 + I-12; M.10387: M.388 + I-12;
M.10388: M.389 + I-12; M.10389: M.390 + I-12; M.10390: M.391 + I-12; M.10391: M.392 + I-12;
M.10392: M.393 + I-12; M.10393: M.394 + I-12; M.10394: M.395 + I-12; M.10395: M.396 + I-12;
M.10396: M.397 + I-12; M.10397: M.398 + I-12; M.10398: M.399 + I-12; M.10399: M.400 + I-12;
M.1400: M.401 + I-12; M.1401: M.402 + I-12; M.1402: M.403 + I-12; M.1403: M.404 + I-12;
M.1404: M.405 + I-12; M.1405: M.406 + I-12; M.1406: M.407 + I-12; M.1407: M.408 + I-12;
M.1408: M.409 + I-12; M.1409: M.410 + I-12; M.1410: M.411 + I-12; M.1411: M.412 + I-12;
M.1412: M.413 + I-12; M.10413: M.414 + I-12; M.10414: M.415 + I-12; M.10415: M.416 + I-12;
M.10416: M.417 + I-12; M.10417: M.418 + I-12; M.10418: M.419 + I-12; M.10419: M.420 + I-12;
M.10420: M.421 + I-12; M.10421: M.422 + I-12; M.10422: M.423 + I-12; M.10423: M.424 + I-12;
M.10424: M.425 + I-12; M.10425: M.426 + I-12; M.10426: M.427 + I-12; M.10427: M.428 + I-12;
M.10428: M.429 + I-12; M.10429: M.430 + I-12; M.10430: M.431 + I-12; M.10431: M.432 + I-12;
M.10432: M.433 + I-12; M.10433: M.434 + I-12; M.10434: M.435 + I-12; M.10435: M.436 + I-12;
M.10436: M.437 + I-12; M.10437: M.438 + I-12; M.10438: M.439 + I-12; M.10439: M.440 + I-12;
M.10440: M.441 + I-12; M.10441: M.442 + I-12; M.10442: M.443 + I-12; M.10443: M.444 + I-12;
M.10444: M.445 + I-12; M.10445: M.446 + I-12; M.10446: M.447 + I-12; M.10447: M.448 + I-12;
M.10448: M.449 + I-12; M.10449: M.450 + I-12.

In another embodiment, the present invention relates to ternary herbicidal mixtures M.11000 to M.11449 listed in Table M(I) below, comprising mixtures of the binary mixtures depicted in table M(a) and a third herbicide I-13.

TABLE M(l)
M.11000: M.1 + I-13; M.11001: M.2 + I-13; M.11002: M.3 + I-13; M.11003: M.4 + I-13;
M.11004: M.5 + I-13; M.11005: M.6 + I-13; M.11006: M.7 + I-13; M.11007: M.8 + I-13;
M.11008: M.9 + I-13; M.11009: M.10 + I-13; M.11010: M.11 + I-13; M.11011: M.12 + I-13;
M.11012: M.13 + I-13; M.11013: M.14 + I-13; M.11014: M.15 + I-13; M.11015: M.16 + I-13;
M.11016: M.17 + I-13; M.11017: M.18 + I-13; M.11018: M.19 + I-13; M.11019: M.20 + I-13;
M.11020: M.21 + I-13; M.11021: M.22 + I-13; M.11022: M.23 + I-13; M.11023: M.24 + I-13;
M.11024: M.25 + I-13; M.11025: M.26 + I-13; M.11026: M.27 + I-13; M.11027: M.28 + I-13;
M.11028: M.29 + I-13; M.11029: M.30 + I-13; M.11030: M.31 + I-13; M.11031: M.32 + I-13;
M.11032: M.33 + I-13; M.11033: M.34 + I-13; M.11034: M.35 + I-13; M.11035: M.36 + I-13;
M.11036: M.37 + I-13; M.11037: M.38 + I-13; M.11038: M.39 + I-13; M.11039: M.40 + I-13;
M.11040: M.41 + I-13; M.11041: M.42 + I-13; M.11042: M.43 + I-13; M.11043: M.44 + I-13;
M.11044: M.45 + I-13; M.11045: M.46 + I-13; M.11046: M.47 + I-13; M.11047: M.48 + I-13;
M.11048: M.49 + I-13; M.11049: M.50 + I-13; M.11050: M.51 + I-13; M.11051: M.52 + I-13;
M.11052: M.53 + I-13; M.11053: M.54 + I-13; M.11054: M.55 + I-13; M.11055: M.56 + I-13;
M.11056: M.57 + I-13; M.11057: M.58 + I-13; M.11058: M.59 + I-13; M.11059: M.60 + I-13;
M.11060: M.61 + I-13; M.11061: M.62 + I-13; M.11062: M.63 + I-13; M.11063: M.64 + I-13;
M.11064: M.65 + I-13; M.11065: M.66 + I-13; M.11066: M.67 + I-13; M.11067: M.68 + I-13;
M.11068: M.69 + I-13; M.11069: M.70 + I-13; M.11070: M.71 + I-13; M.11071: M.72 + I-13;
M.11072: M.73 + I-13; M.11073: M.74 + I-13; M.11074: M.75 + I-13; M.11075: M.76 + I-13;
M.11076: M.77 + I-13; M.11077: M.78 + I-13; M.11078: M.79 + I-13; M.11079: M.80 + I-13;
M.11080: M.81 + I-13; M.11081: M.82 + I-13; M.11082: M.83 + I-13; M.11083: M.84 + I-13;
M.11084: M.85 + I-13; M.11085: M.86 + I-13; M.11086: M.87 + I-13; M.11087: M.88 + I-13;
M.11088: M.89 + I-13; M.11089: M.90 + I-13; M.11090: M.91 + I-13; M.11091: M.92 + I-13;
M.11092: M.93 + I-13; M.11093: M.94 + I-13; M.11094: M.95 + I-13; M.11095: M.96 + I-13;
M.11096: M.97 + I-13; M.11097: M.98 + I-13; M.11098: M.99 + I-13; M.11099: M.100 + I-13;
M.11100: M.101 + I-13; M.11101: M.102 + I-13; M.11102: M.103 + I-13; M.11103: M.104 + I-13;
M.11104: M.105 + I-13; M.11105: M.106 + I-13; M.11106: M.107 + I-13; M.11107: M.108 + I-13;
M.11108: M.109 + I-13; M.11109: M.110 + I-13; M.11110: M.111 + I-13; M.11111: M.112 + I-13;
M.11112: M.113 + I-13; M.11113: M.114 + I-13; M.11114: M.115 + I-13; M.11115: M.116 + I-13;
M.11116: M.117 + I-13; M.11117: M.118 + I-13; M.11118: M.119 + I-13; M.11119: M.120 + I-13;
M.11120: M.121 + I-13; M.11121: M.122 + I-13; M.11122: M.123 + I-13; M.11123: M.124 + I-13;
M.11124: M.125 + I-13; M.11125: M.126 + I-13; M.11126: M.127 + I-13; M.11127: M.128 + I-13;
M.11128: M.129 + I-13; M.11129: M.130 + I-13; M.11130: M.131 + I-13; M.11131: M.132 + I-13;
M.11132: M.133 + I-13; M.11133: M.134 + I-13; M.11134: M.135 + I-13; M.11135: M.136 + I-13;
M.11136: M.137 + I-13; M.11137: M.138 + I-13; M.11138: M.139 + I-13; M.11139: M.140 + I-13;
M.11140: M.141 + I-13; M.11141: M.142 + I-13; M.11142: M.143 + I-13; M.11143: M.144 + I-13;
M.11144: M.145 + I-13; M.11145: M.146 + I-13; M.11146: M.147 + I-13; M.11147: M.148 + I-13;
M.11148: M.149 + I-13; M.11149: M.150 + I-13; M.11150: M.151 + I-13; M.11151: M.152 + I-13;
M.11152: M.153 + I-13; M.11153: M.154 + I-13; M.11154: M.155 + I-13; M.11155: M.156 + I-13;
M.11156: M.157 + I-13; M.11157: M.158 + I-13; M.11158: M.159 + I-13; M.11159: M.160 + I-13;
M.11160: M.161 + I-13; M.11161: M.162 + I-13; M.11162: M.163 + I-13; M.11163: M.164 + I-13;
M.11164: M.165 + I-13; M.11165: M.166 + I-13; M.11166: M.167 + I-13; M.11167: M.168 + I-13;
M.11168: M.169 + I-13; M.11169: M.170 + I-13; M.11170: M.171 + I-13; M.11171: M.172 + I-13;
M.11172: M.173 + I-13; M.11173: M.174 + I-13; M.11174: M.175 + I-13; M.11175: M.176 + I-13;
M.11176: M.177 + I-13; M.11177: M.178 + I-13; M.11178: M.179 + I-13; M.11179: M.180 + I-13;
M.11180: M.181 + I-13; M.11181: M.182 + I-13; M.11182: M.183 + I-13; M.11183: M.184 + I-13;
M.11184: M.185 + I-13; M.11185: M.186 + I-13; M.11186: M.187 + I-13; M.11187: M.188 + I-13;
M.11188: M.189 + I-13; M.11189: M.190 + I-13; M.11190: M.191 + I-13; M.11191: M.192 + I-13;
M.11192: M.193 + I-13; M.11193: M.194 + I-13; M.11194: M.195 + I-13; M.11195: M.196 + I-13;
M.11196: M.197 + I-13; M.11197: M.198 + I-13; M.11198: M.199 + I-13; M.11199: M.200 + I-13;
M.11200: M.201 + I-13; M.11201: M.202 + I-13; M.11202: M.203 + I-13; M.11203: M.204 + I-13;
M.11204: M.205 + I-13; M.11205: M.206 + I-13; M.11206: M.207 + I-13; M.11207: M.208 + I-13;
M.11208: M.209 + I-13; M.11209: M.210 + I-13; M.11210: M.211 + I-13; M.11211: M.212 + I-13;
M.11212: M.213 + I-13; M.11213: M.214 + I-13; M.11214: M.215 + I-13; M.11215: M.216 + I-13;
M.11216: M.217 + I-13; M.11217: M.218 + I-13; M.11218: M.219 + I-13; M.11219: M.220 + I-13;
M.11220: M.221 + I-13; M.11221: M.222 + I-13; M.11222: M.223 + I-13; M.11223: M.224 + I-13;
M.11224: M.225 + I-13; M.11225: M.226 + I-13; M.11226: M.227 + I-13; M.11227: M.228 + I-13;
M.11228: M.229 + I-13; M.11229: M.230 + I-13; M.11230: M.231 + I-13; M.11231: M.232 + I-13;
M.11232: M.233 + I-13; M.11233: M.234 + I-13; M.11234: M.235 + I-13; M.11235: M.236 + I-13;
M.11236: M.237 + I-13; M.11237: M.238 + I-13; M.11238: M.239 + I-13; M.11239: M.240 + I-13;
M.11240: M.241 + I-13; M.11241: M.242 + I-13; M.11242: M.243 + I-13; M.11243: M.244 + I-13;
M.11244: M.245 + I-13; M.11245: M.246 + I-13; M.11246: M.247 + I-13; M.11247: M.248 + I-13;
M.11248: M.249 + I-13; M.11249: M.250 + I-13; M.11250: M.251 + I-13; M.11251: M.252 + I-13;
M.11252: M.253 + I-13; M.11253: M.254 + I-13; M.11254: M.255 + I-13; M.11255: M.256 + I-13;
M.11256: M.257 + I-13; M.11257: M.258 + I-13; M.11258: M.259 + I-13; M.11259: M.260 + I-13;
M.11260: M.261 + I-13; M.11261: M.262 + I-13; M.11262: M.263 + I-13; M.11263: M.264 + I-13;
M.11264: M.265 + I-13; M.11265: M.266 + I-13; M.11266: M.267 + I-13; M.11267: M.268 + I-13;
M.11268: M.269 + I-13; M.11269: M.270 + I-13; M.11270: M.271 + I-13; M.11271: M.272 + I-13;
M.11272: M.273 + I-13; M.11273: M.274 + I-13; M.11274: M.275 + I-13; M.11275: M.276 + I-13;
M.11276: M.277 + I-13; M.11277: M.278 + I-13; M.11278: M.279 + I-13; M.11279: M.280 + I-13;
M.11280: M.281 + I-13; M.11281: M.282 + I-13; M.11282: M.283 + I-13; M.11283: M.284 + I-13;
M.11284: M.285 + I-13; M.11285: M.286 + I-13; M.11286: M.287 + I-13; M.11287: M.288 + I-13;
M.11288: M.289 + I-13; M.11289: M.290 + I-13; M.11290: M.291 + I-13; M.11291: M.292 + I-13;
M.11292: M.293 + I-13; M.11293: M.294 + I-13; M.11294: M.295 + I-13; M.11295: M.296 + I-13;
M.11296: M.297 + I-13; M.11297: M.298 + I-13; M.11298: M.299 + I-13; M.11299: M.300 + I-13;
M.11300: M.301 + I-13; M.11301: M.302 + I-13; M.11302: M.303 + I-13; M.11303: M.304 + I-13;
M.11304: M.305 + I-13; M.11305: M.306 + I-13; M.11306: M.307 + I-13; M.11307: M.308 + I-13;
M.11308: M.309 + I-13; M.11309: M.310 + I-13; M.11310: M.311 + I-13; M.11311: M.312 + I-13;
M.11312: M.313 + I-13; M.11313: M.314 + I-13; M.11314: M.315 + I-13; M.11315: M.316 + I-13;
M.11316: M.317 + I-13; M.11317: M.318 + I-13; M.11318: M.319 + I-13; M.11319: M.320 + I-13;
M.11320: M.321 + I-13; M.11321: M.322 + I-13; M.11322: M.323 + I-13; M.11323: M.324 + I-13;
M.11324: M.325 + I-13; M.11325: M.326 + I-13; M.11326: M.327 + I-13; M.11327: M.328 + I-13;
M.11328: M.329 + I-13; M.11329: M.330 + I-13; M.11330: M.331 + I-13; M.11331: M.332 + I-13;
M.11332: M.333 + I-13; M.11333: M.334 + I-13; M.11334: M.335 + I-13; M.11335: M.336 + I-13;
M.11336: M.337 + I-13; M.11337: M.338 + I-13; M.11338: M.339 + I-13; M.11339: M.340 + I-13;
M.11340: M.341 + I-13; M.11341: M.342 + I-13; M.11342: M.343 + I-13; M.11343: M.344 + I-13;
M.11344: M.345 + I-13; M.11345: M.346 + I-13; M.11346: M.347 + I-13; M.11347: M.348 + I-13;
M.11348: M.349 + I-13; M.11349: M.350 + I-13; M.11350: M.351 + I-13; M.11351: M.352 + I-13;
M.11352: M.353 + I-13; M.11353: M.354 + I-13; M.11354: M.355 + I-13; M.11355: M.356 + I-13;
M.11356: M.357 + I-13; M.11357: M.358 + I-13; M.11358: M.359 + I-13; M.11359: M.360 + I-13;
M.11360: M.361 + I-13; M.11361: M.362 + I-13; M.11362: M.363 + I-13; M.11363: M.364 + I-13;
M.11364: M.365 + I-13; M.11365: M.366 + I-13; M.11366: M.367 + I-13; M.11367: M.368 + I-13;
M.11368: M.369 + I-13; M.11369: M.370 + I-13; M.11370: M.371 + I-13; M.11371: M.372 + I-13;
M.11372: M.373 + I-13; M.11373: M.374 + I-13; M.11374: M.375 + I-13; M.11375: M.376 + I-13;
M.11376: M.377 + I-13; M.11377: M.378 + I-13; M.11378: M.379 + I-13; M.11379: M.380 + I-13;
M.11380: M.381 + I-13; M.11381: M.382 + I-13; M.11382: M.383 + I-13; M.11383: M.384 + I-13;
M.11384: M.385 + I-13; M.11385: M.386 + I-13; M.11386: M.387 + I-13; M.11387: M.388 + I-13;
M.11388: M.389 + I-13; M.11389: M.390 + I-13; M.11390: M.391 + I-13; M.11391: M.392 + I-13;
M.11392: M.393 + I-13; M.11393: M.394 + I-13; M.11394: M.395 + I-13; M.11395: M.396 + I-13;
M.11396: M.397 + I-13; M.11397: M.398 + I-13; M.11398: M.399 + I-13; M.11399: M.400 + I-13;
M.11400: M.401 + I-13; M.11401: M.402 + I-13; M.11402: M.403 + I-13; M.11403: M.404 + I-13;
M.11404: M.405 + I-13; M.11405: M.406 + I-13; M.11406: M.407 + I-13; M.11407: M.408 + I-13;
M.11408: M.409 + I-13; M.11409: M.410 + I-13; M.11410: M.411 + I-13; M.11411: M.412 + I-13;
M.11412: M.413 + I-13; M.11413: M.414 + I-13; M.11414: M.415 + I-13; M.11415: M.416 + I-13;
M.11416: M.417 + I-13; M.11417: M.418 + I-13; M.11418: M.419 + I-13; M.11419: M.420 + I-13;
M.11420: M.421 + I-13; M.11421: M.422 + I-13; M.11422: M.423 + I-13; M.11423: M.424 + I-13;
M.11424: M.425 + I-13; M.11425: M.426 + I-13; M.11426: M.427 + I-13; M.11427: M.428 + I-13;
M.11428: M.429 + I-13; M.11429: M.430 + I-13; M.11430: M.431 + I-13; M.11431: M.432 + I-13;
M.11432: M.433 + I-13; M.11433: M.434 + I-13; M.11434: M.435 + I-13; M.11435: M.436 + I-13;
M.11436: M.437 + I-13; M.11437: M.438 + I-13; M.11438: M.439 + I-13; M.11439: M.440 + I-13;
M.11440: M.441 + I-13; M.11441: M.442 + I-13; M.11442: M.443 + I-13; M.11443: M.444 + I-13;
M.11444: M.445 + I-13; M.11445: M.446 + I-13; M.11446: M.447 + I-13; M.11447: M.448 + I-13;
M.11448: M.449 + I-13; M.11449: M.450 + I-13.

In another embodiment, the present invention relates to ternary herbicidal mixtures M.12000 to M.12449 listed in Table M(m) below, comprising mixtures of the binary mixtures depicted in table M(a) and a third herbicide I-14.

TABLE M(m)
M.12000: M.1 + I-14; M.12001: M.2 + I-14; M.12002: M.3 + I-14; M.12003: M.4 + I-14;
M.12004: M.5 + I-14; M.12005: M.6 + I-14; M.12006: M.7 + I-14; M.12007: M.8 + I-14;
M.12008: M.9 + I-14; M.12009: M.10 + I-14; M.12010: M.11 + I-14; M.12011: M.12 + I-14;
M.12012: M.13 + I-14; M.12013: M.14 + I-14; M.12014: M.15 + I-14; M.12015: M.16 + I-14;
M.12016: M.17 + I-14; M.12017: M.18 + I-14; M.12018: M.19 + I-14; M.12019: M.20 + I-14;
M.12020: M.21 + I-14; M.12021: M.22 + I-14; M.12022: M.23 + I-14; M.12023: M.24 + I-14;
M.12024: M.25 + I-14; M.12025: M.26 + I-14; M.12026: M.27 + I-14; M.12027: M.28 + I-14;
M.12028: M.29 + I-14; M.12029: M.30 + I-14; M.12030: M.31 + I-14; M.12031: M.32 + I-14;
M.12032: M.33 + I-14; M.12033: M.34 + I-14; M.12034: M.35 + I-14; M.12035: M.36 + I-14;
M.12036: M.37 + I-14; M.12037: M.38 + I-14; M.12038: M.39 + I-14; M.12039: M.40 + I-14;
M.12040: M.41 + I-14; M.12041: M.42 + I-14; M.12042: M.43 + I-14; M.12043: M.44 + I-14;
M.12044: M.45 + I-14; M.12045: M.46 + I-14; M.12046: M.47 + I-14; M.12047: M.48 + I-14;
M.12048: M.49 + I-14; M.12049: M.50 + I-14; M.12050: M.51 + I-14; M.12051: M.52 + I-14;
M.12052: M.53 + I-14; M.12053: M.54 + I-14; M.12054: M.55 + I-14; M.12055: M.56 + I-14;
M.12056: M.57 + I-14; M.12057: M.58 + I-14; M.12058: M.59 + I-14; M.12059: M.60 + I-14;
M.12060: M.61 + I-14; M.12061: M.62 + I-14; M.12062: M.63 + I-14; M.12063: M.64 + I-14;
M.12064: M.65 + I-14; M.12065: M.66 + I-14; M.12066: M.67 + I-14; M.12067: M.68 + I-14;
M.12068: M.69 + I-14; M.12069: M.70 + I-14; M.12070: M.71 + I-14; M.12071: M.72 + I-14;
M.12072: M.73 + I-14; M.12073: M.74 + I-14; M.12074: M.75 + I-14; M.12075: M.76 + I-14;
M.12076: M.77 + I-14; M.12077: M.78 + I-14; M.12078: M.79 + I-14; M.12079: M.80 + I-14;
M.12080: M.81 + I-14; M.12081: M.82 + I-14; M.12082: M.83 + I-14; M.12083: M.84 + I-14;
M.12084: M.85 + I-14; M.12085: M.86 + I-14; M.12086: M.87 + I-14; M.12087: M.88 + I-14;
M.12088: M.89 + I-14; M.12089: M.90 + I-14; M.12090: M.91 + I-14; M.12091: M.92 + I-14;
M.12092: M.93 + I-14; M.12093: M.94 + I-14; M.12094: M.95 + I-14; M.12095: M.96 + I-14;
M.12096: M.97 + I-14; M.12097: M.98 + I-14; M.12098: M.99 + I-14; M.12099: M.100 + I-14;
M.12100: M.101 + I-14; M.12101: M.102 + I-14; M.12102: M.103 + I-14; M.12103: M.104 + I-14;
M.12104: M.105 + I-14; M.12105: M.106 + I-14; M.12106: M.107 + I-14; M.12107: M.108 + I-14;
M.12108: M.109 + I-14; M.12109: M.110 + I-14; M.12110: M.111 + I-14; M.12111: M.112 + I-14;
M.12112: M.113 + I-14; M.12113: M.114 + I-14; M.12114: M.115 + I-14; M.12115: M.116 + I-14;
M.12116: M.117 + I-14; M.12117: M.118 + I-14; M.12118: M.119 + I-14; M.12119: M.120 + I-14;
M.12120: M.121 + I-14; M.12121: M.122 + I-14; M.12122: M.123 + I-14; M.12123: M.124 + I-14;
M.12124: M.125 + I-14; M.12125: M.126 + I-14; M.12126: M.127 + I-14; M.12127: M.128 + I-14;
M.12128: M.129 + I-14; M.12129: M.130 + I-14; M.12130: M.131 + I-14; M.12131: M.132 + I-14;
M.12132: M.133 + I-14; M.12133: M.134 + I-14; M.12134: M.135 + I-14; M.12135: M.136 + I-14;
M.12136: M.137 + I-14; M.12137: M.138 + I-14; M.12138: M.139 + I-14; M.12139: M.140 + I-14;
M.12140: M.141 + I-14; M.12141: M.142 + I-14; M.12142: M.143 + I-14; M.12143: M.144 + I-14;
M.12144: M.145 + I-14; M.12145: M.146 + I-14; M.12146: M.147 + I-14; M.12147: M.148 + I-14;
M.12148: M.149 + I-14; M.12149: M.150 + I-14; M.12150: M.151 + I-14; M.12151: M.152 + I-14;
M.12152: M.153 + I-14; M.12153: M.154 + I-14; M.12154: M.155 + I-14; M.12155: M.156 + I-14;
M.12156: M.157 + I-14; M.12157: M.158 + I-14; M.12158: M.159 + I-14; M.12159: M.160 + I-14;
M.12160: M.161 + I-14; M.12161: M.162 + I-14; M.12162: M.163 + I-14; M.12163: M.164 + I-14;
M.12164: M.165 + I-14; M.12165: M.166 + I-14; M.12166: M.167 + I-14; M.12167: M.168 + I-14;
M.12168: M.169 + I-14; M.12169: M.170 + I-14; M.12170: M.171 + I-14; M.12171: M.172 + I-14;
M.12172: M.173 + I-14; M.12173: M.174 + I-14; M.12174: M.175 + I-14; M.12175: M.176 + I-14;
M.12176: M.177 + I-14; M.12177: M.178 + I-14; M.12178: M.179 + I-14; M.12179: M.180 + I-14;
M.12180: M.181 + I-14; M.12181: M.182 + I-14; M.12182: M.183 + I-14; M.12183: M.184 + I-14;
M.12184: M.185 + I-14; M.12185: M.186 + I-14; M.12186: M.187 + I-14; M.12187: M.188 + I-14;
M.12188: M.189 + I-14; M.12189: M.190 + I-14; M.12190: M.191 + I-14; M.12191: M.192 + I-14;
M.12192: M.193 + I-14; M.12193: M.194 + I-14; M.12194: M.195 + I-14; M.12195: M.196 + I-14;
M.12196: M.197 + I-14; M.12197: M.198 + I-14; M.12198: M.199 + I-14; M.12199: M.200 + I-14;
M.12200: M.201 + I-14; M.12201: M.202 + I-14; M.12202: M.203 + I-14; M.12203: M.204 + I-14;
M.12204: M.205 + I-14; M.12205: M.206 + I-14; M.12206: M.207 + I-14; M.12207: M.208 + I-14;
M.12208: M.209 + I-14; M.12209: M.210 + I-14; M.12210: M.211 + I-14; M.12211: M.212 + I-14;
M.12212: M.213 + I-14; M.12213: M.214 + I-14; M.12214: M.215 + I-14; M.12215: M.216 + I-14;
M.12216: M.217 + I-14; M.12217: M.218 + I-14; M.12218: M.219 + I-14; M.12219: M.220 + I-14;
M.12220: M.221 + I-14; M.12221: M.222 + I-14; M.12222: M.223 + I-14; M.12223: M.224 + I-14;
M.12224: M.225 + I-14; M.12225: M.226 + I-14; M.12226: M.227 + I-14; M.12227: M.228 + I-14;
M.12228: M.229 + I-14; M.12229: M.230 + I-14; M.12230: M.231 + I-14; M.12231: M.232 + I-14;
M.12232: M.233 + I-14; M.12233: M.234 + I-14; M.12234: M.235 + I-14; M.12235: M.236 + I-14;
M.12236: M.237 + I-14; M.12237: M.238 + I-14; M.12238: M.239 + I-14; M.12239: M.240 + I-14;
M.12240: M.241 + I-14; M.12241: M.242 + I-14; M.12242: M.243 + I-14; M.12243: M.244 + I-14;
M.12244: M.245 + I-14; M.12245: M.246 + I-14; M.12246: M.247 + I-14; M.12247: M.248 + I-14;
M.12248: M.249 + I-14; M.12249: M.250 + I-14; M.12250: M.251 + I-14; M.12251: M.252 + I-14;
M.12252: M.253 + I-14; M.12253: M.254 + I-14; M.12254: M.255 + I-14; M.12255: M.256 + I-14;
M.12256: M.257 + I-14; M.12257: M.258 + I-14; M.12258: M.259 + I-14; M.12259: M.260 + I-14;
M.12260: M.261 + I-14; M.12261: M.262 + I-14; M.12262: M.263 + I-14; M.12263: M.264 + I-14;
M.12264: M.265 + I-14; M.12265: M.266 + I-14; M.12266: M.267 + I-14; M.12267: M.268 + I-14;
M.12268: M.269 + I-14; M.12269: M.270 + I-14; M.12270: M.271 + I-14; M.12271: M.272 + I-14;
M.12272: M.273 + I-14; M.12273: M.274 + I-14; M.12274: M.275 + I-14; M.12275: M.276 + I-14;
M.12276: M.277 + I-14; M.12277: M.278 + I-14; M.12278: M.279 + I-14; M.12279: M.280 + I-14;
M.12280: M.281 + I-14; M.12281: M.282 + I-14; M.12282: M.283 + I-14; M.12283: M.284 + I-14;
M.12284: M.285 + I-14; M.12285: M.286 + I-14; M.12286: M.287 + I-14; M.12287: M.288 + I-14;
M.12288: M.289 + I-14; M.12289: M.290 + I-14; M.12290: M.291 + I-14; M.12291: M.292 + I-14;
M.12292: M.293 + I-14; M.12293: M.294 + I-14; M.12294: M.295 + I-14; M.12295: M.296 + I-14;
M.12296: M.297 + I-14; M.12297: M.298 + I-14; M.12298: M.299 + I-14; M.12299: M.300 + I-14;
M.12300: M.301 + I-14; M.12301: M.302 + I-14; M.12302: M.303 + I-14; M.12303: M.304 + I-14;
M.12304: M.305 + I-14; M.12305: M.306 + I-14; M.12306: M.307 + I-14; M.12307: M.308 + I-14;
M.12308: M.309 + I-14; M.12309: M.310 + I-14; M.12310: M.311 + I-14; M.12311: M.312 + I-14;
M.12312: M.313 + I-14; M.12313: M.314 + I-14; M.12314: M.315 + I-14; M.12315: M.316 + I-14;
M.12316: M.317 + I-14; M.12317: M.318 + I-14; M.12318: M.319 + I-14; M.12319: M.320 + I-14;
M.12320: M.321 + I-14; M.12321: M.322 + I-14; M.12322: M.323 + I-14; M.12323: M.324 + I-14;
M.12324: M.325 + I-14; M.12325: M.326 + I-14; M.12326: M.327 + I-14; M.12327: M.328 + I-14;
M.12328: M.329 + I-14; M.12329: M.330 + I-14; M.12330: M.331 + I-14; M.12331: M.332 + I-14;
M.12332: M.333 + I-14; M.12333: M.334 + I-14; M.12334: M.335 + I-14; M.12335: M.336 + I-14;
M.12336: M.337 + I-14; M.12337: M.338 + I-14; M.12338: M.339 + I-14; M.12339: M.340 + I-14;
M.12340: M.341 + I-14; M.12341: M.342 + I-14; M.12342: M.343 + I-14; M.12343: M.344 + I-14;
M.12344: M.345 + I-14; M.12345: M.346 + I-14; M.12346: M.347 + I-14; M.12347: M.348 + I-14;
M.12348: M.349 + I-14; M.12349: M.350 + I-14; M.12350: M.351 + I-14; M.12351: M.352 + I-14;
M.12352: M.353 + I-14; M.12353: M.354 + I-14; M.12354: M.355 + I-14; M.12355: M.356 + I-14;
M.12356: M.357 + I-14; M.12357: M.358 + I-14; M.12358: M.359 + I-14; M.12359: M.360 + I-14;
M.12360: M.361 + I-14; M.12361: M.362 + I-14; M.12362: M.363 + I-14; M.12363: M.364 + I-14;
M.12364: M.365 + I-14; M.12365: M.366 + I-14; M.12366: M.367 + I-14; M.12367: M.368 + I-14;
M.12368: M.369 + I-14; M.12369: M.370 + I-14; M.12370: M.371 + I-14; M.12371: M.372 + I-14;
M.12372: M.373 + I-14; M.12373: M.374 + I-14; M.12374: M.375 + I-14; M.12375: M.376 + I-14;
M.12376: M.377 + I-14; M.12377: M.378 + I-14; M.12378: M.379 + I-14; M.12379: M.380 + I-14;
M.12380: M.381 + I-14; M.12381: M.382 + I-14; M.12382: M.383 + I-14; M.12383: M.384 + I-14;
M.12384: M.385 + I-14; M.12385: M.386 + I-14; M.12386: M.387 + I-14; M.12387: M.388 + I-14;
M.12388: M.389 + I-14; M.12389: M.390 + I-14; M.12390: M.391 + I-14; M.12391: M.392 + I-14;
M.12392: M.393 + I-14; M.12393: M.394 + I-14; M.12394: M.395 + I-14; M.12395: M.396 + I-14;
M.12396: M.397 + I-14; M.12397: M.398 + I-14; M.12398: M.399 + I-14; M.12399: M.400 + I-14;
M.12400: M.401 + I-14; M.12401: M.402 + I-14; M.12402: M.403 + I-14; M.12403: M.404 + I-14;
M.12404: M.405 + I-14; M.12405: M.406 + I-14; M.12406: M.407 + I-14; M.12407: M.408 + I-14;
M.12408: M.409 + I-14; M.12409: M.410 + I-14; M.12410: M.411 + I-14; M.12411: M.412 + I-14;
M.12412: M.413 + I-14; M.12413: M.414 + I-14; M.12414: M.415 + I-14; M.12415: M.416 + I-14;
M.12416: M.417 + I-14; M.12417: M.418 + I-14; M.12418: M.419 + I-14; M.12419: M.420 + I-14;
M.12420: M.421 + I-14; M.12421: M.422 + I-14; M.12422: M.423 + I-14; M.12423: M.424 + I-14;
M.12424: M.425 + I-14; M.12425: M.426 + I-14; M.12426: M.427 + I-14; M.12427: M.428 + I-14;
M.12428: M.429 + I-14; M.12429: M.430 + I-14; M.12430: M.431 + I-14; M.12431: M.432 + I-14;
M.12432: M.433 + I-14; M.12433: M.434 + I-14; M.12434: M.435 + I-14; M.12435: M.436 + I-14;
M.12436: M.437 + I-14; M.12437: M.438 + I-14; M.12438: M.439 + I-14; M.12439: M.440 + I-14;
M.12440: M.441 + I-14; M.12441: M.442 + I-14; M.12442: M.443 + I-14; M.12443: M.444 + I-14;
M.12444: M.445 + I-14; M.12445: M.446 + I-14; M.12446: M.447 + I-14; M.12447: M.448 + I-14;
M.12448: M.449 + I-14; M.12449: M.450 + I-14.

In another embodiment, the present invention relates to ternary herbicidal mixtures M.13000 to M.13449 listed in Table M(n) below, comprising mixtures of the binary mixtures depicted in table M(a) and a third herbicide I-15.

TABLE M(n)
M.13000: M.1 + I-15; M.13001: M.2 + I-15; M.13002: M.3 + I-15; M.13003: M.4 + I-15;
M.13004: M.5 + I-15; M.13005: M.6 + I-15; M.13006: M.7 + I-15; M.13007: M.8 + I-15;
M.13008: M.9 + I-15; M.13009: M.10 + I-15; M.13010: M.11 + I-15; M.13011: M.12 + I-15;
M.13012: M.13 + I-15; M.13013: M.14 + I-15; M.13014: M.15 + I-15; M.13015: M.16 + I-15;
M.13016: M.17 + I-15; M.13017: M.18 + I-15; M.13018: M.19 + I-15; M.13019: M.20 + I-15;
M.13020: M.21 + I-15; M.13021: M.22 + I-15; M.13022: M.23 + I-15; M.13023: M.24 + I-15;
M.13024: M.25 + I-15; M.13025: M.26 + I-15; M.13026: M.27 + I-15; M.13027: M.28 + I-15;
M.13028: M.29 + I-15; M.13029: M.30 + I-15; M.13030: M.31 + I-15; M.13031: M.32 + I-15;
M.13032: M.33 + I-15; M.13033: M.34 + I-15; M.13034: M.35 + I-15; M.13035: M.36 + I-15;
M.13036: M.37 + I-15; M.13037: M.38 + I-15; M.13038: M.39 + I-15; M.13039: M.40 + I-15;
M.13040: M.41 + I-15; M.13041: M.42 + I-15; M.13042: M.43 + I-15; M.13043: M.44 + I-15;
M.13044: M.45 + I-15; M.13045: M.46 + I-15; M.13046: M.47 + I-15; M.13047: M.48 + I-15;
M.13048: M.49 + I-15; M.13049: M.50 + I-15; M.13050: M.51 + I-15; M.13051: M.52 + I-15;
M.13052: M.53 + I-15; M.13053: M.54 + I-15; M.13055: M.56 + I-15; M.13056: M.57 + I-15;
M.13057: M.58 + I-15; M.13058: M.59 + I-15; M.13059: M.60 + I-15; M.13060: M.61 + I-15;
M.13061: M.62 + I-15; M.13062: M.63 + I-15; M.13063: M.64 + I-15; M.13064: M.65 + I-15;
M.13065: M.66 + I-15; M.13066: M.67 + I-15; M.13067: M.68 + I-15; M.13068: M.69 + I-15;
M.13069: M.70 + I-15; M.13070: M.71 + I-15; M.13071: M.72 + I-15; M.13072: M.73 + I-15;
M.13073: M.74 + I-15; M.13074: M.75 + I-15; M.13075: M.76 + I-15; M.13076: M.77 + I-15;
M.13077: M.78 + I-15; M.13078: M.79 + I-15; M.13079: M.80 + I-15; M.13080: M.81 + I-15;
M.13081: M.82 + I-15; M.13082: M.83 + I-15; M.13083: M.84 + I-15; M.13084: M.85 + I-15;
M.13085: M.86 + I-15; M.13086: M.87 + I-15; M.13087: M.88 + I-15; M.13088: M.89 + I-15;
M.13089: M.90 + I-15; M.13090: M.91 + I-15; M.13091: M.92 + I-15; M.13092: M.93 + I-15;
M.13093: M.94 + I-15; M.13094: M.95 + I-15; M.13095: M.96 + I-15; M.13096: M.97 + I-15;
M.13097: M.98 + I-15; M.13098: M.99 + I-15; M.13099: M.100 + I-15; M.13100: M.101 + I-15;
M.13101: M.102 + I-15; M.13102: M.103 + I-15; M.13103: M.104 + I-15; M.13104: M.105 + I-15;
M.13105: M.106 + I-15; M.13106: M.107 + I-15; M.13107: M.108 + I-15; M.13108: M.109 + I-15;
M.13109: M.110 + I-15; M.13110: M.111 + I-15; M.13111: M.112 + I-15; M.13112: M.113 + I-15;
M.13113: M.114 + I-15; M.13114: M.115 + I-15; M.13115: M.116 + I-15; M.13116: M.117 + I-15;
M.13117: M.118 + I-15; M.13118: M.119 + I-15; M.13119: M.120 + I-15; M.13120: M.121 + I-15;
M.13121: M.122 + I-15; M.13122: M.123 + I-15; M.13123: M.124 + I-15; M.13124: M.125 + I-15;
M.13125: M.126 + I-15; M.13126: M.127 + I-15; M.13127: M.128 + I-15; M.13128: M.129 + I-15;
M.13129: M.130 + I-15; M.13130: M.131 + I-15; M.13131: M.132 + I-15; M.13132: M.133 + I-15;
M.13133: M.134 + I-15; M.13134: M.135 + I-15; M.13135: M.136 + I-15; M.13136: M.137 + I-15;
M.13137: M.138 + I-15; M.13138: M.139 + I-15; M.13139: M.140 + I-15; M.13140: M.141 + I-15;
M.13141: M.142 + I-15; M.13142: M.143 + I-15; M.13143: M.144 + I-15; M.13144: M.145 + I-15;
M.13145: M.146 + I-15; M.13146: M.147 + I-15; M.13147: M.148 + I-15; M.13148: M.149 + I-15;
M.13149: M.150 + I-15; M.13150: M.151 + I-15; M.13151: M.152 + I-15; M.13152: M.153 + I-15;
M.13153: M.154 + I-15; M.13154: M.155 + I-15; M.13155: M.156 + I-15; M.13156: M.157 + I-15;
M.13157: M.158 + I-15; M.13158: M.159 + I-15; M.13159: M.160 + I-15; M.13160: M.161 + I-15;
M.13161: M.162 + I-15; M.13162: M.163 + I-15; M.13163: M.164 + I-15; M.13164: M.165 + I-15;
M.13165: M.166 + I-15; M.13166: M.167 + I-15; M.13167: M.168 + I-15; M.13168: M.169 + I-15;
M.13169: M.170 + I-15; M.13170: M.171 + I-15; M.13171: M.172 + I-15; M.13172: M.173 + I-15;
M.13173: M.174 + I-15; M.13174: M.175 + I-15; M.13175: M.176 + I-15; M.13176: M.177 + I-15;
M.13177: M.178 + I-15; M.13178: M.179 + I-15; M.13179: M.180 + I-15; M.13180: M.181 + I-15;
M.13181: M.182 + I-15; M.13182: M.183 + I-15; M.13183: M.184 + I-15; M.13184: M.185 + I-15;
M.13185: M.186 + I-15; M.13186: M.187 + I-15; M.13187: M.188 + I-15; M.13188: M.189 + I-15;
M.13189: M.190 + I-15; M.13190: M.191 + I-15; M.13191: M.192 + I-15; M.13192: M.193 + I-15;
M.13193: M.194 + I-15; M.13194: M.195 + I-15; M.13195: M.196 + I-15; M.13196: M.197 + I-15;
M.13197: M.198 + I-15; M.13198: M.199 + I-15; M.13199: M.200 + I-15; M.13200: M.201 + I-15;
M.13201: M.202 + I-15; M.13202: M.203 + I-15; M.13203: M.204 + I-15; M.13204: M.205 + I-15;
M.13205: M.206 + I-15; M.13206: M.207 + I-15; M.13207: M.208 + I-15; M.13208: M.209 + I-15;
M.13209: M.210 + I-15; M.13210: M.211 + I-15; M.13211: M.212 + I-15; M.13212: M.213 + I-15;
M.13213: M.214 + I-15; M.13214: M.215 + I-15; M.13215: M.216 + I-15; M.13216: M.217 + I-15;
M.13217: M.218 + I-15; M.13218: M.219 + I-15; M.13219: M.220 + I-15; M.13220: M.221 + I-15;
M.13221: M.222 + I-15; M.13222: M.223 + I-15; M.13223: M.224 + I-15; M.13224: M.225 + I-15;
M.13225: M.226 + I-15; M.13226: M.227 + I-15; M.13227: M.228 + I-15; M.13228: M.229 + I-15;
M.13229: M.230 + I-15; M.13230: M.231 + I-15; M.13231: M.232 + I-15; M.13232: M.233 + I-15;
M.13233: M.234 + I-15; M.13234: M.235 + I-15; M.13235: M.236 + I-15; M.13236: M.237 + I-15;
M.13237: M.238 + I-15; M.13238: M.239 + I-15; M.13239: M.240 + I-15; M.13240: M.241 + I-15;
M.13241: M.242 + I-15; M.13242: M.243 + I-15; M.13243: M.244 + I-15; M.13244: M.245 + I-15;
M.13245: M.246 + I-15; M.13246: M.247 + I-15; M.13247: M.248 + I-15; M.13248: M.249 + I-15;
M.13249: M.250 + I-15; M.13250: M.251 + I-15; M.13251: M.252 + I-15; M.13252: M.253 + I-15;
M.13253: M.254 + I-15; M.13254: M.255 + I-15; M.13255: M.256 + I-15; M.13256: M.257 + I-15;
M.13257: M.258 + I-15; M.13258: M.259 + I-15; M.13259: M.260 + I-15; M.13260: M.261 + I-15;
M.13261: M.262 + I-15; M.13262: M.263 + I-15; M.13263: M.264 + I-15; M.13264: M.265 + I-15;
M.13265: M.266 + I-15; M.13266: M.267 + I-15; M.13267: M.268 + I-15; M.13268: M.269 + I-15;
M.13269: M.270 + I-15; M.13270: M.271 + I-15; M.13271: M.272 + I-15; M.13272: M.273 + I-15;
M.13273: M.274 + I-15; M.13274: M.275 + I-15; M.13275: M.276 + I-15; M.13276: M.277 + I-15;
M.13277: M.278 + I-15; M.13278: M.279 + I-15; M.13279: M.280 + I-15; M.13280: M.281 + I-15;
M.13281: M.282 + I-15; M.13282: M.283 + I-15; M.13283: M.284 + I-15; M.13284: M.285 + I-15;
M.13285: M.286 + I-15; M.13286: M.287 + I-15; M.13287: M.288 + I-15; M.13288: M.289 + I-15;
M.13289: M.290 + I-15; M.13290: M.291 + I-15; M.13291: M.292 + I-15; M.13292: M.293 + I-15;
M.13293: M.294 + I-15; M.13294: M.295 + I-15; M.13295: M.296 + I-15; M.13296: M.297 + I-15;
M.13297: M.298 + I-15; M.13298: M.299 + I-15; M.13299: M.300 + I-15; M.13300: M.301 + I-15;
M.13301: M.302 + I-15; M.13302: M.303 + I-15; M.13303: M.304 + I-15; M.13304: M.305 + I-15;
M.13305: M.306 + I-15; M.13306: M.307 + I-15; M.13307: M.308 + I-15; M.13308: M.309 + I-15;
M.13309: M.310 + I-15; M.13310: M.311 + I-15; M.13311: M.312 + I-15; M.13312: M.313 + I-15;
M.13313: M.314 + I-15; M.13314: M.315 + I-15; M.13315: M.316 + I-15; M.13316: M.317 + I-15;
M.13317: M.318 + I-15; M.13318: M.319 + I-15; M.13319: M.320 + I-15; M.13320: M.321 + I-15;
M.13321: M.322 + I-15; M.13322: M.323 + I-15; M.13323: M.324 + I-15; M.13324: M.325 + I-15;
M.13325: M.326 + I-15; M.13326: M.327 + I-15; M.13327: M.328 + I-15; M.13328: M.329 + I-15;
M.13329: M.330 + I-15; M.13330: M.331 + I-15; M.13331: M.332 + I-15; M.13332: M.333 + I-15;
M.13333: M.334 + I-15; M.13334: M.335 + I-15; M.13335: M.336 + I-15; M.13336: M.337 + I-15;
M.13337: M.338 + I-15; M.13338: M.339 + I-15; M.13339: M.340 + I-15; M.13340: M.341 + I-15;
M.13341: M.342 + I-15; M.13342: M.343 + I-15; M.13343: M.344 + I-15; M.13344: M.345 + I-15;
M.13345: M.346 + I-15; M.13346: M.347 + I-15; M.13347: M.348 + I-15; M.13348: M.349 + I-15;
M.13349: M.350 + I-15; M.13350: M.351 + I-15; M.13351: M.352 + I-15; M.13352: M.353 + I-15;
M.13353: M.354 + I-15; M.13354: M.355 + I-15; M.13355: M.356 + I-15; M.13356: M.357 + I-15;
M.13357: M.358 + I-15; M.13358: M.359 + I-15; M.13359: M.360 + I-15; M.13360: M.361 + I-15;
M.13361: M.362 + I-15; M.13362: M.363 + I-15; M.13363: M.364 + I-15; M.13364: M.365 + I-15;
M.13365: M.366 + I-15; M.13366: M.367 + I-15; M.13367: M.368 + I-15; M.13368: M.369 + I-15;
M.13369: M.370 + I-15; M.13370: M.371 + I-15; M.13371: M.372 + I-15; M.13372: M.373 + I-15;
M.13373: M.374 + I-15; M.13374: M.375 + I-15; M.13375: M.376 + I-15; M.13376: M.377 + I-15;
M.13377: M.378 + I-15; M.13378: M.379 + I-15; M.13379: M.380 + I-15; M.13380: M.381 + I-15;
M.13381: M.382 + I-15; M.13382: M.383 + I-15; M.13383: M.384 + I-15; M.13384: M.385 + I-15;
M.13385: M.386 + I-15; M.13386: M.387 + I-15; M.13387: M.388 + I-15; M.13388: M.389 + I-15;
M.13389: M.390 + I-15; M.13390: M.391 + I-15; M.13391: M.392 + I-15; M.13392: M.393 + I-15;
M.13393: M.394 + I-15; M.13394: M.395 + I-15; M.13395: M.396 + I-15; M.13396: M.397 + I-15;
M.13397: M.398 + I-15; M.13398: M.399 + I-15; M.13399: M.400 + I-15; M.13400: M.401 + I-15;
M.13401: M.402 + I-15; M.13402: M.403 + I-15; M.13403: M.404 + I-15; M.13404: M.405 + I-15;
M.13405: M.406 + I-15; M.13406: M.407 + I-15; M.13407: M.408 + I-15; M.13408: M.409 + I-15;
M.13409: M.410 + I-15; M.13410: M.411 + I-15; M.13411: M.412 + I-15; M.13412: M.413 + I-15;
M.13413: M.414 + I-15; M.13414: M.415 + I-15; M.13415: M.416 + I-15; M.13416: M.417 + I-15;
M.13417: M.418 + I-15; M.13418: M.419 + I-15; M.13419: M.420 + I-15; M.13420: M.421 + I-15;
M.13421: M.422 + I-15; M.13422: M.423 + I-15; M.13423: M.424 + I-15; M.13424: M.425 + I-15;
M.13425: M.426 + I-15; M.13426: M.427 + I-15; M.13427: M.428 + I-15; M.13428: M.429 + I-15;
M.13429: M.430 + I-15; M.13430: M.431 + I-15; M.13431: M.432 + I-15; M.13432: M.433 + I-15;
M.13433: M.434 + I-15; M.13434: M.435 + I-15; M.13435: M.436 + I-15; M.13436: M.437 + I-15;
M.13437: M.438 + I-15; M.13438: M.439 + I-15; M.13439: M.440 + I-15; M.13440: M.441 + I-15;
M.13441: M.442 + I-15; M.13442: M.443 + I-15; M.13443: M.444 + I-15; M.13444: M.445 + I-15;
M.13445: M.446 + I-15; M.13446: M.447 + I-15; M.13447: M.448 + I-15; M.13448: M.449 + I-15;
M.13449: M.450 + I-15.

In another embodiment, the present invention relates to ternary herbicidal mixtures M.14000 to M.14449 listed in Table M(o) below, comprising mixtures of the binary mixtures depicted in table M(a) and a third herbicide I-16.

TABLE M(o)
M.14000: M.1 + I-16; M.14001: M.2 + I-16; M.14002: M.3 + I-16; M.14003: M.4 + I-16;
M.14004: M.5 + I-16; M.14005: M.6 + I-16; M.14006: M.7 + I-16; M.14007: M.8 + I-16;
M.14008: M.9 + I-16; M.14009: M.10 + I-16; M.14010: M.11 + I-16; M.14011: M.12 + I-16;
M.14012: M.13 + I-16; M.14013: M.14 + I-16; M.14014: M.15 + I-16; M.14015: M.16 + I-16;
M.14016: M.17 + I-16; M.14017: M.18 + I-16; M.14018: M.19 + I-16; M.14019: M.20 + I-16;
M.14020: M.21 + I-16; M.14021: M.22 + I-16; M.14022: M.23 + I-16; M.14023: M.24 + I-16;
M.14024: M.25 + I-16; M.14025: M.26 + I-16; M.14026: M.27 + I-16; M.14027: M.28 + I-16;
M.14028: M.29 + I-16; M.14029: M.30 + I-16; M.14030: M.31 + I-16; M.14031: M.32 + I-16;
M.14032: M.33 + I-16; M.14033: M.34 + I-16; M.14034: M.35 + I-16; M.14035: M.36 + I-16;
M.14036: M.37 + I-16; M.14037: M.38 + I-16; M.14038: M.39 + I-16; M.14039: M.40 + I-16;
M.14040: M.41 + I-16; M.14041: M.42 + I-16; M.14042: M.43 + I-16; M.14043: M.44 + I-16;
M.14044: M.45 + I-16; M.14045: M.46 + I-16; M.14046: M.47 + I-16; M.14047: M.48 + I-16;
M.14048: M.49 + I-16; M.14049: M.50 + I-16; M.14050: M.51 + I-16; M.14051: M.52 + I-16;
M.14052: M.53 + I-16; M.14053: M.54 + I-16; M.14054: M.55 + I-16; M.14055: M.56 + I-16;
M.14056: M.57 + I-16; M.14057: M.58 + I-16; M.14058: M.59 + I-16; M.14059: M.60 + I-16;
M.14060: M.61 + I-16; M.14061: M.62 + I-16; M.14062: M.63 + I-16; M.14063: M.64 + I-16;
M.14064: M.65 + I-16; M.14065: M.66 + I-16; M.14066: M.67 + I-16; M.14067: M.68 + I-16;
M.14068: M.69 + I-16; M.14069: M.70 + I-16; M.14070: M.71 + I-16; M.14071: M.72 + I-16;
M.14072: M.73 + I-16; M.14073: M.74 + I-16; M.14074: M.75 + I-16; M.14075: M.76 + I-16;
M.14076: M.77 + I-16; M.14077: M.78 + I-16; M.14078: M.79 + I-16; M.14079: M.80 + I-16;
M.14080: M.81 + I-16; M.14081: M.82 + I-16; M.14082: M.83 + I-16; M.14083: M.84 + I-16;
M.14084: M.85 + I-16; M.14085: M.86 + I-16; M.14086: M.87 + I-16; M.14087: M.88 + I-16;
M.14088: M.89 + I-16; M.14089: M.90 + I-16; M.14090: M.91 + I-16; M.14091: M.92 + I-16;
M.14092: M.93 + I-16; M.14093: M.94 + I-16; M.14094: M.95 + I-16; M.14095: M.96 + I-16;
M.14096: M.97 + I-16; M.14097: M.98 + I-16; M.14098: M.99 + I-16; M.14099: M.100 + I-16;
M.14100: M.101 + I-16; M.14101: M.102 + I-16; M.14102: M.103 + I-16; M.14103: M.104 + I-16;
M.14104: M.105 + I-16; M.14105: M.106 + I-16; M.14106: M.107 + I-16; M.14107: M.108 + I-16;
M.14108: M.109 + I-16; M.14109: M.110 + I-16; M.14110: M.111 + I-16; M.14111: M.112 + I-16;
M.14112: M.113 + I-16; M.14113: M.114 + I-16; M.14114: M.115 + I-16; M.14115: M.116 + I-16;
M.14116: M.117 + I-16; M.14117: M.118 + I-16; M.14118: M.119 + I-16; M.14119: M.120 + I-16;
M.14120: M.121 + I-16; M.14121: M.122 + I-16; M.14122: M.123 + I-16; M.14123: M.124 + I-16;
M.14124: M.125 + I-16; M.14125: M.126 + I-16; M.14126: M.127 + I-16; M.14127: M.128 + I-16;
M.14128: M.129 + I-16; M.14129: M.130 + I-16; M.14130: M.131 + I-16; M.14131: M.132 + I-16;
M.14132: M.133 + I-16; M.14133: M.134 + I-16; M.14134: M.135 + I-16; M.14135: M.136 + I-16;
M.14136: M.137 + I-16; M.14137: M.138 + I-16; M.14138: M.139 + I-16; M.14139: M.140 + I-16;
M.14140: M.141 + I-16; M.14141: M.142 + I-16; M.14142: M.143 + I-16; M.14143: M.144 + I-16;
M.14144: M.145 + I-16; M.14145: M.146 + I-16; M.14146: M.147 + I-16; M.14147: M.148 + I-16;
M.14148: M.149 + I-16; M.14149: M.150 + I-16; M.14150: M.151 + I-16; M.14151: M.152 + I-16;
M.14152: M.153 + I-16; M.14153: M.154 + I-16; M.14154: M.155 + I-16; M.14155: M.156 + I-16;
M.14156: M.157 + I-16; M.14157: M.158 + I-16; M.14158: M.159 + I-16; M.14159: M.160 + I-16;
M.14160: M.161 + I-16; M.14161: M.162 + I-16; M.14162: M.163 + I-16; M.14163: M.164 + I-16;
M.14164: M.165 + I-16; M.14165: M.166 + I-16; M.14166: M.167 + I-16; M.14167: M.168 + I-16;
M.14168: M.169 + I-16; M.14169: M.170 + I-16; M.14170: M.171 + I-16; M.14171: M.172 + I-16;
M.14172: M.173 + I-16; M.14173: M.174 + I-16; M.14174: M.175 + I-16; M.14175: M.176 + I-16;
M.14176: M.177 + I-16; M.14177: M.178 + I-16; M.14178: M.179 + I-16; M.14179: M.180 + I-16;
M.14180: M.181 + I-16; M.14181: M.182 + I-16; M.14182: M.183 + I-16; M.14183: M.184 + I-16;
M.14184: M.185 + I-16; M.14185: M.186 + I-16; M.14186: M.187 + I-16; M.14187: M.188 + I-16;
M.14188: M.189 + I-16; M.14189: M.190 + I-16; M.14190: M.191 + I-16; M.14191: M.192 + I-16;
M.14192: M.193 + I-16; M.14193: M.194 + I-16; M.14194: M.195 + I-16; M.14195: M.196 + I-16;
M.14196: M.197 + I-16; M.14197: M.198 + I-16; M.14198: M.199 + I-16; M.14199: M.200 + I-16;
M.14200: M.201 + I-16; M.14201: M.202 + I-16; M.14202: M.203 + I-16; M.14203: M.204 + I-16;
M.14204: M.205 + I-16; M.14205: M.206 + I-16; M.14206: M.207 + I-16; M.14207: M.208 + I-16;
M.14208: M.209 + I-16; M.14209: M.210 + I-16; M.14210: M.211 + I-16; M.14211: M.212 + I-16;
M.14212: M.213 + I-16; M.14213: M.214 + I-16; M.14214: M.215 + I-16; M.14215: M.216 + I-16;
M.14216: M.217 + I-16; M.14217: M.218 + I-16; M.14218: M.219 + I-16; M.14219: M.220 + I-16;
M.14220: M.221 + I-16; M.14221: M.222 + I-16; M.14222: M.223 + I-16; M.14223: M.224 + I-16;
M.14224: M.225 + I-16; M.14225: M.226 + I-16; M.14226: M.227 + I-16; M.14227: M.228 + I-16;
M.14228: M.229 + I-16; M.14229: M.230 + I-16; M.14230: M.231 + I-16; M.14231: M.232 + I-16;
M.14232: M.233 + I-16; M.14233: M.234 + I-16; M.14234: M.235 + I-16; M.14235: M.236 + I-16;
M.14236: M.237 + I-16; M.14237: M.238 + I-16; M.14238: M.239 + I-16; M.14239: M.240 + I-16;
M.14240: M.241 + I-16; M.14241: M.242 + I-16; M.14242: M.243 + I-16; M.14243: M.244 + I-16;
M.14244: M.245 + I-16; M.14245: M.246 + I-16; M.14246: M.247 + I-16; M.14247: M.248 + I-16;
M.14248: M.249 + I-16; M.14249: M.250 + I-16; M.14250: M.251 + I-16; M.14251: M.252 + I-16;
M.14252: M.253 + I-16; M.14253: M.254 + I-16; M.14254: M.255 + I-16; M.14255: M.256 + I-16;
M.14256: M.257 + I-16; M.14257: M.258 + I-16; M.14258: M.259 + I-16; M.14259: M.260 + I-16;
M.14260: M.261 + I-16; M.14261: M.262 + I-16; M.14262: M.263 + I-16; M.14263: M.264 + I-16;
M.14264: M.265 + I-16; M.14265: M.266 + I-16; M.14266: M.267 + I-16; M.14267: M.268 + I-16;
M.14268: M.269 + I-16; M.14269: M.270 + I-16; M.14270: M.271 + I-16; M.14271: M.272 + I-16;
M.14272: M.273 + I-16; M.14273: M.274 + I-16; M.14274: M.275 + I-16; M.14275: M.276 + I-16;
M.14276: M.277 + I-16; M.14277: M.278 + I-16; M.14278: M.279 + I-16; M.14279: M.280 + I-16;
M.14280: M.281 + I-16; M.14281: M.282 + I-16; M.14282: M.283 + I-16; M.14283: M.284 + I-16;
M.14284: M.285 + I-16; M.14285: M.286 + I-16; M.14286: M.287 + I-16; M.14287: M.288 + I-16;
M.14288: M.289 + I-16; M.14289: M.290 + I-16; M.14290: M.291 + I-16; M.14291: M.292 + I-16;
M.14292: M.293 + I-16; M.14293: M.294 + I-16; M.14294: M.295 + I-16; M.14295: M.296 + I-16;
M.14296: M.297 + I-16; M.14297: M.298 + I-16; M.14298: M.299 + I-16; M.14299: M.300 + I-16;
M.14300: M.301 + I-16; M.14301: M.302 + I-16; M.14302: M.303 + I-16; M.14303: M.304 + I-16;
M.14304: M.305 + I-16; M.14305: M.306 + I-16; M.14306: M.307 + I-16; M.14307: M.308 + I-16;
M.14308: M.309 + I-16; M.14309: M.310 + I-16; M.14310: M.311 + I-16; M.14311: M.312 + I-16;
M.14312: M.313 + I-16; M.14313: M.314 + I-16; M.14314: M.315 + I-16; M.14315: M.316 + I-16;
M.14316: M.317 + I-16; M.14317: M.318 + I-16; M.14318: M.319 + I-16; M.14319: M.320 + I-16;
M.14320: M.321 + I-16; M.14321: M.322 + I-16; M.14322: M.323 + I-16; M.14323: M.324 + I-16;
M.14324: M.325 + I-16; M.14325: M.326 + I-16; M.14326: M.327 + I-16; M.14327: M.328 + I-16;
M.14328: M.329 + I-16; M.14329: M.330 + I-16; M.14330: M.331 + I-16; M.14331: M.332 + I-16;
M.14332: M.333 + I-16; M.14333: M.334 + I-16; M.14334: M.335 + I-16; M.14335: M.336 + I-16;
M.14336: M.337 + I-16; M.14337: M.338 + I-16; M.14338: M.339 + I-16; M.14339: M.340 + I-16;
M.14340: M.341 + I-16; M.14341: M.342 + I-16; M.14342: M.343 + I-16; M.14343: M.344 + I-16;
M.14344: M.345 + I-16; M.14345: M.346 + I-16; M.14346: M.347 + I-16; M.14347: M.348 + I-16;
M.14348: M.349 + I-16; M.14349: M.350 + I-16; M.14350: M.351 + I-16; M.14351: M.352 + I-16;
M.14352: M.353 + I-16; M.14353: M.354 + I-16; M.14354: M.355 + I-16; M.14355: M.356 + I-16;
M.14356: M.357 + I-16; M.14357: M.358 + I-16; M.14358: M.359 + I-16; M.14359: M.360 + I-16;
M.14360: M.361 + I-16; M.14361: M.362 + I-16; M.14362: M.363 + I-16; M.14363: M.364 + I-16;
M.14364: M.365 + I-16; M.14365: M.366 + I-16; M.14366: M.367 + I-16; M.14367: M.368 + I-16;
M.14368: M.369 + I-16; M.14369: M.370 + I-16; M.14370: M.371 + I-16; M.14371: M.372 + I-16;
M.14372: M.373 + I-16; M.14373: M.374 + I-16; M.14374: M.375 + I-16; M.14375: M.376 + I-16;
M.14376: M.377 + I-16; M.14377: M.378 + I-16; M.14378: M.379 + I-16; M.14379: M.380 + I-16;
M.14380: M.381 + I-16; M.14381: M.382 + I-16; M.14382: M.383 + I-16; M.14383: M.384 + I-16;
M.14384: M.385 + I-16; M.14385: M.386 + I-16; M.14386: M.387 + I-16; M.14387: M.388 + I-16;
M.14388: M.389 + I-16; M.14389: M.390 + I-16; M.14390: M.391 + I-16; M.14391: M.392 + I-16;
M.14392: M.393 + I-16; M.14393: M.394 + I-16; M.14394: M.395 + I-16; M.14395: M.396 + I-16;
M.14396: M.397 + I-16; M.14397: M.398 + I-16; M.14398: M.399 + I-16; M.14399: M.400 + I-16;
M.14400: M.401 + I-16; M.14401: M.402 + I-16; M.14402: M.403 + I-16; M.14403: M.404 + I-16;
M.14404: M.405 + I-16; M.14405: M.406 + I-16; M.14406: M.407 + I-16; M.14407: M.408 + I-16;
M.14408: M.409 + I-16; M.14409: M.410 + I-16; M.14410: M.411 + I-16; M.14411: M.412 + I-16;
M.14412: M.413 + I-16; M.14413: M.414 + I-16; M.14414: M.415 + I-16; M.14415: M.416 + I-16;
M.14416: M.417 + I-16; M.14417: M.418 + I-16; M.14418: M.419 + I-16; M.14419: M.420 + I-16;
M.14420: M.421 + I-16; M.14421: M.422 + I-16; M.14422: M.423 + I-16; M.14423: M.424 + I-16;
M.14424: M.425 + I-16; M.14425: M.426 + I-16; M.14426: M.427 + I-16; M.14427: M.428 + I-16;
M.14428: M.429 + I-16; M.14429: M.430 + I-16; M.14430: M.431 + I-16; M.14431: M.432 + I-16;
M.14432: M.433 + I-16; M.14433: M.434 + I-16; M.14434: M.435 + I-16; M.14435: M.436 + I-16;
M.14436: M.437 + I-16; M.14437: M.438 + I-16; M.14438: M.439 + I-16; M.14439: M.440 + I-16;
M.14440: M.441 + I-16; M.14441: M.442 + I-16; M.14442: M.443 + I-16; M.14443: M.444 + I-16;
M.14444: M.445 + I-16; M.14445: M.446 + I-16; M.14446: M.447 + I-16; M.14447: M.448 + I-16;
M.14448: M.449 + I-16; M.14449: M.450 + I-16.

In another embodiment, the present invention relates to ternary herbicidal mixtures M.15000 to M.15449 listed in Table M(p) below, comprising mixtures of the binary mixtures depicted in table M(a) and a third herbicide I-17.

TABLE M(p)
M.15000: M.1 + I-17; M.15001: M.2 + I-17; M.15002: M.3 + I-17; M.15003: M.4 + I-17;
M.15004: M.5 + I-17; M.15005: M.6 + I-17; M.15006: M.7 + I-17; M.15007: M.8 + I-17;
M.15008: M.9 + I-17; M.15009: M.10 + I-17; M.15010: M.11 + I-17; M.1011: M.12 + I-17;
M.15012: M.13 + I-17; M.15013: M.14 + I-17; M.15014: M.15 + I-17; M.15015: M.16 + I-17;
M.15016: M.17 + I-17; M.15017: M.18 + I-17; M.15018: M.19 + I-17; M.15019: M.20 + I-17;
M.15020: M.21 + I-17; M.15021: M.22 + I-17; M.15022: M.23 + I-17; M.15023: M.24 + I-17;
M.15024: M.25 + I-17; M.15025: M.26 + I-17; M.15026: M.27 + I-17; M.15027: M.28 + I-17;
M.15028: M.29 + I-17; M.15029: M.30 + I-17; M.15030: M.31 + I-17; M.15031: M.32 + I-17;
M.15032: M.33 + I-17; M.15033: M.34 + I-17; M.15034: M.35 + I-17; M.15035: M.36 + I-17;
M.15036: M.37 + I-17; M.15037: M.38 + I-17; M.15038: M.39 + I-17; M.15039: M.40 + I-17;
M.15040: M.41 + I-17; M.15041: M.42 + I-17; M.15042: M.43 + I-17; M.15043: M.44 + I-17;
M.15044: M.45 + I-17; M.15045: M.46 + I-17; M.15046: M.47 + I-17; M.15047: M.48 + I-17;
M.15048: M.49 + I-17; M.15049: M.50 + I-17; M.15050: M.51 + I-17; M.15051: M.52 + I-17;
M.15052: M.53 + I-17; M.15053: M.54 + I-17; M.15054: M.55 + I-17; M.15055: M.56 + I-17;
M.15056: M.57 + I-17; M.15057: M.58 + I-17; M.15058: M.59 + I-17; M.15059: M.60 + I-17;
M.15060: M.61 + I-17; M.15061: M.62 + I-17; M.15062: M.63 + I-17; M.15063: M.64 + I-17;
M.15064: M.65 + I-17; M.15065: M.66 + I-17; M.15066: M.67 + I-17; M.15067: M.68 + I-17;
M.15068: M.69 + I-17; M.15069: M.70 + I-17; M.15070: M.71 + I-17; M.15071: M.72 + I-17;
M.15072: M.73 + I-17; M.15073: M.74 + I-17; M.15074: M.75 + I-17; M.15075: M.76 + I-17;
M.15076: M.77 + I-17; M.15077: M.78 + I-17; M.15078: M.79 + I-17; M.15079: M.80 + I-17;
M.15080: M.81 + I-17; M.15081: M.82 + I-17; M.15082: M.83 + I-17; M.15083: M.84 + I-17;
M.15084: M.85 + I-17; M.15085: M.86 + I-17; M.15086: M.87 + I-17; M.15087: M.88 + I-17;
M.15088: M.89 + I-17; M.15089: M.90 + I-17; M.15090: M.91 + I-17; M.15091: M.92 + I-17;
M.15092: M.93 + I-17; M.15093: M.94 + I-17; M.15094: M.95 + I-17; M.15095: M.96 + I-17;
M.15096: M.97 + I-17; M.15097: M.98 + I-17; M.15098: M.99 + I-17; M.15099: M.100 + I-17;
M.15100: M.101 + I-17; M.15101: M.102 + I-17; M.15102: M.103 + I-17; M.15103: M.104 + I-17;
M.15104: M.105 + I-17; M.15105: M.106 + I-17; M.15106: M.107 + I-17; M.15107: M.108 + I-17;
M.15108: M.109 + I-17; M.15109: M.110 + I-17; M.15110: M.111 + I-17; M.15111: M.112 + I-17;
M.15112: M.113 + I-17; M.15113: M.114 + I-17; M.15114: M.115 + I-17; M.11515: M.116 + I-17;
M.15116: M.117 + I-17; M.15117: M.118 + I-17; M.15118: M.119 + I-17; M.15119: M.120 + I-17;
M.15120: M.121 + I-17; M.15121: M.122 + I-17; M.15122: M.123 + I-17; M.15123: M.124 + I-17;
M.15124: M.125 + I-17; M.15125: M.126 + I-17; M.15126: M.127 + I-17; M.15127: M.128 + I-17;
M.15128: M.129 + I-17; M.15129: M.130 + I-17; M.15130: M.131 + I-17; M.15131: M.132 + I-17;
M.15132: M.133 + I-17; M.15133: M.134 + I-17; M.15134: M.135 + I-17; M.15135: M.136 + I-17;
M.15136: M.137 + I-17; M.15137: M.138 + I-17; M.15138: M.139 + I-17; M.15139: M.140 + I-17;
M.15140: M.141 + I-17; M.15141: M.142 + I-17; M.15142: M.143 + I-17; M.15143: M.144 + I-17;
M.15144: M.145 + I-17; M.15145: M.146 + I-17; M.15146: M.147 + I-17; M.15147: M.148 + I-17;
M.15148: M.149 + I-17; M.15149: M.150 + I-17; M.15150: M.151 + I-17; M.15151: M.152 + I-17;
M.15152: M.153 + I-17; M.15153: M.154 + I-17; M.15154: M.155 + I-17; M.15155: M.156 + I-17;
M.15156: M.157 + I-17; M.15157: M.158 + I-17; M.15158: M.159 + I-17; M.15159: M.160 + I-17;
M.15160: M.161 + I-17; M.15161: M.162 + I-17; M.15162: M.163 + I-17; M.15163: M.164 + I-17;
M.15164: M.165 + I-17; M.15165: M.166 + I-17; M.15166: M.167 + I-17; M.15167: M.168 + I-17;
M.15168: M.169 + I-17; M.15169: M.170 + I-17; M.15170: M.171 + I-17; M.15171: M.172 + I-17;
M.15172: M.173 + I-17; M.15173: M.174 + I-17; M.15174: M.175 + I-17; M.15175: M.176 + I-17;
M.15176: M.177 + I-17; M.15177: M.178 + I-17; M.15178: M.179 + I-17; M.15179: M.180 + I-17;
M.15180: M.181 + I-17; M.15181: M.182 + I-17; M.15182: M.183 + I-17; M.15183: M.184 + I-17;
M.15184: M.185 + I-17; M.15185: M.186 + I-17; M.15186: M.187 + I-17; M.15187: M.188 + I-17;
M.15188: M.189 + I-17; M.15189: M.190 + I-17; M.15190: M.191 + I-17; M.15191: M.192 + I-17;
M.15192: M.193 + I-17; M.15193: M.194 + I-17; M.15194: M.195 + I-17; M.15195: M.196 + I-17;
M.15196: M.197 + I-17; M.15197: M.198 + I-17; M.15198: M.199 + I-17; M.15199: M.200 + I-17;
M.15200: M.201 + I-17; M.15201: M.202 + I-17; M.15202: M.203 + I-17; M.15203: M.204 + I-17;
M.15204: M.205 + I-17; M.15205: M.206 + I-17; M.15206: M.207 + I-17; M.15207: M.208 + I-17;
M.15208: M.209 + I-17; M.15209: M.210 + I-17; M.15210: M.211 + I-17; M.15211: M.212 + I-17;
M.15212: M.213 + I-17; M.15213: M.214 + I-17; M.15214: M.215 + I-17; M.15215: M.216 + I-17;
M.15216: M.217 + I-17; M.15217: M.218 + I-17; M.15218: M.219 + I-17; M.15219: M.220 + I-17;
M.15220: M.221 + I-17; M.15221: M.222 + I-17; M.15222: M.223 + I-17; M.15223: M.224 + I-17;
M.15224: M.225 + I-17; M.15225: M.226 + I-17; M.15226: M.227 + I-17; M.15227: M.228 + I-17;
M.15228: M.229 + I-17; M.15229: M.230 + I-17; M.15230: M.231 + I-17; M.15231: M.232 + I-17;
M.15232: M.233 + I-17; M.15233: M.234 + I-17; M.15234: M.235 + I-17; M.15235: M.236 + I-17;
M.15236: M.237 + I-17; M.15237: M.238 + I-17; M.15238: M.239 + I-17; M.15239: M.240 + I-17;
M.15240: M.241 + I-17; M.15241: M.242 + I-17; M.15242: M.243 + I-17; M.15243: M.244 + I-17;
M.15244: M.245 + I-17; M.15245: M.246 + I-17; M.15246: M.247 + I-17; M.15247: M.248 + I-17;
M.15248: M.249 + I-17; M.15249: M.250 + I-17; M.15250: M.251 + I-17; M.15251: M.252 + I-17;
M.15252: M.253 + I-17; M.15253: M.254 + I-17; M.15254: M.255 + I-17; M.15255: M.256 + I-17;
M.15256: M.257 + I-17; M.15257: M.258 + I-17; M.15258: M.259 + I-17; M.15259: M.260 + I-17;
M.15260: M.261 + I-17; M.15261: M.262 + I-17; M.15262: M.263 + I-17; M.15263: M.264 + I-17;
M.15264: M.265 + I-17; M.15265: M.266 + I-17; M.15266: M.267 + I-17; M.15267: M.268 + I-17;
M.15268: M.269 + I-17; M.15269: M.270 + I-17; M.15270: M.271 + I-17; M.15271: M.272 + I-17;
M.15272: M.273 + I-17; M.15273: M.274 + I-17; M.15274: M.275 + I-17; M.15275: M.276 + I-17;
M.15276: M.277 + I-17; M.15277: M.278 + I-17; M.15278: M.279 + I-17; M.15279: M.280 + I-17;
M.15280: M.281 + I-17; M.15281: M.282 + I-17; M.15282: M.283 + I-17; M.15283: M.284 + I-17;
M.15284: M.285 + I-17; M.15285: M.286 + I-17; M.15286: M.287 + I-17; M.15287: M.288 + I-17;
M.15288: M.289 + I-17; M.15289: M.290 + I-17; M.15290: M.291 + I-17; M.15291: M.292 + I-17;
M.15292: M.293 + I-17; M.15293: M.294 + I-17; M.15294: M.295 + I-17; M.15295: M.296 + I-17;
M.15296: M.297 + I-17; M.15297: M.298 + I-17; M.15298: M.299 + I-17; M.15299: M.300 + I-17;
M.15300: M.301 + I-17; M.15301: M.302 + I-17; M.15302: M.303 + I-17; M.15303: M.304 + I-17;
M.15304: M.305 + I-17; M.15305: M.306 + I-17; M.15306: M.307 + I-17; M.15307: M.308 + I-17;
M.15308: M.309 + I-17; M.15309: M.310 + I-17; M.15310: M.311 + I-17; M.15311: M.312 + I-17;
M.15312: M.313 + I-17; M.15313: M.314 + I-17; M.15314: M.315 + I-17; M.15315: M.316 + I-17;
M.15316: M.317 + I-17; M.15317: M.318 + I-17; M.15318: M.319 + I-17; M.15319: M.320 + I-17;
M.15320: M.321 + I-17; M.15321: M.322 + I-17; M.15322: M.323 + I-17; M.15323: M.324 + I-17;
M.15324: M.325 + I-17; M.15325: M.326 + I-17; M.15326: M.327 + I-17; M.15327: M.328 + I-17;
M.15328: M.329 + I-17; M.15329: M.330 + I-17; M.15330: M.331 + I-17; M.15331: M.332 + I-17;
M.15332: M.333 + I-17; M.15333: M.334 + I-17; M.15334: M.335 + I-17; M.15335: M.336 + I-17;
M.15336: M.337 + I-17; M.15337: M.338 + I-17; M.15338: M.339 + I-17; M.15339: M.340 + I-17;
M.15340: M.341 + I-17; M.15341: M.342 + I-17; M.15342: M.343 + I-17; M.15343: M.344 + I-17;
M.15344: M.345 + I-17; M.15345: M.346 + I-17; M.15346: M.347 + I-17; M.15347: M.348 + I-17;
M.15348: M.349 + I-17; M.15349: M.350 + I-17; M.15350: M.351 + I-17; M.15351: M.352 + I-17;
M.15352: M.353 + I-17; M.15353: M.354 + I-17; M.15354: M.355 + I-17; M.15355: M.356 + I-17;
M.15356: M.357 + I-17; M.15357: M.358 + I-17; M.15358: M.359 + I-17; M.15359: M.360 + I-17;
M.15360: M.361 + I-17; M.15361: M.362 + I-17; M.15362: M.363 + I-17; M.15363: M.364 + I-17;
M.15364: M.365 + I-17; M.15365: M.366 + I-17; M.15366: M.367 + I-17; M.15367: M.368 + I-17;
M.15368: M.369 + I-17; M.15369: M.370 + I-17; M.15370: M.371 + I-17; M.15371: M.372 + I-17;
M.15372: M.373 + I-17; M.15373: M.374 + I-17; M.15374: M.375 + I-17; M.15375: M.376 + I-17;
M.15376: M.377 + I-17; M.15377: M.378 + I-17; M.15378: M.379 + I-17; M.15379: M.380 + I-17;
M.15380: M.381 + I-17; M.15381: M.382 + I-17; M.15382: M.383 + I-17; M.15383: M.384 + I-17;
M.15384: M.385 + I-17; M.15385: M.386 + I-17; M.15386: M.387 + I-17; M.15387: M.388 + I-17;
M.15388: M.389 + I-17; M.15389: M.390 + I-17; M.15390: M.391 + I-17; M.15391: M.392 + I-17;
M.15392: M.393 + I-17; M.15393: M.394 + I-17; M.15394: M.395 + I-17; M.15395: M.396 + I-17;
M.15396: M.397 + I-17; M.15397: M.398 + I-17; M.15398: M.399 + I-17; M.15399: M.400 + I-17;
M.15400: M.401 + I-17; M.15401: M.402 + I-17; M.15402: M.403 + I-17; M.15403: M.404 + I-17;
M.15404: M.405 + I-17; M.15405: M.406 + I-17; M.15406: M.407 + I-17; M.15407: M.408 + I-17;
M.15408: M.409 + I-17; M.15409: M.410 + I-17; M.15410: M.411 + I-17; M.15411: M.412 + I-17;
M.15412: M.413 + I-17; M.15413: M.414 + I-17; M.15414: M.415 + I-17; M.15415: M.416 + I-17;
M.15416: M.417 + I-17; M.15417: M.418 + I-17; M.15418: M.419 + I-17; M.15419: M.420 + I-17;
M.15420: M.421 + I-17; M.15421: M.422 + I-17; M.15422: M.423 + I-17; M.15423: M.424 + I-17;
M.15424: M.425 + I-17; M.15425: M.426 + I-17; M.15426: M.427 + I-17; M.15427: M.428 + I-17;
M.15428: M.429 + I-17; M.15429: M.430 + I-17; M.15430: M.431 + I-17; M.15431: M.432 + I-17;
M.15432: M.433 + I-17; M.15433: M.434 + I-17; M.15434: M.435 + I-17; M.15435: M.436 + I-17;
M.15436: M.437 + I-17; M.15437: M.438 + I-17; M.15438: M.439 + I-17; M.15439: M.440 + I-17;
M.15440: M.441 + I-17; M.15441: M.442 + I-17; M.15442: M.443 + I-17; M.15443: M.444 + I-17;
M.15444: M.445 + I-17; M.15445: M.446 + I-17; M.15446: M.447 + I-17; M.15447: M.448 + I-17;
M.15448: M.449 + I-17; M.15449: M.450 + I-17.

In another embodiment, the present invention relates to ternary herbicidal mixtures M.16000 to M.16449 listed in Table M(q) below, comprising mixtures of the binary mixtures depicted in table M(a) and a third herbicide I-18.

TABLE M(q)
M.16000: M.1 + I-18; M.16001: M.2 + I-18; M.16002: M.3 + I-18; M.16003: M.4 + I-18;
M.16004: M.5 + I-18; M.16005: M.6 + I-18; M.16006: M.7 + I-18; M.16007: M.8 + I-18;
M.16008: M.9 + I-18; M.16009: M.10 + I-18; M.16010: M.11 + I-18; M.16011: M.12 + I-18;
M.16012: M.13 + I-18; M.16013: M.14 + I-18; M.16014: M.15 + I-18; M.16015: M.16 + I-18;
M.16016: M.17 + I-18; M.16017: M.18 + I-18; M.16018: M.19 + I-18; M.16019: M.20 + I-18;
M.16020: M.21 + I-18; M.16021: M.22 + I-18; M.16022: M.23 + I-18; M.16023: M.24 + I-18;
M.16024: M.25 + I-18; M.16025: M.26 + I-18; M.16026: M.27 + I-18; M.16027: M.28 + I-18;
M.16028: M.29 + I-18; M.16029: M.30 + I-18; M.16030: M.31 + I-18; M.16031: M.32 + I-18;
M.16032: M.33 + I-18; M.16033: M.34 + I-18; M.16034: M.35 + I-18; M.16035: M.36 + I-18;
M.16036: M.37 + I-18; M.16037: M.38 + I-18; M.16038: M.39 + I-18; M.16039: M.40 + I-18;
M.16040: M.41 + I-18; M.16041: M.42 + I-18; M.16042: M.43 + I-18; M.16043: M.44 + I-18;
M.16044: M.45 + I-18; M.16045: M.46 + I-18; M.16046: M.47 + I-18; M.16047: M.48 + I-18;
M.16048: M.49 + I-18; M.16049: M.50 + I-18; M.16050: M.51 + I-18; M.16051: M.52 + I-18;
M.16052: M.53 + I-18; M.16053: M.54 + I-18; M.16054: M.55 + I-18; M.16055: M.56 + I-18;
M.16056: M.57 + I-18; M.16057: M.58 + I-18; M.16058: M.59 + I-18; M.16059: M.60 + I-18;
M.16060: M.61 + I-18; M.16061: M.62 + I-18; M.16062: M.63 + I-18; M.16063: M.64 + I-18;
M.16064: M.65 + I-18; M.16065: M.66 + I-18; M.16066: M.67 + I-18; M.16067: M.68 + I-18;
M.16068: M.69 + I-18; M.16069: M.70 + I-18; M.16070: M.71 + I-18; M.16071: M.72 + I-18;
M.16072: M.73 + I-18; M.16073: M.74 + I-18; M.16074: M.75 + I-18; M.16075: M.76 + I-18;
M.16076: M.77 + I-18; M.16077: M.78 + I-18; M.16078: M.79 + I-18; M.16079: M.80 + I-18;
M.16080: M.81 + I-18; M.16081: M.82 + I-18; M.16082: M.83 + I-18; M.16083: M.84 + I-18;
M.16084: M.85 + I-18; M.16085: M.86 + I-18; M.16086: M.87 + I-18; M.16087: M.88 + I-18;
M.16088: M.89 + I-18; M.16089: M.90 + I-18; M.16090: M.91 + I-18; M.16091: M.92 + I-18;
M.16092: M.93 + I-18; M.16093: M.94 + I-18; M.16094: M.95 + I-18; M.16095: M.96 + I-18;
M.16096: M.97 + I-18; M.16097: M.98 + I-18; M.16098: M.99 + I-18; M.16099: M.100 + I-18;
M.16100: M.101 + I-18; M.16101: M.102 + I-18; M.16102: M.103 + I-18; M.16103: M.104 + I-18;
M.16104: M.105 + I-18; M.16105: M.106 + I-18; M.16106: M.107 + I-18; M.16107: M.108 + I-18;
M.16108: M.109 + I-18; M.16109: M.110 + I-18; M.16110: M.111 + I-18; M.16111: M.112 + I-18;
M.16112: M.113 + I-18; M.16113: M.114 + I-18; M.16114: M.115 + I-18; M.16115: M.116 + I-18;
M.16116: M.117 + I-18; M.16117: M.118 + I-18; M.16118: M.119 + I-18; M.16119: M.120 + I-18;
M.16120: M.121 + I-18; M.16121: M.122 + I-18; M.16122: M.123 + I-18; M.16123: M.124 + I-18;
M.16124: M.125 + I-18; M.16125: M.126 + I-18; M.16126: M.127 + I-18; M.16127: M.128 + I-18;
M.16128: M.129 + I-18; M.16129: M.130 + I-18; M.16130: M.131 + I-18; M.16131: M.132 + I-18;
M.16132: M.133 + I-18; M.16133: M.134 + I-18; M.16134: M.135 + I-18; M.16135: M.136 + I-18;
M.16136: M.137 + I-18; M.16137: M.138 + I-18; M.16138: M.139 + I-18; M.16139: M.140 + I-18;
M.16140: M.141 + I-18; M.16141: M.142 + I-18; M.16142: M.143 + I-18; M.16143: M.144 + I-18;
M.16144: M.145 + I-18; M.16145: M.146 + I-18; M.16146: M.147 + I-18; M.16147: M.148 + I-18;
M.16148: M.149 + I-18; M.16149: M.150 + I-18; M.16150: M.151 + I-18; M.16151: M.152 + I-18;
M.16152: M.153 + I-18; M.16153: M.154 + I-18; M.16154: M.155 + I-18; M.16155: M.156 + I-18;
M.16156: M.157 + I-18; M.16157: M.158 + I-18; M.16158: M.159 + I-18; M.16159: M.160 + I-18;
M.16160: M.161 + I-18; M.16161: M.162 + I-18; M.16162: M.163 + I-18; M.16163: M.164 + I-18;
M.16164: M.165 + I-18; M.16165: M.166 + I-18; M.16166: M.167 + I-18; M.16167: M.168 + I-18;
M.16168: M.169 + I-18; M.16169: M.170 + I-18; M.16170: M.171 + I-18; M.16171: M.172 + I-18;
M.16172: M.173 + I-18; M.16173: M.174 + I-18; M.16174: M.175 + I-18; M.16175: M.176 + I-18;
M.16176: M.177 + I-18; M.16177: M.178 + I-18; M.16178: M.179 + I-18; M.16179: M.180 + I-18;
M.16180: M.181 + I-18; M.16181: M.182 + I-18; M.16182: M.183 + I-18; M.16183: M.184 + I-18;
M.16184: M.185 + I-18; M.16185: M.186 + I-18; M.16186: M.187 + I-18; M.16187: M.188 + I-18;
M.16188: M.189 + I-18; M.16189: M.190 + I-18; M.16190: M.191 + I-18; M.16191: M.192 + I-18;
M.16192: M.193 + I-18; M.16193: M.194 + I-18; M.16194: M.195 + I-18; M.16195: M.196 + I-18;
M.16196: M.197 + I-18; M.16197: M.198 + I-18; M.16198: M.199 + I-18; M.16199: M.200 + I-18;
M.16200: M.201 + I-18; M.16201: M.202 + I-18; M.16202: M.203 + I-18; M.16203: M.204 + I-18;
M.16204: M.205 + I-18; M.16205: M.206 + I-18; M.16206: M.207 + I-18; M.16207: M.208 + I-18;
M.16208: M.209 + I-18; M.16209: M.210 + I-18; M.16210: M.211 + I-18; M.16211: M.212 + I-18;
M.16212: M.213 + I-18; M.16213: M.214 + I-18; M.16214: M.215 + I-18; M.16215: M.216 + I-18;
M.16216: M.217 + I-18; M.16217: M.218 + I-18; M.16218: M.219 + I-18; M.16219: M.220 + I-18;
M.16220: M.221 + I-18; M.16221: M.222 + I-18; M.16222: M.223 + I-18; M.16223: M.224 + I-18;
M.16224: M.225 + I-18; M.16225: M.226 + I-18; M.16226: M.227 + I-18; M.16227: M.228 + I-18;
M.16228: M.229 + I-18; M.16229: M.230 + I-18; M.16230: M.231 + I-18; M.16231: M.232 + I-18;
M.16232: M.233 + I-18; M.16233: M.234 + I-18; M.16234: M.235 + I-18; M.16235: M.236 + I-18;
M.16236: M.237 + I-18; M.16237: M.238 + I-18; M.16238: M.239 + I-18; M.16239: M.240 + I-18;
M.16240: M.241 + I-18; M.16241: M.242 + I-18; M.16242: M.243 + I-18; M.16243: M.244 + I-18;
M.16244: M.245 + I-18; M.16245: M.246 + I-18; M.16246: M.247 + I-18; M.16247: M.248 + I-18;
M.16248: M.249 + I-18; M.16249: M.250 + I-18; M.16250: M.251 + I-18; M.16251: M.252 + I-18;
M.16252: M.253 + I-18; M.16253: M.254 + I-18; M.16254: M.255 + I-18; M.16255: M.256 + I-18;
M.16256: M.257 + I-18; M.16257: M.258 + I-18; M.16258: M.259 + I-18; M.16259: M.260 + I-18;
M.16260: M.261 + I-18; M.16261: M.262 + I-18; M.16262: M.263 + I-18; M.16263: M.264 + I-18;
M.16264: M.265 + I-18; M.16265: M.266 + I-18; M.16266: M.267 + I-18; M.16267: M.268 + I-18;
M.16268: M.269 + I-18; M.16269: M.270 + I-18; M.16270: M.271 + I-18; M.16271: M.272 + I-18;
M.16272: M.273 + I-18; M.16273: M.274 + I-18; M.16274: M.275 + I-18; M.16275: M.276 + I-18;
M.16276: M.277 + I-18; M.16277: M.278 + I-18; M.16278: M.279 + I-18; M.16279: M.280 + I-18;
M.16280: M.281 + I-18; M.16281: M.282 + I-18; M.16282: M.283 + I-18; M.16283: M.284 + I-18;
M.16284: M.285 + I-18; M.16285: M.286 + I-18; M.16286: M.287 + I-18; M.16287: M.288 + I-18;
M.16288: M.289 + I-18; M.16289: M.290 + I-18; M.16290: M.291 + I-18; M.16291: M.292 + I-18;
M.16292: M.293 + I-18; M.16293: M.294 + I-18; M.16294: M.295 + I-18; M.16295: M.296 + I-18;
M.16296: M.297 + I-18; M.16297: M.298 + I-18; M.16298: M.299 + I-18; M.16299: M.300 + I-18;
M.16300: M.301 + I-18; M.16301: M.302 + I-18; M.16302: M.303 + I-18; M.16303: M.304 + I-18;
M.16304: M.305 + I-18; M.16305: M.306 + I-18; M.16306: M.307 + I-18; M.16307: M.308 + I-18;
M.16308: M.309 + I-18; M.16309: M.310 + I-18; M.16310: M.311 + I-18; M.16311: M.312 + I-18;
M.16312: M.313 + I-18; M.16313: M.314 + I-18; M.16314: M.315 + I-18; M.16315: M.316 + I-18;
M.16316: M.317 + I-18; M.16317: M.318 + I-18; M.16318: M.319 + I-18; M.16319: M.320 + I-18;
M.16320: M.321 + I-18; M.16321: M.322 + I-18; M.16322: M.323 + I-18; M.16323: M.324 + I-18;
M.16324: M.325 + I-18; M.16325: M.326 + I-18; M.16326: M.327 + I-18; M.16327: M.328 + I-18;
M.16328: M.329 + I-18; M.16329: M.330 + I-18; M.16330: M.331 + I-18; M.16331: M.332 + I-18;
M.16332: M.333 + I-18; M.16333: M.334 + I-18; M.16334: M.335 + I-18; M.16335: M.336 + I-18;
M.16336: M.337 + I-18; M.16337: M.338 + I-18; M.16338: M.339 + I-18; M.16339: M.340 + I-18;
M.16340: M.341 + I-18; M.16341: M.342 + I-18; M.16342: M.343 + I-18; M.16343: M.344 + I-18;
M.16344: M.345 + I-18; M.16345: M.346 + I-18; M.16346: M.347 + I-18; M.16347: M.348 + I-18;
M.16348: M.349 + I-18; M.16349: M.350 + I-18; M.16350: M.351 + I-18; M.16351: M.352 + I-18;
M.16352: M.353 + I-18; M.16353: M.354 + I-18; M.16354: M.355 + I-18; M.16355: M.356 + I-18;
M.16356: M.357 + I-18; M.16357: M.358 + I-18; M.16358: M.359 + I-18; M.16359: M.360 + I-18;
M.16360: M.361 + I-18; M.16361: M.362 + I-18; M.16362: M.363 + I-18; M.16363: M.364 + I-18;
M.16364: M.365 + I-18; M.16365: M.366 + I-18; M.16366: M.367 + I-18; M.16367: M.368 + I-18;
M.16368: M.369 + I-18; M.16369: M.370 + I-18; M.16370: M.371 + I-18; M.16371: M.372 + I-18;
M.16372: M.373 + I-18; M.16373: M.374 + I-18; M.16374: M.375 + I-18; M.16375: M.376 + I-18;
M.16376: M.377 + I-18; M.16377: M.378 + I-18; M.16378: M.379 + I-18; M.16379: M.380 + I-18;
M.16380: M.381 + I-18; M.16381: M.382 + I-18; M.16382: M.383 + I-18; M.16383: M.384 + I-18;
M.16384: M.385 + I-18; M.16385: M.386 + I-18; M.16386: M.387 + I-18; M.16387: M.388 + I-18;
M.16388: M.389 + I-18; M.16389: M.390 + I-18; M.16390: M.391 + I-18; M.16391: M.392 + I-18;
M.16392: M.393 + I-18; M.16393: M.394 + I-18; M.16394: M.395 + I-18; M.16395: M.396 + I-18;
M.16396: M.397 + I-18; M.16397: M.398 + I-18; M.16398: M.399 + I-18; M.16399: M.400 + I-18;
M.16400: M.401 + I-18; M.16401: M.402 + I-18; M.16402: M.403 + I-18; M.16403: M.404 + I-18;
M.16404: M.405 + I-18; M.16405: M.406 + I-18; M.16406: M.407 + I-18; M.16407: M.408 + I-18;
M.16408: M.409 + I-18; M.16409: M.410 + I-18; M.16410: M.411 + I-18; M.16411: M.412 + I-18;
M.16412: M.413 + I-18; M.16413: M.414 + I-18; M.16414: M.415 + I-18; M.16415: M.416 + I-18;
M.16416: M.417 + I-18; M.16417: M.418 + I-18; M.16418: M.419 + I-18; M.16419: M.420 + I-18;
M.16420: M.421 + I-18; M.16421: M.422 + I-18; M.16422: M.423 + I-18; M.16423: M.424 + I-18;
M.16424: M.425 + I-18; M.16425: M.426 + I-18; M.16426: M.427 + I-18; M.16427: M.428 + I-18;
M.16428: M.429 + I-18; M.16429: M.430 + I-18; M.16430: M.431 + I-18; M.16431: M.432 + I-18;
M.16432: M.433 + I-18; M.16433: M.434 + I-18; M.16434: M.435 + I-18; M.16435: M.436 + I-18;
M.16436: M.437 + I-18; M.16437: M.438 + I-18; M.16438: M.439 + I-18; M.16439: M.440 + I-18;
M.16440: M.441 + I-18; M.16441: M.442 + I-18; M.16442: M.443 + I-18; M.16443: M.444 + I-18;
M.16444: M.445 + I-18; M.16445: M.446 + I-18; M.16446: M.447 + I-18; M.16447: M.448 + I-18;
M.16448: M.449 + I-18; M.16449: M.450 + I-18.

In another embodiment, the present invention relates to ternary herbicidal mixtures M.17000 to M.17449 listed in Table M(r) below, comprising mixtures of the binary mixtures depicted in table M(a) and a third herbicide I-19.

TABLE M(r)
M.17000: M.1 + I-19; M.17001: M.2 + I-19; M.17002: M.3 + I-19; M.17003: M.4 + I-19;
M.17004: M.5 + I-19; M.17005: M.6 + I-19; M.17006: M.7 + I-19; M.17007: M.8 + I-19;
M.17008: M.9 + I-19; M.17009: M.10 + I-19; M.17010: M.11 + I-19; M.17011: M.12 + I-19;
M.17012: M.13 + I-19; M.17013: M.14 + I-19; M.17014: M.15 + I-19; M.17015: M.16 + I-19;
M.17016: M.17 + I-19; M.17017: M.18 + I-19; M.17018: M.19 + I-19; M.17019: M.20 + I-19;
M.17020: M.21 + I-19; M.17021: M.22 + I-19; M.17022: M.23 + I-19; M.17023: M.24 + I-19;
M.17024: M.25 + I-19; M.17025: M.26 + I-19; M.17026: M.27 + I-19; M.17027: M.28 + I-19;
M.17028: M.29 + I-19; M.17029: M.30 + I-19; M.17030: M.31 + I-19; M.17031: M.32 + I-19;
M.17032: M.33 + I-19; M.17033: M.34 + I-19; M.17034: M.35 + I-19; M.17035: M.36 + I-19;
M.17036: M.37 + I-19; M.17037: M.38 + I-19; M.17038: M.39 + I-19; M.17039: M.40 + I-19;
M.17040: M.41 + I-19; M.17041: M.42 + I-19; M.17042: M.43 + I-19; M.17043: M.44 + I-19;
M.17044: M.45 + I-19; M.17045: M.46 + I-19; M.17046: M.47 + I-19; M.17047: M.48 + I-19;
M.17048: M.49 + I-19; M.17049: M.50 + I-19; M.17050: M.51 + I-19; M.17051: M.52 + I-19;
M.17052: M.53 + I-19; M.17053: M.54 + I-19; M.17054: M.55 + I-19; M.17055: M.56 + I-19;
M.17056: M.57 + I-19; M.17057: M.58 + I-19; M.17058: M.59 + I-19; M.17059: M.60 + I-19;
M.17060: M.61 + I-19; M.17061: M.62 + I-19; M.17062: M.63 + I-19; M.17063: M.64 + I-19;
M.17064: M.65 + I-19; M.17065: M.66 + I-19; M.17066: M.67 + I-19; M.17067: M.68 + I-19;
M.17068: M.69 + I-19; M.17069: M.70 + I-19; M.17070: M.71 + I-19; M.17071: M.72 + I-19;
M.17072: M.73 + I-19; M.17073: M.74 + I-19; M.17074: M.75 + I-19; M.17075: M.76 + I-19;
M.17076: M.77 + I-19; M.17077: M.78 + I-19; M.17078: M.79 + I-19; M.17079: M.80 + I-19;
M.17080: M.81 + I-19; M.17081: M.82 + I-19; M.17082: M.83 + I-19; M.17083: M.84 + I-19;
M.17084: M.85 + I-19; M.17085: M.86 + I-19; M.17086: M.87 + I-19; M.17087: M.88 + I-19;
M.17088: M.89 + I-19; M.17089: M.90 + I-19; M.17090: M.91 + I-19; M.17091: M.92 + I-19;
M.17092: M.93 + I-19; M.17093: M.94 + I-19; M.17094: M.95 + I-19; M.17095: M.96 + I-19;
M.17096: M.97 + I-19; M.17097: M.98 + I-19; M.17098: M.99 + I-19; M.17099: M.100 + I-19;
M.17100: M.101 + I-19; M.17101: M.102 + I-19; M.17102: M.103 + I-19; M.17103: M.104 + I-19;
M.17104: M.105 + I-19; M.17105: M.106 + I-19; M.17106: M.107 + I-19; M.17107: M.108 + I-19;
M.17108: M.109 + I-19; M.17109: M.110 + I-19; M.17110: M.111 + I-19; M.17111: M.112 + I-19;
M.17112: M.113 + I-19; M.17113: M.114 + I-19; M.17114: M.115 + I-19; M.17115: M.116 + I-19;
M.17116: M.117 + I-19; M.17117: M.118 + I-19; M.17118: M.119 + I-19; M.17119: M.120 + I-19;
M.17120: M.121 + I-19; M.17121: M.122 + I-19; M.17122: M.123 + I-19; M.17123: M.124 + I-19;
M.17124: M.125 + I-19; M.17125: M.126 + I-19; M.17126: M.127 + I-19; M.17127: M.128 + I-19;
M.17128: M.129 + I-19; M.17129: M.130 + I-19; M.17130: M.131 + I-19; M.17131: M.132 + I-19;
M.17132: M.133 + I-19; M.17133: M.134 + I-19; M.17134: M.135 + I-19; M.17135: M.136 + I-19;
M.17136: M.137 + I-19; M.17137: M.138 + I-19; M.17138: M.139 + I-19; M.17139: M.140 + I-19;
M.17140: M.141 + I-19; M.17141: M.142 + I-19; M.17142: M.143 + I-19; M.17143: M.144 + I-19;
M.17144: M.145 + I-19; M.17145: M.146 + I-19; M.17146: M.147 + I-19; M.17147: M.148 + I-19;
M.17148: M.149 + I-19; M.17149: M.150 + I-19; M.17150: M.151 + I-19; M.17151: M.152 + I-19;
M.17152: M.153 + I-19; M.17153: M.154 + I-19; M.17154: M.155 + I-19; M.17155: M.156 + I-19;
M.17156: M.157 + I-19; M.17157: M.158 + I-19; M.17158: M.159 + I-19; M.17159: M.160 + I-19;
M.17160: M.161 + I-19; M.17161: M.162 + I-19; M.17162: M.163 + I-19; M.17163: M.164 + I-19;
M.17164: M.165 + I-19; M.17165: M.166 + I-19; M.17166: M.167 + I-19; M.17167: M.168 + I-19;
M.17168: M.169 + I-19; M.17169: M.170 + I-19; M.17170: M.171 + I-19; M.17171: M.172 + I-19;
M.17172: M.173 + I-19; M.17173: M.174 + I-19; M.17174: M.175 + I-19; M.17175: M.176 + I-19;
M.17176: M.177 + I-19; M.17177: M.178 + I-19; M.17178: M.179 + I-19; M.17179: M.180 + I-19;
M.17180: M.181 + I-19; M.17181: M.182 + I-19; M.17182: M.183 + I-19; M.17183: M.184 + I-19;
M.17184: M.185 + I-19; M.17185: M.186 + I-19; M.17186: M.187 + I-19; M.17187: M.188 + I-19;
M.17188: M.189 + I-19; M.17189: M.190 + I-19; M.17190: M.191 + I-19; M.17191: M.192 + I-19;
M.17192: M.193 + I-19; M.17193: M.194 + I-19; M.17194: M.195 + I-19; M.17195: M.196 + I-19;
M.17196: M.197 + I-19; M.17197: M.198 + I-19; M.17198: M.199 + I-19; M.17199: M.200 + I-19;
M.17200: M.201 + I-19; M.17201: M.202 + I-19; M.17202: M.203 + I-19; M.17203: M.204 + I-19;
M.17204: M.205 + I-19; M.17205: M.206 + I-19; M.17206: M.207 + I-19; M.17207: M.208 + I-19;
M.17208: M.209 + I-19; M.17209: M.210 + I-19; M.17210: M.211 + I-19; M.17211: M.212 + I-19;
M.17212: M.213 + I-19; M.17213: M.214 + I-19; M.17214: M.215 + I-19; M.17215: M.216 + I-19;
M.17216: M.217 + I-19; M.17217: M.218 + I-19; M.17218: M.219 + I-19; M.17219: M.220 + I-19;
M.17220: M.221 + I-19; M.17221: M.222 + I-19; M.17222: M.223 + I-19; M.17223: M.224 + I-19;
M.17224: M.225 + I-19; M.17225: M.226 + I-19; M.17226: M.227 + I-19; M.17227: M.228 + I-19;
M.17228: M.229 + I-19; M.17229: M.230 + I-19; M.17230: M.231 + I-19; M.17231: M.232 + I-19;
M.17232: M.233 + I-19; M.17233: M.234 + I-19; M.17234: M.235 + I-19; M.17235: M.236 + I-19;
M.17236: M.237 + I-19; M.17237: M.238 + I-19; M.17238: M.239 + I-19; M.17239: M.240 + I-19;
M.17240: M.241 + I-19; M.17241: M.242 + I-19; M.17242: M.243 + I-19; M.17243: M.244 + I-19;
M.17244: M.245 + I-19; M.17245: M.246 + I-19; M.17246: M.247 + I-19; M.17247: M.248 + I-19;
M.17248: M.249 + I-19; M.17249: M.250 + I-19; M.17250: M.251 + I-19; M.17251: M.252 + I-19;
M.17252: M.253 + I-19; M.17253: M.254 + I-19; M.17254: M.255 + I-19; M.17255: M.256 + I-19;
M.17256: M.257 + I-19; M.17257: M.258 + I-19; M.17258: M.259 + I-19; M.17259: M.260 + I-19;
M.17260: M.261 + I-19; M.17261: M.262 + I-19; M.17262: M.263 + I-19; M.17263: M.264 + I-19;
M.17264: M.265 + I-19; M.17265: M.266 + I-19; M.17266: M.267 + I-19; M.17267: M.268 + I-19;
M.17268: M.269 + I-19; M.17269: M.270 + I-19; M.17270: M.271 + I-19; M.17271: M.272 + I-19;
M.17272: M.273 + I-19; M.17273: M.274 + I-19; M.17274: M.275 + I-19; M.17275: M.276 + I-19;
M.17276: M.277 + I-19; M.17277: M.278 + I-19; M.17278: M.279 + I-19; M.17279: M.280 + I-19;
M.17280: M.281 + I-19; M.17281: M.282 + I-19; M.17282: M.283 + I-19; M.17283: M.284 + I-19;
M.17284: M.285 + I-19; M.17285: M.286 + I-19; M.17286: M.287 + I-19; M.17287: M.288 + I-19;
M.17288: M.289 + I-19; M.17289: M.290 + I-19; M.17290: M.291 + I-19; M.17291: M.292 + I-19;
M.17292: M.293 + I-19; M.17293: M.294 + I-19; M.17294: M.295 + I-19; M.17295: M.296 + I-19;
M.17296: M.297 + I-19; M.17297: M.298 + I-19; M.17298: M.299 + I-19; M.17299: M.300 + I-19;
M.17300: M.301 + I-19; M.17301: M.302 + I-19; M.17302: M.303 + I-19; M.17303: M.304 + I-19;
M.17304: M.305 + I-19; M.17305: M.306 + I-19; M.17306: M.307 + I-19; M.17307: M.308 + I-19;
M.17308: M.309 + I-19; M.17309: M.310 + I-19; M.17310: M.311 + I-19; M.17311: M.312 + I-19;
M.17312: M.313 + I-19; M.17313: M.314 + I-19; M.17314: M.315 + I-19; M.17315: M.316 + I-19;
M.17316: M.317 + I-19; M.17317: M.318 + I-19; M.17318: M.319 + I-19; M.17319: M.320 + I-19;
M.17320: M.321 + I-19; M.17321: M.322 + I-19; M.17322: M.323 + I-19; M.17323: M.324 + I-19;
M.17324: M.325 + I-19; M.17325: M.326 + I-19; M.17326: M.327 + I-19; M.17327: M.328 + I-19;
M.17328: M.329 + I-19; M.17329: M.330 + I-19; M.17330: M.331 + I-19; M.17331: M.332 + I-19;
M.17332: M.333 + I-19; M.17333: M.334 + I-19; M.17334: M.335 + I-19; M.17335: M.336 + I-19;
M.17336: M.337 + I-19; M.17337: M.338 + I-19; M.17338: M.339 + I-19; M.17339: M.340 + I-19;
M.17340: M.341 + I-19; M.17341: M.342 + I-19; M.17342: M.343 + I-19; M.17343: M.344 + I-19;
M.17344: M.345 + I-19; M.17345: M.346 + I-19; M.17346: M.347 + I-19; M.17347: M.348 + I-19;
M.17348: M.349 + I-19; M.17349: M.350 + I-19; M.17350: M.351 + I-19; M.17351: M.352 + I-19;
M.17352: M.353 + I-19; M.17353: M.354 + I-19; M.17354: M.355 + I-19; M.17355: M.356 + I-19;
M.17356: M.357 + I-19; M.17357: M.358 + I-19; M.17358: M.359 + I-19; M.17359: M.360 + I-19;
M.17360: M.361 + I-19; M.17361: M.362 + I-19; M.17362: M.363 + I-19; M.17363: M.364 + I-19;
M.17364: M.365 + I-19; M.17365: M.366 + I-19; M.17366: M.367 + I-19; M.17367: M.368 + I-19;
M.17368: M.369 + I-19; M.17369: M.370 + I-19; M.17370: M.371 + I-19; M.17371: M.372 + I-19;
M.17372: M.373 + I-19; M.17373: M.374 + I-19; M.17374: M.375 + I-19; M.17375: M.376 + I-19;
M.17376: M.377 + I-19; M.17377: M.378 + I-19; M.17378: M.379 + I-19; M.17379: M.380 + I-19;
M.17380: M.381 + I-19; M.17381: M.382 + I-19; M.17382: M.383 + I-19; M.17383: M.384 + I-19;
M.17384: M.385 + I-19; M.17385: M.386 + I-19; M.17386: M.387 + I-19; M.17387: M.388 + I-19;
M.17388: M.389 + I-19; M.17389: M.390 + I-19; M.17390: M.391 + I-19; M.17391: M.392 + I-19;
M.17392: M.393 + I-19; M.17393: M.394 + I-19; M.17394: M.395 + I-19; M.17395: M.396 + I-19;
M.17396: M.397 + I-19; M.17397: M.398 + I-19; M.17398: M.399 + I-19; M.17399: M.400 + I-19;
M.17400: M.401 + I-19; M.17401: M.402 + I-19; M.17402: M.403 + I-19; M.17403: M.404 + I-19;
M.17404: M.405 + I-19; M.17405: M.406 + I-19; M.17406: M.407 + I-19; M.17407: M.408 + I-19;
M.17408: M.409 + I-19; M.17409: M.410 + I-19; M.17410: M.411 + I-19; M.17411: M.412 + I-19;
M.17412: M.413 + I-19; M.17413: M.414 + I-19; M.17414: M.415 + I-19; M.17415: M.416 + I-19;
M.17416: M.417 + I-19; M.17417: M.418 + I-19; M.17418: M.419 + I-19; M.17419: M.420 + I-19;
M.17420: M.421 + I-19; M.17421: M.422 + I-19; M.17422: M.423 + I-19; M.17423: M.424 + I-19;
M.17424: M.425 + I-19; M.17425: M.426 + I-19; M.17426: M.427 + I-19; M.17427: M.428 + I-19;
M.17428: M.429 + I-19; M.17429: M.430 + I-19; M.17430: M.431 + I-19; M.17431: M.432 + I-19;
M.17432: M.433 + I-19; M.17433: M.434 + I-19; M.17434: M.435 + I-19; M.17435: M.436 + I-19;
M.17436: M.437 + I-19; M.17437: M.438 + I-19; M.17438: M.439 + I-19; M.17439: M.440 + I-19;
M.17440: M.441 + I-19; M.17441: M.442 + I-19; M.17442: M.443 + I-19; M.17443: M.444 + I-19;
M.17444: M.445 + I-19; M.17445: M.446 + I-19; M.17446: M.447 + I-19; M.17447: M.448 + I-19;
M.17448: M.449 + I-19; M.17449: M.450 + I-19.

In another embodiment, the present invention relates to ternary herbicidal mixtures M.18000 to M.18449 listed in Table M(s) below, comprising mixtures of the binary mixtures depicted in table M(a) and a third herbicide I-20.

TABLE M(s)
M.18000: M.1 + I-20; M.18001: M.2 + I-20; M.18002: M.3 + I-20; M.18003: M.4 + I-20;
M.18004: M.5 + I-20; M.18005: M.6 + I-20; M.18006: M.7 + I-20; M.18007: M.8 + I-20;
M.18008: M.9 + I-20; M.18009: M.10 + I-20; M.18010: M.11 + I-20; M.18011: M.12 + I-20;
M.18012: M.13 + I-20; M.18013: M.14 + I-20; M.18014: M.15 + I-20; M.18015: M.16 + I-20;
M.18016: M.17 + I-20; M.18017: M.18 + I-20; M.18018: M.19 + I-20; M.18019: M.20 + I-20;
M.18020: M.21 + I-20; M.18021: M.22 + I-20; M.18022: M.23 + I-20; M.18023: M.24 + I-20;
M.18024: M.25 + I-20; M.18025: M.26 + I-20; M.18026: M.27 + I-20; M.18027: M.28 + I-20;
M.18028: M.29 + I-20; M.18029: M.30 + I-20; M.18030: M.31 + I-20; M.18031: M.32 + I-20;
M.18032: M.33 + I-20; M.18033: M.34 + I-20; M.18034: M.35 + I-20; M.18035: M.36 + I-20;
M.18036: M.37 + I-20; M.18037: M.38 + I-20; M.18038: M.39 + I-20; M.18039: M.40 + I-20;
M.18040: M.41 + I-20; M.18041: M.42 + I-20; M.18042: M.43 + I-20; M.18043: M.44 + I-20;
M.18044: M.45 + I-20; M.18045: M.46 + I-20; M.18046: M.47 + I-20; M.18047: M.48 + I-20;
M.18048: M.49 + I-20; M.18049: M.50 + I-20; M.18050: M.51 + I-20; M.18051: M.52 + I-20;
M.18052: M.53 + I-20; M.18053: M.54 + I-20; M.18054: M.55 + I-20; M.18055: M.56 + I-20;
M.18056: M.57 + I-20; M.18057: M.58 + I-20; M.18058: M.59 + I-20; M.18059: M.60 + I-20;
M.18060: M.61 + I-20; M.18061: M.62 + I-20; M.18062: M.63 + I-20; M.18063: M.64 + I-20;
M.18064: M.65 + I-20; M.18065: M.66 + I-20; M.18066: M.67 + I-20; M.18067: M.68 + I-20;
M.18068: M.69 + I-20; M.18069: M.70 + I-20; M.18070: M.71 + I-20; M.18071: M.72 + I-20;
M.18072: M.73 + I-20; M.18073: M.74 + I-20; M.18074: M.75 + I-20; M.18075: M.76 + I-20;
M.18076: M.77 + I-20; M.18077: M.78 + I-20; M.18078: M.79 + I-20; M.18079: M.80 + I-20;
M.18080: M.81 + I-20; M.18081: M.82 + I-20; M.18082: M.83 + I-20; M.18083: M.84 + I-20;
M.18084: M.85 + I-20; M.18085: M.86 + I-20; M.18086: M.87 + I-20; M.18087: M.88 + I-20;
M.18088: M.89 + I-20; M.18089: M.90 + I-20; M.18090: M.91 + I-20; M.18091: M.92 + I-20;
M.18092: M.93 + I-20; M.18093: M.94 + I-20; M.18094: M.95 + I-20; M.18095: M.96 + I-20;
M.18096: M.97 + I-20; M.18097: M.98 + I-20; M.18098: M.99 + I-20; M.18099: M.100 + I-20;
M.18100: M.101 + I-20; M.18101: M.102 + I-20; M.18102: M.103 + I-20; M.18103: M.104 + I-20;
M.18104: M.105 + I-20; M.18105: M.106 + I-20; M.18106: M.107 + I-20; M.18107: M.108 + I-20;
M.18108: M.109 + I-20; M.18109: M.110 + I-20; M.18110: M.111 + I-20; M.18111: M.112 + I-20;
M.18112: M.113 + I-20; M.18113: M.114 + I-20; M.18114: M.115 + I-20; M.18115: M.116 + I-20;
M.18116: M.117 + I-20; M.18117: M.118 + I-20; M.18118: M.119 + I-20; M.18119: M.120 + I-20;
M.18120: M.121 + I-20; M.18121: M.122 + I-20; M.18122: M.123 + I-20; M.18123: M.124 + I-20;
M.18124: M.125 + I-20; M.18125: M.126 + I-20; M.18126: M.127 + I-20; M.18127: M.128 + I-20;
M.18128: M.129 + I-20; M.18129: M.130 + I-20; M.18130: M.131 + I-20; M.18131: M.132 + I-20;
M.18132: M.133 + I-20; M.18133: M.134 + I-20; M.18134: M.135 + I-20; M.18135: M.136 + I-20;
M.18136: M.137 + I-20; M.18137: M.138 + I-20; M.18138: M.139 + I-20; M.18139: M.140 + I-20;
M.18140: M.141 + I-20; M.18141: M.142 + I-20; M.18142: M.143 + I-20; M.18143: M.144 + I-20;
M.18144: M.145 + I-20; M.18145: M.146 + I-20; M.18146: M.147 + I-20; M.18147: M.148 + I-20;
M.18148: M.149 + I-20; M.18149: M.150 + I-20; M.18150: M.151 + I-20; M.18151: M.152 + I-20;
M.18152: M.153 + I-20; M.18153: M.154 + I-20; M.18154: M.155 + I-20; M.18155: M.156 + I-20;
M.18156: M.157 + I-20; M.18157: M.158 + I-20; M.18158: M.159 + I-20; M.18159: M.160 + I-20;
M.18160: M.161 + I-20; M.18161: M.162 + I-20; M.18162: M.163 + I-20; M.18163: M.164 + I-20;
M.18164: M.165 + I-20; M.18165: M.166 + I-20; M.18166: M.167 + I-20; M.18167: M.168 + I-20;
M.18168: M.169 + I-20; M.18169: M.170 + I-20; M.18170: M.171 + I-20; M.18171: M.172 + I-20;
M.18172: M.173 + I-20; M.18173: M.174 + I-20; M.18174: M.175 + I-20; M.18175: M.176 + I-20;
M.18176: M.177 + I-20; M.18177: M.178 + I-20; M.18178: M.179 + I-20; M.18179: M.180 + I-20;
M.18180: M.181 + I-20; M.18181: M.182 + I-20; M.18182: M.183 + I-20; M.18183: M.184 + I-20;
M.18184: M.185 + I-20; M.18185: M.186 + I-20; M.18186: M.187 + I-20; M.18187: M.188 + I-20;
M.18188: M.189 + I-20; M.18189: M.190 + I-20; M.18190: M.191 + I-20; M.18191: M.192 + I-20;
M.18192: M.193 + I-20; M.18193: M.194 + I-20; M.18194: M.195 + I-20; M.18195: M.196 + I-20;
M.18196: M.197 + I-20; M.18197: M.198 + I-20; M.18198: M.199 + I-20; M.18199: M.200 + I-20;
M.18200: M.201 + I-20; M.18201: M.202 + I-20; M.18202: M.203 + I-20; M.18203: M.204 + I-20;
M.18204: M.205 + I-20; M.18205: M.206 + I-20; M.18206: M.207 + I-20; M.18207: M.208 + I-20;
M.18208: M.209 + I-20; M.18209: M.210 + I-20; M.18210: M.211 + I-20; M.18211: M.212 + I-20;
M.18212: M.213 + I-20; M.18213: M.214 + I-20; M.18214: M.215 + I-20; M.18215: M.216 + I-20;
M.18216: M.217 + I-20; M.18217: M.218 + I-20; M.18218: M.219 + I-20; M.18219: M.220 + I-20;
M.18220: M.221 + I-20; M.18221: M.222 + I-20; M.18222: M.223 + I-20; M.18223: M.224 + I-20;
M.18224: M.225 + I-20; M.18225: M.226 + I-20; M.18226: M.227 + I-20; M.18227: M.228 + I-20;
M.18228: M.229 + I-20; M.18229: M.230 + I-20; M.18230: M.231 + I-20; M.18231: M.232 + I-20;
M.18232: M.233 + I-20; M.18233: M.234 + I-20; M.18234: M.235 + I-20; M.18235: M.236 + I-20;
M.18236: M.237 + I-20; M.18237: M.238 + I-20; M.18238: M.239 + I-20; M.18239: M.240 + I-20;
M.18240: M.241 + I-20; M.18241: M.242 + I-20; M.18242: M.243 + I-20; M.18243: M.244 + I-20;
M.18244: M.245 + I-20; M.18245: M.246 + I-20; M.18246: M.247 + I-20; M.18247: M.248 + I-20;
M.18248: M.249 + I-20; M.18249: M.250 + I-20; M.18250: M.251 + I-20; M.18251: M.252 + I-20;
M.18252: M.253 + I-20; M.18253: M.254 + I-20; M.18254: M.255 + I-20; M.18255: M.256 + I-20;
M.18256: M.257 + I-20; M.18257: M.258 + I-20; M.18258: M.259 + I-20; M.18259: M.260 + I-20;
M.18260: M.261 + I-20; M.18261: M.262 + I-20; M.18262: M.263 + I-20; M.18263: M.264 + I-20;
M.18264: M.265 + I-20; M.18265: M.266 + I-20; M.18266: M.267 + I-20; M.18267: M.268 + I-20;
M.18268: M.269 + I-20; M.18269: M.270 + I-20; M.18270: M.271 + I-20; M.18271: M.272 + I-20;
M.18272: M.273 + I-20; M.18273: M.274 + I-20; M.18274: M.275 + I-20; M.18275: M.276 + I-20;
M.18276: M.277 + I-20; M.18277: M.278 + I-20; M.18278: M.279 + I-20; M.18279: M.280 + I-20;
M.18280: M.281 + I-20; M.18281: M.282 + I-20; M.18282: M.283 + I-20; M.18283: M.284 + I-20;
M.18284: M.285 + I-20; M.18285: M.286 + I-20; M.18286: M.287 + I-20; M.18287: M.288 + I-20;
M.18288: M.289 + I-20; M.18289: M.290 + I-20; M.18290: M.291 + I-20; M.18291: M.292 + I-20;
M.18292: M.293 + I-20; M.18293: M.294 + I-20; M.18294: M.295 + I-20; M.18295: M.296 + I-20;
M.18296: M.297 + I-20; M.18297: M.298 + I-20; M.18298: M.299 + I-20; M.18299: M.300 + I-20;
M.18300: M.301 + I-20; M.18301: M.302 + I-20; M.18302: M.303 + I-20; M.18303: M.304 + I-20;
M.18304: M.305 + I-20; M.18305: M.306 + I-20; M.18306: M.307 + I-20; M.18307: M.308 + I-20;
M.18308: M.309 + I-20; M.18309: M.310 + I-20; M.18310: M.311 + I-20; M.18311: M.312 + I-20;
M.18312: M.313 + I-20; M.18313: M.314 + I-20; M.18314: M.315 + I-20; M.18315: M.316 + I-20;
M.18316: M.317 + I-20; M.18317: M.318 + I-20; M.18318: M.319 + I-20; M.18319: M.320 + I-20;
M.18320: M.321 + I-20; M.18321: M.322 + I-20; M.18322: M.323 + I-20; M.18323: M.324 + I-20;
M.18324: M.325 + I-20; M.18325: M.326 + I-20; M.18326: M.327 + I-20; M.18327: M.328 + I-20;
M.18328: M.329 + I-20; M.18329: M.330 + I-20; M.18330: M.331 + I-20; M.18331: M.332 + I-20;
M.18332: M.333 + I-20; M.18333: M.334 + I-20; M.18334: M.335 + I-20; M.18335: M.336 + I-20;
M.18336: M.337 + I-20; M.18337: M.338 + I-20; M.18338: M.339 + I-20; M.18339: M.340 + I-20;
M.18340: M.341 + I-20; M.18341: M.342 + I-20; M.18342: M.343 + I-20; M.18343: M.344 + I-20;
M.18344: M.345 + I-20; M.18345: M.346 + I-20; M.18346: M.347 + I-20; M.18347: M.348 + I-20;
M.18348: M.349 + I-20; M.18349: M.350 + I-20; M.18350: M.351 + I-20; M.18351: M.352 + I-20;
M.18352: M.353 + I-20; M.18353: M.354 + I-20; M.18354: M.355 + I-20; M.18355: M.356 + I-20;
M.18356: M.357 + I-20; M.18357: M.358 + I-20; M.18358: M.359 + I-20; M.18359: M.360 + I-20;
M.18360: M.361 + I-20; M.18361: M.362 + I-20; M.18362: M.363 + I-20; M.18363: M.364 + I-20;
M.18364: M.365 + I-20; M.18365: M.366 + I-20; M.18366: M.367 + I-20; M.18367: M.368 + I-20;
M.18368: M.369 + I-20; M.18369: M.370 + I-20; M.18370: M.371 + I-20; M.18371: M.372 + I-20;
M.18372: M.373 + I-20; M.18373: M.374 + I-20; M.18374: M.375 + I-20; M.18375: M.376 + I-20;
M.18376: M.377 + I-20; M.18377: M.378 + I-20; M.18378: M.379 + I-20; M.18379: M.380 + I-20;
M.18380: M.381 + I-20; M.18381: M.382 + I-20; M.18382: M.383 + I-20; M.18383: M.384 + I-20;
M.18384: M.385 + I-20; M.18385: M.386 + I-20; M.18386: M.387 + I-20; M.18387: M.388 + I-20;
M.18388: M.389 + I-20; M.18389: M.390 + I-20; M.18390: M.391 + I-20; M.18391: M.392 + I-20;
M.18392: M.393 + I-20; M.18393: M.394 + I-20; M.18394: M.395 + I-20; M.18395: M.396 + I-20;
M.18396: M.397 + I-20; M.18397: M.398 + I-20; M.18398: M.399 + I-20; M.18399: M.400 + I-20;
M.18400: M.401 + I-20; M.18401: M.402 + I-20; M.18402: M.403 + I-20; M.18403: M.404 + I-20;
M.18404: M.405 + I-20; M.18405: M.406 + I-20; M.18406: M.407 + I-20; M.18407: M.408 + I-20;
M.18408: M.409 + I-20; M.18409: M.410 + I-20; M.18410: M.411 + I-20; M.18411: M.412 + I-20;
M.18412: M.413 + I-20; M.18413: M.414 + I-20; M.18414: M.415 + I-20; M.18415: M.416 + I-20;
M.18416: M.417 + I-20; M.18417: M.418 + I-20; M.18418: M.419 + I-20; M.18419: M.420 + I-20;
M.18420: M.421 + I-20; M.18421: M.422 + I-20; M.18422: M.423 + I-20; M.18423: M.424 + I-20;
M.18424: M.425 + I-20; M.18425: M.426 + I-20; M.18426: M.427 + I-20; M.18427: M.428 + I-20;
M.18428: M.429 + I-20; M.18429: M.430 + I-20; M.18430: M.431 + I-20; M.18431: M.432 + I-20;
M.18432: M.433 + I-20; M.18433: M.434 + I-20; M.18434: M.435 + I-20; M.18435: M.436 + I-20;
M.18436: M.437 + I-20; M.18437: M.438 + I-20; M.18438: M.439 + I-20; M.18439: M.440 + I-20;
M.18440: M.441 + I-20; M.18441: M.442 + I-20; M.18442: M.443 + I-20; M.18443: M.444 + I-20;
M.18444: M.445 + I-20; M.18445: M.446 + I-20; M.18446: M.447 + I-20; M.18447: M.448 + I-20;
M.18448: M.449 + I-20; M.18449: M.450 + I-20.

In another embodiment, the present invention relates to ternary herbicidal mixtures M.19000 to M.19449 listed in Table M(t) below, comprising mixtures of the binary mixtures depicted in table M(a) and a third herbicide I-21.

TABLE M(t)
M.19000: M.1 + I-21; M.19001: M.2 + I-21; M.19002: M.3 + I-21; M.19003: M.4 + I-21;
M.19004: M.5 + I-21; M.19005: M.6 + I-21; M.19006: M.7 + I-21; M.19007: M.8 + I-21;
M.19008: M.9 + I-21; M.19009: M.10 + I-21; M.19010: M.11 + I-21; M.19011: M.12 + I-21;
M.19012: M.13 + I-21; M.19013: M.14 + I-21; M.19014: M.15 + I-21; M.19015: M.16 + I-21;
M.19016: M.17 + I-21; M.19017: M.18 + I-21; M.19018: M.19 + I-21; M.19019: M.20 + I-21;
M.19020: M.21 + I-21; M.19021: M.22 + I-21; M.19022: M.23 + I-21; M.19023: M.24 + I-21;
M.19024: M.25 + I-21; M.19025: M.26 + I-21; M.19026: M.27 + I-21; M.19027: M.28 + I-21;
M.19028: M.29 + I-21; M.19029: M.30 + I-21; M.19030: M.31 + I-21; M.19031: M.32 + I-21;
M.19032: M.33 + I-21; M.19033: M.34 + I-21; M.19034: M.35 + I-21; M.19035: M.36 + I-21;
M.19036: M.37 + I-21; M.19037: M.38 + I-21; M.19038: M.39 + I-21; M.19039: M.40 + I-21;
M.19040: M.41 + I-21; M.19041: M.42 + I-21; M.19042: M.43 + I-21; M.19043: M.44 + I-21;
M.19044: M.45 + I-21; M.19045: M.46 + I-21; M.19046: M.47 + I-21; M.19047: M.48 + I-21;
M.19048: M.49 + I-21; M.19049: M.50 + I-21; M.19050: M.51 + I-21; M.19051: M.52 + I-21;
M.19052: M.53 + I-21; M.19053: M.54 + I-21; M.19054: M.55 + I-21; M.19055: M.56 + I-21;
M.19056: M.57 + I-21; M.19057: M.58 + I-21; M.19058: M.59 + I-21; M.19059: M.60 + I-21;
M.19060: M.61 + I-21; M.19061: M.62 + I-21; M.19062: M.63 + I-21; M.19063: M.64 + I-21;
M.19064: M.65 + I-21; M.19065: M.66 + I-21; M.19066: M.67 + I-21; M.19067: M.68 + I-21;
M.19068: M.69 + I-21; M.19069: M.70 + I-21; M.19070: M.71 + I-21; M.19071: M.72 + I-21;
M.19072: M.73 + I-21; M.19073: M.74 + I-21; M.19074: M.75 + I-21; M.19075: M.76 + I-21;
M.19076: M.77 + I-21; M.19077: M.78 + I-21; M.19078: M.79 + I-21; M.19079: M.80 + I-21;
M.19080: M.81 + I-21; M.19081: M.82 + I-21; M.19082: M.83 + I-21; M.19083: M.84 + I-21;
M.19084: M.85 + I-21; M.19085: M.86 + I-21; M.19086: M.87 + I-21; M.19087: M.88 + I-21;
M.19088: M.89 + I-21; M.19089: M.90 + I-21; M.19090: M.91 + I-21; M.19091: M.92 + I-21;
M.19092: M.93 + I-21; M.19093: M.94 + I-21; M.19094: M.95 + I-21; M.19095: M.96 + I-21;
M.19096: M.97 + I-21; M.19097: M.98 + I-21; M.19098: M.99 + I-21; M.20099: M.100 + I-21;
M.19100: M.101 + I-21; M.19101: M.102 + I-21; M.19102: M.103 + I-21; M.19103: M.104 + I-21;
M.19104: M.105 + I-21; M.19105: M.106 + I-21; M.19106: M.107 + I-21; M.19107: M.108 + I-21;
M.19108: M.109 + I-21; M.19109: M.110 + I-21; M.19110: M.111 + I-21; M.19111: M.112 + I-21;
M.19112: M.113 + I-21; M.19113: M.114 + I-21; M.19114: M.115 + I-21; M.19115: M.116 + I-21;
M.19116: M.117 + I-21; M.19117: M.118 + I-21; M.19118: M.119 + I-21; M.19119: M.120 + I-21;
M.19120: M.121 + I-21; M.19121: M.122 + I-21; M.19122: M.123 + I-21; M.19123: M.124 + I-21;
M.19124: M.125 + I-21; M.19125: M.126 + I-21; M.19126: M.127 + I-21; M.19127: M.128 + I-21;
M.19128: M.129 + I-21; M.19129: M.130 + I-21; M.19130: M.131 + I-21; M.19131: M.132 + I-21;
M.19132: M.133 + I-21; M.19133: M.134 + I-21; M.19134: M.135 + I-21; M.19135: M.136 + I-21;
M.19136: M.137 + I-21; M.19137: M.138 + I-21; M.19138: M.139 + I-21; M.19139: M.140 + I-21;
M.19140: M.141 + I-21; M.19141: M.142 + I-21; M.19142: M.143 + I-21; M.19143: M.144 + I-21;
M.19144: M.145 + I-21; M.19145: M.146 + I-21; M.19146: M.147 + I-21; M.19147: M.148 + I-21;
M.19148: M.149 + I-21; M.19149: M.150 + I-21; M.19150: M.151 + I-21; M.19151: M.152 + I-21;
M.19152: M.153 + I-21; M.19153: M.154 + I-21; M.19154: M.155 + I-21; M.19155: M.156 + I-21;
M.19156: M.157 + I-21; M.19157: M.158 + I-21; M.19158: M.159 + I-21; M.19159: M.160 + I-21;
M.19160: M.161 + I-21; M.19161: M.162 + I-21; M.19162: M.163 + I-21; M.19163: M.164 + I-21;
M.19164: M.165 + I-21; M.19165: M.166 + I-21; M.19166: M.167 + I-21; M.19167: M.168 + I-21;
M.19168: M.169 + I-21; M.19169: M.170 + I-21; M.19170: M.171 + I-21; M.19171: M.172 + I-21;
M.19172: M.173 + I-21; M.19173: M.174 + I-21; M.19174: M.175 + I-21; M.19175: M.176 + I-21;
M.19176: M.177 + I-21; M.19177: M.178 + I-21; M.19178: M.179 + I-21; M.19179: M.180 + I-21;
M.19180: M.181 + I-21; M.19181: M.182 + I-21; M.19182: M.183 + I-21; M.19183: M.184 + I-21;
M.19184: M.185 + I-21; M.19185: M.186 + I-21; M.19186: M.187 + I-21; M.19187: M.188 + I-21;
M.19188: M.189 + I-21; M.19189: M.190 + I-21; M.19190: M.191 + I-21; M.19191: M.192 + I-21;
M.19192: M.193 + I-21; M.19193: M.194 + I-21; M.19194: M.195 + I-21; M.19195: M.196 + I-21;
M.19196: M.197 + I-21; M.19197: M.198 + I-21; M.19198: M.199 + I-21; M.19199: M.200 + I-21;
M.19200: M.201 + I-21; M.19201: M.202 + I-21; M.19202: M.203 + I-21; M.19203: M.204 + I-21;
M.19204: M.205 + I-21; M.19205: M.206 + I-21; M.19206: M.207 + I-21; M.19207: M.208 + I-21;
M.19208: M.209 + I-21; M.19209: M.210 + I-21; M.19210: M.211 + I-21; M.19211: M.212 + I-21;
M.19212: M.213 + I-21; M.19213: M.214 + I-21; M.19214: M.215 + I-21; M.19215: M.216 + I-21;
M.19216: M.217 + I-21; M.19217: M.218 + I-21; M.19218: M.219 + I-21; M.19219: M.220 + I-21;
M.19220: M.221 + I-21; M.19221: M.222 + I-21; M.19222: M.223 + I-21; M.19223: M.224 + I-21;
M.19224: M.225 + I-21; M.19225: M.226 + I-21; M.19226: M.227 + I-21; M.19227: M.228 + I-21;
M.19228: M.229 + I-21; M.19229: M.230 + I-21; M.19230: M.231 + I-21; M.19231: M.232 + I-21;
M.19232: M.233 + I-21; M.19233: M.234 + I-21; M.19234: M.235 + I-21; M.19235: M.236 + I-21;
M.19236: M.237 + I-21; M.19237: M.238 + I-21; M.19238: M.239 + I-21; M.19239: M.240 + I-21;
M.19240: M.241 + I-21; M.19241: M.242 + I-21; M.19242: M.243 + I-21; M.19243: M.244 + I-21;
M.19244: M.245 + I-21; M.19245: M.246 + I-21; M.19246: M.247 + I-21; M.19247: M.248 + I-21;
M.19248: M.249 + I-21; M.19249: M.250 + I-21; M.19250: M.251 + I-21; M.19251: M.252 + I-21;
M.19252: M.253 + I-21; M.19253: M.254 + I-21; M.19254: M.255 + I-21; M.19255: M.256 + I-21;
M.19256: M.257 + I-21; M.19257: M.258 + I-21; M.19258: M.259 + I-21; M.19259: M.260 + I-21;
M.19260: M.261 + I-21; M.19261: M.262 + I-21; M.19262: M.263 + I-21; M.19263: M.264 + I-21;
M.19264: M.265 + I-21; M.19265: M.266 + I-21; M.19266: M.267 + I-21; M.19267: M.268 + I-21;
M.19268: M.269 + I-21; M.19269: M.270 + I-21; M.19270: M.271 + I-21; M.19271: M.272 + I-21;
M.19272: M.273 + I-21; M.19273: M.274 + I-21; M.19274: M.275 + I-21; M.19275: M.276 + I-21;
M.19276: M.277 + I-21; M.19277: M.278 + I-21; M.19278: M.279 + I-21; M.19279: M.280 + I-21;
M.19280: M.281 + I-21; M.19281: M.282 + I-21; M.19282: M.283 + I-21; M.19283: M.284 + I-21;
M.19284: M.285 + I-21; M.19285: M.286 + I-21; M.19286: M.287 + I-21; M.19287: M.288 + I-21;
M.19288: M.289 + I-21; M.19289: M.290 + I-21; M.19290: M.291 + I-21; M.19291: M.292 + I-21;
M.19292: M.293 + I-21; M.19293: M.294 + I-21; M.19294: M.295 + I-21; M.19295: M.296 + I-21;
M.19296: M.297 + I-21; M.19297: M.298 + I-21; M.19298: M.299 + I-21; M.19299: M.300 + I-21;
M.19300: M.301 + I-21; M.19301: M.302 + I-21; M.19302: M.303 + I-21; M.19303: M.304 + I-21;
M.19304: M.305 + I-21; M.19305: M.306 + I-21; M.19306: M.307 + I-21; M.19307: M.308 + I-21;
M.19308: M.309 + I-21; M.19309: M.310 + I-21; M.19310: M.311 + I-21; M.19311: M.312 + I-21;
M.19312: M.313 + I-21; M.19313: M.314 + I-21; M.19314: M.315 + I-21; M.19315: M.316 + I-21;
M.19316: M.317 + I-21; M.19317: M.318 + I-21; M.19318: M.319 + I-21; M.19319: M.320 + I-21;
M.19320: M.321 + I-21; M.19321: M.322 + I-21; M.19322: M.323 + I-21; M.19323: M.324 + I-21;
M.19324: M.325 + I-21; M.19325: M.326 + I-21; M.19326: M.327 + I-21; M.19327: M.328 + I-21;
M.19328: M.329 + I-21; M.19329: M.330 + I-21; M.19330: M.331 + I-21; M.19331: M.332 + I-21;
M.19332: M.333 + I-21; M.19333: M.334 + I-21; M.19334: M.335 + I-21; M.19335: M.336 + I-21;
M.19336: M.337 + I-21; M.19337: M.338 + I-21; M.19338: M.339 + I-21; M.19339: M.340 + I-21;
M.19340: M.341 + I-21; M.19341: M.342 + I-21; M.19342: M.343 + I-21; M.19343: M.344 + I-21;
M.19344: M.345 + I-21; M.19345: M.346 + I-21; M.19346: M.347 + I-21; M.19347: M.348 + I-21;
M.19348: M.349 + I-21; M.19349: M.350 + I-21; M.19350: M.351 + I-21; M.19351: M.352 + I-21;
M.19352: M.353 + I-21; M.19353: M.354 + I-21; M.19354: M.355 + I-21; M.19355: M.356 + I-21;
M.19356: M.357 + I-21; M.19357: M.358 + I-21; M.19358: M.359 + I-21; M.19359: M.360 + I-21;
M.19360: M.361 + I-21; M.19361: M.362 + I-21; M.19362: M.363 + I-21; M.19363: M.364 + I-21;
M.19364: M.365 + I-21; M.19365: M.366 + I-21; M.19366: M.367 + I-21; M.19367: M.368 + I-21;
M.19368: M.369 + I-21; M.19369: M.370 + I-21; M.19370: M.371 + I-21; M.19371: M.372 + I-21;
M.19372: M.373 + I-21; M.19373: M.374 + I-21; M.19374: M.375 + I-21; M.19375: M.376 + I-21;
M.19376: M.377 + I-21; M.19377: M.378 + I-21; M.19378: M.379 + I-21; M.19379: M.380 + I-21;
M.19380: M.381 + I-21; M.19381: M.382 + I-21; M.19382: M.383 + I-21; M.19383: M.384 + I-21;
M.19384: M.385 + I-21; M.19385: M.386 + I-21; M.19386: M.387 + I-21; M.19387: M.388 + I-21;
M.19388: M.389 + I-21; M.19389: M.390 + I-21; M.19390: M.391 + I-21; M.19391: M.392 + I-21;
M.19392: M.393 + I-21; M.19393: M.394 + I-21; M.19394: M.395 + I-21; M.19395: M.396 + I-21;
M.19396: M.397 + I-21; M.19397: M.398 + I-21; M.19398: M.399 + I-21; M.19399: M.400 + I-21;
M.19400: M.401 + I-21; M.19401: M.402 + I-21; M.19402: M.403 + I-21; M.19403: M.404 + I-21;
M.19404: M.405 + I-21; M.19405: M.406 + I-21; M.19406: M.407 + I-21; M.19407: M.408 + I-21;
M.19408: M.409 + I-21; M.19409: M.410 + I-21; M.19410: M.411 + I-21; M.19411: M.412 + I-21;
M.19412: M.413 + I-21; M.19413: M.414 + I-21; M.19414: M.415 + I-21; M.19415: M.416 + I-21;
M.19416: M.417 + I-21; M.19417: M.418 + I-21; M.19418: M.419 + I-21; M.19419: M.420 + I-21;
M.19420: M.421 + I-21; M.19421: M.422 + I-21; M.19422: M.423 + I-21; M.19423: M.424 + I-21;
M.19424: M.425 + I-21; M.19425: M.426 + I-21; M.19426: M.427 + I-21; M.19427: M.428 + I-21;
M.19428: M.429 + I-21; M.19429: M.430 + I-21; M.19430: M.431 + I-21; M.19431: M.432 + I-21;
M.19432: M.433 + I-21; M.19433: M.434 + I-21; M.19434: M.435 + I-21; M.19435: M.436 + I-21;
M.19436: M.437 + I-21; M.19437: M.438 + I-21; M.19438: M.439 + I-21; M.19439: M.440 + I-21;
M.19440: M.441 + I-21; M.19441: M.442 + I-21; M.19442: M.443 + I-21; M.19443: M.444 + I-21;
M.19444: M.445 + I-21; M.19445: M.446 + I-21; M.19446: M.447 + I-21; M.19447: M.448 + I-21;
M.19448: M.449 + I-21; M.19449: M.450 + I-21.

In another embodiment, the present invention relates to ternary herbicidal mixtures M.20000 to M.20449 listed in Table M(u) below, comprising mixtures of the binary mixtures depicted in table M(a) and a third herbicide I-22.

TABLE M(u)
M.20000: M.1 + I-22; M.20001: M.2 + I-22; M.20002: M.3 + I-22; M.20003: M.4 + I-22;
M.20004: M.5 + I-22; M.20005: M.6 + I-22; M.20006: M.7 + I-22; M.20007: M.8 + I-22;
M.20008: M.9 + I-22; M.20009: M.10 + I-22; M.20010: M.11 + I-22; M.20011: M.12 + I-22;
M.20012: M.13 + I-22; M.20013: M.14 + I-22; M.20014: M.15 + I-22; M.20015: M.16 + I-22;
M.20016: M.17 + I-22; M.20017: M.18 + I-22; M.20018: M.19 + I-22; M.20019: M.20 + I-22;
M.20020: M.21 + I-22; M.20021: M.22 + I-22; M.20022: M.23 + I-22; M.20023: M.24 + I-22;
M.20024: M.25 + I-22; M.20025: M.26 + I-22; M.20026: M.27 + I-22; M.20027: M.28 + I-22;
M.20028: M.29 + I-22; M.20029: M.30 + I-22; M.20030: M.31 + I-22; M.20031: M.32 + I-22;
M.20032: M.33 + I-22; M.20033: M.34 + I-22; M.20034: M.35 + I-22; M.20035: M.36 + I-22;
M.20036: M.37 + I-22; M.20037: M.38 + I-22; M.20038: M.39 + I-22; M.20039: M.40 + I-22;
M.20040: M.41 + I-22; M.20041: M.42 + I-22; M.20042: M.43 + I-22; M.20043: M.44 + I-22;
M.20044: M.45 + I-22; M.20045: M.46 + I-22; M.20046: M.47 + I-22; M.20047: M.48 + I-22;
M.20048: M.49 + I-22; M.20049: M.50 + I-22; M.20050: M.51 + I-22; M.20051: M.52 + I-22;
M.20052: M.53 + I-22; M.20053: M.54 + I-22; M.20054: M.55 + I-22; M.20055: M.56 + I-22;
M.20056: M.57 + I-22; M.20057: M.58 + I-22; M.20058: M.59 + I-22; M.20059: M.60 + I-22;
M.20060: M.61 + I-22; M.20061: M.62 + I-22; M.20062: M.63 + I-22; M.20063: M.64 + I-22;
M.20064: M.65 + I-22; M.20065: M.66 + I-22; M.20066: M.67 + I-22; M.20067: M.68 + I-22;
M.20068: M.69 + I-22; M.20069: M.70 + I-22; M.20070: M.71 + I-22; M.20071: M.72 + I-22;
M.20072: M.73 + I-22; M.20073: M.74 + I-22; M.20074: M.75 + I-22; M.20075: M.76 + I-22;
M.20076: M.77 + I-22; M.20077: M.78 + I-22; M.20078: M.79 + I-22; M.20079: M.80 + I-22;
M.20080: M.81 + I-22; M.20081: M.82 + I-22; M.20082: M.83 + I-22; M.20083: M.84 + I-22;
M.20084: M.85 + I-22; M.20085: M.86 + I-22; M.20086: M.87 + I-22; M.20087: M.88 + I-22;
M.20088: M.89 + I-22; M.20089: M.90 + I-22; M.20090: M.91 + I-22; M.20091: M.92 + I-22;
M.20092: M.93 + I-22; M.20093: M.94 + I-22; M.20094: M.95 + I-22; M.20095: M.96 + I-22;
M.20096: M.97 + I-22; M.20097: M.98 + I-22; M.20098: M.99 + I-22; M.20099: M.100 + I-22;
M.20100: M.101 + I-22; M.20101: M.102 + I-22; M.20102: M.103 + I-22; M.20103: M.104 + I-22;
M.20104: M.105 + I-22; M.20105: M.106 + I-22; M.20106: M.107 + I-22; M.20107: M.108 + I-22;
M.20108: M.109 + I-22; M.20109: M.110 + I-22; M.20110: M.111 + I-22; M.20111: M.112 + I-22;
M.20112: M.113 + I-22; M.20113: M.114 + I-22; M.20114: M.115 + I-22; M.20115: M.116 + I-22;
M.20116: M.117 + I-22; M.20117: M.118 + I-22; M.20118: M.119 + I-22; M.20119: M.120 + I-22;
M.20120: M.121 + I-22; M.20121: M.122 + I-22; M.20122: M.123 + I-22; M.20123: M.124 + I-22;
M.20124: M.125 + I-22; M.20125: M.126 + I-22; M.20126: M.127 + I-22; M.20127: M.128 + I-22;
M.20128: M.129 + I-22; M.20129: M.130 + I-22; M.20130: M.131 + I-22; M.20131: M.132 + I-22;
M.20132: M.133 + I-22; M.20133: M.134 + I-22; M.20134: M.135 + I-22; M.20135: M.136 + I-22;
M.20136: M.137 + I-22; M.20137: M.138 + I-22; M.20138: M.139 + I-22; M.20139: M.140 + I-22;
M.20140: M.141 + I-22; M.20141: M.142 + I-22; M.20142: M.143 + I-22; M.20143: M.144 + I-22;
M.20144: M.145 + I-22; M.20145: M.146 + I-22; M.20146: M.147 + I-22; M.20147: M.148 + I-22;
M.20148: M.149 + I-22; M.20149: M.150 + I-22; M.20150: M.151 + I-22; M.20151: M.152 + I-22;
M.20152: M.153 + I-22; M.20153: M.154 + I-22; M.20154: M.155 + I-22; M.20155: M.156 + I-22;
M.20156: M.157 + I-22; M.20157: M.158 + I-22; M.20158: M.159 + I-22; M.20159: M.160 + I-22;
M.20160: M.161 + I-22; M.20161: M.162 + I-22; M.20162: M.163 + I-22; M.20163: M.164 + I-22;
M.20164: M.165 + I-22; M.20165: M.166 + I-22; M.20166: M.167 + I-22; M.20167: M.168 + I-22;
M.20168: M.169 + I-22; M.20169: M.170 + I-22; M.20170: M.171 + I-22; M.20171: M.172 + I-22;
M.20172: M.173 + I-22; M.20173: M.174 + I-22; M.20174: M.175 + I-22; M.20175: M.176 + I-22;
M.20176: M.177 + I-22; M.20177: M.178 + I-22; M.20178: M.179 + I-22; M.20179: M.180 + I-22;
M.20180: M.181 + I-22; M.20181: M.182 + I-22; M.20182: M.183 + I-22; M.20183: M.184 + I-22;
M.20184: M.185 + I-22; M.20185: M.186 + I-22; M.20186: M.187 + I-22; M.20187: M.188 + I-22;
M.20188: M.189 + I-22; M.20189: M.190 + I-22; M.20190: M.191 + I-22; M.20191: M.192 + I-22;
M.20192: M.193 + I-22; M.20193: M.194 + I-22; M.20194: M.195 + I-22; M.20195: M.196 + I-22;
M.20196: M.197 + I-22; M.20197: M.198 + I-22; M.20198: M.199 + I-22; M.20199: M.200 + I-22;
M.20200: M.201 + I-22; M.20201: M.202 + I-22; M.20202: M.203 + I-22; M.20203: M.204 + I-22;
M.20204: M.205 + I-22; M.20205: M.206 + I-22; M.20206: M.207 + I-22; M.20207: M.208 + I-22;
M.20208: M.209 + I-22; M.20209: M.210 + I-22; M.20210: M.211 + I-22; M.20211: M.212 + I-22;
M.20212: M.213 + I-22; M.20213: M.214 + I-22; M.20214: M.215 + I-22; M.20215: M.216 + I-22;
M.20216: M.217 + I-22; M.20217: M.218 + I-22; M.20218: M.219 + I-22; M.20219: M.220 + I-22;
M.20220: M.221 + I-22; M.20221: M.222 + I-22; M.20222: M.223 + I-22; M.20223: M.224 + I-22;
M.20224: M.225 + I-22; M.20225: M.226 + I-22; M.20226: M.227 + I-22; M.20227: M.228 + I-22;
M.20228: M.229 + I-22; M.20229: M.230 + I-22; M.20230: M.231 + I-22; M.20231: M.232 + I-22;
M.20232: M.233 + I-22; M.20233: M.234 + I-22; M.20234: M.235 + I-22; M.20235: M.236 + I-22;
M.20236: M.237 + I-22; M.20237: M.238 + I-22; M.20238: M.239 + I-22; M.20239: M.240 + I-22;
M.20240: M.241 + I-22; M.20241: M.242 + I-22; M.20242: M.243 + I-22; M.20243: M.244 + I-22;
M.20244: M.245 + I-22; M.20245: M.246 + I-22; M.20246: M.247 + I-22; M.20247: M.248 + I-22;
M.20248: M.249 + I-22; M.20249: M.250 + I-22; M.20250: M.251 + I-22; M.20251: M.252 + I-22;
M.20252: M.253 + I-22; M.20253: M.254 + I-22; M.20254: M.255 + I-22; M.20255: M.256 + I-22;
M.20256: M.257 + I-22; M.20257: M.258 + I-22; M.20258: M.259 + I-22; M.20259: M.260 + I-22;
M.20260: M.261 + I-22; M.20261: M.262 + I-22; M.20262: M.263 + I-22; M.20263: M.264 + I-22;
M.20264: M.265 + I-22; M.20265: M.266 + I-22; M.20266: M.267 + I-22; M.20267: M.268 + I-22;
M.20268: M.269 + I-22; M.20269: M.270 + I-22; M.20270: M.271 + I-22; M.20271: M.272 + I-22;
M.20272: M.273 + I-22; M.20273: M.274 + I-22; M.20274: M.275 + I-22; M.20275: M.276 + I-22;
M.20276: M.277 + I-22; M.20277: M.278 + I-22; M.20278: M.279 + I-22; M.20279: M.280 + I-22;
M.20280: M.281 + I-22; M.20281: M.282 + I-22; M.20282: M.283 + I-22; M.20283: M.284 + I-22;
M.20284: M.285 + I-22; M.20285: M.286 + I-22; M.20286: M.287 + I-22; M.20287: M.288 + I-22;
M.20288: M.289 + I-22; M.20289: M.290 + I-22; M.20290: M.291 + I-22; M.20291: M.292 + I-22;
M.20292: M.293 + I-22; M.20293: M.294 + I-22; M.20294: M.295 + I-22; M.20295: M.296 + I-22;
M.20296: M.297 + I-22; M.20297: M.298 + I-22; M.20298: M.299 + I-22; M.20299: M.300 + I-22;
M.20300: M.301 + I-22; M.20301: M.302 + I-22; M.20302: M.303 + I-22; M.20303: M.304 + I-22;
M.20304: M.305 + I-22; M.20305: M.306 + I-22; M.20306: M.307 + I-22; M.20307: M.308 + I-22;
M.20308: M.309 + I-22; M.20309: M.310 + I-22; M.20310: M.311 + I-22; M.20311: M.312 + I-22;
M.20312: M.313 + I-22; M.20313: M.314 + I-22; M.20314: M.315 + I-22; M.20315: M.316 + I-22;
M.20316: M.317 + I-22; M.20317: M.318 + I-22; M.20318: M.319 + I-22; M.20319: M.320 + I-22;
M.20320: M.321 + I-22; M.20321: M.322 + I-22; M.20322: M.323 + I-22; M.20323: M.324 + I-22;
M.20324: M.325 + I-22; M.20325: M.326 + I-22; M.20326: M.327 + I-22; M.20327: M.328 + I-22;
M.20328: M.329 + I-22; M.20329: M.330 + I-22; M.20330: M.331 + I-22; M.20331: M.332 + I-22;
M.20332: M.333 + I-22; M.20333: M.334 + I-22; M.20334: M.335 + I-22; M.20335: M.336 + I-22;
M.20336: M.337 + I-22; M.20337: M.338 + I-22; M.20338: M.339 + I-22; M.20339: M.340 + I-22;
M.20340: M.341 + I-22; M.20341: M.342 + I-22; M.20342: M.343 + I-22; M.20343: M.344 + I-22;
M.20344: M.345 + I-22; M.20345: M.346 + I-22; M.20346: M.347 + I-22; M.20347: M.348 + I-22;
M.20348: M.349 + I-22; M.20349: M.350 + I-22; M.20350: M.351 + I-22; M.20351: M.352 + I-22;
M.20352: M.353 + I-22; M.20353: M.354 + I-22; M.20354: M.355 + I-22; M.20355: M.356 + I-22;
M.20356: M.357 + I-22; M.20357: M.358 + I-22; M.20358: M.359 + I-22; M.20359: M.360 + I-22;
M.20360: M.361 + I-22; M.20361: M.362 + I-22; M.20362: M.363 + I-22; M.20363: M.364 + I-22;
M.20364: M.365 + I-22; M.20365: M.366 + I-22; M.20366: M.367 + I-22; M.20367: M.368 + I-22;
M.20368: M.369 + I-22; M.20369: M.370 + I-22; M.20370: M.371 + I-22; M.20371: M.372 + I-22;
M.20372: M.373 + I-22; M.20373: M.374 + I-22; M.20374: M.375 + I-22; M.20375: M.376 + I-22;
M.20376: M.377 + I-22; M.20377: M.378 + I-22; M.20378: M.379 + I-22; M.20379: M.380 + I-22;
M.20380: M.381 + I-22; M.20381: M.382 + I-22; M.20382: M.383 + I-22; M.20383: M.384 + I-22;
M.20384: M.385 + I-22; M.20385: M.386 + I-22; M.20386: M.387 + I-22; M.20387: M.388 + I-22;
M.20388: M.389 + I-22; M.20389: M.390 + I-22; M.20390: M.391 + I-22; M.20391: M.392 + I-22;
M.20392: M.393 + I-22; M.20393: M.394 + I-22; M.20394: M.395 + I-22; M.20395: M.396 + I-22;
M.20396: M.397 + I-22; M.20397: M.398 + I-22; M.20398: M.399 + I-22; M.20399: M.400 + I-22;
M.20400: M.401 + I-22; M.20401: M.402 + I-22; M.20402: M.403 + I-22; M.20403: M.404 + I-22;
M.20404: M.405 + I-22; M.20405: M.406 + I-22; M.20406: M.407 + I-22; M.20407: M.408 + I-22;
M.20408: M.409 + I-22; M.20409: M.410 + I-22; M.20410: M.411 + I-22; M.20411: M.412 + I-22;
M.20412: M.413 + I-22; M.20413: M.414 + I-22; M.20414: M.415 + I-22; M.20415: M.416 + I-22;
M.20416: M.417 + I-22; M.20417: M.418 + I-22; M.20418: M.419 + I-22; M.20419: M.420 + I-22;
M.20420: M.421 + I-22; M.20421: M.422 + I-22; M.20422: M.423 + I-22; M.20423: M.424 + I-22;
M.20424: M.425 + I-22; M.20425: M.426 + I-22; M.20426: M.427 + I-22; M.20427: M.428 + I-22;
M.20428: M.429 + I-22; M.20429: M.430 + I-22; M.20430: M.431 + I-22; M.20431: M.432 + I-22;
M.20432: M.433 + I-22; M.20433: M.434 + I-22; M.20434: M.435 + I-22; M.20435: M.436 + I-22;
M.20436: M.437 + I-22; M.20437: M.438 + I-22; M.20438: M.439 + I-22; M.20439: M.440 + I-22;
M.20440: M.441 + I-22; M.20441: M.442 + I-22; M.20442: M.443 + I-22; M.20443: M.444 + I-22;
M.20444: M.445 + I-22; M.20445: M.446 + I-22; M.20446: M.447 + I-22; M.20447: M.448 + I-22;
M.20448: M.449 + I-22; M.20449: M.450 + I-22.

In another embodiment, the present invention relates to ternary herbicidal mixtures M.21000 to M.21449 listed in Table M(v) below, comprising mixtures of the binary mixtures depicted in table M(a) and a third herbicide I-23.

TABLE M(v)
M.21000: M.1 + I-23; M.21001: M.2 + I-23; M.21002: M.3 + I-23; M.21003: M.4 + I-23;
M.21004: M.5 + I-23; M.21005: M.6 + I-23; M.21006: M.7 + I-23; M.21007: M.8 + I-23;
M.21008: M.9 + I-23; M.21009: M.10 + I-23; M.21010: M.11 + I-23; M.21011: M.12 + I-23;
M.21012: M.13 + I-23; M.21013: M.14 + I-23; M.21014: M.15 + I-23; M.21015: M.16 + I-23;
M.21016: M.17 + I-23; M.21017: M.18 + I-23; M.21018: M.19 + I-23; M.21019: M.20 + I-23;
M.21020: M.21 + I-23; M.21021: M.22 + I-23; M.21022: M.23 + I-23; M.21023: M.24 + I-23;
M.21024: M.25 + I-23; M.21025: M.26 + I-23; M.21026: M.27 + I-23; M.21027: M.28 + I-23;
M.21028: M.29 + I-23; M.21029: M.30 + I-23; M.21030: M.31 + I-23; M.21031: M.32 + I-23;
M.21032: M.33 + I-23; M.21033: M.34 + I-23; M.21034: M.35 + I-23; M.21035: M.36 + I-23;
M.21036: M.37 + I-23; M.21037: M.38 + I-23; M.21038: M.39 + I-23; M.21039: M.40 + I-23;
M.21040: M.41 + I-23; M.21041: M.42 + I-23; M.21042: M.43 + I-23; M.21043: M.44 + I-23;
M.21044: M.45 + I-23; M.21045: M.46 + I-23; M.21046: M.47 + I-23; M.21047: M.48 + I-23;
M.21048: M.49 + I-23; M.21049: M.50 + I-23; M.21050: M.51 + I-23; M.21051: M.52 + I-23;
M.21052: M.53 + I-23; M.21053: M.54 + I-23; M.21054: M.55 + I-23; M.21055: M.56 + I-23;
M.21056: M.57 + I-23; M.21057: M.58 + I-23; M.21058: M.59 + I-23; M.21059: M.60 + I-23;
M.21060: M.61 + I-23; M.21061: M.62 + I-23; M.21062: M.63 + I-23; M.21063: M.64 + I-23;
M.21064: M.65 + I-23; M.21065: M.66 + I-23; M.21066: M.67 + I-23; M.21067: M.68 + I-23;
M.21068: M.69 + I-23; M.21069: M.70 + I-23; M.21070: M.71 + I-23; M.21071: M.72 + I-23;
M.21072: M.73 + I-23; M.21073: M.74 + I-23; M.21074: M.75 + I-23; M.21075: M.76 + I-23;
M.21076: M.77 + I-23; M.21077: M.78 + I-23; M.21078: M.79 + I-23; M.21079: M.80 + I-23;
M.21080: M.81 + I-23; M.21081: M.82 + I-23; M.21082: M.83 + I-23; M.21083: M.84 + I-23;
M.21084: M.85 + I-23; M.21085: M.86 + I-23; M.21086: M.87 + I-23; M.21087: M.88 + I-23;
M.21088: M.89 + I-23; M.21089: M.90 + I-23; M.21090: M.91 + I-23; M.21091: M.92 + I-23;
M.21092: M.93 + I-23; M.21093: M.94 + I-23; M.21094: M.95 + I-23; M.21095: M.96 + I-23;
M.21096: M.97 + I-23; M.21097: M.98 + I-23; M.21098: M.99 + I-23; M.21099: M.100 + I-23;
M.21100: M.101 + I-23; M.21101: M.102 + I-23; M.21102: M.103 + I-23; M.21103: M.104 + I-23;
M.21104: M.105 + I-23; M.21105: M.106 + I-23; M.21106: M.107 + I-23; M.21107: M.108 + I-23;
M.21108: M.109 + I-23; M.21109: M.110 + I-23; M.21110: M.111 + I-23; M.21111: M.112 + I-23;
M.21112: M.113 + I-23; M.21113: M.114 + I-23; M.21114: M.115 + I-23; M.21115: M.116 + I-23;
M.21116: M.117 + I-23; M.21117: M.118 + I-23; M.21118: M.119 + I-23; M.21119: M.120 + I-23;
M.21120: M.121 + I-23; M.21121: M.122 + I-23; M.21122: M.123 + I-23; M.21123: M.124 + I-23;
M.21124: M.125 + I-23; M.21125: M.126 + I-23; M.21126: M.127 + I-23; M.21127: M.128 + I-23;
M.21128: M.129 + I-23; M.21129: M.130 + I-23; M.21130: M.131 + I-23; M.21131: M.132 + I-23;
M.21132: M.133 + I-23; M.21133: M.134 + I-23; M.21134: M.135 + I-23; M.21135: M.136 + I-23;
M.21136: M.137 + I-23; M.21137: M.138 + I-23; M.21138: M.139 + I-23; M.21139: M.140 + I-23;
M.21140: M.141 + I-23; M.21141: M.142 + I-23; M.21142: M.143 + I-23; M.21143: M.144 + I-23;
M.21144: M.145 + I-23; M.21145: M.146 + I-23; M.21146: M.147 + I-23; M.21147: M.148 + I-23;
M.21148: M.149 + I-23; M.21149: M.150 + I-23; M.21150: M.151 + I-23; M.21151: M.152 + I-23;
M.21152: M.153 + I-23; M.21153: M.154 + I-23; M.21154: M.155 + I-23; M.21155: M.156 + I-23;
M.21156: M.157 + I-23; M.21157: M.158 + I-23; M.21158: M.159 + I-23; M.21159: M.160 + I-23;
M.21160: M.161 + I-23; M.21161: M.162 + I-23; M.21162: M.163 + I-23; M.21163: M.164 + I-23;
M.21164: M.165 + I-23; M.21165: M.166 + I-23; M.21166: M.167 + I-23; M.21167: M.168 + I-23;
M.21168: M.169 + I-23; M.21169: M.170 + I-23; M.21170: M.171 + I-23; M.21171: M.172 + I-23;
M.21172: M.173 + I-23; M.21173: M.174 + I-23; M.21174: M.175 + I-23; M.21175: M.176 + I-23;
M.21176: M.177 + I-23; M.21177: M.178 + I-23; M.21178: M.179 + I-23; M.21179: M.180 + I-23;
M.21180: M.181 + I-23; M.21181: M.182 + I-23; M.21182: M.183 + I-23; M.21183: M.184 + I-23;
M.21184: M.185 + I-23; M.21185: M.186 + I-23; M.21186: M.187 + I-23; M.21187: M.188 + I-23;
M.21188: M.189 + I-23; M.21189: M.190 + I-23; M.21190: M.191 + I-23; M.21191: M.192 + I-23;
M.21192: M.193 + I-23; M.21193: M.194 + I-23; M.21194: M.195 + I-23; M.21195: M.196 + I-23;
M.21196: M.197 + I-23; M.21197: M.198 + I-23; M.21198: M.199 + I-23; M.21199: M.200 + I-23;
M.21200: M.201 + I-23; M.21201: M.202 + I-23; M.21202: M.203 + I-23; M.21203: M.204 + I-23;
M.21204: M.205 + I-23; M.21205: M.206 + I-23; M.21206: M.207 + I-23; M.21207: M.208 + I-23;
M.21208: M.209 + I-23; M.21209: M.210 + I-23; M.21210: M.211 + I-23; M.21211: M.212 + I-23;
M.21212: M.213 + I-23; M.21213: M.214 + I-23; M.21214: M.215 + I-23; M.21215: M.216 + I-23;
M.21216: M.217 + I-23; M.21217: M.218 + I-23; M.21218: M.219 + I-23; M.21219: M.220 + I-23;
M.21220: M.221 + I-23; M.21221: M.222 + I-23; M.21222: M.223 + I-23; M.21223: M.224 + I-23;
M.21224: M.225 + I-23; M.21225: M.226 + I-23; M.21226: M.227 + I-23; M.21227: M.228 + I-23;
M.21228: M.229 + I-23; M.21229: M.230 + I-23; M.21230: M.231 + I-23; M.21231: M.232 + I-23;
M.21232: M.233 + I-23; M.21233: M.234 + I-23; M.21234: M.235 + I-23; M.21235: M.236 + I-23;
M.21236: M.237 + I-23; M.21237: M.238 + I-23; M.21238: M.239 + I-23; M.21239: M.240 + I-23;
M.21240: M.241 + I-23; M.21241: M.242 + I-23; M.21242: M.243 + I-23; M.21243: M.244 + I-23;
M.21244: M.245 + I-23; M.21245: M.246 + I-23; M.21246: M.247 + I-23; M.21247: M.248 + I-23;
M.21248: M.249 + I-23; M.21249: M.250 + I-23; M.21250: M.251 + I-23; M.21251: M.252 + I-23;
M.21252: M.253 + I-23; M.21253: M.254 + I-23; M.21254: M.255 + I-23; M.21255: M.256 + I-23;
M.21256: M.257 + I-23; M.21257: M.258 + I-23; M.21258: M.259 + I-23; M.21259: M.260 + I-23;
M.21260: M.261 + I-23; M.21261: M.262 + I-23; M.21262: M.263 + I-23; M.21263: M.264 + I-23;
M.21264: M.265 + I-23; M.21265: M.266 + I-23; M.21266: M.267 + I-23; M.21267: M.268 + I-23;
M.21268: M.269 + I-23; M.21269: M.270 + I-23; M.21270: M.271 + I-23; M.21271: M.272 + I-23;
M.21272: M.273 + I-23; M.21273: M.274 + I-23; M.21274: M.275 + I-23; M.21275: M.276 + I-23;
M.21276: M.277 + I-23; M.21277: M.278 + I-23; M.21278: M.279 + I-23; M.21279: M.280 + I-23;
M.21280: M.281 + I-23; M.21281: M.282 + I-23; M.21282: M.283 + I-23; M.21283: M.284 + I-23;
M.21284: M.285 + I-23; M.21285: M.286 + I-23; M.21286: M.287 + I-23; M.21287: M.288 + I-23;
M.21288: M.289 + I-23; M.21289: M.290 + I-23; M.21290: M.291 + I-23; M.21291: M.292 + I-23;
M.21292: M.293 + I-23; M.21293: M.294 + I-23; M.21294: M.295 + I-23; M.21295: M.296 + I-23;
M.21296: M.297 + I-23; M.21297: M.298 + I-23; M.21298: M.299 + I-23; M.21299: M.300 + I-23;
M.21300: M.301 + I-23; M.21301: M.302 + I-23; M.21302: M.303 + I-23; M.21303: M.304 + I-23;
M.21304: M.305 + I-23; M.21305: M.306 + I-23; M.21306: M.307 + I-23; M.21307: M.308 + I-23;
M.21308: M.309 + I-23; M.21309: M.310 + I-23; M.21310: M.311 + I-23; M.21311: M.312 + I-23;
M.21312: M.313 + I-23; M.21313: M.314 + I-23; M.21314: M.315 + I-23; M.21315: M.316 + I-23;
M.21316: M.317 + I-23; M.21317: M.318 + I-23; M.21318: M.319 + I-23; M.21319: M.320 + I-23;
M.21320: M.321 + I-23; M.21321: M.322 + I-23; M.21322: M.323 + I-23; M.21323: M.324 + I-23;
M.21324: M.325 + I-23; M.21325: M.326 + I-23; M.21326: M.327 + I-23; M.21327: M.328 + I-23;
M.21328: M.329 + I-23; M.21329: M.330 + I-23; M.21330: M.331 + I-23; M.21331: M.332 + I-23;
M.21332: M.333 + I-23; M.21333: M.334 + I-23; M.21334: M.335 + I-23; M.21335: M.336 + I-23;
M.21336: M.337 + I-23; M.21337: M.338 + I-23; M.21338: M.339 + I-23; M.21339: M.340 + I-23;
M.21340: M.341 + I-23; M.21341: M.342 + I-23; M.21342: M.343 + I-23; M.21343: M.344 + I-23;
M.21344: M.345 + I-23; M.21345: M.346 + I-23; M.21346: M.347 + I-23; M.21347: M.348 + I-23;
M.21348: M.349 + I-23; M.21349: M.350 + I-23; M.21350: M.351 + I-23; M.21351: M.352 + I-23;
M.21352: M.353 + I-23; M.21353: M.354 + I-23; M.21354: M.355 + I-23; M.21355: M.356 + I-23;
M.21356: M.357 + I-23; M.21357: M.358 + I-23; M.21358: M.359 + I-23; M.21359: M.360 + I-23;
M.21360: M.361 + I-23; M.21361: M.362 + I-23; M.21362: M.363 + I-23; M.21363: M.364 + I-23;
M.21364: M.365 + I-23; M.21365: M.366 + I-23; M.21366: M.367 + I-23; M.21367: M.368 + I-23;
M.21368: M.369 + I-23; M.21369: M.370 + I-23; M.21370: M.371 + I-23; M.21371: M.372 + I-23;
M.21372: M.373 + I-23; M.21373: M.374 + I-23; M.21374: M.375 + I-23; M.21375: M.376 + I-23;
M.21376: M.377 + I-23; M.21377: M.378 + I-23; M.21378: M.379 + I-23; M.21379: M.380 + I-23;
M.21380: M.381 + I-23; M.21381: M.382 + I-23; M.21382: M.383 + I-23; M.21383: M.384 + I-23;
M.21384: M.385 + I-23; M.21385: M.386 + I-23; M.21386: M.387 + I-23; M.21387: M.388 + I-23;
M.21388: M.389 + I-23; M.21389: M.390 + I-23; M.21390: M.391 + I-23; M.21391: M.392 + I-23;
M.21392: M.393 + I-23; M.21393: M.394 + I-23; M.21394: M.395 + I-23; M.21395: M.396 + I-23;
M.21396: M.397 + I-23; M.21397: M.398 + I-23; M.21398: M.399 + I-23; M.21399: M.400 + I-23;
M.21400: M.401 + I-23; M.21401: M.402 + I-23; M.21402: M.403 + I-23; M.21403: M.404 + I-23;
M.21404: M.405 + I-23; M.21405: M.406 + I-23; M.21406: M.407 + I-23; M.21407: M.408 + I-23;
M.21408: M.409 + I-23; M.21409: M.410 + I-23; M.21410: M.411 + I-23; M.21411: M.412 + I-23;
M.21412: M.413 + I-23; M.21413: M.414 + I-23; M.21414: M.415 + I-23; M.21415: M.416 + I-23;
M.21416: M.417 + I-23; M.21417: M.418 + I-23; M.21418: M.419 + I-23; M.21419: M.420 + I-23;
M.21420: M.421 + I-23; M.21421: M.422 + I-23; M.21422: M.423 + I-23; M.21423: M.424 + I-23;
M.21424: M.425 + I-23; M.21425: M.426 + I-23; M.21426: M.427 + I-23; M.21427: M.428 + I-23;
M.21428: M.429 + I-23; M.21429: M.430 + I-23; M.21430: M.431 + I-23; M.21431: M.432 + I-23;
M.21432: M.433 + I-23; M.21433: M.434 + I-23; M.21434: M.435 + I-23; M.21435: M.436 + I-23;
M.21436: M.437 + I-23; M.21437: M.438 + I-23; M.21438: M.439 + I-23; M.21439: M.440 + I-23;
M.21440: M.441 + I-23; M.21441: M.442 + I-23; M.21442: M.443 + I-23; M.21443: M.444 + I-23;
M.21444: M.445 + I-23; M.21445: M.446 + I-23; M.21446: M.447 + I-23; M.21447: M.448 + I-23;
M.21448: M.449 + I-23; M.21449: M.450 + I-23.

In another embodiment, the present invention relates to ternary herbicidal mixtures M.22000 to M.22449 listed in Table M(w) below, comprising mixtures of the binary mixtures depicted in table M(a) and a third herbicide I-24.

TABLE M(w)
M.22000: M.1 + I-24; M.22001: M.2 + I-24; M.22002: M.3 + I-24; M.22003: M.4 + I-24;
M.22004: M.5 + I-24; M.22005: M.6 + I-24; M.22006: M.7 + I-24; M.22007: M.8 + I-24;
M.22008: M.9 + I-24; M.22009: M.10 + I-24; M.22010: M.11 + I-24; M.22011: M.12 + I-24;
M.22012: M.13 + I-24; M.22013: M.14 + I-24; M.22014: M.15 + I-24; M.22015: M.16 + I-24;
M.22016: M.17 + I-24; M.22017: M.18 + I-24; M.22018: M.19 + I-24; M.22019: M.20 + I-24;
M.22020: M.21 + I-24; M.22021: M.22 + I-24; M.22022: M.23 + I-24; M.22023: M.24 + I-24;
M.22024: M.25 + I-24; M.22025: M.26 + I-24; M.22026: M.27 + I-24; M.22027: M.28 + I-24;
M.22028: M.29 + I-24; M.22029: M.30 + I-24; M.22030: M.31 + I-24; M.22031: M.32 + I-24;
M.22032: M.33 + I-24; M.22033: M.34 + I-24; M.22034: M.35 + I-24; M.22035: M.36 + I-24;
M.22036: M.37 + I-24; M.22037: M.38 + I-24; M.22038: M.39 + I-24; M.22039: M.40 + I-24;
M.22040: M.41 + I-24; M.22041: M.42 + I-24; M.22042: M.43 + I-24; M.22043: M.44 + I-24;
M.22044: M.45 + I-24; M.22045: M.46 + I-24; M.22046: M.47 + I-24; M.22047: M.48 + I-24;
M.22048: M.49 + I-24; M.22049: M.50 + I-24; M.22050: M.51 + I-24; M.22051: M.52 + I-24;
M.22052: M.53 + I-24; M.22053: M.54 + I-24; M.22054: M.55 + I-24; M.22055: M.56 + I-24;
M.22056: M.57 + I-24; M.22057: M.58 + I-24; M.22058: M.59 + I-24; M.22059: M.60 + I-24;
M.22060: M.61 + I-24; M.22061: M.62 + I-24; M.22062: M.63 + I-24; M.22063: M.64 + I-24;
M.22064: M.65 + I-24; M.22065: M.66 + I-24; M.22066: M.67 + I-24; M.22067: M.68 + I-24;
M.22068: M.69 + I-24; M.22069: M.70 + I-24; M.22070: M.71 + I-24; M.22071: M.72 + I-24;
M.22072: M.73 + I-24; M.22073: M.74 + I-24; M.22074: M.75 + I-24; M.22075: M.76 + I-24;
M.22076: M.77 + I-24; M.22077: M.78 + I-24; M.22078: M.79 + I-24; M.22079: M.80 + I-24;
M.22080: M.81 + I-24; M.22081: M.82 + I-24; M.22082: M.83 + I-24; M.22083: M.84 + I-24;
M.22084: M.85 + I-24; M.22085: M.86 + I-24; M.22086: M.87 + I-24; M.22087: M.88 + I-24;
M.22088: M.89 + I-24; M.22089: M.90 + I-24; M.22090: M.91 + I-24; M.22091: M.92 + I-24;
M.22092: M.93 + I-24; M.22093: M.94 + I-24; M.22094: M.95 + I-24; M.22095: M.96 + I-24;
M.22096: M.97 + I-24; M.22097: M.98 + I-24; M.22098: M.99 + I-24; M.22099: M.100 + I-24;
M.22100: M.101 + I-24; M.22101: M.102 + I-24; M.22102: M.103 + I-24; M.22103: M.104 + I-24;
M.22104: M.105 + I-24; M.22105: M.106 + I-24; M.22106: M.107 + I-24; M.22107: M.108 + I-24;
M.22108: M.109 + I-24; M.22109: M.110 + I-24; M.22110: M.111 + I-24; M.22111: M.112 + I-24;
M.22112: M.113 + I-24; M.22113: M.114 + I-24; M.22114: M.115 + I-24; M.22115: M.116 + I-24;
M.22116: M.117 + I-24; M.22117: M.118 + I-24; M.22118: M.119 + I-24; M.22119: M.120 + I-24;
M.22120: M.121 + I-24; M.22121: M.122 + I-24; M.22122: M.123 + I-24; M.22123: M.124 + I-24;
M.22124: M.125 + I-24; M.22125: M.126 + I-24; M.22126: M.127 + I-24; M.22127: M.128 + I-24;
M.22128: M.129 + I-24; M.22129: M.130 + I-24; M.22130: M.131 + I-24; M.22131: M.132 + I-24;
M.22132: M.133 + I-24; M.22133: M.134 + I-24; M.22134: M.135 + I-24; M.22135: M.136 + I-24;
M.22136: M.137 + I-24; M.22137: M.138 + I-24; M.22138: M.139 + I-24; M.22139: M.140 + I-24;
M.22140: M.141 + I-24; M.22141: M.142 + I-24; M.22142: M.143 + I-24; M.22143: M.144 + I-24;
M.22144: M.145 + I-24; M.22145: M.146 + I-24; M.22146: M.147 + I-24; M.22147: M.148 + I-24;
M.22148: M.149 + I-24; M.22149: M.150 + I-24; M.22150: M.151 + I-24; M.22151: M.152 + I-24;
M.22152: M.153 + I-24; M.22153: M.154 + I-24; M.22154: M.155 + I-24; M.22155: M.156 + I-24;
M.22156: M.157 + I-24; M.22157: M.158 + I-24; M.22158: M.159 + I-24; M.22159: M.160 + I-24;
M.22160: M.161 + I-24; M.22161: M.162 + I-24; M.22162: M.163 + I-24; M.22163: M.164 + I-24;
M.22164: M.165 + I-24; M.22165: M.166 + I-24; M.22166: M.167 + I-24; M.22167: M.168 + I-24;
M.22168: M.169 + I-24; M.22169: M.170 + I-24; M.22170: M.171 + I-24; M.22171: M.172 + I-24;
M.22172: M.173 + I-24; M.22173: M.174 + I-24; M.22174: M.175 + I-24; M.22175: M.176 + I-24;
M.22176: M.177 + I-24; M.22177: M.178 + I-24; M.22178: M.179 + I-24; M.22179: M.180 + I-24;
M.22180: M.181 + I-24; M.22181: M.182 + I-24; M.22182: M.183 + I-24; M.22183: M.184 + I-24;
M.22184: M.185 + I-24; M.22185: M.186 + I-24; M.22186: M.187 + I-24; M.22187: M.188 + I-24;
M.22188: M.189 + I-24; M.22189: M.190 + I-24; M.22190: M.191 + I-24; M.22191: M.192 + I-24;
M.22192: M.193 + I-24; M.22193: M.194 + I-24; M.22194: M.195 + I-24; M.22195: M.196 + I-24;
M.22196: M.197 + I-24; M.22197: M.198 + I-24; M.22198: M.199 + I-24; M.22199: M.200 + I-24;
M.22200: M.201 + I-24; M.22201: M.202 + I-24; M.22202: M.203 + I-24; M.22203: M.204 + I-24;
M.22204: M.205 + I-24; M.22205: M.206 + I-24; M.22206: M.207 + I-24; M.22207: M.208 + I-24;
M.22208: M.209 + I-24; M.22209: M.210 + I-24; M.22210: M.211 + I-24; M.22211: M.212 + I-24;
M.22212: M.213 + I-24; M.22213: M.214 + I-24; M.22214: M.215 + I-24; M.22215: M.216 + I-24;
M.22216: M.217 + I-24; M.22217: M.218 + I-24; M.22218: M.219 + I-24; M.22219: M.220 + I-24;
M.22220: M.221 + I-24; M.22221: M.222 + I-24; M.22222: M.223 + I-24; M.22223: M.224 + I-24;
M.22224: M.225 + I-24; M.22225: M.226 + I-24; M.22226: M.227 + I-24; M.22227: M.228 + I-24;
M.22228: M.229 + I-24; M.22229: M.230 + I-24; M.22230: M.231 + I-24; M.22231: M.232 + I-24;
M.22232: M.233 + I-24; M.22233: M.234 + I-24; M.22234: M.235 + I-24; M.22235: M.236 + I-24;
M.22236: M.237 + I-24; M.22237: M.238 + I-24; M.22238: M.239 + I-24; M.22239: M.240 + I-24;
M.22240: M.241 + I-24; M.22241: M.242 + I-24; M.22242: M.243 + I-24; M.22243: M.244 + I-24;
M.22244: M.245 + I-24; M.22245: M.246 + I-24; M.22246: M.247 + I-24; M.22247: M.248 + I-24;
M.22248: M.249 + I-24; M.22249: M.250 + I-24; M.22250: M.251 + I-24; M.22251: M.252 + I-24;
M.22252: M.253 + I-24; M.22253: M.254 + I-24; M.22254: M.255 + I-24; M.22255: M.256 + I-24;
M.22256: M.257 + I-24; M.22257: M.258 + I-24; M.22258: M.259 + I-24; M.22259: M.260 + I-24;
M.22260: M.261 + I-24; M.22261: M.262 + I-24; M.22262: M.263 + I-24; M.22263: M.264 + I-24;
M.22264: M.265 + I-24; M.22265: M.266 + I-24; M.22266: M.267 + I-24; M.22267: M.268 + I-24;
M.22268: M.269 + I-24; M.22269: M.270 + I-24; M.22270: M.271 + I-24; M.22271: M.272 + I-24;
M.22272: M.273 + I-24; M.22273: M.274 + I-24; M.22274: M.275 + I-24; M.22275: M.276 + I-24;
M.22276: M.277 + I-24; M.22277: M.278 + I-24; M.22278: M.279 + I-24; M.22279: M.280 + I-24;
M.22280: M.281 + I-24; M.22281: M.282 + I-24; M.22282: M.283 + I-24; M.22283: M.284 + I-24;
M.22284: M.285 + I-24; M.22285: M.286 + I-24; M.22286: M.287 + I-24; M.22287: M.288 + I-24;
M.22288: M.289 + I-24; M.22289: M.290 + I-24; M.22290: M.291 + I-24; M.22291: M.292 + I-24;
M.22292: M.293 + I-24; M.22293: M.294 + I-24; M.22294: M.295 + I-24; M.22295: M.296 + I-24;
M.22296: M.297 + I-24; M.22297: M.298 + I-24; M.22298: M.299 + I-24; M.22299: M.300 + I-24;
M.22300: M.301 + I-24; M.22301: M.302 + I-24; M.22302: M.303 + I-24; M.22303: M.304 + I-24;
M.22304: M.305 + I-24; M.22305: M.306 + I-24; M.22306: M.307 + I-24; M.22307: M.308 + I-24;
M.22308: M.309 + I-24; M.22309: M.310 + I-24; M.22310: M.311 + I-24; M.22311: M.312 + I-24;
M.22312: M.313 + I-24; M.22313: M.314 + I-24; M.22314: M.315 + I-24; M.22315: M.316 + I-24;
M.22316: M.317 + I-24; M.22317: M.318 + I-24; M.22318: M.319 + I-24; M.22319: M.320 + I-24;
M.22320: M.321 + I-24; M.22321: M.322 + I-24; M.22322: M.323 + I-24; M.22323: M.324 + I-24;
M.22324: M.325 + I-24; M.22325: M.326 + I-24; M.22326: M.327 + I-24; M.22327: M.328 + I-24;
M.22328: M.329 + I-24; M.22329: M.330 + I-24; M.22330: M.331 + I-24; M.22331: M.332 + I-24;
M.22332: M.333 + I-24; M.22333: M.334 + I-24; M.22334: M.335 + I-24; M.22335: M.336 + I-24;
M.22336: M.337 + I-24; M.22337: M.338 + I-24; M.22338: M.339 + I-24; M.22339: M.340 + I-24;
M.22340: M.341 + I-24; M.22341: M.342 + I-24; M.22342: M.343 + I-24; M.22343: M.344 + I-24;
M.22344: M.345 + I-24; M.22345: M.346 + I-24; M.22346: M.347 + I-24; M.22347: M.348 + I-24;
M.22348: M.349 + I-24; M.22349: M.350 + I-24; M.22350: M.351 + I-24; M.22351: M.352 + I-24;
M.22352: M.353 + I-24; M.22353: M.354 + I-24; M.22354: M.355 + I-24; M.22355: M.356 + I-24;
M.22356: M.357 + I-24; M.22357: M.358 + I-24; M.22358: M.359 + I-24; M.22359: M.360 + I-24;
M.22360: M.361 + I-24; M.22361: M.362 + I-24; M.22362: M.363 + I-24; M.22363: M.364 + I-24;
M.22364: M.365 + I-24; M.22365: M.366 + I-24; M.22366: M.367 + I-24; M.22367: M.368 + I-24;
M.22368: M.369 + I-24; M.22369: M.370 + I-24; M.22370: M.371 + I-24; M.22371: M.372 + I-24;
M.22372: M.373 + I-24; M.22373: M.374 + I-24; M.22374: M.375 + I-24; M.22375: M.376 + I-24;
M.22376: M.377 + I-24; M.22377: M.378 + I-24; M.22378: M.379 + I-24; M.22379: M.380 + I-24;
M.22380: M.381 + I-24; M.22381: M.382 + I-24; M.22382: M.383 + I-24; M.22383: M.384 + I-24;
M.22384: M.385 + I-24; M.22385: M.386 + I-24; M.22386: M.387 + I-24; M.22387: M.388 + I-24;
M.22388: M.389 + I-24; M.22389: M.390 + I-24; M.22390: M.391 + I-24; M.22391: M.392 + I-24;
M.22392: M.393 + I-24; M.22393: M.394 + I-24; M.22394: M.395 + I-24; M.22395: M.396 + I-24;
M.22396: M.397 + I-24; M.22397: M.398 + I-24; M.22398: M.399 + I-24; M.22399: M.400 + I-24;
M.22400: M.401 + I-24; M.22401: M.402 + I-24; M.22402: M.403 + I-24; M.22403: M.404 + I-24;
M.22404: M.405 + I-24; M.22405: M.406 + I-24; M.22406: M.407 + I-24; M.22407: M.408 + I-24;
M.22408: M.409 + I-24; M.22409: M.410 + I-24; M.22410: M.411 + I-24; M.22411: M.412 + I-24;
M.22412: M.413 + I-24; M.22413: M.414 + I-24; M.22414: M.415 + I-24; M.22415: M.416 + I-24;
M.22416: M.417 + I-24; M.22417: M.418 + I-24; M.22418: M.419 + I-24; M.22419: M.420 + I-24;
M.22420: M.421 + I-24; M.22421: M.422 + I-24; M.22422: M.423 + I-24; M.22423: M.424 + I-24;
M.22424: M.425 + I-24; M.22425: M.426 + I-24; M.22426: M.427 + I-24; M.22427: M.428 + I-24;
M.22428: M.429 + I-24; M.22429: M.430 + I-24; M.22430: M.431 + I-24; M.22431: M.432 + I-24;
M.22432: M.433 + I-24; M.22433: M.434 + I-24; M.22434: M.435 + I-24; M.22435: M.436 + I-24;
M.22436: M.437 + I-24; M.22437: M.438 + I-24; M.22438: M.439 + I-24; M.22439: M.440 + I-24;
M.22440: M.441 + I-24; M.22441: M.442 + I-24; M.22442: M.443 + I-24; M.22443: M.444 + I-24;
M.22444: M.445 + I-24; M.22445: M.446 + I-24; M.22446: M.447 + I-24; M.22447: M.448 + I-24;
M.22448: M.449 + I-24; M.22449: M.450 + I-24.

In another embodiment, the present invention relates to ternary herbicidal mixtures M.23000 to M.23449 listed in Table M(x) below, comprising mixtures of the binary mixtures depicted in table M(a) and a third herbicide I-25.

TABLE M(x)
M.23000: M.1 + I-25; M.23001: M.2 + I-25; M.23002: M.3 + I-25; M.23003: M.4 + I-25;
M.23004: M.5 + I-25; M.23005: M.6 + I-25; M.23006: M.7 + I-25; M.23007: M.8 + I-25;
M.23008: M.9 + I-25; M.23009: M.10 + I-25; M.23010: M.11 + I-25; M.23011: M.12 + I-25;
M.23012: M.13 + I-25; M.23013: M.14 + I-25; M.23014: M.15 + I-25; M.23015: M.16 + I-25;
M.23016: M.17 + I-25; M.23017: M.18 + I-25; M.23018: M.19 + I-25; M.23019: M.20 + I-25;
M.23020: M.21 + I-25; M.23021: M.22 + I-25; M.23022: M.23 + I-25; M.23023: M.24 + I-25;
M.23024: M.25 + I-25; M.23025: M.26 + I-25; M.23026: M.27 + I-25; M.23027: M.28 + I-25;
M.23028: M.29 + I-25; M.23029: M.30 + I-25; M.23030: M.31 + I-25; M.23031: M.32 + I-25;
M.23032: M.33 + I-25; M.23033: M.34 + I-25; M.23034: M.35 + I-25; M.23035: M.36 + I-25;
M.23036: M.37 + I-25; M.23037: M.38 + I-25; M.23038: M.39 + I-25; M.23039: M.40 + I-25;
M.23040: M.41 + I-25; M.23041: M.42 + I-25; M.23042: M.43 + I-25; M.23043: M.44 + I-25;
M.23044: M.45 + I-25; M.23045: M.46 + I-25; M.23046: M.47 + I-25; M.23047: M.48 + I-25;
M.23048: M.49 + I-25; M.23049: M.50 + I-25; M.23050: M.51 + I-25; M.23051: M.52 + I-25;
M.23052: M.53 + I-25; M.23053: M.54 + I-25; M.23054: M.55 + I-25; M.23055: M.56 + I-25;
M.23056: M.57 + I-25; M.23057: M.58 + I-25; M.23058: M.59 + I-25; M.23059: M.60 + I-25;
M.23060: M.61 + I-25; M.23061: M.62 + I-25; M.23062: M.63 + I-25; M.23063: M.64 + I-25;
M.23064: M.65 + I-25; M.23065: M.66 + I-25; M.23066: M.67 + I-25; M.23067: M.68 + I-25;
M.23068: M.69 + I-25; M.23069: M.70 + I-25; M.23070: M.71 + I-25; M.23071: M.72 + I-25;
M.23072: M.73 + I-25; M.23073: M.74 + I-25; M.23074: M.75 + I-25; M.23075: M.76 + I-25;
M.23076: M.77 + I-25; M.23077: M.78 + I-25; M.23078: M.79 + I-25; M.23079: M.80 + I-25;
M.23080: M.81 + I-25; M.23081: M.82 + I-25; M.23082: M.83 + I-25; M.23083: M.84 + I-25;
M.23084: M.85 + I-25; M.23085: M.86 + I-25; M.23086: M.87 + I-25; M.23087: M.88 + I-25;
M.23088: M.89 + I-25; M.23089: M.90 + I-25; M.23090: M.91 + I-25; M.23091: M.92 + I-25;
M.23092: M.93 + I-25; M.23093: M.94 + I-25; M.23094: M.95 + I-25; M.23095: M.96 + I-25;
M.23096: M.97 + I-25; M.23097: M.98 + I-25; M.23098: M.99 + I-25; M.23099: M.100 + I-25;
M.23100: M.101 + I-25; M.23101: M.102 + I-25; M.23102: M.103 + I-25; M.23103: M.104 + I-25;
M.23104: M.105 + I-25; M.23105: M.106 + I-25; M.23106: M.107 + I-25; M.23107: M.108 + I-25;
M.23108: M.109 + I-25; M.23109: M.110 + I-25; M.23110: M.111 + I-25; M.23111: M.112 + I-25;
M.23112: M.113 + I-25; M.23113: M.114 + I-25; M.23114: M.115 + I-25; M.23115: M.116 + I-25;
M.23116: M.117 + I-25; M.23117: M.118 + I-25; M.23118: M.119 + I-25; M.23119: M.120 + I-25;
M.23120: M.121 + I-25; M.23121: M.122 + I-25; M.23122: M.123 + I-25; M.23123: M.124 + I-25;
M.23124: M.125 + I-25; M.23125: M.126 + I-25; M.23126: M.127 + I-25; M.23127: M.128 + I-25;
M.23128: M.129 + I-25; M.23129: M.130 + I-25; M.23130: M.131 + I-25; M.23131: M.132 + I-25;
M.23132: M.133 + I-25; M.23133: M.134 + I-25; M.23134: M.135 + I-25; M.23135: M.136 + I-25;
M.23136: M.137 + I-25; M.23137: M.138 + I-25; M.23138: M.139 + I-25; M.23139: M.140 + I-25;
M.23140: M.141 + I-25; M.23141: M.142 + I-25; M.23142: M.143 + I-25; M.23143: M.144 + I-25;
M.23144: M.145 + I-25; M.23145: M.146 + I-25; M.23146: M.147 + I-25; M.23147: M.148 + I-25;
M.23148: M.149 + I-25; M.23149: M.150 + I-25; M.23150: M.151 + I-25; M.23151: M.152 + I-25;
M.23152: M.153 + I-25; M.23153: M.154 + I-25; M.23154: M.155 + I-25; M.23155: M.156 + I-25;
M.23156: M.157 + I-25; M.23157: M.158 + I-25; M.23158: M.159 + I-25; M.23159: M.160 + I-25;
M.23160: M.161 + I-25; M.23161: M.162 + I-25; M.23162: M.163 + I-25; M.23163: M.164 + I-25;
M.23164: M.165 + I-25; M.23165: M.166 + I-25; M.23166: M.167 + I-25; M.23167: M.168 + I-25;
M.23168: M.169 + I-25; M.23169: M.170 + I-25; M.23170: M.171 + I-25; M.23171: M.172 + I-25;
M.23172: M.173 + I-25; M.23173: M.174 + I-25; M.23174: M.175 + I-25; M.23175: M.176 + I-25;
M.23176: M.177 + I-25; M.23177: M.178 + I-25; M.23178: M.179 + I-25; M.23179: M.180 + I-25;
M.23180: M.181 + I-25; M.23181: M.182 + I-25; M.23182: M.183 + I-25; M.23183: M.184 + I-25;
M.23184: M.185 + I-25; M.23185: M.186 + I-25; M.23186: M.187 + I-25; M.23187: M.188 + I-25;
M.23188: M.189 + I-25; M.23189: M.190 + I-25; M.23190: M.191 + I-25; M.23191: M.192 + I-25;
M.23192: M.193 + I-25; M.23193: M.194 + I-25; M.23194: M.195 + I-25; M.23195: M.196 + I-25;
M.23196: M.197 + I-25; M.23197: M.198 + I-25; M.23198: M.199 + I-25; M.23199: M.200 + I-25;
M.23200: M.201 + I-25; M.23201: M.202 + I-25; M.23202: M.203 + I-25; M.23203: M.204 + I-25;
M.23204: M.205 + I-25; M.23205: M.206 + I-25; M.23206: M.207 + I-25; M.23207: M.208 + I-25;
M.23208: M.209 + I-25; M.23209: M.210 + I-25; M.23210: M.211 + I-25; M.23211: M.212 + I-25;
M.23212: M.213 + I-25; M.23213: M.214 + I-25; M.23214: M.215 + I-25; M.23215: M.216 + I-25;
M.23216: M.217 + I-25; M.23217: M.218 + I-25; M.23218: M.219 + I-25; M.23219: M.220 + I-25;
M.23220: M.221 + I-25; M.23221: M.222 + I-25; M.23222: M.223 + I-25; M.23223: M.224 + I-25;
M.23224: M.225 + I-25; M.23225: M.226 + I-25; M.23226: M.227 + I-25; M.23227: M.228 + I-25;
M.23228: M.229 + I-25; M.23229: M.230 + I-25; M.23230: M.231 + I-25; M.23231: M.232 + I-25;
M.23232: M.233 + I-25; M.23233: M.234 + I-25; M.23234: M.235 + I-25; M.23235: M.236 + I-25;
M.23236: M.237 + I-25; M.23237: M.238 + I-25; M.23238: M.239 + I-25; M.23239: M.240 + I-25;
M.23240: M.241 + I-25; M.23241: M.242 + I-25; M.23242: M.243 + I-25; M.23243: M.244 + I-25;
M.23244: M.245 + I-25; M.23245: M.246 + I-25; M.23246: M.247 + I-25; M.23247: M.248 + I-25;
M.23248: M.249 + I-25; M.23249: M.250 + I-25; M.23250: M.251 + I-25; M.23251: M.252 + I-25;
M.23252: M.253 + I-25; M.23253: M.254 + I-25; M.23254: M.255 + I-25; M.23255: M.256 + I-25;
M.23256: M.257 + I-25; M.23257: M.258 + I-25; M.23258: M.259 + I-25; M.23259: M.260 + I-25;
M.23260: M.261 + I-25; M.23261: M.262 + I-25; M.23262: M.263 + I-25; M.23263: M.264 + I-25;
M.23264: M.265 + I-25; M.23265: M.266 + I-25; M.23266: M.267 + I-25; M.23267: M.268 + I-25;
M.23268: M.269 + I-25; M.23269: M.270 + I-25; M.23270: M.271 + I-25; M.23271: M.272 + I-25;
M.23272: M.273 + I-25; M.23273: M.274 + I-25; M.23274: M.275 + I-25; M.23275: M.276 + I-25;
M.23276: M.277 + I-25; M.23277: M.278 + I-25; M.23278: M.279 + I-25; M.23279: M.280 + I-25;
M.23280: M.281 + I-25; M.23281: M.282 + I-25; M.23282: M.283 + I-25; M.23283: M.284 + I-25;
M.23284: M.285 + I-25; M.23285: M.286 + I-25; M.23286: M.287 + I-25; M.23287: M.288 + I-25;
M.23288: M.289 + I-25; M.23289: M.290 + I-25; M.23290: M.291 + I-25; M.23291: M.292 + I-25;
M.23292: M.293 + I-25; M.23293: M.294 + I-25; M.23294: M.295 + I-25; M.23295: M.296 + I-25;
M.23296: M.297 + I-25; M.23297: M.298 + I-25; M.23298: M.299 + I-25; M.23299: M.300 + I-25;
M.23300: M.301 + I-25; M.23301: M.302 + I-25; M.23302: M.303 + I-25; M.23303: M.304 + I-25;
M.23304: M.305 + I-25; M.23305: M.306 + I-25; M.23306: M.307 + I-25; M.23307: M.308 + I-25;
M.23308: M.309 + I-25; M.23309: M.310 + I-25; M.23310: M.311 + I-25; M.23311: M.312 + I-25;
M.23312: M.313 + I-25; M.23313: M.314 + I-25; M.23314: M.315 + I-25; M.23315: M.316 + I-25;
M.23316: M.317 + I-25; M.23317: M.318 + I-25; M.23318: M.319 + I-25; M.23319: M.320 + I-25;
M.23320: M.321 + I-25; M.23321: M.322 + I-25; M.23322: M.323 + I-25; M.23323: M.324 + I-25;
M.23324: M.325 + I-25; M.23325: M.326 + I-25; M.23326: M.327 + I-25; M.23327: M.328 + I-25;
M.23328: M.329 + I-25; M.23329: M.330 + I-25; M.23330: M.331 + I-25; M.23331: M.332 + I-25;
M.23332: M.333 + I-25; M.23333: M.334 + I-25; M.23334: M.335 + I-25; M.23335: M.336 + I-25;
M.23336: M.337 + I-25; M.23337: M.338 + I-25; M.23338: M.339 + I-25; M.23339: M.340 + I-25;
M.23340: M.341 + I-25; M.23341: M.342 + I-25; M.23342: M.343 + I-25; M.23343: M.344 + I-25;
M.23344: M.345 + I-25; M.23345: M.346 + I-25; M.23346: M.347 + I-25; M.23347: M.348 + I-25;
M.23348: M.349 + I-25; M.23349: M.350 + I-25; M.23350: M.351 + I-25; M.23351: M.352 + I-25;
M.23352: M.353 + I-25; M.23353: M.354 + I-25; M.23354: M.355 + I-25; M.23355: M.356 + I-25;
M.23356: M.357 + I-25; M.23357: M.358 + I-25; M.23358: M.359 + I-25; M.23359: M.360 + I-25;
M.23360: M.361 + I-25; M.23361: M.362 + I-25; M.23362: M.363 + I-25; M.23363: M.364 + I-25;
M.23364: M.365 + I-25; M.23365: M.366 + I-25; M.23366: M.367 + I-25; M.23367: M.368 + I-25;
M.23368: M.369 + I-25; M.23369: M.370 + I-25; M.23370: M.371 + I-25; M.23371: M.372 + I-25;
M.23372: M.373 + I-25; M.23373: M.374 + I-25; M.23374: M.375 + I-25; M.23375: M.376 + I-25;
M.23376: M.377 + I-25; M.23377: M.378 + I-25; M.23378: M.379 + I-25; M.23379: M.380 + I-25;
M.23380: M.381 + I-25; M.23381: M.382 + I-25; M.23382: M.383 + I-25; M.23383: M.384 + I-25;
M.23384: M.385 + I-25; M.23385: M.386 + I-25; M.23386: M.387 + I-25; M.23387: M.388 + I-25;
M.23388: M.389 + I-25; M.23389: M.390 + I-25; M.23390: M.391 + I-25; M.23391: M.392 + I-25;
M.23392: M.393 + I-25; M.23393: M.394 + I-25; M.23394: M.395 + I-25; M.23395: M.396 + I-25;
M.23396: M.397 + I-25; M.23397: M.398 + I-25; M.23398: M.399 + I-25; M.23399: M.400 + I-25;
M.23400: M.401 + I-25; M.23401: M.402 + I-25; M.23402: M.403 + I-25; M.23403: M.404 + I-25;
M.23404: M.405 + I-25; M.23405: M.406 + I-25; M.23406: M.407 + I-25; M.23407: M.408 + I-25;
M.23408: M.409 + I-25; M.23409: M.410 + I-25; M.23410: M.411 + I-25; M.23411: M.412 + I-25;
M.23412: M.413 + I-25; M.23413: M.414 + I-25; M.23414: M.415 + I-25; M.23415: M.416 + I-25;
M.23416: M.417 + I-25; M.23417: M.418 + I-25; M.23418: M.419 + I-25; M.23419: M.420 + I-25;
M.23420: M.421 + I-25; M.23421: M.422 + I-25; M.23422: M.423 + I-25; M.23423: M.424 + I-25;
M.23424: M.425 + I-25; M.23425: M.426 + I-25; M.23426: M.427 + I-25; M.23427: M.428 + I-25;
M.23428: M.429 + I-25; M.23429: M.430 + I-25; M.23430: M.431 + I-25; M.23431: M.432 + I-25;
M.23432: M.433 + I-25; M.23433: M.434 + I-25; M.23434: M.435 + I-25; M.23435: M.436 + I-25;
M.23436: M.437 + I-25; M.23437: M.438 + I-25; M.23438: M.439 + I-25; M.23439: M.440 + I-25;
M.23440: M.441 + I-25; M.23441: M.442 + I-25; M.23442: M.443 + I-25; M.23443: M.444 + I-25;
M.23444: M.445 + I-25; M.23445: M.446 + I-25; M.23446: M.447 + I-25; M.23447: M.448 + I-25;
M.23448: M.449 + I-25; M.23449: M.450 + I-25.

In another embodiment, the present invention relates to ternary herbicidal mixtures M.24000 to M.24449 listed in Table M(y) below, comprising mixtures of the binary mixtures depicted in table M(a) and a third herbicide I-26.

TABLE M(y)
M.24000: M.1 + I-26; M.24001: M.2 + I-26; M.24002: M.3 + I-26; M.24003: M.4 + I-26;
M.24004: M.5 + I-26; M.24005: M.6 + I-26; M.24006: M.7 + I-26; M.24007: M.8 + I-26;
M.24008: M.9 + I-26; M.24009: M.10 + I-26; M.24010: M.11 + I-26; M.24011: M.12 + I-26;
M.24012: M.13 + I-26; M.24013: M.14 + I-26; M.24014: M.15 + I-26; M.24015: M.16 + I-26;
M.24016: M.17 + I-26; M.24017: M.18 + I-26; M.24018: M.19 + I-26; M.24019: M.20 + I-26;
M.24020: M.21 + I-26; M.24021: M.22 + I-26; M.24022: M.23 + I-26; M.24023: M.24 + I-26;
M.24024: M.25 + I-26; M.24025: M.26 + I-26; M.24026: M.27 + I-26; M.24027: M.28 + I-26;
M.24028: M.29 + I-26; M.24029: M.30 + I-26; M.24030: M.31 + I-26; M.24031: M.32 + I-26;
M.24032: M.33 + I-26; M.24033: M.34 + I-26; M.24034: M.35 + I-26; M.24035: M.36 + I-26;
M.24036: M.37 + I-26; M.24037: M.38 + I-26; M.24038: M.39 + I-26; M.24039: M.40 + I-26;
M.24040: M.41 + I-26; M.24041: M.42 + I-26; M.24042: M.43 + I-26; M.24043: M.44 + I-26;
M.24044: M.45 + I-26; M.24045: M.46 + I-26; M.24046: M.47 + I-26; M.24047: M.48 + I-26;
M.24048: M.49 + I-26; M.24049: M.50 + I-26; M.24050: M.51 + I-26; M.24051: M.52 + I-26;
M.24052: M.53 + I-26; M.24053: M.54 + I-26; M.24054: M.55 + I-26; M.24055: M.56 + I-26;
M.24056: M.57 + I-26; M.24057: M.58 + I-26; M.24058: M.59 + I-26; M.24059: M.60 + I-26;
M.24060: M.61 + I-26; M.24061: M.62 + I-26; M.24062: M.63 + I-26; M.24063: M.64 + I-26;
M.24064: M.65 + I-26; M.24065: M.66 + I-26; M.24066: M.67 + I-26; M.24067: M.68 + I-26;
M.24068: M.69 + I-26; M.24069: M.70 + I-26; M.24070: M.71 + I-26; M.24071: M.72 + I-26;
M.24072: M.73 + I-26; M.24073: M.74 + I-26; M.24074: M.75 + I-26; M.24075: M.76 + I-26;
M.24076: M.77 + I-26; M.24077: M.78 + I-26; M.24078: M.79 + I-26; M.24079: M.80 + I-26;
M.24080: M.81 + I-26; M.24081: M.82 + I-26; M.24082: M.83 + I-26; M.24083: M.84 + I-26;
M.24084: M.85 + I-26; M.24085: M.86 + I-26; M.24086: M.87 + I-26; M.24087: M.88 + I-26;
M.24088: M.89 + I-26; M.24089: M.90 + I-26; M.24090: M.91 + I-26; M.24091: M.92 + I-26;
M.24092: M.93 + I-26; M.24093: M.94 + I-26; M.24094: M.95 + I-26; M.24095: M.96 + I-26;
M.24096: M.97 + I-26; M.24097: M.98 + I-26; M.24098: M.99 + I-26; M.24099: M.100 + I-26;
M.24100: M.101 + I-26; M.24101: M.102 + I-26; M.24102: M.103 + I-26; M.24103: M.104 + I-26;
M.24104: M.105 + I-26; M.24105: M.106 + I-26; M.24106: M.107 + I-26; M.24107: M.108 + I-26;
M.24108: M.109 + I-26; M.24109: M.110 + I-26; M.24110: M.111 + I-26; M.24111: M.112 + I-26;
M.24112: M.113 + I-26; M.24113: M.114 + I-26; M.24114: M.115 + I-26; M.24115: M.116 + I-26;
M.24116: M.117 + I-26; M.24117: M.118 + I-26; M.24118: M.119 + I-26; M.24119: M.120 + I-26;
M.24120: M.121 + I-26; M.24121: M.122 + I-26; M.24122: M.123 + I-26; M.24123: M.124 + I-26;
M.24124: M.125 + I-26; M.24125: M.126 + I-26; M.24126: M.127 + I-26; M.24127: M.128 + I-26;
M.24128: M.129 + I-26; M.24129: M.130 + I-26; M.24130: M.131 + I-26; M.24131: M.132 + I-26;
M.24132: M.133 + I-26; M.24133: M.134 + I-26; M.24134: M.135 + I-26; M.24135: M.136 + I-26;
M.24136: M.137 + I-26; M.24137: M.138 + I-26; M.24138: M.139 + I-26; M.24139: M.140 + I-26;
M.24140: M.141 + I-26; M.24141: M.142 + I-26; M.24142: M.143 + I-26; M.24143: M.144 + I-26;
M.24144: M.145 + I-26; M.24145: M.146 + I-26; M.24146: M.147 + I-26; M.24147: M.148 + I-26;
M.24148: M.149 + I-26; M.24149: M.150 + I-26; M.24150: M.151 + I-26; M.24151: M.152 + I-26;
M.24152: M.153 + I-26; M.24153: M.154 + I-26; M.24154: M.155 + I-26; M.24155: M.156 + I-26;
M.24156: M.157 + I-26; M.24157: M.158 + I-26; M.24158: M.159 + I-26; M.24159: M.160 + I-26;
M.24160: M.161 + I-26; M.24161: M.162 + I-26; M.24162: M.163 + I-26; M.24163: M.164 + I-26;
M.24164: M.165 + I-26; M.24165: M.166 + I-26; M.24166: M.167 + I-26; M.24167: M.168 + I-26;
M.24168: M.169 + I-26; M.24169: M.170 + I-26; M.24170: M.171 + I-26; M.24171: M.172 + I-26;
M.24172: M.173 + I-26; M.24173: M.174 + I-26; M.24174: M.175 + I-26; M.24175: M.176 + I-26;
M.24176: M.177 + I-26; M.24177: M.178 + I-26; M.24178: M.179 + I-26; M.24179: M.180 + I-26;
M.24180: M.181 + I-26; M.24181: M.182 + I-26; M.24182: M.183 + I-26; M.24183: M.184 + I-26;
M.24184: M.185 + I-26; M.24185: M.186 + I-26; M.24186: M.187 + I-26; M.24187: M.188 + I-26;
M.24188: M.189 + I-26; M.24189: M.190 + I-26; M.24190: M.191 + I-26; M.24191: M.192 + I-26;
M.24192: M.193 + I-26; M.24193: M.194 + I-26; M.24194: M.195 + I-26; M.24195: M.196 + I-26;
M.24196: M.197 + I-26; M.24197: M.198 + I-26; M.24198: M.199 + I-26; M.24199: M.200 + I-26;
M.24200: M.201 + I-26; M.24201: M.202 + I-26; M.24202: M.203 + I-26; M.24203: M.204 + I-26;
M.24204: M.205 + I-26; M.24205: M.206 + I-26; M.24206: M.207 + I-26; M.24207: M.208 + I-26;
M.24208: M.209 + I-26; M.24209: M.210 + I-26; M.24210: M.211 + I-26; M.24211: M.212 + I-26;
M.24212: M.213 + I-26; M.24213: M.214 + I-26; M.24214: M.215 + I-26; M.24215: M.216 + I-26;
M.24216: M.217 + I-26; M.24217: M.218 + I-26; M.24218: M.219 + I-26; M.24219: M.220 + I-26;
M.24220: M.221 + I-26; M.24221: M.222 + I-26; M.24222: M.223 + I-26; M.24223: M.224 + I-26;
M.24224: M.225 + I-26; M.24225: M.226 + I-26; M.24226: M.227 + I-26; M.24227: M.228 + I-26;
M.24228: M.229 + I-26; M.24229: M.230 + I-26; M.24230: M.231 + I-26; M.24231: M.232 + I-26;
M.24232: M.233 + I-26; M.24233: M.234 + I-26; M.24234: M.235 + I-26; M.24235: M.236 + I-26;
M.24236: M.237 + I-26; M.24237: M.238 + I-26; M.24238: M.239 + I-26; M.24239: M.240 + I-26;
M.24240: M.241 + I-26; M.24241: M.242 + I-26; M.24242: M.243 + I-26; M.24243: M.244 + I-26;
M.24244: M.245 + I-26; M.24245: M.246 + I-26; M.24246: M.247 + I-26; M.24247: M.248 + I-26;
M.24248: M.249 + I-26; M.24249: M.250 + I-26; M.24250: M.251 + I-26; M.24251: M.252 + I-26;
M.24252: M.253 + I-26; M.24253: M.254 + I-26; M.24254: M.255 + I-26; M.24255: M.256 + I-26;
M.24256: M.257 + I-26; M.24257: M.258 + I-26; M.24258: M.259 + I-26; M.24259: M.260 + I-26;
M.24260: M.261 + I-26; M.24261: M.262 + I-26; M.24262: M.263 + I-26; M.24263: M.264 + I-26;
M.24264: M.265 + I-26; M.24265: M.266 + I-26; M.24266: M.267 + I-26; M.24267: M.268 + I-26;
M.24268: M.269 + I-26; M.24269: M.270 + I-26; M.24270: M.271 + I-26; M.24271: M.272 + I-26;
M.24272: M.273 + I-26; M.24273: M.274 + I-26; M.24274: M.275 + I-26; M.24275: M.276 + I-26;
M.24276: M.277 + I-26; M.24277: M.278 + I-26; M.24278: M.279 + I-26; M.24279: M.280 + I-26;
M.24280: M.281 + I-26; M.24281: M.282 + I-26; M.24282: M.283 + I-26; M.24283: M.284 + I-26;
M.24284: M.285 + I-26; M.24285: M.286 + I-26; M.24286: M.287 + I-26; M.24287: M.288 + I-26;
M.24288: M.289 + I-26; M.24289: M.290 + I-26; M.24290: M.291 + I-26; M.24291: M.292 + I-26;
M.24292: M.293 + I-26; M.24293: M.294 + I-26; M.24294: M.295 + I-26; M.24295: M.296 + I-26;
M.24296: M.297 + I-26; M.24297: M.298 + I-26; M.24298: M.299 + I-26; M.24299: M.300 + I-26;
M.24300: M.301 + I-26; M.24301: M.302 + I-26; M.24302: M.303 + I-26; M.24303: M.304 + I-26;
M.24304: M.305 + I-26; M.24305: M.306 + I-26; M.24306: M.307 + I-26; M.24307: M.308 + I-26;
M.24308: M.309 + I-26; M.24309: M.310 + I-26; M.24310: M.311 + I-26; M.24311: M.312 + I-26;
M.24312: M.313 + I-26; M.24313: M.314 + I-26; M.24314: M.315 + I-26; M.24315: M.316 + I-26;
M.24316: M.317 + I-26; M.24317: M.318 + I-26; M.24318: M.319 + I-26; M.24319: M.320 + I-26;
M.24320: M.321 + I-26; M.24321: M.322 + I-26; M.24322: M.323 + I-26; M.24323: M.324 + I-26;
M.24324: M.325 + I-26; M.24325: M.326 + I-26; M.24326: M.327 + I-26; M.24327: M.328 + I-26;
M.24328: M.329 + I-26; M.24329: M.330 + I-26; M.24330: M.331 + I-26; M.24331: M.332 + I-26;
M.24332: M.333 + I-26; M.24333: M.334 + I-26; M.24334: M.335 + I-26; M.24335: M.336 + I-26;
M.24336: M.337 + I-26; M.24337: M.338 + I-26; M.24338: M.339 + I-26; M.24339: M.340 + I-26;
M.24340: M.341 + I-26; M.24341: M.342 + I-26; M.24342: M.343 + I-26; M.24343: M.344 + I-26;
M.24344: M.345 + I-26; M.24345: M.346 + I-26; M.24346: M.347 + I-26; M.24347: M.348 + I-26;
M.24348: M.349 + I-26; M.24349: M.350 + I-26; M.24350: M.351 + I-26; M.24351: M.352 + I-26;
M.24352: M.353 + I-26; M.24353: M.354 + I-26; M.24354: M.355 + I-26; M.24355: M.356 + I-26;
M.24356: M.357 + I-26; M.24357: M.358 + I-26; M.24358: M.359 + I-26; M.24359: M.360 + I-26;
M.24360: M.361 + I-26; M.24361: M.362 + I-26; M.24362: M.363 + I-26; M.24363: M.364 + I-26;
M.24364: M.365 + I-26; M.24365: M.366 + I-26; M.24366: M.367 + I-26; M.24367: M.368 + I-26;
M.24368: M.369 + I-26; M.24369: M.370 + I-26; M.24370: M.371 + I-26; M.24371: M.372 + I-26;
M.24372: M.373 + I-26; M.24373: M.374 + I-26; M.24374: M.375 + I-26; M.24375: M.376 + I-26;
M.24376: M.377 + I-26; M.24377: M.378 + I-26; M.24378: M.379 + I-26; M.24379: M.380 + I-26;
M.24380: M.381 + I-26; M.24381: M.382 + I-26; M.24382: M.383 + I-26; M.24383: M.384 + I-26;
M.24384: M.385 + I-26; M.24385: M.386 + I-26; M.24386: M.387 + I-26; M.24387: M.388 + I-26;
M.24388: M.389 + I-26; M.24389: M.390 + I-26; M.24390: M.391 + I-26; M.24391: M.392 + I-26;
M.24392: M.393 + I-26; M.24393: M.394 + I-26; M.24394: M.395 + I-26; M.24395: M.396 + I-26;
M.24396: M.397 + I-26; M.24397: M.398 + I-26; M.24398: M.399 + I-26; M.24399: M.400 + I-26;
M.24400: M.401 + I-26; M.24401: M.402 + I-26; M.24402: M.403 + I-26; M.24403: M.404 + I-26;
M.24404: M.405 + I-26; M.24405: M.406 + I-26; M.24406: M.407 + I-26; M.24407: M.408 + I-26;
M.24408: M.409 + I-26; M.24409: M.410 + I-26; M.24410: M.411 + I-26; M.24411: M.412 + I-26;
M.24412: M.413 + I-26; M.24413: M.414 + I-26; M.24414: M.415 + I-26; M.24415: M.416 + I-26;
M.24416: M.417 + I-26; M.24417: M.418 + I-26; M.24418: M.419 + I-26; M.24419: M.420 + I-26;
M.24420: M.421 + I-26; M.24421: M.422 + I-26; M.24422: M.423 + I-26; M.24423: M.424 + I-26;
M.24424: M.425 + I-26; M.24425: M.426 + I-26; M.24426: M.427 + I-26; M.24427: M.428 + I-26;
M.24428: M.429 + I-26; M.24429: M.430 + I-26; M.24430: M.431 + I-26; M.24431: M.432 + I-26;
M.24432: M.433 + I-26; M.24433: M.434 + I-26; M.24434: M.435 + I-26; M.24435: M.436 + I-26;
M.24436: M.437 + I-26; M.24437: M.438 + I-26; M.24438: M.439 + I-26; M.24439: M.440 + I-26;
M.24440: M.441 + I-26; M.24441: M.442 + I-26; M.24442: M.443 + I-26; M.24443: M.444 + I-26;
M.24444: M.445 + I-26; M.24445: M.446 + I-26; M.24446: M.447 + I-26; M.24447: M.448 + I-26;
M.24448: M.449 + I-26; M.24449: M.450 + I-26.

In another embodiment, the present invention relates to ternary herbicidal mixtures M.25000 to M.25449 listed in Table M(z) below, comprising mixtures of the binary mixtures depicted in table M(a) and a third herbicide I-27.

TABLE M(z)
M.25000: M.1 + I-27; M.25001: M.2 + I-27; M.25002: M.3 + I-27; M.25003: M.4 + I-27;
M.25004: M.5 + I-27; M.25005: M.6 + I-27; M.25006: M.7 + I-27; M.25007: M.8 + I-27;
M.25008: M.9 + I-27; M.25009: M.10 + I-27; M.25010: M.11 + I-27; M.25011: M.12 + I-27;
M.25012: M.13 + I-27; M.25013: M.14 + I-27; M.25014: M.15 + I-27; M.25015: M.16 + I-27;
M.25016: M.17 + I-27; M.25017: M.18 + I-27; M.25018: M.19 + I-27; M.25019: M.20 + I-27;
M.25020: M.21 + I-27; M.25021: M.22 + I-27; M.25022: M.23 + I-27; M.25023: M.24 + I-27;
M.25024: M.25 + I-27; M.25025: M.26 + I-27; M.25026: M.27 + I-27; M.25027: M.28 + I-27;
M.25028: M.29 + I-27; M.25029: M.30 + I-27; M.25030: M.31 + I-27; M.25031: M.32 + I-27;
M.25032: M.33 + I-27; M.25033: M.34 + I-27; M.25034: M.35 + I-27; M.25035: M.36 + I-27;
M.25036: M.37 + I-27; M.25037: M.38 + I-27; M.25038: M.39 + I-27; M.25039: M.40 + I-27;
M.25040: M.41 + I-27; M.25041: M.42 + I-27; M.25042: M.43 + I-27; M.25043: M.44 + I-27;
M.25044: M.45 + I-27; M.25045: M.46 + I-27; M.25046: M.47 + I-27; M.25047: M.48 + I-27;
M.25048: M.49 + I-27; M.25049: M.50 + I-27; M.25050: M.51 + I-27; M.25051: M.52 + I-27;
M.25052: M.53 + I-27; M.25053: M.54 + I-27; M.25054: M.55 + I-27; M.25055: M.56 + I-27;
M.25056: M.57 + I-27; M.25057: M.58 + I-27; M.25058: M.59 + I-27; M.25059: M.60 + I-27;
M.25060: M.61 + I-27; M.25061: M.62 + I-27; M.25062: M.63 + I-27; M.25063: M.64 + I-27;
M.25064: M.65 + I-27; M.25065: M.66 + I-27; M.25066: M.67 + I-27; M.25067: M.68 + I-27;
M.25068: M.69 + I-27; M.25069: M.70 + I-27; M.25070: M.71 + I-27; M.25071: M.72 + I-27;
M.25072: M.73 + I-27; M.25073: M.74 + I-27; M.25074: M.75 + I-27; M.25075: M.76 + I-27;
M.25076: M.77 + I-27; M.25077: M.78 + I-27; M.25078: M.79 + I-27; M.25079: M.80 + I-27;
M.25080: M.81 + I-27; M.25081: M.82 + I-27; M.25082: M.83 + I-27; M.25083: M.84 + I-27;
M.25084: M.85 + I-27; M.25085: M.86 + I-27; M.25086: M.87 + I-27; M.25087: M.88 + I-27;
M.25088: M.89 + I-27; M.25089: M.90 + I-27; M.25090: M.91 + I-27; M.25091: M.92 + I-27;
M.25092: M.93 + I-27; M.25093: M.94 + I-27; M.25094: M.95 + I-27; M.25095: M.96 + I-27;
M.25096: M.97 + I-27; M.25097: M.98 + I-27; M.25098: M.99 + I-27; M.25099: M.100 + I-27;
M.25100: M.101 + I-27; M.25101: M.102 + I-27; M.25102: M.103 + I-27; M.25103: M.104 + I-27;
M.25104: M.105 + I-27; M.25105: M.106 + I-27; M.25106: M.107 + I-27; M.25107: M.108 + I-27;
M.25108: M.109 + I-27; M.25109: M.110 + I-27; M.25110: M.111 + I-27; M.25111: M.112 + I-27;
M.25112: M.113 + I-27; M.25113: M.114 + I-27; M.25114: M.115 + I-27; M.25115: M.116 + I-27;
M.25116: M.117 + I-27; M.25117: M.118 + I-27; M.25118: M.119 + I-27; M.25119: M.120 + I-27;
M.25120: M.121 + I-27; M.25121: M.122 + I-27; M.25122: M.123 + I-27; M.25123: M.124 + I-27;
M.25124: M.125 + I-27; M.25125: M.126 + I-27; M.25126: M.127 + I-27; M.25127: M.128 + I-27;
M.25128: M.129 + I-27; M.25129: M.130 + I-27; M.25130: M.131 + I-27; M.25131: M.132 + I-27;
M.25132: M.133 + I-27; M.25133: M.134 + I-27; M.25134: M.135 + I-27; M.25135: M.136 + I-27;
M.25136: M.137 + I-27; M.25137: M.138 + I-27; M.25138: M.139 + I-27; M.25139: M.140 + I-27;
M.25140: M.141 + I-27; M.25141: M.142 + I-27; M.25142: M.143 + I-27; M.25143: M.144 + I-27;
M.25144: M.145 + I-27; M.25145: M.146 + I-27; M.25146: M.147 + I-27; M.25147: M.148 + I-27;
M.25148: M.149 + I-27; M.25149: M.150 + I-27; M.25150: M.151 + I-27; M.25151: M.152 + I-27;
M.25152: M.153 + I-27; M.25153: M.154 + I-27; M.25154: M.155 + I-27; M.25155: M.156 + I-27;
M.25156: M.157 + I-27; M.25157: M.158 + I-27; M.25158: M.159 + I-27; M.25159: M.160 + I-27;
M.25160: M.161 + I-27; M.25161: M.162 + I-27; M.25162: M.163 + I-27; M.25163: M.164 + I-27;
M.25164: M.165 + I-27; M.25165: M.166 + I-27; M.25166: M.167 + I-27; M.25167: M.168 + I-27;
M.25168: M.169 + I-27; M.25169: M.170 + I-27; M.25170: M.171 + I-27; M.25171: M.172 + I-27;
M.25172: M.173 + I-27; M.25173: M.174 + I-27; M.25174: M.175 + I-27; M.25175: M.176 + I-27;
M.25176: M.177 + I-27; M.25177: M.178 + I-27; M.25178: M.179 + I-27; M.25179: M.180 + I-27;
M.25180: M.181 + I-27; M.25181: M.182 + I-27; M.25182: M.183 + I-27; M.25183: M.184 + I-27;
M.25184: M.185 + I-27; M.25185: M.186 + I-27; M.25186: M.187 + I-27; M.25187: M.188 + I-27;
M.25188: M.189 + I-27; M.25189: M.190 + I-27; M.25190: M.191 + I-27; M.25191: M.192 + I-27;
M.25192: M.193 + I-27; M.25193: M.194 + I-27; M.25194: M.195 + I-27; M.25195: M.196 + I-27;
M.25196: M.197 + I-27; M.25197: M.198 + I-27; M.25198: M.199 + I-27; M.25199: M.200 + I-27;
M.25200: M.201 + I-27; M.25201: M.202 + I-27; M.25202: M.203 + I-27; M.25203: M.204 + I-27;
M.25204: M.205 + I-27; M.25205: M.206 + I-27; M.25206: M.207 + I-27; M.25207: M.208 + I-27;
M.25208: M.209 + I-27; M.25209: M.210 + I-27; M.25210: M.211 + I-27; M.25211: M.212 + I-27;
M.25212: M.213 + I-27; M.25213: M.214 + I-27; M.25214: M.215 + I-27; M.25215: M.216 + I-27;
M.25216: M.217 + I-27; M.25217: M.218 + I-27; M.25218: M.219 + I-27; M.25219: M.220 + I-27;
M.25220: M.221 + I-27; M.25221: M.222 + I-27; M.25222: M.223 + I-27; M.25223: M.224 + I-27;
M.25224: M.225 + I-27; M.25225: M.226 + I-27; M.25226: M.227 + I-27; M.25227: M.228 + I-27;
M.25228: M.229 + I-27; M.25229: M.230 + I-27; M.25230: M.231 + I-27; M.25231: M.232 + I-27;
M.25232: M.233 + I-27; M.25233: M.234 + I-27; M.25234: M.235 + I-27; M.25235: M.236 + I-27;
M.25236: M.237 + I-27; M.25237: M.238 + I-27; M.25238: M.239 + I-27; M.25239: M.240 + I-27;
M.25240: M.241 + I-27; M.25241: M.242 + I-27; M.25242: M.243 + I-27; M.25243: M.244 + I-27;
M.25244: M.245 + I-27; M.25245: M.246 + I-27; M.25246: M.247 + I-27; M.25247: M.248 + I-27;
M.25248: M.249 + I-27; M.25249: M.250 + I-27; M.25250: M.251 + I-27; M.25251: M.252 + I-27;
M.25252: M.253 + I-27; M.25253: M.254 + I-27; M.25254: M.255 + I-27; M.25255: M.256 + I-27;
M.25256: M.257 + I-27; M.25257: M.258 + I-27; M.25258: M.259 + I-27; M.25259: M.260 + I-27;
M.25260: M.261 + I-27; M.25261: M.262 + I-27; M.25262: M.263 + I-27; M.25263: M.264 + I-27;
M.25264: M.265 + I-27; M.25265: M.266 + I-27; M.25266: M.267 + I-27; M.25267: M.268 + I-27;
M.25268: M.269 + I-27; M.25269: M.270 + I-27; M.25270: M.271 + I-27; M.25271: M.272 + I-27;
M.25272: M.273 + I-27; M.25273: M.274 + I-27; M.25274: M.275 + I-27; M.25275: M.276 + I-27;
M.25276: M.277 + I-27; M.25277: M.278 + I-27; M.25278: M.279 + I-27; M.25279: M.280 + I-27;
M.25280: M.281 + I-27; M.25281: M.282 + I-27; M.25282: M.283 + I-27; M.25283: M.284 + I-27;
M.25284: M.285 + I-27; M.25285: M.286 + I-27; M.25286: M.287 + I-27; M.25287: M.288 + I-27;
M.25288: M.289 + I-27; M.25289: M.290 + I-27; M.25290: M.291 + I-27; M.25291: M.292 + I-27;
M.25292: M.293 + I-27; M.25293: M.294 + I-27; M.25294: M.295 + I-27; M.25295: M.296 + I-27;
M.25296: M.297 + I-27; M.25297: M.298 + I-27; M.25298: M.299 + I-27; M.25299: M.300 + I-27;
M.25300: M.301 + I-27; M.25301: M.302 + I-27; M.25302: M.303 + I-27; M.25303: M.304 + I-27;
M.25304: M.305 + I-27; M.25305: M.306 + I-27; M.25306: M.307 + I-27; M.25307: M.308 + I-27;
M.25308: M.309 + I-27; M.25309: M.310 + I-27; M.25310: M.311 + I-27; M.25311: M.312 + I-27;
M.25312: M.313 + I-27; M.25313: M.314 + I-27; M.25314: M.315 + I-27; M.25315: M.316 + I-27;
M.25316: M.317 + I-27; M.25317: M.318 + I-27; M.25318: M.319 + I-27; M.25319: M.320 + I-27;
M.25320: M.321 + I-27; M.25321: M.322 + I-27; M.25322: M.323 + I-27; M.25323: M.324 + I-27;
M.25324: M.325 + I-27; M.25325: M.326 + I-27; M.25326: M.327 + I-27; M.25327: M.328 + I-27;
M.25328: M.329 + I-27; M.25329: M.330 + I-27; M.25330: M.331 + I-27; M.25331: M.332 + I-27;
M.25332: M.333 + I-27; M.25333: M.334 + I-27; M.25334: M.335 + I-27; M.25335: M.336 + I-27;
M.25336: M.337 + I-27; M.25337: M.338 + I-27; M.25338: M.339 + I-27; M.25339: M.340 + I-27;
M.25340: M.341 + I-27; M.25341: M.342 + I-27; M.25342: M.343 + I-27; M.25343: M.344 + I-27;
M.25344: M.345 + I-27; M.25345: M.346 + I-27; M.25346: M.347 + I-27; M.25347: M.348 + I-27;
M.25348: M.349 + I-27; M.25349: M.350 + I-27; M.25350: M.351 + I-27; M.25351: M.352 + I-27;
M.25352: M.353 + I-27; M.25353: M.354 + I-27; M.25354: M.355 + I-27; M.25355: M.356 + I-27;
M.25356: M.357 + I-27; M.25357: M.358 + I-27; M.25358: M.359 + I-27; M.25359: M.360 + I-27;
M.25360: M.361 + I-27; M.25361: M.362 + I-27; M.25362: M.363 + I-27; M.25363: M.364 + I-27;
M.25364: M.365 + I-27; M.25365: M.366 + I-27; M.25366: M.367 + I-27; M.25367: M.368 + I-27;
M.25368: M.369 + I-27; M.25369: M.370 + I-27; M.25370: M.371 + I-27; M.25371: M.372 + I-27;
M.25372: M.373 + I-27; M.25373: M.374 + I-27; M.25374: M.375 + I-27; M.25375: M.376 + I-27;
M.25376: M.377 + I-27; M.25377: M.378 + I-27; M.25378: M.379 + I-27; M.25379: M.380 + I-27;
M.25380: M.381 + I-27; M.25381: M.382 + I-27; M.25382: M.383 + I-27; M.25383: M.384 + I-27;
M.25384: M.385 + I-27; M.25385: M.386 + I-27; M.25386: M.387 + I-27; M.25387: M.388 + I-27;
M.25388: M.389 + I-27; M.25389: M.390 + I-27; M.25390: M.391 + I-27; M.25391: M.392 + I-27;
M.25392: M.393 + I-27; M.25393: M.394 + I-27; M.25394: M.395 + I-27; M.25395: M.396 + I-27;
M.25396: M.397 + I-27; M.25397: M.398 + I-27; M.25398: M.399 + I-27; M.25399: M.400 + I-27;
M.25400: M.401 + I-27; M.25401: M.402 + I-27; M.25402: M.403 + I-27; M.25403: M.404 + I-27;
M.25404: M.405 + I-27; M.25405: M.406 + I-27; M.25406: M.407 + I-27; M.25407: M.408 + I-27;
M.25408: M.409 + I-27; M.25409: M.410 + I-27; M.25410: M.411 + I-27; M.25411: M.412 + I-27;
M.25412: M.413 + I-27; M.25413: M.414 + I-27; M.25414: M.415 + I-27; M.25415: M.416 + I-27;
M.25416: M.417 + I-27; M.25417: M.418 + I-27; M.25418: M.419 + I-27; M.25419: M.420 + I-27;
M.25420: M.421 + I-27; M.25421: M.422 + I-27; M.25422: M.423 + I-27; M.25423: M.424 + I-27;
M.25424: M.425 + I-27; M.25425: M.426 + I-27; M.25426: M.427 + I-27; M.25427: M.428 + I-27;
M.25428: M.429 + I-27; M.25429: M.430 + I-27; M.25430: M.431 + I-27; M.25431: M.432 + I-27;
M.25432: M.433 + I-27; M.25433: M.434 + I-27; M.25434: M.435 + I-27; M.25435: M.436 + I-27;
M.25436: M.437 + I-27; M.25437: M.438 + I-27; M.25438: M.439 + I-27; M.25439: M.440 + I-27;
M.25440: M.441 + I-27; M.25441: M.442 + I-27; M.25442: M.443 + I-27; M.25443: M.444 + I-27;
M.25444: M.445 + I-27; M.25445: M.446 + I-27; M.25446: M.447 + I-27; M.25447: M.448 + I-27;
M.25448: M.449 + I-27; M.25449: M.450 + I-27.

In another embodiment, the present invention relates to ternary herbicidal mixtures M.26000 to M.26449 listed in Table M(aa) below, comprising mixtures of the binary mixtures depicted in table M(a) and a third herbicide I-28.

TABLE M(aa)
M.26000: M.1 + I-28; M.26001: M.2 + I-28; M.26002: M.3 + I-28; M.26003: M.4 + I-28;
M.26004: M.5 + I-28; M.26005: M.6 + I-28; M.26006: M.7 + I-28; M.26007: M.8 + I-28;
M.26008: M.9 + I-28; M.26009: M.10 + I-28; M.26010: M.11 + I-28; M.26011: M.12 + I-28;
M.26012: M.13 + I-28; M.26013: M.14 + I-28; M.26014: M.15 + I-28; M.26015: M.16 + I-28;
M.26016: M.17 + I-28; M.26017: M.18 + I-28; M.26018: M.19 + I-28; M.26019: M.20 + I-28;
M.26020: M.21 + I-28; M.26021: M.22 + I-28; M.26022: M.23 + I-28; M.26023: M.24 + I-28;
M.26024: M.25 + I-28; M.26025: M.26 + I-28; M.26026: M.27 + I-28; M.26027: M.28 + I-28;
M.26028: M.29 + I-28; M.26029: M.30 + I-28; M.26030: M.31 + I-28; M.26031: M.32 + I-28;
M.26032: M.33 + I-28; M.26033: M.34 + I-28; M.26034: M.35 + I-28; M.26035: M.36 + I-28;
M.26036: M.37 + I-28; M.26037: M.38 + I-28; M.26038: M.39 + I-28; M.26039: M.40 + I-28;
M.26040: M.41 + I-28; M.26041: M.42 + I-28; M.26042: M.43 + I-28; M.26043: M.44 + I-28;
M.26044: M.45 + I-28; M.26045: M.46 + I-28; M.26046: M.47 + I-28; M.26047: M.48 + I-28;
M.26048: M.49 + I-28; M.26049: M.50 + I-28; M.26050: M.51 + I-28; M.26051: M.52 + I-28;
M.26052: M.53 + I-28; M.26053: M.54 + I-28; M.26054: M.55 + I-28; M.26055: M.56 + I-28;
M.26056: M.57 + I-28; M.26057: M.58 + I-28; M.26058: M.59 + I-28; M.26059: M.60 + I-28;
M.26060: M.61 + I-28; M.26061: M.62 + I-28; M.26062: M.63 + I-28; M.26063: M.64 + I-28;
M.26064: M.65 + I-28; M.26065: M.66 + I-28; M.26066: M.67 + I-28; M.26067: M.68 + I-28;
M.26068: M.69 + I-28; M.26069: M.70 + I-28; M.26070: M.71 + I-28; M.26071: M.72 + I-28;
M.26072: M.73 + I-28; M.26073: M.74 + I-28; M.26074: M.75 + I-28; M.26075: M.76 + I-28;
M.26076: M.77 + I-28; M.26077: M.78 + I-28; M.26078: M.79 + I-28; M.26079: M.80 + I-28;
M.26080: M.81 + I-28; M.26081: M.82 + I-28; M.26082: M.83 + I-28; M.26083: M.84 + I-28;
M.26084: M.85 + I-28; M.26085: M.86 + I-28; M.26086: M.87 + I-28; M.26087: M.88 + I-28;
M.26088: M.89 + I-28; M.26089: M.90 + I-28; M.26090: M.91 + I-28; M.26091: M.92 + I-28;
M.26092: M.93 + I-28; M.26093: M.94 + I-28; M.26094: M.95 + I-28; M.26095: M.96 + I-28;
M.26096: M.97 + I-28; M.26097: M.98 + I-28; M.26098: M.99 + I-28; M.26099: M.100 + I-28;
M.26100: M.101 + I-28; M.26101: M.102 + I-28; M.26102: M.103 + I-28; M.26103: M.104 + I-28;
M.26104: M.105 + I-28; M.26105: M.106 + I-28; M.26106: M.107 + I-28; M.26107: M.108 + I-28;
M.26108: M.109 + I-28; M.26109: M.110 + I-28; M.26110: M.111 + I-28; M.26111: M.112 + I-28;
M.26112: M.113 + I-28; M.26113: M.114 + I-28; M.26114: M.115 + I-28; M.26115: M.116 + I-28;
M.26116: M.117 + I-28; M.26117: M.118 + I-28; M.26118: M.119 + I-28; M.26119: M.120 + I-28;
M.26120: M.121 + I-28; M.26121: M.122 + I-28; M.26122: M.123 + I-28; M.26123: M.124 + I-28;
M.26124: M.125 + I-28; M.26125: M.126 + I-28; M.26126: M.127 + I-28; M.26127: M.128 + I-28;
M.26128: M.129 + I-28; M.26129: M.130 + I-28; M.26130: M.131 + I-28; M.26131: M.132 + I-28;
M.26132: M.133 + I-28; M.26133: M.134 + I-28; M.26134: M.135 + I-28; M.26135: M.136 + I-28;
M.26136: M.137 + I-28; M.26137: M.138 + I-28; M.26138: M.139 + I-28; M.26139: M.140 + I-28;
M.26140: M.141 + I-28; M.26141: M.142 + I-28; M.26142: M.143 + I-28; M.26143: M.144 + I-28;
M.26144: M.145 + I-28; M.26145: M.146 + I-28; M.26146: M.147 + I-28; M.26147: M.148 + I-28;
M.26148: M.149 + I-28; M.26149: M.150 + I-28; M.26150: M.151 + I-28; M.26151: M.152 + I-28;
M.26152: M.153 + I-28; M.26153: M.154 + I-28; M.26154: M.155 + I-28; M.26155: M.156 + I-28;
M.26156: M.157 + I-28; M.26157: M.158 + I-28; M.26158: M.159 + I-28; M.26159: M.160 + I-28;
M.26160: M.161 + I-28; M.26161: M.162 + I-28; M.26162: M.163 + I-28; M.26163: M.164 + I-28;
M.26164: M.165 + I-28; M.26165: M.166 + I-28; M.26166: M.167 + I-28; M.26167: M.168 + I-28;
M.26168: M.169 + I-28; M.26169: M.170 + I-28; M.26170: M.171 + I-28; M.26171: M.172 + I-28;
M.26172: M.173 + I-28; M.26173: M.174 + I-28; M.26174: M.175 + I-28; M.26175: M.176 + I-28;
M.26176: M.177 + I-28; M.26177: M.178 + I-28; M.26178: M.179 + I-28; M.26179: M.180 + I-28;
M.26180: M.181 + I-28; M.26181: M.182 + I-28; M.26182: M.183 + I-28; M.26183: M.184 + I-28;
M.26184: M.185 + I-28; M.26185: M.186 + I-28; M.26186: M.187 + I-28; M.26187: M.188 + I-28;
M.26188: M.189 + I-28; M.26189: M.190 + I-28; M.26190: M.191 + I-28; M.26191: M.192 + I-28;
M.26192: M.193 + I-28; M.26193: M.194 + I-28; M.26194: M.195 + I-28; M.26195: M.196 + I-28;
M.26196: M.197 + I-28; M.26197: M.198 + I-28; M.26198: M.199 + I-28; M.26199: M.200 + I-28;
M.26200: M.201 + I-28; M.26201: M.202 + I-28; M.26202: M.203 + I-28; M.26203: M.204 + I-28;
M.26204: M.205 + I-28; M.26205: M.206 + I-28; M.26206: M.207 + I-28; M.26207: M.208 + I-28;
M.26208: M.209 + I-28; M.26209: M.210 + I-28; M.26210: M.211 + I-28; M.26211: M.212 + I-28;
M.26212: M.213 + I-28; M.26213: M.214 + I-28; M.26214: M.215 + I-28; M.26215: M.216 + I-28;
M.26216: M.217 + I-28; M.26217: M.218 + I-28; M.26218: M.219 + I-28; M.26219: M.220 + I-28;
M.26220: M.221 + I-28; M.26221: M.222 + I-28; M.26222: M.223 + I-28; M.26223: M.224 + I-28;
M.26224: M.225 + I-28; M.26225: M.226 + I-28; M.26226: M.227 + I-28; M.26227: M.228 + I-28;
M.26228: M.229 + I-28; M.26229: M.230 + I-28; M.26230: M.231 + I-28; M.26231: M.232 + I-28;
M.26232: M.233 + I-28; M.26233: M.234 + I-28; M.26234: M.235 + I-28; M.26235: M.236 + I-28;
M.26236: M.237 + I-28; M.26237: M.238 + I-28; M.26238: M.239 + I-28; M.26239: M.240 + I-28;
M.26240: M.241 + I-28; M.26241: M.242 + I-28; M.26242: M.243 + I-28; M.26243: M.244 + I-28;
M.26244: M.245 + I-28; M.26245: M.246 + I-28; M.26246: M.247 + I-28; M.26247: M.248 + I-28;
M.26248: M.249 + I-28; M.26249: M.250 + I-28; M.26250: M.251 + I-28; M.26251: M.252 + I-28;
M.26252: M.253 + I-28; M.26253: M.254 + I-28; M.26254: M.255 + I-28; M.26255: M.256 + I-28;
M.26256: M.257 + I-28; M.26257: M.258 + I-28; M.26258: M.259 + I-28; M.26259: M.260 + I-28;
M.26260: M.261 + I-28; M.26261: M.262 + I-28; M.26262: M.263 + I-28; M.26263: M.264 + I-28;
M.26264: M.265 + I-28; M.26265: M.266 + I-28; M.26266: M.267 + I-28; M.26267: M.268 + I-28;
M.26268: M.269 + I-28; M.26269: M.270 + I-28; M.26270: M.271 + I-28; M.26271: M.272 + I-28;
M.26272: M.273 + I-28; M.26273: M.274 + I-28; M.26274: M.275 + I-28; M.26275: M.276 + I-28;
M.26276: M.277 + I-28; M.26277: M.278 + I-28; M.26278: M.279 + I-28; M.26279: M.280 + I-28;
M.26280: M.281 + I-28; M.26281: M.282 + I-28; M.26282: M.283 + I-28; M.26283: M.284 + I-28;
M.26284: M.285 + I-28; M.26285: M.286 + I-28; M.26286: M.287 + I-28; M.26287: M.288 + I-28;
M.26288: M.289 + I-28; M.26289: M.290 + I-28; M.26290: M.291 + I-28; M.26291: M.292 + I-28;
M.26292: M.293 + I-28; M.26293: M.294 + I-28; M.26294: M.295 + I-28; M.26295: M.296 + I-28;
M.26296: M.297 + I-28; M.26297: M.298 + I-28; M.26298: M.299 + I-28; M.26299: M.300 + I-28;
M.26300: M.301 + I-28; M.26301: M.302 + I-28; M.26302: M.303 + I-28; M.26303: M.304 + I-28;
M.26304: M.305 + I-28; M.26305: M.306 + I-28; M.26306: M.307 + I-28; M.26307: M.308 + I-28;
M.26308: M.309 + I-28; M.26309: M.310 + I-28; M.26310: M.311 + I-28; M.26311: M.312 + I-28;
M.26312: M.313 + I-28; M.26313: M.314 + I-28; M.26314: M.315 + I-28; M.26315: M.316 + I-28;
M.26316: M.317 + I-28; M.26317: M.318 + I-28; M.26318: M.319 + I-28; M.26319: M.320 + I-28;
M.26320: M.321 + I-28; M.26321: M.322 + I-28; M.26322: M.323 + I-28; M.26323: M.324 + I-28;
M.26324: M.325 + I-28; M.26325: M.326 + I-28; M.26326: M.327 + I-28; M.26327: M.328 + I-28;
M.26328: M.329 + I-28; M.26329: M.330 + I-28; M.26330: M.331 + I-28; M.26331: M.332 + I-28;
M.26332: M.333 + I-28; M.26333: M.334 + I-28; M.26334: M.335 + I-28; M.26335: M.336 + I-28;
M.26336: M.337 + I-28; M.26337: M.338 + I-28; M.26338: M.339 + I-28; M.26339: M.340 + I-28;
M.26340: M.341 + I-28; M.26341: M.342 + I-28; M.26342: M.343 + I-28; M.26343: M.344 + I-28;
M.26344: M.345 + I-28; M.26345: M.346 + I-28; M.26346: M.347 + I-28; M.26347: M.348 + I-28;
M.26348: M.349 + I-28; M.26349: M.350 + I-28; M.26350: M.351 + I-28; M.26351: M.352 + I-28;
M.26352: M.353 + I-28; M.26353: M.354 + I-28; M.26354: M.355 + I-28; M.26355: M.356 + I-28;
M.26356: M.357 + I-28; M.26357: M.358 + I-28; M.26358: M.359 + I-28; M.26359: M.360 + I-28;
M.26360: M.361 + I-28; M.26361: M.362 + I-28; M.26362: M.363 + I-28; M.26363: M.364 + I-28;
M.26364: M.365 + I-28; M.26365: M.366 + I-28; M.26366: M.367 + I-28; M.26367: M.368 + I-28;
M.26368: M.369 + I-28; M.26369: M.370 + I-28; M.26370: M.371 + I-28; M.26371: M.372 + I-28;
M.26372: M.373 + I-28; M.26373: M.374 + I-28; M.26374: M.375 + I-28; M.26375: M.376 + I-28;
M.26376: M.377 + I-28; M.26377: M.378 + I-28; M.26378: M.379 + I-28; M.26379: M.380 + I-28;
M.26380: M.381 + I-28; M.26381: M.382 + I-28; M.26382: M.383 + I-28; M.26383: M.384 + I-28;
M.26384: M.385 + I-28; M.26385: M.386 + I-28; M.26386: M.387 + I-28; M.26387: M.388 + I-28;
M.26388: M.389 + I-28; M.26389: M.390 + I-28; M.26390: M.391 + I-28; M.26391: M.392 + I-28;
M.26392: M.393 + I-28; M.26393: M.394 + I-28; M.26394: M.395 + I-28; M.26395: M.396 + I-28;
M.26396: M.397 + I-28; M.26397: M.398 + I-28; M.26398: M.399 + I-28; M.26399: M.400 + I-28;
M.26400: M.401 + I-28; M.26401: M.402 + I-28; M.26402: M.403 + I-28; M.26403: M.404 + I-28;
M.26404: M.405 + I-28; M.26405: M.406 + I-28; M.26406: M.407 + I-28; M.26407: M.408 + I-28;
M.26408: M.409 + I-28; M.26409: M.410 + I-28; M.26410: M.411 + I-28; M.26411: M.412 + I-28;
M.26412: M.413 + I-28; M.26413: M.414 + I-28; M.26414: M.415 + I-28; M.26415: M.416 + I-28;
M.26416: M.417 + I-28; M.26417: M.418 + I-28; M.26418: M.419 + I-28; M.26419: M.420 + I-28;
M.26420: M.421 + I-28; M.26421: M.422 + I-28; M.26422: M.423 + I-28; M.26423: M.424 + I-28;
M.26424: M.425 + I-28; M.26425: M.426 + I-28; M.26426: M.427 + I-28; M.26427: M.428 + I-28;
M.26428: M.429 + I-28; M.26429: M.430 + I-28; M.26430: M.431 + I-28; M.26431: M.432 + I-28;
M.26432: M.433 + I-28; M.26433: M.434 + I-28; M.26434: M.435 + I-28; M.26435: M.436 + I-28;
M.26436: M.437 + I-28; M.26437: M.438 + I-28; M.26438: M.439 + I-28; M.26439: M.440 + I-28;
M.26440: M.441 + I-28; M.26441: M.442 + I-28; M.26442: M.443 + I-28; M.26443: M.444 + I-28;
M.26444: M.445 + I-28; M.26445: M.446 + I-28; M.26446: M.447 + I-28; M.26447: M.448 + I-28;
M.26448: M.449 + I-28; M.26449: M.450 + I-28.

In another embodiment, the present invention relates to ternary herbicidal mixtures M.27000 to M.27449 listed in Table M(ab) below, comprising mixtures of the binary mixtures depicted in table M(a) and a third herbicide I-29.

TABLE M(ab)
M.27000: M.1 + I-29; M.27001: M.2 + I-29; M.27002: M.3 + I-29; M.27003: M.4 + I-29;
M.27004: M.5 + I-29; M.27005: M.6 + I-29; M.27006: M.7 + I-29; M.27007: M.8 + I-29;
M.27008: M.9 + I-29; M.27009: M.10 + I-29; M.27010: M.11 + I-29; M.27011: M.12 + I-29;
M.27012: M.13 + I-29; M.27013: M.14 + I-29; M.27014: M.15 + I-29; M.27015: M.16 + I-29;
M.27016: M.17 + I-29; M.27017: M.18 + I-29; M.27018: M.19 + I-29; M.27019: M.20 + I-29;
M.27020: M.21 + I-29; M.27021: M.22 + I-29; M.27022: M.23 + I-29; M.27023: M.24 + I-29;
M.27024: M.25 + I-29; M.27025: M.26 + I-29; M.27026: M.27 + I-29; M.27027: M.28 + I-29;
M.27028: M.29 + I-29; M.27029: M.30 + I-29; M.27030: M.31 + I-29; M.27031: M.32 + I-29;
M.27032: M.33 + I-29; M.27033: M.34 + I-29; M.27034: M.35 + I-29; M.27035: M.36 + I-29;
M.27036: M.37 + I-29; M.27037: M.38 + I-29; M.27038: M.39 + I-29; M.27039: M.40 + I-29;
M.27040: M.41 + I-29; M.27041: M.42 + I-29; M.27042: M.43 + I-29; M.27043: M.44 + I-29;
M.27044: M.45 + I-29; M.27045: M.46 + I-29; M.27046: M.47 + I-29; M.27047: M.48 + I-29;
M.27048: M.49 + I-29; M.27049: M.50 + I-29; M.27050: M.51 + I-29; M.27051: M.52 + I-29;
M.27052: M.53 + I-29; M.27053: M.54 + I-29; M.27054: M.55 + I-29; M.27055: M.56 + I-29;
M.27056: M.57 + I-29; M.27057: M.58 + I-29; M.27058: M.59 + I-29; M.27059: M.60 + I-29;
M.27060: M.61 + I-29; M.27061: M.62 + I-29; M.27062: M.63 + I-29; M.27063: M.64 + I-29;
M.27064: M.65 + I-29; M.27065: M.66 + I-29; M.27066: M.67 + I-29; M.27067: M.68 + I-29;
M.27068: M.69 + I-29; M.27069: M.70 + I-29; M.27070: M.71 + I-29; M.27071: M.72 + I-29;
M.27072: M.73 + I-29; M.27073: M.74 + I-29; M.27074: M.75 + I-29; M.27075: M.76 + I-29;
M.27076: M.77 + I-29; M.27077: M.78 + I-29; M.27078: M.79 + I-29; M.27079: M.80 + I-29;
M.27080: M.81 + I-29; M.27081: M.82 + I-29; M.27082: M.83 + I-29; M.27083: M.84 + I-29;
M.27084: M.85 + I-29; M.27085: M.86 + I-29; M.27086: M.87 + I-29; M.27087: M.88 + I-29;
M.27088: M.89 + I-29; M.27089: M.90 + I-29; M.27090: M.91 + I-29; M.27091: M.92 + I-29;
M.27092: M.93 + I-29; M.27093: M.94 + I-29; M.27094: M.95 + I-29; M.27095: M.96 + I-29;
M.27096: M.97 + I-29; M.27097: M.98 + I-29; M.27098: M.99 + I-29; M.27099: M.100 + I-29;
M.27100: M.101 + I-29; M.27101: M.102 + I-29; M.27102: M.103 + I-29; M.27103: M.104 + I-29;
M.27104: M.105 + I-29; M.27105: M.106 + I-29; M.27106: M.107 + I-29; M.27107: M.108 + I-29;
M.27108: M.109 + I-29; M.27109: M.110 + I-29; M.27110: M.111 + I-29; M.27111: M.112 + I-29;
M.27112: M.113 + I-29; M.27113: M.114 + I-29; M.27114: M.115 + I-29; M.27115: M.116 + I-29;
M.27116: M.117 + I-29; M.27117: M.118 + I-29; M.27118: M.119 + I-29; M.27119: M.120 + I-29;
M.27120: M.121 + I-29; M.27121: M.122 + I-29; M.27122: M.123 + I-29; M.27123: M.124 + I-29;
M.27124: M.125 + I-29; M.27125: M.126 + I-29; M.27126: M.127 + I-29; M.27127: M.128 + I-29;
M.27128: M.129 + I-29; M.27129: M.130 + I-29; M.27130: M.131 + I-29; M.27131: M.132 + I-29;
M.27132: M.133 + I-29; M.27133: M.134 + I-29; M.27134: M.135 + I-29; M.27135: M.136 + I-29;
M.27136: M.137 + I-29; M.27137: M.138 + I-29; M.27138: M.139 + I-29; M.27139: M.140 + I-29;
M.27140: M.141 + I-29; M.27141: M.142 + I-29; M.27142: M.143 + I-29; M.27143: M.144 + I-29;
M.27144: M.145 + I-29; M.27145: M.146 + I-29; M.27146: M.147 + I-29; M.27147: M.148 + I-29;
M.27148: M.149 + I-29; M.27149: M.150 + I-29; M.27150: M.151 + I-29; M.27151: M.152 + I-29;
M.27152: M.153 + I-29; M.27153: M.154 + I-29; M.27154: M.155 + I-29; M.27155: M.156 + I-29;
M.27156: M.157 + I-29; M.27157: M.158 + I-29; M.27158: M.159 + I-29; M.27159: M.160 + I-29;
M.27160: M.161 + I-29; M.27161: M.162 + I-29; M.27162: M.163 + I-29; M.27163: M.164 + I-29;
M.27164: M.165 + I-29; M.27165: M.166 + I-29; M.27166: M.167 + I-29; M.27167: M.168 + I-29;
M.27168: M.169 + I-29; M.27169: M.170 + I-29; M.27170: M.171 + I-29; M.27171: M.172 + I-29;
M.27172: M.173 + I-29; M.27173: M.174 + I-29; M.27174: M.175 + I-29; M.27175: M.176 + I-29;
M.27176: M.177 + I-29; M.27177: M.178 + I-29; M.27178: M.179 + I-29; M.27179: M.180 + I-29;
M.27180: M.181 + I-29; M.27181: M.182 + I-29; M.27182: M.183 + I-29; M.27183: M.184 + I-29;
M.27184: M.185 + I-29; M.27185: M.186 + I-29; M.27186: M.187 + I-29; M.27187: M.188 + I-29;
M.27188: M.189 + I-29; M.27189: M.190 + I-29; M.27190: M.191 + I-29; M.27191: M.192 + I-29;
M.27192: M.193 + I-29; M.27193: M.194 + I-29; M.27194: M.195 + I-29; M.27195: M.196 + I-29;
M.27196: M.197 + I-29; M.27197: M.198 + I-29; M.27198: M.199 + I-29; M.27199: M.200 + I-29;
M.27200: M.201 + I-29; M.27201: M.202 + I-29; M.27202: M.203 + I-29; M.27203: M.204 + I-29;
M.27204: M.205 + I-29; M.27205: M.206 + I-29; M.27206: M.207 + I-29; M.27207: M.208 + I-29;
M.27208: M.209 + I-29; M.27209: M.210 + I-29; M.27210: M.211 + I-29; M.27211: M.212 + I-29;
M.27212: M.213 + I-29; M.27213: M.214 + I-29; M.27214: M.215 + I-29; M.27215: M.216 + I-29;
M.27216: M.217 + I-29; M.27217: M.218 + I-29; M.27218: M.219 + I-29; M.27219: M.220 + I-29;
M.27220: M.221 + I-29; M.27221: M.222 + I-29; M.27222: M.223 + I-29; M.27223: M.224 + I-29;
M.27224: M.225 + I-29; M.27225: M.226 + I-29; M.27226: M.227 + I-29; M.27227: M.228 + I-29;
M.27228: M.229 + I-29; M.27229: M.230 + I-29; M.27230: M.231 + I-29; M.27231: M.232 + I-29;
M.27232: M.233 + I-29; M.27233: M.234 + I-29; M.27234: M.235 + I-29; M.27235: M.236 + I-29;
M.27236: M.237 + I-29; M.27237: M.238 + I-29; M.27238: M.239 + I-29; M.27239: M.240 + I-29;
M.27240: M.241 + I-29; M.27241: M.242 + I-29; M.27242: M.243 + I-29; M.27243: M.244 + I-29;
M.27244: M.245 + I-29; M.27245: M.246 + I-29; M.27246: M.247 + I-29; M.27247: M.248 + I-29;
M.27248: M.249 + I-29; M.27249: M.250 + I-29; M.27250: M.251 + I-29; M.27251: M.252 + I-29;
M.27252: M.253 + I-29; M.27253: M.254 + I-29; M.27254: M.255 + I-29; M.27255: M.256 + I-29;
M.27256: M.257 + I-29; M.27257: M.258 + I-29; M.27258: M.259 + I-29; M.27259: M.260 + I-29;
M.27260: M.261 + I-29; M.27261: M.262 + I-29; M.27262: M.263 + I-29; M.27263: M.264 + I-29;
M.27264: M.265 + I-29; M.27265: M.266 + I-29; M.27266: M.267 + I-29; M.27267: M.268 + I-29;
M.27268: M.269 + I-29; M.27269: M.270 + I-29; M.27270: M.271 + I-29; M.27271: M.272 + I-29;
M.27272: M.273 + I-29; M.27273: M.274 + I-29; M.27274: M.275 + I-29; M.27275: M.276 + I-29;
M.27276: M.277 + I-29; M.27277: M.278 + I-29; M.27278: M.279 + I-29; M.27279: M.280 + I-29;
M.27280: M.281 + I-29; M.27281: M.282 + I-29; M.27282: M.283 + I-29; M.27283: M.284 + I-29;
M.27284: M.285 + I-29; M.27285: M.286 + I-29; M.27286: M.287 + I-29; M.27287: M.288 + I-29;
M.27288: M.289 + I-29; M.27289: M.290 + I-29; M.27290: M.291 + I-29; M.27291: M.292 + I-29;
M.27292: M.293 + I-29; M.27293: M.294 + I-29; M.27294: M.295 + I-29; M.27295: M.296 + I-29;
M.27296: M.297 + I-29; M.27297: M.298 + I-29; M.27298: M.299 + I-29; M.27299: M.300 + I-29;
M.27300: M.301 + I-29; M.27301: M.302 + I-29; M.27302: M.303 + I-29; M.27303: M.304 + I-29;
M.27304: M.305 + I-29; M.27305: M.306 + I-29; M.27306: M.307 + I-29; M.27307: M.308 + I-29;
M.27308: M.309 + I-29; M.27309: M.310 + I-29; M.27310: M.311 + I-29; M.27311: M.312 + I-29;
M.27312: M.313 + I-29; M.27313: M.314 + I-29; M.27314: M.315 + I-29; M.27315: M.316 + I-29;
M.27316: M.317 + I-29; M.27317: M.318 + I-29; M.27318: M.319 + I-29; M.27319: M.320 + I-29;
M.27320: M.321 + I-29; M.27321: M.322 + I-29; M.27322: M.323 + I-29; M.27323: M.324 + I-29;
M.27324: M.325 + I-29; M.27325: M.326 + I-29; M.27326: M.327 + I-29; M.27327: M.328 + I-29;
M.27328: M.329 + I-29; M.27329: M.330 + I-29; M.27330: M.331 + I-29; M.27331: M.332 + I-29;
M.27332: M.333 + I-29; M.27333: M.334 + I-29; M.27334: M.335 + I-29; M.27335: M.336 + I-29;
M.27336: M.337 + I-29; M.27337: M.338 + I-29; M.27338: M.339 + I-29; M.27339: M.340 + I-29;
M.27340: M.341 + I-29; M.27341: M.342 + I-29; M.27342: M.343 + I-29; M.27343: M.344 + I-29;
M.27344: M.345 + I-29; M.27345: M.346 + I-29; M.27346: M.347 + I-29; M.27347: M.348 + I-29;
M.27348: M.349 + I-29; M.27349: M.350 + I-29; M.27350: M.351 + I-29; M.27351: M.352 + I-29;
M.27352: M.353 + I-29; M.27353: M.354 + I-29; M.27354: M.355 + I-29; M.27355: M.356 + I-29;
M.27356: M.357 + I-29; M.27357: M.358 + I-29; M.27358: M.359 + I-29; M.27359: M.360 + I-29;
M.27360: M.361 + I-29; M.27361: M.362 + I-29; M.27362: M.363 + I-29; M.27363: M.364 + I-29;
M.27364: M.365 + I-29; M.27365: M.366 + I-29; M.27366: M.367 + I-29; M.27367: M.368 + I-29;
M.27368: M.369 + I-29; M.27369: M.370 + I-29; M.27370: M.371 + I-29; M.27371: M.372 + I-29;
M.27372: M.373 + I-29; M.27373: M.374 + I-29; M.27374: M.375 + I-29; M.27375: M.376 + I-29;
M.27376: M.377 + I-29; M.27377: M.378 + I-29; M.27378: M.379 + I-29; M.27379: M.380 + I-29;
M.27380: M.381 + I-29; M.27381: M.382 + I-29; M.27382: M.383 + I-29; M.27383: M.384 + I-29;
M.27384: M.385 + I-29; M.27385: M.386 + I-29; M.27386: M.387 + I-29; M.27387: M.388 + I-29;
M.27388: M.389 + I-29; M.27389: M.390 + I-29; M.27390: M.391 + I-29; M.27391: M.392 + I-29;
M.27392: M.393 + I-29; M.27393: M.394 + I-29; M.27394: M.395 + I-29; M.27395: M.396 + I-29;
M.27396: M.397 + I-29; M.27397: M.398 + I-29; M.27398: M.399 + I-29; M.27399: M.400 + I-29;
M.27400: M.401 + I-29; M.27401: M.402 + I-29; M.27402: M.403 + I-29; M.27403: M.404 + I-29;
M.27404: M.405 + I-29; M.27405: M.406 + I-29; M.27406: M.407 + I-29; M.27407: M.408 + I-29;
M.27408: M.409 + I-29; M.27409: M.410 + I-29; M.27410: M.411 + I-29; M.27411: M.412 + I-29;
M.27412: M.413 + I-29; M.27413: M.414 + I-29; M.27414: M.415 + I-29; M.27415: M.416 + I-29;
M.27416: M.417 + I-29; M.27417: M.418 + I-29; M.27418: M.419 + I-29; M.27419: M.420 + I-29;
M.27420: M.421 + I-29; M.27421: M.422 + I-29; M.27422: M.423 + I-29; M.27423: M.424 + I-29;
M.27424: M.425 + I-29; M.27425: M.426 + I-29; M.27426: M.427 + I-29; M.27427: M.428 + I-29;
M.27428: M.429 + I-29; M.27429: M.430 + I-29; M.27430: M.431 + I-29; M.27431: M.432 + I-29;
M.27432: M.433 + I-29; M.27433: M.434 + I-29; M.27434: M.435 + I-29; M.27435: M.436 + I-29;
M.27436: M.437 + I-29; M.27437: M.438 + I-29; M.27438: M.439 + I-29; M.27439: M.440 + I-29;
M.27440: M.441 + I-29; M.27441: M.442 + I-29; M.27442: M.443 + I-29; M.27443: M.444 + I-29;
M.27444: M.445 + I-29; M.27445: M.446 + I-29; M.27446: M.447 + I-29; M.27447: M.448 + I-29;
M.27448: M.449 + I-29; M.27449: M.450 + I-29.

In another embodiment, the present invention relates to ternary herbicidal mixtures M.28000 to M.28449 listed in Table M(ac) below, comprising mixtures of the binary mixtures depicted in table M(a) and a third herbicide I-30.

TABLE M(ac)
M.28000: M.1 + I-30; M.28001: M.2 + I-30; M.28002: M.3 + I-30; M.28003: M.4 + I-30;
M.28004: M.5 + I-30; M.28005: M.6 + I-30; M.28006: M.7 + I-30; M.28007: M.8 + I-30;
M.28008: M.9 + I-30; M.28009: M.10 + I-30; M.28010: M.11 + I-30; M.28011: M.12 + I-30;
M.28012: M.13 + I-30; M.28013: M.14 + I-30; M.28014: M.15 + I-30; M.28015: M.16 + I-30;
M.28016: M.17 + I-30; M.28017: M.18 + I-30; M.28018: M.19 + I-30; M.28019: M.20 + I-30;
M.28020: M.21 + I-30; M.28021: M.22 + I-30; M.28022: M.23 + I-30; M.28023: M.24 + I-30;
M.28024: M.25 + I-30; M.28025: M.26 + I-30; M.28026: M.27 + I-30; M.28027: M.28 + I-30;
M.28028: M.29 + I-30; M.28029: M.30 + I-30; M.28030: M.31 + I-30; M.28031: M.32 + I-30;
M.28032: M.33 + I-30; M.28033: M.34 + I-30; M.28034: M.35 + I-30; M.28035: M.36 + I-30;
M.28036: M.37 + I-30; M.28037: M.38 + I-30; M.28038: M.39 + I-30; M.28039: M.40 + I-30;
M.28040: M.41 + I-30; M.28041: M.42 + I-30; M.28042: M.43 + I-30; M.28043: M.44 + I-30;
M.28044: M.45 + I-30; M.28045: M.46 + I-30; M.28046: M.47 + I-30; M.28047: M.48 + I-30;
M.28048: M.49 + I-30; M.28049: M.50 + I-30; M.28050: M.51 + I-30; M.28051: M.52 + I-30;
M.28052: M.53 + I-30; M.28053: M.54 + I-30; M.28054: M.55 + I-30; M.28055: M.56 + I-30;
M.28056: M.57 + I-30; M.28057: M.58 + I-30; M.28058: M.59 + I-30; M.28059: M.60 + I-30;
M.28060: M.61 + I-30; M.28061: M.62 + I-30; M.28062: M.63 + I-30; M.28063: M.64 + I-30;
M.28064: M.65 + I-30; M.28065: M.66 + I-30; M.28066: M.67 + I-30; M.28067: M.68 + I-30;
M.28068: M.69 + I-30; M.28069: M.70 + I-30; M.28070: M.71 + I-30; M.28071: M.72 + I-30;
M.28072: M.73 + I-30; M.28073: M.74 + I-30; M.28074: M.75 + I-30; M.28075: M.76 + I-30;
M.28076: M.77 + I-30; M.28077: M.78 + I-30; M.28078: M.79 + I-30; M.28079: M.80 + I-30;
M.28080: M.81 + I-30; M.28081: M.82 + I-30; M.28082: M.83 + I-30; M.28083: M.84 + I-30;
M.28084: M.85 + I-30; M.28085: M.86 + I-30; M.28086: M.87 + I-30; M.28087: M.88 + I-30;
M.28088: M.89 + I-30; M.28089: M.90 + I-30; M.28090: M.91 + I-30; M.28091: M.92 + I-30;
M.28092: M.93 + I-30; M.28093: M.94 + I-30; M.28094: M.95 + I-30; M.28095: M.96 + I-30;
M.28096: M.97 + I-30; M.28097: M.98 + I-30; M.28098: M.99 + I-30; M.28099: M.100 + I-30;
M.28100: M.101 + I-30; M.28101: M.102 + I-30; M.28102: M.103 + I-30; M.28103: M.104 + I-30;
M.28104: M.105 + I-30; M.28105: M.106 + I-30; M.28106: M.107 + I-30; M.28107: M.108 + I-30;
M.28108: M.109 + I-30; M.28109: M.110 + I-30; M.28110: M.111 + I-30; M.28111: M.112 + I-30;
M.28112: M.113 + I-30; M.28113: M.114 + I-30; M.28114: M.115 + I-30; M.28115: M.116 + I-30;
M.28116: M.117 + I-30; M.28117: M.118 + I-30; M.28118: M.119 + I-30; M.28119: M.120 + I-30;
M.28120: M.121 + I-30; M.28121: M.122 + I-30; M.28122: M.123 + I-30; M.28123: M.124 + I-30;
M.28124: M.125 + I-30; M.28125: M.126 + I-30; M.28126: M.127 + I-30; M.28127: M.128 + I-30;
M.28128: M.129 + I-30; M.28129: M.130 + I-30; M.28130: M.131 + I-30; M.28131: M.132 + I-30;
M.28132: M.133 + I-30; M.28133: M.134 + I-30; M.28134: M.135 + I-30; M.28135: M.136 + I-30;
M.28136: M.137 + I-30; M.28137: M.138 + I-30; M.28138: M.139 + I-30; M.28139: M.140 + I-30;
M.28140: M.141 + I-30; M.28141: M.142 + I-30; M.28142: M.143 + I-30; M.28143: M.144 + I-30;
M.28144: M.145 + I-30; M.28145: M.146 + I-30; M.28146: M.147 + I-30; M.28147: M.148 + I-30;
M.28148: M.149 + I-30; M.28149: M.150 + I-30; M.28150: M.151 + I-30; M.28151: M.152 + I-30;
M.28152: M.153 + I-30; M.28153: M.154 + I-30; M.28154: M.155 + I-30; M.28155: M.156 + I-30;
M.28156: M.157 + I-30; M.28157: M.158 + I-30; M.28158: M.159 + I-30; M.28159: M.160 + I-30;
M.28160: M.161 + I-30; M.28161: M.162 + I-30; M.28162: M.163 + I-30; M.28163: M.164 + I-30;
M.28164: M.165 + I-30; M.28165: M.166 + I-30; M.28166: M.167 + I-30; M.28167: M.168 + I-30;
M.28168: M.169 + I-30; M.28169: M.170 + I-30; M.28170: M.171 + I-30; M.28171: M.172 + I-30;
M.28172: M.173 + I-30; M.28173: M.174 + I-30; M.28174: M.175 + I-30; M.28175: M.176 + I-30;
M.28176: M.177 + I-30; M.28177: M.178 + I-30; M.28178: M.179 + I-30; M.28179: M.180 + I-30;
M.28180: M.181 + I-30; M.28181: M.182 + I-30; M.28182: M.183 + I-30; M.28183: M.184 + I-30;
M.28184: M.185 + I-30; M.28185: M.186 + I-30; M.28186: M.187 + I-30; M.28187: M.188 + I-30;
M.28188: M.189 + I-30; M.28189: M.190 + I-30; M.28190: M.191 + I-30; M.28191: M.192 + I-30;
M.28192: M.193 + I-30; M.28193: M.194 + I-30; M.28194: M.195 + I-30; M.28195: M.196 + I-30;
M.28196: M.197 + I-30; M.28197: M.198 + I-30; M.28198: M.199 + I-30; M.28199: M.200 + I-30;
M.28200: M.201 + I-30; M.28201: M.202 + I-30; M.28202: M.203 + I-30; M.28203: M.204 + I-30;
M.28204: M.205 + I-30; M.28205: M.206 + I-30; M.28206: M.207 + I-30; M.28207: M.208 + I-30;
M.28208: M.209 + I-30; M.28209: M.210 + I-30; M.28210: M.211 + I-30; M.28211: M.212 + I-30;
M.28212: M.213 + I-30; M.28213: M.214 + I-30; M.28214: M.215 + I-30; M.28215: M.216 + I-30;
M.28216: M.217 + I-30; M.28217: M.218 + I-30; M.28218: M.219 + I-30; M.28219: M.220 + I-30;
M.28220: M.221 + I-30; M.28221: M.222 + I-30; M.28222: M.223 + I-30; M.28223: M.224 + I-30;
M.28224: M.225 + I-30; M.28225: M.226 + I-30; M.28226: M.227 + I-30; M.28227: M.228 + I-30;
M.28228: M.229 + I-30; M.28229: M.230 + I-30; M.28230: M.231 + I-30; M.28231: M.232 + I-30;
M.28232: M.233 + I-30; M.28233: M.234 + I-30; M.28234: M.235 + I-30; M.28235: M.236 + I-30;
M.28236: M.237 + I-30; M.28237: M.238 + I-30; M.28238: M.239 + I-30; M.28239: M.240 + I-30;
M.28240: M.241 + I-30; M.28241: M.242 + I-30; M.28242: M.243 + I-30; M.28243: M.244 + I-30;
M.28244: M.245 + I-30; M.28245: M.246 + I-30; M.28246: M.247 + I-30; M.28247: M.248 + I-30;
M.28248: M.249 + I-30; M.28249: M.250 + I-30; M.28250: M.251 + I-30; M.28251: M.252 + I-30;
M.28252: M.253 + I-30; M.28253: M.254 + I-30; M.28254: M.255 + I-30; M.28255: M.256 + I-30;
M.28256: M.257 + I-30; M.28257: M.258 + I-30; M.28258: M.259 + I-30; M.28259: M.260 + I-30;
M.28260: M.261 + I-30; M.28261: M.262 + I-30; M.28262: M.263 + I-30; M.28263: M.264 + I-30;
M.28264: M.265 + I-30; M.28265: M.266 + I-30; M.28266: M.267 + I-30; M.28267: M.268 + I-30;
M.28268: M.269 + I-30; M.28269: M.270 + I-30; M.28270: M.271 + I-30; M.28271: M.272 + I-30;
M.28272: M.273 + I-30; M.28273: M.274 + I-30; M.28274: M.275 + I-30; M.28275: M.276 + I-30;
M.28276: M.277 + I-30; M.28277: M.278 + I-30; M.28278: M.279 + I-30; M.28279: M.280 + I-30;
M.28280: M.281 + I-30; M.28281: M.282 + I-30; M.28282: M.283 + I-30; M.28283: M.284 + I-30;
M.28284: M.285 + I-30; M.28285: M.286 + I-30; M.28286: M.287 + I-30; M.28287: M.288 + I-30;
M.28288: M.289 + I-30; M.28289: M.290 + I-30; M.28290: M.291 + I-30; M.28291: M.292 + I-30;
M.28292: M.293 + I-30; M.28293: M.294 + I-30; M.28294: M.295 + I-30; M.28295: M.296 + I-30;
M.28296: M.297 + I-30; M.28297: M.298 + I-30; M.28298: M.299 + I-30; M.28299: M.300 + I-30;
M.28300: M.301 + I-30; M.28301: M.302 + I-30; M.28302: M.303 + I-30; M.28303: M.304 + I-30;
M.28304: M.305 + I-30; M.28305: M.306 + I-30; M.28306: M.307 + I-30; M.28307: M.308 + I-30;
M.28308: M.309 + I-30; M.28309: M.310 + I-30; M.28310: M.311 + I-30; M.28311: M.312 + I-30;
M.28312: M.313 + I-30; M.28313: M.314 + I-30; M.28314: M.315 + I-30; M.28315: M.316 + I-30;
M.28316: M.317 + I-30; M.28317: M.318 + I-30; M.28318: M.319 + I-30; M.28319: M.320 + I-30;
M.28320: M.321 + I-30; M.28321: M.322 + I-30; M.28322: M.323 + I-30; M.28323: M.324 + I-30;
M.28324: M.325 + I-30; M.28325: M.326 + I-30; M.28326: M.327 + I-30; M.28327: M.328 + I-30;
M.28328: M.329 + I-30; M.28329: M.330 + I-30; M.28330: M.331 + I-30; M.28331: M.332 + I-30;
M.28332: M.333 + I-30; M.28333: M.334 + I-30; M.28334: M.335 + I-30; M.28335: M.336 + I-30;
M.28336: M.337 + I-30; M.28337: M.338 + I-30; M.28338: M.339 + I-30; M.28339: M.340 + I-30;
M.28340: M.341 + I-30; M.28341: M.342 + I-30; M.28342: M.343 + I-30; M.28343: M.344 + I-30;
M.28344: M.345 + I-30; M.28345: M.346 + I-30; M.28346: M.347 + I-30; M.28347: M.348 + I-30;
M.28348: M.349 + I-30; M.28349: M.350 + I-30; M.28350: M.351 + I-30; M.28351: M.352 + I-30;
M.28352: M.353 + I-30; M.28353: M.354 + I-30; M.28354: M.355 + I-30; M.28355: M.356 + I-30;
M.28356: M.357 + I-30; M.28357: M.358 + I-30; M.28358: M.359 + I-30; M.28359: M.360 + I-30;
M.28360: M.361 + I-30; M.28361: M.362 + I-30; M.28362: M.363 + I-30; M.28363: M.364 + I-30;
M.28364: M.365 + I-30; M.28365: M.366 + I-30; M.28366: M.367 + I-30; M.28367: M.368 + I-30;
M.28368: M.369 + I-30; M.28369: M.370 + I-30; M.28370: M.371 + I-30; M.28371: M.372 + I-30;
M.28372: M.373 + I-30; M.28373: M.374 + I-30; M.28374: M.375 + I-30; M.28375: M.376 + I-30;
M.28376: M.377 + I-30; M.28377: M.378 + I-30; M.28378: M.379 + I-30; M.28379: M.380 + I-30;
M.28380: M.381 + I-30; M.28381: M.382 + I-30; M.28382: M.383 + I-30; M.28383: M.384 + I-30;
M.28384: M.385 + I-30; M.28385: M.386 + I-30; M.28386: M.387 + I-30; M.28387: M.388 + I-30;
M.28388: M.389 + I-30; M.28389: M.390 + I-30; M.28390: M.391 + I-30; M.28391: M.392 + I-30;
M.28392: M.393 + I-30; M.28393: M.394 + I-30; M.28394: M.395 + I-30; M.28395: M.396 + I-30;
M.28396: M.397 + I-30; M.28397: M.398 + I-30; M.28398: M.399 + I-30; M.28399: M.400 + I-30;
M.28400: M.401 + I-30; M.28401: M.402 + I-30; M.28402: M.403 + I-30; M.28403: M.404 + I-30;
M.28404: M.405 + I-30; M.28405: M.406 + I-30; M.28406: M.407 + I-30; M.28407: M.408 + I-30;
M.28408: M.409 + I-30; M.28409: M.410 + I-30; M.28410: M.411 + I-30; M.28411: M.412 + I-30;
M.28412: M.413 + I-30; M.28413: M.414 + I-30; M.28414: M.415 + I-30; M.28415: M.416 + I-30;
M.28416: M.417 + I-30; M.28417: M.418 + I-30; M.28418: M.419 + I-30; M.28419: M.420 + I-30;
M.28420: M.421 + I-30; M.28421: M.422 + I-30; M.28422: M.423 + I-30; M.28423: M.424 + I-30;
M.28424: M.425 + I-30; M.28425: M.426 + I-30; M.28426: M.427 + I-30; M.28427: M.428 + I-30;
M.28428: M.429 + I-30; M.28429: M.430 + I-30; M.28430: M.431 + I-30; M.28431: M.432 + I-30;
M.28432: M.433 + I-30; M.28433: M.434 + I-30; M.28434: M.435 + I-30; M.28435: M.436 + I-30;
M.28436: M.437 + I-30; M.28437: M.438 + I-30; M.28438: M.439 + I-30; M.28439: M.440 + I-30;
M.28440: M.441 + I-30; M.28441: M.442 + I-30; M.28442: M.443 + I-30; M.28443: M.444 + I-30;
M.28444: M.445 + I-30; M.28445: M.446 + I-30; M.28446: M.447 + I-30; M.28447: M.448 + I-30;
M.28448: M.449 + I-30; M.28449: M.450 + I-30.

In another embodiment, the present invention relates to ternary herbicidal mixtures M.29000 to M.29449 listed in Table M(ad) below, comprising mixtures of the binary mixtures depicted in table M(a) and a third herbicide I-31.

TABLE M(ad)
M.29000: M.1 + I-31; M.29001: M.2 + I-31; M.29002: M.3 + I-31; M.29003: M.4 + I-31;
M.29004: M.5 + I-31; M.29005: M.6 + I-31; M.29006: M.7 + I-31; M.29007: M.8 + I-31;
M.29008: M.9 + I-31; M.29009: M.10 + I-31; M.29010: M.11 + I-31; M.29011: M.12 + I-31;
M.29012: M.13 + I-31; M.29013: M.14 + I-31; M.29014: M.15 + I-31; M.29015: M.16 + I-31;
M.29016: M.17 + I-31; M.29017: M.18 + I-31; M.29018: M.19 + I-31; M.29019: M.20 + I-31;
M.29020: M.21 + I-31; M.29021: M.22 + I-31; M.29022: M.23 + I-31; M.29023: M.24 + I-31;
M.29024: M.25 + I-31; M.29025: M.26 + I-31; M.29026: M.27 + I-31; M.29027: M.28 + I-31;
M.29028: M.29 + I-31; M.29029: M.30 + I-31; M.29030: M.31 + I-31; M.29031: M.32 + I-31;
M.29032: M.33 + I-31; M.29033: M.34 + I-31; M.29034: M.35 + I-31; M.29035: M.36 + I-31;
M.29036: M.37 + I-31; M.29037: M.38 + I-31; M.29038: M.39 + I-31; M.29039: M.40 + I-31;
M.29040: M.41 + I-31; M.29041: M.42 + I-31; M.29042: M.43 + I-31; M.29043: M.44 + I-31;
M.29044: M.45 + I-31; M.29045: M.46 + I-31; M.29046: M.47 + I-31; M.29047: M.48 + I-31;
M.29048: M.49 + I-31; M.29049: M.50 + I-31; M.29050: M.51 + I-31; M.29051: M.52 + I-31;
M.29052: M.53 + I-31; M.29053: M.54 + I-31; M.29054: M.55 + I-31; M.29055: M.56 + I-31;
M.29056: M.57 + I-31; M.29057: M.58 + I-31; M.29058: M.59 + I-31; M.29059: M.60 + I-31;
M.29060: M.61 + I-31; M.29061: M.62 + I-31; M.29062: M.63 + I-31; M.29063: M.64 + I-31;
M.29064: M.65 + I-31; M.29065: M.66 + I-31; M.29066: M.67 + I-31; M.29067: M.68 + I-31;
M.29068: M.69 + I-31; M.29069: M.70 + I-31; M.29070: M.71 + I-31; M.29071: M.72 + I-31;
M.29072: M.73 + I-31; M.29073: M.74 + I-31; M.29074: M.75 + I-31; M.29075: M.76 + I-31;
M.29076: M.77 + I-31; M.29077: M.78 + I-31; M.29078: M.79 + I-31; M.29079: M.80 + I-31;
M.29080: M.81 + I-31; M.29081: M.82 + I-31; M.29082: M.83 + I-31; M.29083: M.84 + I-31;
M.29084: M.85 + I-31; M.29085: M.86 + I-31; M.29086: M.87 + I-31; M.29087: M.88 + I-31;
M.29088: M.89 + I-31; M.29089: M.90 + I-31; M.29090: M.91 + I-31; M.29091: M.92 + I-31;
M.29092: M.93 + I-31; M.29093: M.94 + I-31; M.29094: M.95 + I-31; M.29095: M.96 + I-31;
M.29096: M.97 + I-31; M.29097: M.98 + I-31; M.29098: M.99 + I-31; M.29099: M.100 + I-31;
M.29100: M.101 + I-31; M.29101: M.102 + I-31; M.29102: M.103 + I-31; M.29103: M.104 + I-31;
M.29104: M.105 + I-31; M.29105: M.106 + I-31; M.29106: M.107 + I-31; M.29107: M.108 + I-31;
M.29108: M.109 + I-31; M.29109: M.110 + I-31; M.29110: M.111 + I-31; M.29111: M.112 + I-31;
M.29112: M.113 + I-31; M.29113: M.114 + I-31; M.29114: M.115 + I-31; M.29115: M.116 + I-31;
M.29116: M.117 + I-31; M.29117: M.118 + I-31; M.29118: M.119 + I-31; M.29119: M.120 + I-31;
M.29120: M.121 + I-31; M.29121: M.122 + I-31; M.29122: M.123 + I-31; M.29123: M.124 + I-31;
M.29124: M.125 + I-31; M.29125: M.126 + I-31; M.29126: M.127 + I-31; M.29127: M.128 + I-31;
M.29128: M.129 + I-31; M.29129: M.130 + I-31; M.29130: M.131 + I-31; M.29131: M.132 + I-31;
M.29132: M.133 + I-31; M.29133: M.134 + I-31; M.29134: M.135 + I-31; M.29135: M.136 + I-31;
M.29136: M.137 + I-31; M.29137: M.138 + I-31; M.29138: M.139 + I-31; M.29139: M.140 + I-31;
M.29140: M.141 + I-31; M.29141: M.142 + I-31; M.29142: M.143 + I-31; M.29143: M.144 + I-31;
M.29144: M.145 + I-31; M.29145: M.146 + I-31; M.29146: M.147 + I-31; M.29147: M.148 + I-31;
M.29148: M.149 + I-31; M.29149: M.150 + I-31; M.29150: M.151 + I-31; M.29151: M.152 + I-31;
M.29152: M.153 + I-31; M.29153: M.154 + I-31; M.29154: M.155 + I-31; M.29155: M.156 + I-31;
M.29156: M.157 + I-31; M.29157: M.158 + I-31; M.29158: M.159 + I-31; M.29159: M.160 + I-31;
M.29160: M.161 + I-31; M.29161: M.162 + I-31; M.29162: M.163 + I-31; M.29163: M.164 + I-31;
M.29164: M.165 + I-31; M.29165: M.166 + I-31; M.29166: M.167 + I-31; M.29167: M.168 + I-31;
M.29168: M.169 + I-31; M.29169: M.170 + I-31; M.29170: M.171 + I-31; M.29171: M.172 + I-31;
M.29172: M.173 + I-31; M.29173: M.174 + I-31; M.29174: M.175 + I-31; M.29175: M.176 + I-31;
M.29176: M.177 + I-31; M.29177: M.178 + I-31; M.29178: M.179 + I-31; M.29179: M.180 + I-31;
M.29180: M.181 + I-31; M.29181: M.182 + I-31; M.29182: M.183 + I-31; M.29183: M.184 + I-31;
M.29184: M.185 + I-31; M.29185: M.186 + I-31; M.29186: M.187 + I-31; M.29187: M.188 + I-31;
M.29188: M.189 + I-31; M.29189: M.190 + I-31; M.29190: M.191 + I-31; M.29191: M.192 + I-31;
M.29192: M.193 + I-31; M.29193: M.194 + I-31; M.29194: M.195 + I-31; M.29195: M.196 + I-31;
M.29196: M.197 + I-31; M.29197: M.198 + I-31; M.29198: M.199 + I-31; M.29199: M.200 + I-31;
M.29200: M.201 + I-31; M.29201: M.202 + I-31; M.29202: M.203 + I-31; M.29203: M.204 + I-31;
M.29204: M.205 + I-31; M.29205: M.206 + I-31; M.29206: M.207 + I-31; M.29207: M.208 + I-31;
M.29208: M.209 + I-31; M.29209: M.210 + I-31; M.29210: M.211 + I-31; M.29211: M.212 + I-31;
M.29212: M.213 + I-31; M.29213: M.214 + I-31; M.29214: M.215 + I-31; M.29215: M.216 + I-31;
M.29216: M.217 + I-31; M.29217: M.218 + I-31; M.29218: M.219 + I-31; M.29219: M.220 + I-31;
M.29220: M.221 + I-31; M.29221: M.222 + I-31; M.29222: M.223 + I-31; M.29223: M.224 + I-31;
M.29224: M.225 + I-31; M.29225: M.226 + I-31; M.29226: M.227 + I-31; M.29227: M.228 + I-31;
M.29228: M.229 + I-31; M.29229: M.230 + I-31; M.29230: M.231 + I-31; M.29231: M.232 + I-31;
M.29232: M.233 + I-31; M.29233: M.234 + I-31; M.29234: M.235 + I-31; M.29235: M.236 + I-31;
M.29236: M.237 + I-31; M.29237: M.238 + I-31; M.29238: M.239 + I-31; M.29239: M.240 + I-31;
M.29240: M.241 + I-31; M.29241: M.242 + I-31; M.29242: M.243 + I-31; M.29243: M.244 + I-31;
M.29244: M.245 + I-31; M.29245: M.246 + I-31; M.29246: M.247 + I-31; M.29247: M.248 + I-31;
M.29248: M.249 + I-31; M.29249: M.250 + I-31; M.29250: M.251 + I-31; M.29251: M.252 + I-31;
M.29252: M.253 + I-31; M.29253: M.254 + I-31; M.29254: M.255 + I-31; M.29255: M.256 + I-31;
M.29256: M.257 + I-31; M.29257: M.258 + I-31; M.29258: M.259 + I-31; M.29259: M.260 + I-31;
M.29260: M.261 + I-31; M.29261: M.262 + I-31; M.29262: M.263 + I-31; M.29263: M.264 + I-31;
M.29264: M.265 + I-31; M.29265: M.266 + I-31; M.29266: M.267 + I-31; M.29267: M.268 + I-31;
M.29268: M.269 + I-31; M.29269: M.270 + I-31; M.29270: M.271 + I-31; M.29271: M.272 + I-31;
M.29272: M.273 + I-31; M.29273: M.274 + I-31; M.29274: M.275 + I-31; M.29275: M.276 + I-31;
M.29276: M.277 + I-31; M.29277: M.278 + I-31; M.29278: M.279 + I-31; M.29279: M.280 + I-31;
M.29280: M.281 + I-31; M.29281: M.282 + I-31; M.29282: M.283 + I-31; M.29283: M.284 + I-31;
M.29284: M.285 + I-31; M.29285: M.286 + I-31; M.29286: M.287 + I-31; M.29287: M.288 + I-31;
M.29288: M.289 + I-31; M.29289: M.290 + I-31; M.29290: M.291 + I-31; M.29291: M.292 + I-31;
M.29292: M.293 + I-31; M.29293: M.294 + I-31; M.29294: M.295 + I-31; M.29295: M.296 + I-31;
M.29296: M.297 + I-31; M.29297: M.298 + I-31; M.29298: M.299 + I-31; M.29299: M.300 + I-31;
M.29300: M.301 + I-31; M.29301: M.302 + I-31; M.29302: M.303 + I-31; M.29303: M.304 + I-31;
M.29304: M.305 + I-31; M.29305: M.306 + I-31; M.29306: M.307 + I-31; M.29307: M.308 + I-31;
M.29308: M.309 + I-31; M.29309: M.310 + I-31; M.29310: M.311 + I-31; M.29311: M.312 + I-31;
M.29312: M.313 + I-31; M.29313: M.314 + I-31; M.29314: M.315 + I-31; M.29315: M.316 + I-31;
M.29316: M.317 + I-31; M.29317: M.318 + I-31; M.29318: M.319 + I-31; M.29319: M.320 + I-31;
M.29320: M.321 + I-31; M.29321: M.322 + I-31; M.29322: M.323 + I-31; M.29323: M.324 + I-31;
M.29324: M.325 + I-31; M.29325: M.326 + I-31; M.29326: M.327 + I-31; M.29327: M.328 + I-31;
M.29328: M.329 + I-31; M.29329: M.330 + I-31; M.29330: M.331 + I-31; M.29331: M.332 + I-31;
M.29332: M.333 + I-31; M.29333: M.334 + I-31; M.29334: M.335 + I-31; M.29335: M.336 + I-31;
M.29336: M.337 + I-31; M.29337: M.338 + I-31; M.29338: M.339 + I-31; M.29339: M.340 + I-31;
M.29340: M.341 + I-31; M.29341: M.342 + I-31; M.29342: M.343 + I-31; M.29343: M.344 + I-31;
M.29344: M.345 + I-31; M.29345: M.346 + I-31; M.29346: M.347 + I-31; M.29347: M.348 + I-31;
M.29348: M.349 + I-31; M.29349: M.350 + I-31; M.29350: M.351 + I-31; M.29351: M.352 + I-31;
M.29352: M.353 + I-31; M.29353: M.354 + I-31; M.29354: M.355 + I-31; M.29355: M.356 + I-31;
M.29356: M.357 + I-31; M.29357: M.358 + I-31; M.29358: M.359 + I-31; M.29359: M.360 + I-31;
M.29360: M.361 + I-31; M.29361: M.362 + I-31; M.29362: M.363 + I-31; M.29363: M.364 + I-31;
M.29364: M.365 + I-31; M.29365: M.366 + I-31; M.29366: M.367 + I-31; M.29367: M.368 + I-31;
M.29368: M.369 + I-31; M.29369: M.370 + I-31; M.29370: M.371 + I-31; M.29371: M.372 + I-31;
M.29372: M.373 + I-31; M.29373: M.374 + I-31; M.29374: M.375 + I-31; M.29375: M.376 + I-31;
M.29376: M.377 + I-31; M.29377: M.378 + I-31; M.29378: M.379 + I-31; M.29379: M.380 + I-31;
M.29380: M.381 + I-31; M.29381: M.382 + I-31; M.29382: M.383 + I-31; M.29383: M.384 + I-31;
M.29384: M.385 + I-31; M.29385: M.386 + I-31; M.29386: M.387 + I-31; M.29387: M.388 + I-31;
M.29388: M.389 + I-31; M.29389: M.390 + I-31; M.29390: M.391 + I-31; M.29391: M.392 + I-31;
M.29392: M.393 + I-31; M.29393: M.394 + I-31; M.29394: M.395 + I-31; M.29395: M.396 + I-31;
M.29396: M.397 + I-31; M.29397: M.398 + I-31; M.29398: M.399 + I-31; M.29399: M.400 + I-31;
M.29400: M.401 + I-31; M.29401: M.402 + I-31; M.29402: M.403 + I-31; M.29403: M.404 + I-31;
M.29404: M.405 + I-31; M.29405: M.406 + I-31; M.29406: M.407 + I-31; M.29407: M.408 + I-31;
M.29408: M.409 + I-31; M.29409: M.410 + I-31; M.29410: M.411 + I-31; M.29411: M.412 + I-31;
M.29412: M.413 + I-31; M.29413: M.414 + I-31; M.29414: M.415 + I-31; M.29415: M.416 + I-31;
M.29416: M.417 + I-31; M.29417: M.418 + I-31; M.29418: M.419 + I-31; M.29419: M.420 + I-31;
M.29420: M.421 + I-31; M.29421: M.422 + I-31; M.29422: M.423 + I-31; M.29423: M.424 + I-31;
M.29424: M.425 + I-31; M.29425: M.426 + I-31; M.29426: M.427 + I-31; M.29427: M.428 + I-31;
M.29428: M.429 + I-31; M.29429: M.430 + I-31; M.29430: M.431 + I-31; M.29431: M.432 + I-31;
M.29432: M.433 + I-31; M.29433: M.434 + I-31; M.29434: M.435 + I-31; M.29435: M.436 + I-31;
M.29436: M.437 + I-31; M.29437: M.438 + I-31; M.29438: M.439 + I-31; M.29439: M.440 + I-31;
M.29440: M.441 + I-31; M.29441: M.442 + I-31; M.29442: M.443 + I-31; M.29443: M.444 + I-31;
M.29444: M.445 + I-31; M.29445: M.446 + I-31; M.29446: M.447 + I-31; M.29447: M.448 + I-31;
M.29448: M.449 + I-31; M.29449: M.450 + I-31.

1. Method for controlling weeds in short-statured corn plants comprising the application of a herbicide composition to the short-statured corn plants, parts of such plants, their seeds, or their locus of growth.

2. Method according to claim one, whereby the herbicide composition comprises at least one herbicide or herbicide composition selected from the group consisting of I-1, I-2, I-3, I-4, 1-5, I-6, I-7, I-8, I-9, I-10, I-11, I-12, I-13, I-14, I-15, I-16, I-17, I-18, I-19, I-20, I-21, I-22, I-23, I-24, I-25, I-26, I-27, I-28, I-29, I-30 and I-31.
